(19) United States
(12) Patent Application Publication
(10) Pub. No.: US 2024/0084062 A1
(43) Pub. Date: Mar. 14, 2024

(54) COMPOSITION, CURED SUBSTANCE OR MOLDED BODY, OPTICAL MEMBER, AND LENS

(71) Applicant: FUJIFILM Corporation, Tokyo (JP)

(72) Inventors: Takafumi NAKAYAMA, Kanagawa (JP); Naoyuki Morooka, Kanagawa (JP)

(73) Assignee: FUJIFILM Corporation, Tokyo (JP)

(21) Appl. No.: 18/494,412

(22) Filed: Oct. 25, 2023

Related U.S. Application Data
(63) Continuation of application No. PCT/JP22/21626, filed on May 26, 2022.

(30) Foreign Application Priority Data
May 31, 2021 (KR) 2021-091394
Apr. 22, 2022 (KR) 2022-070906

(51) Int. Cl. C08F 220/36; C08L 33/14

(52) U.S. Cl. CPC C08F 220/365; C08L 33/14

(57) ABSTRACT

Provided are a composition containing a component A and a component B, a cured substance or a molded body thereof, an optical member and a lens.

Component A: A compound having a nitrogen-containing fused aromatic ring as a partial structure

Component B: A compound represented by any of General Formulae (B1) to (B5)

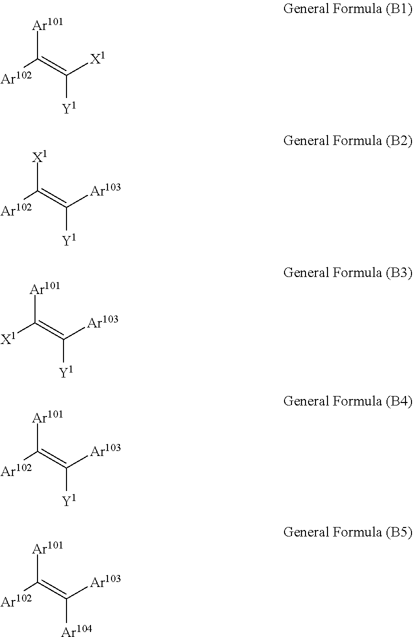

In General Formulae (B1) to (B5), Ar¹⁰¹ to Ar¹⁰⁴ represent an aryl group or a heteroaryl group, X¹ represents a monovalent substituent, Y¹ represents a hydrogen atom or a monovalent substituent, and adjacent two of Ar¹⁰¹ to Ar¹⁰⁴, X¹, and Y¹ may be bonded to each other to form a ring, where none of the monovalent substituents employed as X¹ or Y¹ is an aryl group or a heteroaryl group.

### CROSS-REFERENCE TO RELATED APPLICATIONS

This application is a Continuation of PCT International Application No. PCT/JP2022/021626 filed on May 26, 2022, which claims priority under 35 U.S.C. § 119 (a) to Japanese Patent Application No. 2021-091394 filed in Japan on May 31, 2021, and Japanese Patent Application No. 2022-070906 filed in Japan on Apr. 22, 2022. Each of the above applications is hereby expressly incorporated by reference, in its entirety, into the present application.

### BACKGROUND OF THE INVENTION

### 1. Field of the Invention

The present invention relates to a composition, a cured substance or a molded body, an optical member, and a lens.

### 2. Description of the Related Art

In the related art, glass materials have been used for optical members of imaging modules such as cameras, video cameras, mobile phones with a camera, video phones, or intercoms with a camera. The glass materials have been preferably used from the viewpoints of various optical characteristics and excellent environmental resistance, but the glass materials have a disadvantage in that weight and the size are difficult to reduce and the workability and productivity are poor. On the contrary, resin cured substances can be mass-produced and have excellent workability and thus have been used for various optical members in recent years.

In recent years, with miniaturization of imaging modules, optical members used in imaging modules are required to be miniaturized. However, a problem of chromatic aberration occurs in a case of miniaturization of the optical members. Accordingly, in optical members formed of resin cured substances, it has been examined to correct the chromatic aberration by adjusting an Abbe number using a monomer or an additive of a curable composition.

Polycyclic fused ring compounds having nitrogen atoms as atoms constituting fused rings have a low Abbe number νd or high partial dispersion ratios θg and F-Number as wavelength dispersion characteristics of the refractive index and thus have been developed as materials constituting optical members used for imaging modules. For example, JP2021-1328A describes, as a transparent optical resin, a thermoplastic resin having a structural unit that contains a polycyclic fused ring having nitrogen atoms as atoms constituting the fused ring.

Meanwhile, since optical members of imaging modules are used in a light irradiation environment such as outdoors, it is also important to suppress coloration (that is, a decrease in transmittance) of cured substances which occurs in a case of long-term use, long-term storage, or the like in a light irradiation environment such as outdoors (hereinafter, also referred to as “light resistance”).

In the past research conducted by the present inventors, it was found that light resistance is improved by using an unsaturated carbonyl compound having a specific structure such as methyl cinnamate in a case of using a compound having a nitrogen-containing fused aromatic ring in the structure as a monomer so that the unsaturated carbonyl compound acts as a quencher, as described in WO2020/009053A.

### SUMMARY OF THE INVENTION

As a result of further research repeatedly conducted by the present inventors, it is clarified that sufficiently high light resistance is not obtained in a case of using a technique of blending the unsaturated carbonyl compound having a specific structure such as methyl cinnamate described in WO2020/009053A as a quencher in a technique of using a monomer having a nitrogen-containing fused aromatic ring, and thus there is a room for further improvement.

An object of the present invention is to provide a composition which contains a compound having a nitrogen-containing fused aromatic ring and from which a cured substance or a molded body having excellent light resistance compared with the related art can be obtained. Further, another object of the present invention is to provide a cured substance or a molded body obtained from the composition, an optical member and a lens containing the cured substance or the molded body.

That is, the above-described objects of the present invention have been achieved by the following means.
<1>
A composition comprising:
a component A which is a compound having a nitrogen-containing fused aromatic ring as a partial structure; and
a component B which is a compound represented by any of General Formulae (B1) to (B5),

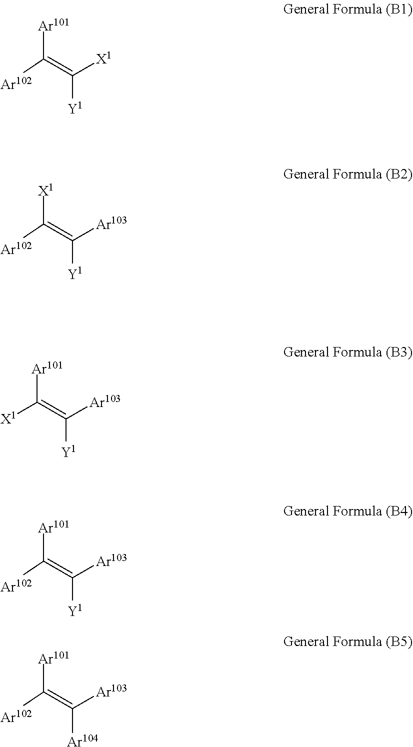

in General formulae (B1) to (B5), Ar¹⁰¹ to Ar¹⁰⁴ represent an aryl group or a heteroaryl group, X¹ represents a monovalent substituent, Y¹ represents a hydrogen atom or a monovalent substituent, and adjacent two of Ar¹⁰¹ to Ar¹⁰⁴, X¹, and Y¹ may be bonded to each other to form a ring, where none of the monovalent substituents which may be employed as X¹ or Y¹ is an aryl group or a heteroaryl group.
<2>
The composition according to <1>, in which the component A is a compound represented by General Formula (A1) or (A2) or a polymer having a structural unit represented by General Formula (A3) or (A4),

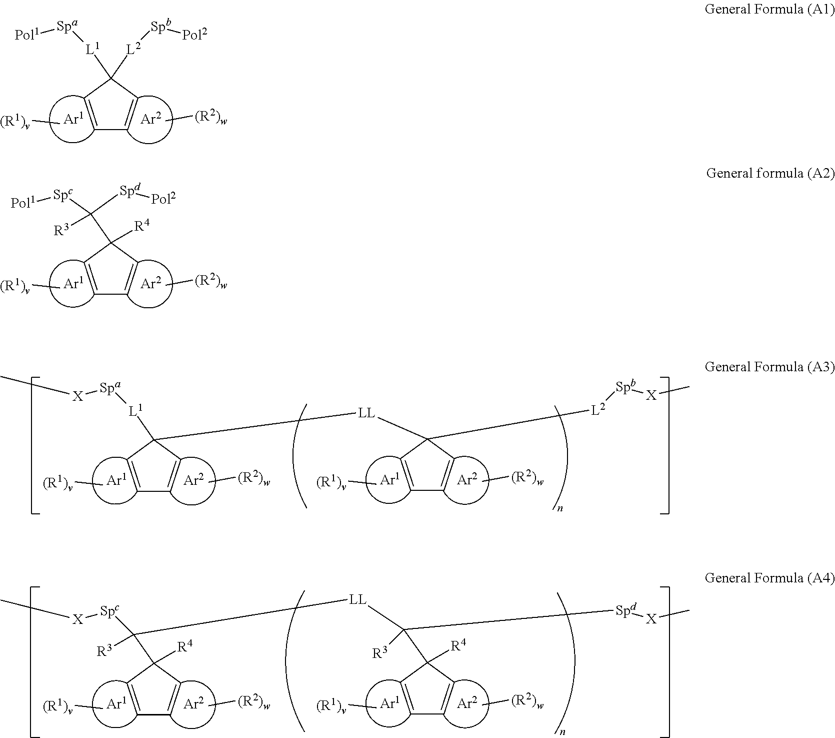

in General Formulae (A1) to (A4), R³ and R⁴ represent a hydrogen atom or a monovalent substituent,
L¹ and L² represent an alkylene group having 1 to 6 carbon atoms, an arylene group having 6 to 10 carbon atoms, or a heteroarylene group having 5 to 10 ring-constituting atoms,
LL represents a single bond or a divalent linking group,
Sp^{a} to Sp^{d} represent a single bond or a divalent linking group,
Pol¹ and Pol² represent a hydrogen atom or a polymerizable group, where at least one of Pol¹ or Pol² represents a polymerizable group,
a ring Ar¹ represents an aromatic ring represented by Formula (AR1) or a fused ring having the aromatic ring as a ring constituting the fused ring,
a ring Ar² represents an aromatic ring represented by Formula (AR2) or a fused ring having the aromatic ring as a ring constituting the fused ring, where at least one of the ring Ar¹ or the ring Ar² represents the nitrogen-containing fused aromatic ring described above,
R¹ represents a substituent contained in a ring-constituting atom of the ring Ar¹, R² represents a substituent contained in a ring-constituting atom of the ring Ar²,
v represents an integer of 0 or greater, and a maximum number of v is a maximum number of substituents that may be contained in the ring-constituting atom of the ring Ar¹,
w represents an integer of 0 or greater, and a maximum number of w is a maximum number of substituents that may be contained in the ring-constituting atom of the ring Ar²,
n represents an integer of 0 to 5, and
X represents an oxygen atom, a carbonyl group, an amino group, or a group formed by combining two of these groups,

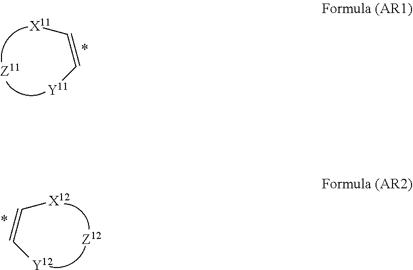

in Formulae (AR1) and (AR2), X¹¹, Y¹¹, X¹², and Y¹² represent an oxygen atom, a sulfur atom, a nitrogen atom, or a carbon atom,
Z¹¹ represents an atomic group which forms a 5- to 7-membered aromatic ring with —X¹¹—C═C—Y¹¹— and is composed of atoms selected from an oxygen atom, a sulfur atom, a nitrogen atom, and a carbon atom,
Z¹² represents an atomic group which forms a 5- to 7-membered aromatic ring with —X¹²—C═C—Y¹²— and is composed of atoms selected from an oxygen atom, a sulfur atom, a nitrogen atom, and a carbon atom, and
* corresponds to a double bond of a cyclopentadiene ring in General Formulae (A1) to (A4).
<3>
The composition according to <2>,
in which the component A is the compound represented by General Formula (A1).
<4>
The composition according to <3>,
in which the component A is a compound represented by General Formula (A11),

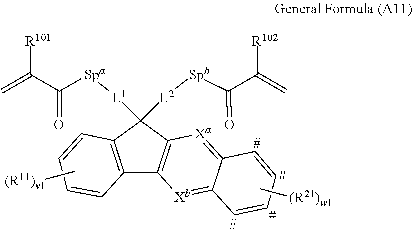

in General Formula (A11), X^{a} and X^{b} represent a nitrogen atom or CH, and CH at a position # may be substituted with a nitrogen atom, where at least one of X^{a}, X^{b}, or CH at the position # is a nitrogen atom,
R¹¹ and R²¹ represent a substituent, v1 and w1 represent an integer of 0 to 4, R¹⁰¹ and R¹⁰² represent a hydrogen atom or a methyl group, and
L¹, L², Sp^{a}, and Sp^{b} respectively have the same definition as that for L¹, L², Sp^{a}, and Sp^{b} in General Formula (A1).
<5>
The composition according to any one of <1> to <4>, in which the component B is a compound represented by any of General Formula (B11), (B41), or (B51),

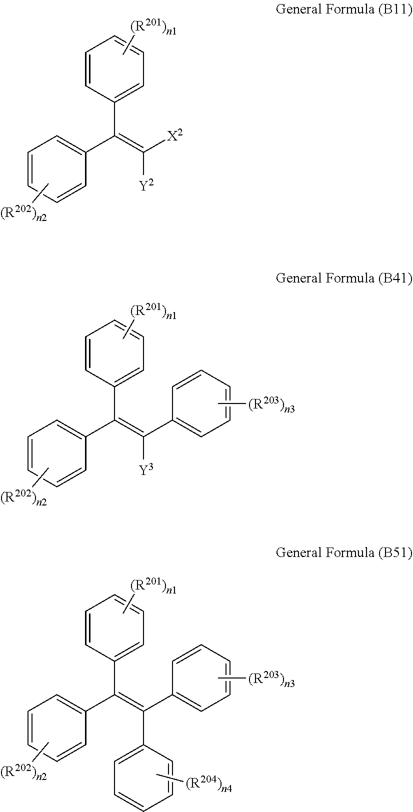

in General Formulae (B11), (B41), and (B51), R²⁰¹ to R²⁰⁴ represent a substituent, n1 to n4 represent an integer of 0 to 5, X² represents a monovalent substituent, and
Y² and Y³ represent a hydrogen atom or a monovalent substituent, where none of the monovalent substituents may be employed as X², Y², or Y³ is an aryl group or a heteroaryl group.
<6>
The composition according to <5>,
in which at least one of R²⁰¹, R²⁰², X², or Y² in General Formula (B11), at least one of R²⁰¹, R²⁰², R²⁰³, or Y³ in General Formula (B41), and at least one of R²⁰¹, R²⁰², R²⁰³, or R²⁰⁴ in General Formula (B51) have a partial structure represented by any of Formulae (Pol-1) to (Pol-6).

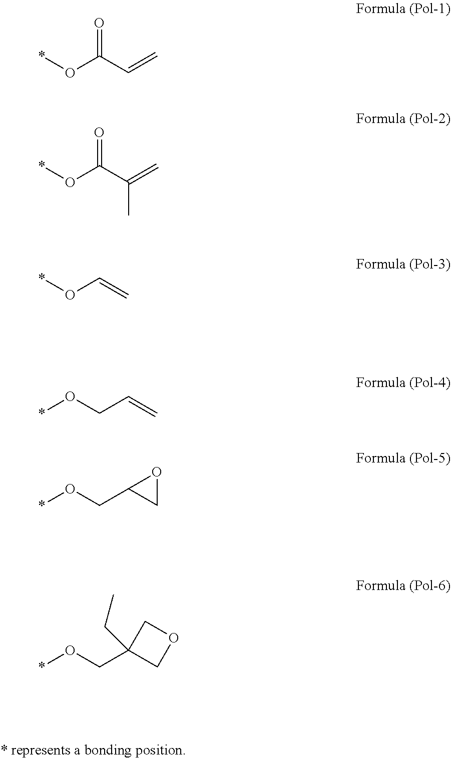

<7>
The composition according to <5>,
in which the component B is the compound represented by General Formula (B11) or (B41), where Y² represents a monovalent substituent.
<8>
The composition according to <6>,
in which the component B is a compound represented by General Formula (B12),

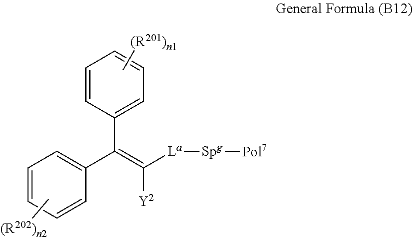

in General Formula (B12), L represents a single bond, —O—, —C(═O)—, —C(═O)O—, an alkylene group, —CR^{β1}═CR^{β2}—, a cycloalkylene group, or a cycloalkenylene group, where a right side of —C(═O)O— is bonded to Sp^{g},
R^{β1} and R^{β2} represent a hydrogen atom or a monovalent substituent,
Sp^{g} represents a single bond or a divalent linking group,
Pol⁷ is the group represented by any of Formulae (Pol-1) to (Pol-6), where, in a case where L is a single bond, Sp^{g} is a single bond, and
R²⁰¹, R²⁰², n1, n2, and Y² have the same definition as that for R²⁰¹, R²⁰², n1, n2, and
Y² described above.
<9>
A cured substance or a molded body of the composition according to any one of <1> to <8>.
<10>
An optical member comprising:
the cured substance or the molded body according to <9>.
<11>
A lens comprising: the cured substance or the molded body according to <9>.

In the present invention, in a case where a plurality of substituents or linking groups (hereinafter, referred to as the substituents or the like) represented by a specific symbol or formula are present or in a case where a plurality of substituents or the like are defined at the same time, the respective substituents or the like may be the same as or different from each other (the respective substituents or the like may be the same as or different from each other regardless of the presence of the expression “each independently”) unless otherwise specified. The same also applies to the definition of the number of substituents or the like. Further, in a case where a plurality of substituents or the like are close to each other (particularly in a case where the substituents or the like are adjacent to each other), the substituents or the like may be linked to each other to form a ring unless otherwise specified. Further, rings such as an alicyclic ring, an aromatic ring, and a heterocyclic ring may be fused to form a fused ring unless otherwise specified.

In the present invention, in a case where a molecule has an E-type double bond and a Z-type double bond, the molecule may be either an E isomer or a Z isomer or may be a mixture thereof, unless otherwise specified.

Further, in the present invention, in case where a compound has one or two or more asymmetric carbons, either the (R) isomer or the (S) isomer can be independently employed for the stereochemistry of asymmetric carbons, unless otherwise specified. In addition, the compound may be a mixture of optical isomers or stereoisomers such as diastereoisomers or a racemic isomer.

In the present invention, unless otherwise specified, in a case where a compound has a repeating structure, the repetition numbers of the repeating structures may all be the same repetition number, or it may be a mixture of compounds having different repetition numbers.

In addition, in the present invention, the expression of the compound means that a compound having a partially changed structure is included within a range where the effects of the present invention are not impaired. Furthermore, a compound in which substitution or unsubstitution is not specified may have any substituent within a range where the effects of the present invention are not impaired.

In the present invention, a substituent (the same applies to a linking group and a ring) in which substitution or unsubstitution is not specified may have any substituent within a range where desired effects are not impaired. For example, the concept of “alkyl group” includes both an unsubstituted alkyl group and a substituted alkyl group.

In the present invention, in a case where the number of carbon atoms of a certain group is defined, the number of carbon atoms denotes the number of carbon atoms of the entire group unless otherwise specified in the present invention or in the present specification. That is, in a case where this group further has a substituent, the number of carbon atoms denotes the number of carbon atoms in the entire group including this substituent.

In the present invention, a numerical range shown using “to” denotes a range including numerical values described before and after “to” as a lower limit and an upper limit.

In the composition of the present invention, each component (the component A, the component B, and other components described below which may be further contained as appropriate) may be used alone or in a mixture of two or more kinds thereof. The same also applies to the cured substance, the molded body, the optical member, and the lens obtained from the composition of the present invention.

In the description of the content of each component in the composition of the present invention, the solid content in the composition of the present invention denotes components remaining in the cured substance or the molded body obtained from the composition of the present invention, in addition to the component A and the component B. In general, the remainder obtained by removing solvents is “solid content”.

In the present specification, “(meth)acrylate” denotes any one or both acrylate and methacrylate, and “(meth)acryloyl” denotes any one or both acryloyl and methacryloyl. A monomer in the present invention is a compound distinguished from an oligomer and a polymer and having a weight-average molecular weight of 1000 or less.

In the present invention, an aliphatic hydrocarbon group denotes an alkyl group obtained by removing one arbitrary hydrogen atom from a linear or branched alkane, an alkenyl group obtained by removing one arbitrary hydrogen atom from a linear or branched alkene, or an alkynyl group obtained by removing one arbitrary hydrogen atom from a linear or branched alkyne. In the present specification, the aliphatic hydrocarbon group is preferably an alkyl group obtained by removing one arbitrary hydrogen atom from a linear or branched alkane.

Examples of the alkyl group include a methyl group, an ethyl group, a propyl group, an isopropyl group, a butyl group, an isobutyl group, a sec-butyl group, a tert-butyl group, a pentyl group, a 1-methylbutyl group, a 3-methylbutyl group, a hexyl group, a 1-methylpentyl group, a 4-methylpentyl group, a heptyl group, a 1-methylhexyl group, a 5-methylhexyl group, a 2-ethylhexyl group, an octyl group, a 1-methylheptyl group, a nonyl group, a 1-methyloctyl group, a decyl group, an undecyl group, a dodecyl group, a tridecyl group, a tetradecyl group, a pentadecyl group, a hexadecyl group, a heptadecyl group, an octadecyl group, a nonadecyl group, and an eicosyl group.

In addition, in the present invention, the aliphatic hydrocarbon group (unsubstituted) is preferably an alkyl group having 1 to 12 carbon atoms, and particularly preferably a methyl group or an ethyl group.

In the present specification, the term alkyl group denotes a linear or branched alkyl group. Examples of the alkyl group include those exemplified above. Similarly, the alkyl group in a group containing an alkyl group (such as an alkoxy group, an alkoxycarbonyl group, an acyl group, or an acyloxy group, amide group, amino group, silyl group substituted with alkoxy group (alkoxysilyl group)) denotes a linear or branched alkyl group, and examples of the alkyl group include those exemplified above.

In addition, in the present invention, examples of an alkylene group include a group obtained by removing one arbitrary hydrogen atom from the above-described alkyl groups, and examples of a linear alkylene group include a group obtained by removing one hydrogen atom bonded to a terminal carbon atom from a linear alkyl group among the above-described alkyl groups.

In the present invention, an alicyclic hydrocarbon ring denotes a saturated hydrocarbon ring (cycloalkane). Examples of the alicyclic hydrocarbon ring include cyclopropane, cyclobutane, cyclopentane, cyclohexane, cycloheptane, cyclooctane, cyclononane, and cyclodecane.

In the present invention, an unsaturated hydrocarbon ring denotes a hydrocarbon ring having a carbon-carbon unsaturated double bond, which is not an aromatic ring. Examples of the unsaturated hydrocarbon ring include indene, indane, and fluorene.

In the present invention, the term alicyclic hydrocarbon group denotes a cycloalkyl group obtained by removing one arbitrary hydrogen atom from a cycloalkane. Examples of the alicyclic hydrocarbon group include a cyclopropyl group, a cyclobutyl group, a cyclopentyl group, a cyclohexyl group, a cycloheptyl group, a cyclooctyl group, a cyclononyl group, and a cyclodecyl group. Among these, a cycloalkyl group having 3 to 12 carbon atoms is preferable.

In the present invention, the term unsaturated hydrocarbon ring group denotes a group obtained by removing one arbitrary hydrogen atom from an unsaturated hydrocarbon ring.

In the present invention, a cycloalkylene group denotes a divalent group obtained by removing two arbitrary hydrogen atoms from a cycloalkane. Examples of the cycloalkylene group include a cyclohexylene group.

In the present invention, the term aromatic ring means any one or both of an aromatic hydrocarbon ring or an aromatic heterocyclic ring.

In the present invention, an aromatic hydrocarbon ring denotes an aromatic ring forming a ring only with carbon atoms. The aromatic hydrocarbon ring may be a monocycle or a fused ring. An aromatic hydrocarbon ring having 6 to 14 carbon atoms is preferable. Examples of aromatic hydrocarbon rings include a benzene ring, a naphthalene ring, an anthracene ring, and a phenanthrene ring. In the present specification, in a case where the aromatic hydrocarbon ring is bonded to another ring, the aromatic hydrocarbon ring may be substituted on another ring as a monovalent or divalent aromatic hydrocarbon group.

In the present specification, in a case where a monovalent group is referred to as an aromatic hydrocarbon group, the monovalent group denotes a monovalent group obtained by removing one arbitrary hydrogen atom from an aromatic hydrocarbon ring. A monovalent aromatic hydrocarbon group (aryl group) is preferably an aromatic hydrocarbon group having 6 to 14 carbon atoms. Examples thereof include a phenyl group, a 1-naphthyl group, a 2-naphthyl group, a 1-anthracenyl group, a 2-anthracenyl group, a 3-anthracenyl group, a 4-anthracenyl group, a 9-anthracenyl group, a 1-phenanthryl group, a 2-phenanthryl group, a 3-phenanthryl group, a 4-phenanthryl group, and a 9-phenanthryl group. Among the examples, a phenyl group is preferable.

In the present invention, in a case where a divalent group is referred to as an aromatic hydrocarbon group, the divalent group denotes a divalent group obtained by removing one arbitrary hydrogen atom from the above-described monovalent aromatic hydrocarbon group. Examples of divalent aromatic hydrocarbon group (arylene group) include a phenylene group, a naphthylene group, and a phenanthrylene group, where, a phenylene group is preferable, and a 1,4-phenylene group is more preferable.

In the present specification, an aromatic heterocyclic ring denotes an aromatic ring whose ring is formed by carbon atoms and heteroatoms. Examples of the heteroatoms include an oxygen atom, a nitrogen atom, and a sulfur atom. The aromatic heterocyclic ring may be a monocycle or a fused ring, and the number of atoms constituting the ring is preferably 5 to 20 and more preferably 5 to 14. Each ring constituting the aromatic heterocyclic ring is preferably a 5- or 6-membered ring. The number of heteroatoms in the atoms constituting the ring is not particularly limited, but is preferably in a range of 1 to 3 and more preferably 1 or 2. Examples of the aromatic heterocyclic rings include a furan ring, a thiophene ring, a pyrrole ring, an imidazole ring, an isothiazole ring, an isoxazole ring, a pyridine ring, a pyrazine ring, a pyrimidine ring, a pyridazine ring, a quinoline ring, a benzofuran ring, a benzothiazole ring, a benzoxazole ring, and examples of nitrogen-containing fused aromatic ring described below. In the present specification, in a case where the aromatic heterocyclic ring is bonded to another ring, the aromatic heterocyclic ring may be substituted on another ring as a monovalent or divalent aromatic heterocyclic group.

In the present invention, in a case where a monovalent group is referred to as an aromatic heterocyclic group, the monovalent group denotes a monovalent group obtained by removing one arbitrary hydrogen atom from an aromatic heterocyclic ring. Examples of the monovalent aromatic heterocyclic group (heteroaryl group) include a furyl group, a thienyl group, a pyrrolyl group, an imidazolyl group, an isothiazolyl group, an isooxazolyl group, a pyridyl group, a pyrazinyl group, a pyrimidyl group, a pyridazinyl group, a quinolyl group, a benzofuranyl group (preferably, a 2-benzofuranyl group), a benzothiazolyl group (preferably, a 2-benzothiazolyl group), and a benzoxazolyl group (preferably, a 2-benzoxazolyl group). Among these, a furyl group, a thienyl group, a benzofuranyl group, a benzothiazolyl group, and a benzoxazolyl group are preferable, and a 2-furyl group and a 2-thienyl group are more preferable.

In the present invention, the term divalent aromatic heterocyclic group denotes a divalent group obtained by removing two arbitrary hydrogen atoms from an aromatic heterocyclic ring. Examples of the divalent aromatic heterocyclic group (heteroarylene group) include a divalent group obtained by removing one arbitrary hydrogen atom from the (monovalent) aromatic heterocyclic group described above.

In the present invention, examples of the halogen atoms include a fluorine atom, a chlorine atom, a bromine atom, and an iodine atom.

In the present invention, all structures represented by any of the following formula are isopropylene structures. The isopropylene structure may be any of two structural isomers in which a methyl group is bonded to any one carbon atom constituting an ethylene group or in the form of a mixture of such structural isomers.

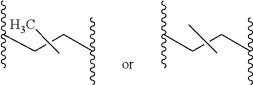

Examples of the structural isomer that can be present as in the example having the isopropylene structure include structural isomers with different substitution positions of the substituent, in a case where a polymerizable compound represented by any of General Formulae (A0) to (A2) and a polymer having a structural unit represented by General Formula (A3) or (A4) have a structure in which a substituent has been substituted with a linear alkylene group. The component A may be a mixture of such structural isomers.

The cured substance or the molded body to be obtained from the composition of the present invention has excellent light resistance. The cured substance or the molded body of the present invention has excellent light resistance. Therefore, even in a case where the optical member and lens of the present invention which contain the cured substance or the molded body as a constituent member are used long-term in a light irradiation environment such as outdoors, coloration can be suppressed.

### DESCRIPTION OF THE PREFERRED EMBODIMENTS

Hereinafter, the present invention will be described in detail. The constituent requirements described below will be described based on representative embodiments and specific examples, but the present invention is not limited to such embodiments.

<Composition>

A composition according to the embodiment of the present invention contains a component A and a component B.

Component A: A compound having a nitrogen-containing fused aromatic ring as a partial structure

Component B: A compound represented by any of General Formulae (B1) to (B5)

The component A contained in the composition according to the embodiment of the present invention may be a polymerizable compound or a polymer as long as the component A has the nitrogen-containing fused aromatic ring as a partial structure, as described below.

The composition according to the embodiment of the present invention is a curable composition in a case where the composition according to the embodiment of the present invention contains a polymerizable compound having a nitrogen-containing fused aromatic ring (also simply referred to as “compound having a nitrogen-containing fused aromatic ring”) as the component A, and the composition according to the embodiment of the present invention is a resin composition in a case where the composition according to the embodiment of the present invention contains a polymer having a nitrogen-containing fused aromatic ring (preferably a structural unit having a nitrogen-containing fused aromatic ring) as the component A. Hereinafter, the former is also referred to as a curable composition according to the embodiment of the present invention, and the latter is also referred to as a resin composition according to the embodiment of the present invention.

Among the compositions according to the embodiment of the present invention, a composition containing both the compound having a nitrogen-containing fused aromatic ring and the polymer having a nitrogen-containing fused aromatic ring is classified into the curable composition according to the embodiment of the present invention. That is, the resin composition according to the embodiment of the present invention does not contain a polymerizable compound containing a nitrogen-containing fused aromatic ring.

The composition according to the embodiment of the present invention may further contain other components in addition to the component A and the component B. Specific examples of the other components may include additives such as a (meth)acrylate monomer (monomer other than the component A or the component B), a thermal radical polymerization initiator, a photoradical polymerization initiator, a polymer or a monomer other than the components described above, a dispersant, a plasticizer, a thermal stabilizer, and a release agent. Further, it is preferable that the resin composition according to the embodiment of the present invention does not contain a polymer or monomer containing a polymerizable group, and a thermal radical polymerization initiator or a photoradical polymerization initiator.

The component A contained in the composition according to the embodiment of the present invention has a nitrogen-containing fused aromatic ring as a partial structure. It is considered that since the polymer (cured substance) thereof in a case where the composition according to the embodiment of the present invention is a curable composition containing a compound having a nitrogen-containing fused aromatic ring as the component A or the molded body in a case where the composition according to the embodiment of the present invention is a resin composition containing a polymer having a nitrogen-containing fused aromatic ring as the component A has a maximum absorption wavelength in an ultraviolet region at a wavelength range of approximately 300 to 400 nm, excellent optical characteristics such as a low Abbe number (νD) and high partial dispersion ratios (θg and F-Number) as dispersion characteristics of the refractive index are exhibited. However, the polymer having a nitrogen-containing fused aromatic ring described above is likely to be deteriorated by light (photoreaction) due to the nitrogen-containing fused aromatic ring contained as a partial structure.

As a result of the examination conducted so far by the present inventors, it was found that in a case where an unsaturated carbonyl compound having a specific structure such as methyl cinnamate is blended with a specific fused ring compound having a nitrogen atom, the unsaturated carbonyl compound acts as a quencher, energy transfer occurs from the polymer having a nitrogen-containing fused aromatic ring excited by absorbing light to the quencher, and the state of the polymer having a nitrogen-containing fused aromatic ring is returned to a ground state, and thus the light resistance is improved as described in WO2020/009053A. However, as a result of further research conducted by the present inventors, it is clarified that the effect of improving the light resistance due to the unsaturated carbonyl compound having a specific structure is not sufficient, and thus a problem that the light resistance cannot be improved any further even in a case where the amount of the unsaturated carbonyl compound to be added is increased occurs. In order to solve this problem that the light resistance is not improved any further, the present inventors found that the effect of significantly improving the light resistance is exhibited compared with the case of using methyl cinnamate by allowing the composition to contain the component B having a specific chemical structure in place of methyl cinnamate even in a case where the amount of the component B to be added is small. The reason for this is not clear, but is assumed as follows.

In the technique of the related art described in WO2020/009053A, a reaction in which the unsaturated carbonyl compound having a specific structure, such as methyl cinnamate that receives energy, generates the corresponding cyclobutane compound through the [2+2] photocyclization addition reaction is considered to occur in addition to the energy transfer from the polymer having a nitrogen-containing fused aromatic ring in the transition state described above. Among hydrogen atoms on the cyclobutane ring in the cyclobutane compound, since the hydrogen atom at the benzyl position is easily abstracted, occurrence of the hydrogen abstraction reaction due to the polymer having a nitrogen-containing fused aromatic ring which is excited by absorbing light is considered to be a factor that causes coloring of the polymer having a nitrogen-containing fused aromatic ring. In the present invention, it is assumed that the effect of improving particularly excellent light resistance can be achieved by allowing the composition to contain, as a compound having a chemical structure in which the [2+2] photocyclization addition reaction is unlikely to occur due to steric hindrance and the hydrogen abstraction reaction is unlikely to occur, a compound represented by any of General Formulae (B1) to (B5) in which at least three hydrogen atoms are substituted with substituents and at least two of the substituents are aryl groups or heteroaryl groups among four hydrogen atoms in CH₂═CH₂, as the component B.

[Component A: Compound Having Nitrogen-Containing Fused Aromatic Ring as Partial Structure]

The composition according to the embodiment of the present invention contains, as the component A, a compound having a nitrogen-containing fused aromatic ring as a partial structure. Since the component A has a nitrogen-containing fused aromatic ring as a partial structure, the cured substance of the curable composition according to the embodiment of the present invention or the molded body of the resin composition according to the embodiment of the present invention can support abnormal dispersibility of the refractive index, for example, having absorption in a near-ultraviolet region, decreasing an Abbe number (νD), or increasing the partial dispersion ratios (θg and F-Number), and thus a chromatic aberration correction function can be enhanced in a case of using the cured substance or the molded body as a compound lens.

(Nitrogen-Containing Fused Aromatic Ring)

The nitrogen-containing fused aromatic ring contained in the compound serving as the component A is a nitrogen-containing fused aromatic ring satisfying all the following items (i) to (iii).
(i) The nitrogen-containing fused aromatic ring has a fused-ring structure in which two or more 6-membered rings are fused.
(ii) The nitrogen-containing fused aromatic ring has at least one nitrogen atom (N) as a ring-constituting atom.
(iii) All ring-constituting atoms have p-orbitals, and all the p-orbitals contribute to aromaticity.

That is, the nitrogen-containing fused aromatic ring satisfying the above-described items (i) to (iii) (hereinafter, also simply referred to as “nitrogen-containing fused aromatic ring”) is an aromatic heterocyclic ring formed by two or more 6-membered rings being fused, which is an aromatic ring having at least one nitrogen atom as the ring-constituting atom constituting the aromatic heterocyclic ring.

As the definition of the item (i) described above, the nitrogen-containing fused aromatic ring has preferably a fused-ring structure in which two to five 6-membered rings are fused and more preferably a fused-ring structure in which two 6-membered rings are fused.

As the definition of the item (ii) described above, from the viewpoint of further improving the light resistance, the nitrogen-containing fused aromatic ring has preferably two or more nitrogen atoms, more preferably two or three nitrogen atoms, and still more preferably two nitrogen atoms as ring-constituting atoms.

The nitrogen-containing fused aromatic ring may have heteroatoms other than the nitrogen atom (N), such as an oxygen atom (O) or a sulfur atom (S), but it is preferable that the nitrogen-containing fused aromatic ring does not have such heteroatoms.

As the definition of the item (iii) described above, all rings (monocycles) constituting the nitrogen-containing fused aromatic ring exhibit aromaticity.

For example, in the compound represented by General Formula (A11), the nitrogen-containing fused aromatic ring has a fused-ring structure in which two 6-membered rings positioned on a lower right side in the structural formula are fused. That is, a benzene ring that may have R¹¹ positioned on a lower left side in the structural formula and a 5-membered ring positioned on a right side of the benzene ring are not included in the nitrogen-containing fused aromatic ring. This is because one of the carbon atoms constituting the 5-membered ring positioned on the right side of the benzene ring, which may have R¹¹, has a p-orbital that does not contribute to aromaticity and thus the definition of the item (iii) is not satisfied.

Further, a group represented by any of General Formulae (Ar-a) to (Ar-c) has at least a quinoxaline ring structure as the nitrogen-containing fused aromatic ring, and a group represented by General formula (Ar-d) or (Ar-e) has at least a quinazoline ring structure as the nitrogen-containing fused aromatic ring. Further, in a case where T¹ and T² or Z¹ and Z² are bonded to each other to form a nitrogen-containing fused aromatic ring satisfying all the items (i) to (iii) together with the quinoxaline ring or the quinazoline ring, the nitrogen-containing fused aromatic ring is configured to include an aromatic ring formed by T¹ and T² or Z¹ and Z² being bonded to each other.

Examples of the nitrogen-containing fused aromatic ring include a nitrogen-containing fused aromatic ring having one nitrogen atom such as an isoquinoline ring or a quinoline ring, a nitrogen-containing fused aromatic ring having two nitrogen atoms such as a phthalazine ring, a quinoxaline ring, a quinazoline ring, a cinnoline ring, or a naphthyridine ring with a different disposition of nitrogen atoms, a nitrogen-containing fused aromatic ring having three nitrogen atoms such as a pyrido[3,4-b]pyrazine ring or a pyrido[2,3-b]pyrazine ring, and a nitrogen-containing fused aromatic ring having four nitrogen atoms such as a pteridine ring. Among these, from the viewpoint of further improving the light resistance, a quinoxaline ring or a quinazoline ring is preferable.

The nitrogen-containing fused aromatic ring may have substituents or may be unsubstituted. In a case where the nitrogen-containing fused aromatic ring has substituents, adjacent substituents may be bonded to each other to form a ring.

The form in which the nitrogen-containing fused aromatic ring is incorporated in the compound as a partial structure is not particularly limited, and examples thereof include a form in which the nitrogen-containing fused aromatic ring is incorporated in the compound as a monovalent group or a divalent group by a bonding site formed by removing one hydrogen atom of any of the carbon atoms constituting the ring of the nitrogen-containing fused aromatic ring (hereinafter, also simply referred to as “bonding site on the nitrogen-containing fused aromatic ring”) or a bonding site formed by removing one hydrogen atom of any of the atoms (preferably carbon atoms) in the substituent of nitrogen-containing fused aromatic ring (hereinafter, also simply referred to as “bonding site on the substituent of the nitrogen-containing fused aromatic ring”).

For example, in a case where the nitrogen-containing fused aromatic ring is a quinoxaline ring or a quinazoline ring, the positions of the bonding sites on the quinoxaline ring or the quinazoline ring are not particularly limited, but two positions selected from a 5-position to a 8-position are preferable, and a combination of a 5-position and a 8-position or a combination of a 6-position and a 7-position is more preferable.

Further, in a case where the bonding site is a bonding site on the substituent of the quinoxaline ring or the quinazoline ring, the position of the substituent having the bonding site and the position of the bonding site are not particularly limited. As the substituent having such a bonding site, an aromatic hydrocarbon group or an aromatic heterocyclic group is preferable, an aromatic hydrocarbon group having 6 to 12 carbon atoms is more preferable, a phenyl group which may have a substituent (a phenylene group which may have a substituent as a state of having a bonding site) is still more preferable, and a phenyl group (a phenylene group as a state of having a bonding site) is particularly preferable. In a case where a phenyl group has a bonding site, it is preferable that the bonding site is positioned at the 4-position (the bonding position with respect to a quinoxaline ring or a quinazoline ring is defined as the 1-position) (that is, a 1,4-phenylene group).

The component A may be a polymerizable compound having the nitrogen-containing fused aromatic ring or a polymer having the nitrogen-containing fused aromatic ring (preferably a structural unit having the nitrogen-containing fused aromatic ring).

In a case where the composition according to the embodiment of the present invention contains the polymerizable compound having a nitrogen-containing fused aromatic ring as the component A, the composition according to the embodiment of the present invention is a curable composition, and the cured substance obtained by curing the composition according to the embodiment of the present invention, that is, polymerizing the component A can be used as a cured substance with a low Abbe number (νD) or high partial dispersion ratios (θg and F-Number). On the contrary, in a case where the composition according to the embodiment of the present invention contains the polymer having a structural unit that has a nitrogen-containing fused aromatic ring as the component A, the composition according to the embodiment of the present invention is a resin composition, and the molded body obtained by molding the composition according to the embodiment of the present invention can be used as a molded body with a low Abbe number (νD) or high partial dispersion ratios (θg and F-Number).

[Compound Having Nitrogen-Containing Fused Aromatic Ring]

As the compound having the nitrogen-containing fused aromatic ring, a compound represented by General Formula (A0) or a compound represented by General Formula (A1) or (A2) is preferable. Among these, from the viewpoint of further improving the light resistance, a compound represented by General Formula (A1) or (A2) is more preferable.

Hereinafter, the compound represented by General Formula (A0) or the compound represented by General Formula (A1) or (A2) will be sequentially described in detail.

(Compound Represented by General Formula (A0))

As the compound having the nitrogen-containing fused aromatic ring, a compound represented by General Formula (A0) is preferable.

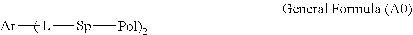

In the formula, Ar represents a group represented by any of General Formulae (Ar-a) to (Ar-e).

L represents a single bond, —O—, —S—, —C(═O)—, —OC(═O)—, —C(═O)O—, —OC(═O)O—, —NR^{α1}C(═O)—, —C(═O)—NR^{α2}—, —OC(═O)NR^{α3}—, —NR^{α4}C(═O)O—, —SC(═O)—, or —C(═O)S—.

R^{α1} to R^{α4} represent -Sp^{α}-Pol³ or a halogen atom.

Sp and Sp^{α} represent a single bond or a divalent linking group, and Pol and Pol³ represent a hydrogen atom or a polymerizable group.

A plurality of Us may be the same as or different from each other, a plurality of Sp's may be the same as or different from each other, and a plurality of Pol's may be the same as or different from each other.

Here, the polymerizable compound represented by General Formula (A0) contains at least one polymerizable group.

Hereinafter, Ar, L, Sp, and Sp^{α}, and each substituent of Pol and Pol³ will be described.

(1) Ar: group represented by any of General Formulae (Ar-a) to (Ar-e)

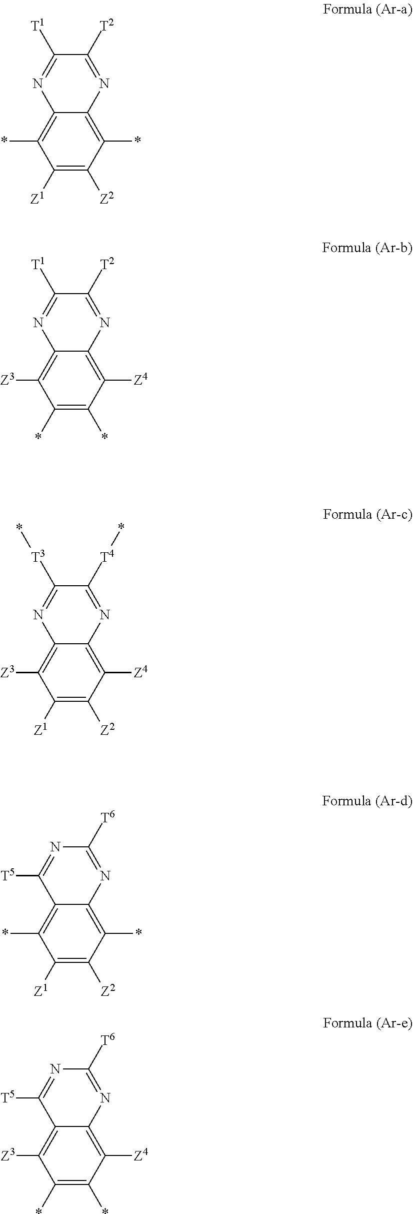

In the formulae, Z¹, Z², Z³, and Z⁴ represent a hydrogen atom or as a monovalent group, an aliphatic hydrocarbon group having 1 to 20 carbon atoms, an alkoxy group having 1 to 20 carbon atoms, an alkoxycarbonyl group having 1 to 20 carbon atoms, an alicyclic hydrocarbon group having 3 to 20 carbon atoms, an aromatic hydrocarbon group having 6 to 20 carbon atoms, a halogen atom, a cyano group, a nitro group, —NR¹²R¹³, —SR¹², or an aromatic heterocyclic group having 5 to 20 ring-constituting atoms.

Z¹ and Z² may be bonded to each other to form an aromatic hydrocarbon ring or an aromatic heterocyclic ring.

R¹² and R¹³ represent a hydrogen atom or an alkyl group having 1 to 6 carbon atoms.

Further, * represents a bonding position with respect to Pol-Sp-L-.

The aliphatic hydrocarbon group having 1 to 20 carbon atoms which can be employed as Z¹ to Z⁴, the alkoxy group having 1 to 20 carbon atoms, the alkoxycarbonyl group having 1 to 20 carbon atoms, the alicyclic hydrocarbon group having 3 to 20 carbon atoms, the aromatic hydrocarbon group having 6 to 20 carbon atoms, or the aromatic heterocyclic group having 5 to 20 ring-constituting atoms, the aromatic hydrocarbon ring or the aromatic heterocyclic ring which can be formed by Z¹ and Z² being bonded to each other, and the alkyl group having 1 to 6 carbon atoms which can be employed as R¹² and R¹³ may be unsubstituted or may have substituents.

As these substituents or the substituents that may be included by ring, there are not particularly limited as long as the substituents are not groups with extremely high releasability (easily decomposable groups) such as an acid chloride (—COCl) or -OTf(-O—SO₂CF₃). Examples thereof include a halogen atom, a hydroxy group, an amino group, a cyano group, a nitro group, a nitroso group, a carboxy group, an alkyl group having 1 to 6 carbon atoms, an alkoxy group having 1 to 6 carbon atoms, an alkoxycarbonyl group having 1 to 6 carbon atoms, an alkylcarbonyloxy group having 1 to 6 carbon atoms, an alkylcarbonyl group having 1 to 6 carbon atoms, an alkylsulfinyl group having 1 to 6 carbon atoms, an alkylsulfonyl group having 1 to 6 carbon atoms, a fluoroalkyl group having 1 to 6 carbon atoms, an alkylsulfanyl group having 1 to 6 carbon atoms, a N-alkylamino group having 1 to 6 carbon atoms, a N,N-dialkylamino group having 2 to 12 carbon atoms, a N-alkylsulfamoyl group having 1 to 6 carbon atoms, and a N,N-dialkylsulfamoyl group having 2 to 12 carbon atoms.

Among these substituents, a halogen atom, a hydroxy group, an alkyl group having 1 to 6 carbon atoms, an alkoxy group having 1 to 6 carbon atoms, or a fluoroalkyl group having 1 to 6 carbon atoms are preferable, and a fluorine atom, a chlorine atom, a bromine atom, a hydroxy group, a methyl group, a methoxy group, or a fluoromethyl group are more preferable.

It is preferable that Z¹ and Z² represent a hydrogen atom or an aliphatic hydrocarbon group having 1 to 20 carbon atoms or Z¹ and Z² are bonded to each other to form an aromatic hydrocarbon ring and more preferable that Z¹ and Z² represent a hydrogen atom or a methyl group or Z¹ and Z² are bonded to each other to form a benzene ring.

Z³ and Z⁴ represent preferably a hydrogen atom or an aliphatic hydrocarbon group having 1 to 20 carbon atoms and more preferably a hydrogen atom or a methyl group.

T¹ and T² in General Formulae (Ar-a) and (Ar-b) and T⁵ and T⁶ in General Formulae (Ar-d) and (Ar-e) represent, as a monovalent group, a halogen atom, a cyano group, a nitro group, -L⁶-Sp^{β}-Pol⁶, an alicyclic hydrocarbon group having 3 to 20 carbon atoms, an aromatic hydrocarbon group having 6 to 20 carbon atoms, an aromatic heterocyclic group having 5 to 20 ring-constituting atoms, —NR¹²R¹³ or —SR¹².

L⁶ has the same definition as that for L. Here, L⁶ represents a group in which the left side is bonded to a quinoxaline ring or a quinazoline ring and the right side is bonded to Sp^{R} in the description of the linking group exemplified as L. For example, in a case where the linking group —OC(═O)— is described as an example, the left side means an ether bond side and the right side means a carbonyl bond side.

L⁶ represents preferably a single bond, —O—, —OC(═O)—, or —C(═O)O— and more preferably a single bond.

Sp^{R} represents a single bond, a linear alkylene group having 1 to 30 carbon atoms, or a linear alkylene group having 2 to 30 carbon atoms in which one or two or more non-adjacent —CH₂—'s are substituted with a group selected from —O—, —S—, —C(═O)—, —OC(═O)—, —C(═O)O—, —OC(═O)O—, —NR^{β1}C(═O)—, —C(═O)NR^{β2}—, —OC(═O)NR^{β3}—, —NR^{β4}C(═O)O—, —SC(═O)—, and —C(═O)S—.

R^{β1} to R^{β4} represent -Sp^{γ}-Pol⁴ or a halogen atom.

Sp^{γ} represents a single bond, a linear alkylene group having 1 to 30 carbon atoms, or a linear alkylene group having 2 to 30 carbon atoms in which one or two or more non-adjacent —CH₂—'s are substituted with a group selected from —O—, —S—, —C(═O)—, —OC(═O)—, —C(═O)O—, —OC(═O)O—, —NHC(═O)—, —C(═O)NH—, —OC(═O)NH—, —NHC(═O)O—, —SC(═O)—, and —C(═O)S—.

Pol⁴ and Pol⁶ each have the same definition as that for Pol described below.

It is preferable that Sp^{β} and Sp^{γ} represent a linear alkylene group having 1 to 10 carbon atoms or a linear alkylene group having 2 to 10 carbon atoms in which one or two or more non-adjacent —CH₂—'s are substituted with a group selected from —O—, —C(═O)—, —OC(═O)—, —C(═O)O—, and —OC(═O)O—.

It is preferable that Pol⁴ and Pol⁶ represent a hydrogen atom.

Examples of -L⁶-Sp^{β}-Pol⁶ include a hydrogen atom, the following groups exemplified as the group represented by -L-Sp-Pol, a group selected from an aliphatic hydrocarbon group having 1 to 20 carbon atoms and an alkoxy group having 1 to 20 carbon atoms, and groups containing polymerizable groups at terminals of these groups.

-Sp^{γ}-Pol⁴ represents preferably a hydrogen atom or an alkyl group having 1 to 4 carbon atoms and more preferably a hydrogen atom or an unsubstituted alkyl group having 1 to 4 carbon atoms.

It is preferable that R^{β1} to R^{β4} represent a hydrogen atom, an unsubstituted alkyl group having 1 to 4 carbon atoms, or a halogen atom.

T¹ and T² represent preferably an aromatic hydrocarbon group having 6 to 20 carbon atoms, an aromatic heterocyclic group having 5 to 20 ring-constituting atoms, an aliphatic hydrocarbon group having 1 to 20 carbon atoms, or the following groups exemplified as the group represented by -L-Sp-Pol, more preferably a phenyl group, a biphenylyl group, a naphthyl group, an alkyl group having 1 to 6 carbon atoms, a furyl group, or a thienyl group, still more preferably a phenyl group, a 4-biphenylyl group, a 1-naphthyl group, a 2-naphthyl group, an alkyl group having 1 to 6 carbon atoms, a 2-furyl group, or a 2-thienyl group, and particularly preferably a phenyl group.

T¹ and T² may be the same as or different from each other, but it is preferable that T¹ and T² are the same as each other. Here, it is also preferable that one of T¹ and T² represents a phenyl group and the other represents a hydrogen atom or an alkyl group having 1 to 4 carbon atoms.

It is preferable that at least one of T¹ or T² does not represent a hydrogen atom. In addition, it is preferable that at least one of T¹ or T² represents an aromatic hydrocarbon group having 6 to 20 carbon atoms or an aromatic heterocyclic group having 5 to 20 ring-constituting atoms.

T¹ and T² may be bonded to each other to form an aromatic hydrocarbon ring or an aromatic heterocyclic ring. In this case, T¹ and T² are preferably bonded to each other to form an aromatic hydrocarbon ring, are more preferably bonded to each other to form benzene, naphthalene, anthracene, or phenanthrene, and are still more preferably bonded to each other to form benzene or phenanthrene.

T⁵ and T⁶ represent preferably an aromatic hydrocarbon group having 6 to 20 carbon atoms, an aromatic heterocyclic group having 5 to 20 ring-constituting atoms, an aliphatic hydrocarbon group having 1 to 20 carbon atoms, or the following groups exemplified as the group represented by -L-Sp-Pol, more preferably a hydrogen atom, a phenyl group, a biphenylyl group, a naphthyl group, an alkyl group having 1 to 6 carbon atoms, a furyl group, or a thienyl group, still more preferably a hydrogen atom, a phenyl group, a 4-biphenylyl group, a 1-naphthyl group, a 2-naphthyl group, an alkyl group having 1 to 6 carbon atoms, a 2-furyl group, or a 2-thienyl group, and particularly preferably a hydrogen atom or a phenyl group.

T⁵ and T⁶ may be the same as or different from each other. It is also preferable that T⁶ represents any of the above-described preferable substituents and T⁵ represents a hydrogen atom.

It is preferable that at least one of T⁵ or T⁶ does not represent a hydrogen atom. In addition, it is preferable that at least one of T⁵ or T⁶ represents an aromatic hydrocarbon group having 6 to 20 carbon atoms or an aromatic heterocyclic group.

In General Formula (Ar-c), T³ and T⁴ represent a divalent linking group, and a divalent aromatic hydrocarbon group having 6 to 12 carbon atoms, or a divalent aromatic heterocyclic group.

T³ and T⁴ represent preferably a divalent aromatic hydrocarbon group having 6 to 12 carbon atoms, more preferably a divalent aromatic hydrocarbon group having 6 to 10 carbon atoms, still more preferably a phenylene group, and particularly preferably a 1,4-phenylene group.

T³ and T⁴ may be the same as or different from each other, but it is preferable that T³ and T⁴ are the same as each other.

(2) L

In General Formula (A0), L represents a single bond, —O—, —S—, —C(═O)—, —OC(═O)—, —C(═O)O—, —OC(═O)O—, —NR^{α1}C(═O)—, —C(═O)—NR^{α2}—, —OC(═O)NR^{α3}—, —NR^{α4}C(═O)O—, —SC(═O)—, or —C(═O)S—. In the description of the linking group above, the left side is bonded to Ar, and the right side is bonded to Sp. For example, in a case where the linking group —OC(═O)— is described as an example, the left side means an ether bond side and the right side means a carbonyl bond side.

R^{α1} to R^{α4} represent -Sp^{α}-Pol³ or a halogen atom.

L represents preferably —O—, —OC(═O)—, —C(═O)O—, —OC(═O)O—, —NR^{α1}C(═O)—, —C(═O)—NR^{α2}—, —OC(═O)NR^{α3}—, or —NR^{α4}C(═O)O—, more preferably —O—, —OC(═O)—, —OC(═O)O—, or —OC(═O)NR^{α3}—, and still more preferably —O— or —OC(═O)—.

A plurality of L's may be the same or different from each other, but it is preferable that L¹ and L² are the same.

(3) Sp and Sp^{α}

Sp and Sp^{α} represent a single bond or a divalent linking group.

In a case where Sp and Sp^{α} represent a divalent linking group, examples thereof include a linear alkylene group, a cycloalkylene group, a divalent aromatic hydrocarbon group, and a divalent aromatic heterocyclic group. Other examples thereof include a linking group in which two or more linking groups selected from a linear alkylene group, a cycloalkylene group, a divalent aromatic ring group, and a divalent aromatic heterocyclic group are bonded to each other vis a linking group selected from a single bond, —O—, —S—, —C(═O)—, —OC(═O)—, —C(═O)O—, —OC(═O)O—, —NR^{α1}C(═O)—, —C(═O)NR^{α2}—, —OC(═O)NR^{α3}—, —NR^{α4}C(═O)O—, —SC(═O)—, and —C(═O)S—.

In the description of the linking group, the left side is bonded to L or N (in a case of Sp^{α}), and the right side is bonded to Pol or Pol³ (in a case of Sp^{α}). For example, in a case where the linking group —OC(═O)— is described as an example, the left side means an ether bond side and the right side means a carbonyl bond side.

R^{α1} to R^{α4} respectively have the same definition as that for R^{α1} to R^{α4} described below.

As the substituents that the linear alkylene group, the cycloalkylene group, the divalent aromatic hydrocarbon group, and the divalent aromatic heterocyclic group, which can be employed as Sp and Sp^{α}, may have, there are not particularly limited as long as the substituents are not groups with extremely high releasability (easily decomposable groups) such as an acid chloride (—COCl) or -OTf(-O—SO₂CF₃). Examples thereof include an alkyl group, a cycloalkyl group, an alkoxy group, an acyl group, an acyloxy group, an alkoxycarbonyl group, an amide group, an amino group, a halogen atom, a nitro group, a cyano group, and a substituent formed by combining two or more of the above-described substituents.

The substituent may be a group represented by -Sp⁵-Pol⁵. Sp⁵ and Pol⁵ respectively have the same definition as that for Sp and Pol, and the preferable ranges thereof are also the same as described above. The number of substituents is not particularly limited, and the above-described groups may include one to four substituents. In a case where the above-described groups include two or more substituents, two or more substituents may be the same as or different from each other.

As the divalent linking group represented by Sp, a linear alkylene group having 1 to 30 carbon atoms, a linking group in which a linear alkylene group having 1 to 30 carbon atoms and a cycloalkylene group having 3 to 10 carbon atoms are bonded to each other via a single bond, —O—, —C(═O)—, —OC(═O)—, —C(═O)O—, —OC(═O)O—, —NR^{α1}C(═O)—, or —C(═O)NR^{α2}—, or a linear alkylene group having 2 to 30 carbon atoms in which one or two or more non-adjacent —CH₂—'s are substituted with a group selected from —O—, —S—, —C(═O)—, —OC(═O)—, —C(═O)O—, —OC(═O)O—, —NR^{α1}C(═O)—, —C(═O)NR^{α2}—, —OC(═O)NR^{α3}—, —NR^{α4}C(═O)O—, —SC(═O)—, and —C(═O)S— is preferable.

In the linear alkylene group having 2 to 30 carbon atoms in which —CH₂— is substituted with a group selected from —O—, —S—, —C(═O)—, —OC(═O)—, —C(═O)O—, —OC(═O)O—, —NR^{α1}C(═O)—, —C(═O)NR^{α2}—, —OC(═O)NR^{α3}—, —NR^{α4}C(═O)O—, —SC(═O)—, and —C(═O)S— (hereinafter, also referred to as “other divalent groups in the present paragraph), it is preferable that other divalent groups are not directly bonded to L. That is, it is preferable that a moiety substituted with other divalent group is not an L side terminal of Sp.

As the divalent linking group represented by Sp, a linear alkylene group having 1 to 20 carbon atoms, a linking group in which a linear alkylene group having 1 to 20 carbon atoms and a cycloalkylene group having 3 to 6 carbon atoms are bonded to each other via —O—, —C(═O)—, —OC(═O)—, —C(═O)O—, or —OC(═O)O—, or a linear alkylene group having 2 to 20 carbon atoms in which one or two or more non-adjacent —CH₂—'s are substituted with a group selected from —O—, —C(═O)—, —OC(═O)—, —C(═O)O—, —OC(═O)O—, —NR^{α1}C(═O)—, —C(═O)NR^{α2}—, —OC(═O)NR^{α3}—, and —NR^{α4}C(═O)O— is more preferable, a linear alkylene group having 1 to 10 carbon atoms, a linking group in which a linear alkylene group having 1 to 10 carbon atoms and a cycloalkylene group having 3 to 6 carbon atoms are bonded to each other via —O—, —C(═O)—, —OC(═O)—, or —C(═O)O—, or a linear alkylene group having 2 to 10 carbon atoms in which one or two or more non-adjacent —CH₂—'s are substituted with a group selected from —O—, —C(═O)—, —OC(═O)—, and —C(═O)O— is still more preferable, and a linear alkylene group having 1 to 10 carbon atoms which has no substituent or has a methyl group as a substituent, a linking group in which a linear alkylene group having 1 to 10 carbon atoms which has no substituent or has a methyl group as a substituent and an unsubstituted cycloalkylene group having 3 to 6 carbon atoms are bonded to each other via —O—, —C(═O)—, —OC(═O)—, or —C(═O)O—, or a linear alkylene group having 2 to 10 carbon atoms which has no substituent or a methyl group as a substituent and in which one or two or more non-adjacent —CH₂—'s are substituted with a group selected from —O—, —C(═O)—, —OC(═O)—, and —C(═O)O— is particularly preferable.

A plurality of Sp's may be the same as or different from each other, but it is preferable that the plurality of Sp's are the same as each other.

In Pol-Sp-L-, it is preferable that Sp and L do not represent a single bond at the same time and more preferable that both Sp and L do not represent a single bond.

In General Formula (A0), -L-Sp- represents preferably a structure in which —OC(═O)—C₂H₄— or —OC(═O)—C₂H₄— is repeated 2 to 10 times, more preferably a structure in which —OC(═O)—C₂H₄— is repeated 2 to 5 times, and still more preferably —OC(═O)—C₂H₄—OC(═O)—C₂H₄—.

As the divalent linking group represented by Sp^{α}, a single bond or a linear alkylene group having 1 to 10 carbon atoms is preferable, a linear alkylene group having 1 to 5 carbon atoms is more preferable, a linear alkylene group having 1 to 3 carbon atoms is still more preferable, and an unsubstituted linear alkylene group having 1 to 3 carbon atoms is particularly preferable.

(4) Pol and Pol³

Pol and Pol³ represent a hydrogen atom or a polymerizable group.

The polymerizable group that can be employed as Pol and Pol³ may be a group having any of a vinylidene structure, an oxirane structure, and an oxetane structure. From the viewpoint of convenience in synthesizing a compound, as the polymerizable group, a group in which the linking moiety with respect to Sp or Sp^{α} is an oxygen atom and which has any of a vinylidene structure, an oxirane structure, and an oxetane structure is preferable, and examples thereof include a polymerizable group represented by any of Formulae (Pol-1) to (Pol-6).

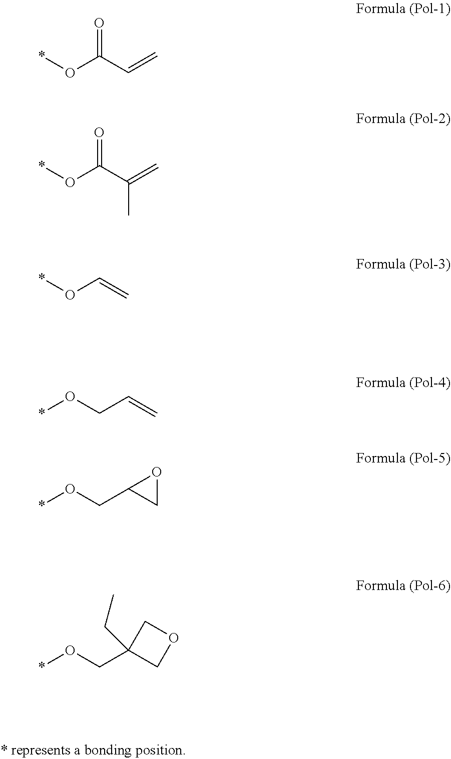

Among these, a (meth)acryloyloxy group represented by Formula (Pol-1) or (Pol-2) is preferable, and a methacryloyloxy group represented by Formula (Pol-2) is more preferable.

Pol represents preferably a polymerizable group and more preferably a (meth)acryloyloxy group. In particular, from the viewpoint of improving the moist heat durability of a lens formed of the curable composition of the embodiment of the present invention, it is particularly preferable that Pol represents a methacryloyloxy group.

A plurality of Pol's may be the same or different from each other, but it is preferable that the plurality of Pol's are the same.

The polymerizable compound represented by General Formula (A0) is a compound having at least one polymerizable group and preferably has at least two polymerizable groups. The upper limit of the number of polymerizable groups contained in the polymerizable compound represented by General Formula (A0) is not particularly limited, but is, for example, preferably 4 or less.

The polymerizable compound represented by General Formula (A0) has preferably a polymerizable group as at least Pol and more preferably a polymerizable group only as Pol.

It is preferable that Pol³ represents a hydrogen atom.

-Sp^{α}-Pol³ represents preferably a hydrogen atom or an alkyl group having 1 to 4 carbon atoms and more preferably a hydrogen atom or an unsubstituted alkyl group having 1 to 4 carbon atoms.

In the polymerizable compound represented by General Formula (A0), a plurality of Pol-Sp-L-'s may be the same as or different from each other, but it is preferable that the plurality of Pol-Sp-L-'s are the same as each other.

Examples of specific structures of Pol-Sp-L- include the following structures.

R represents a hydrogen atom or a methyl group. Further, * represents a bonding position with respect to Ar.

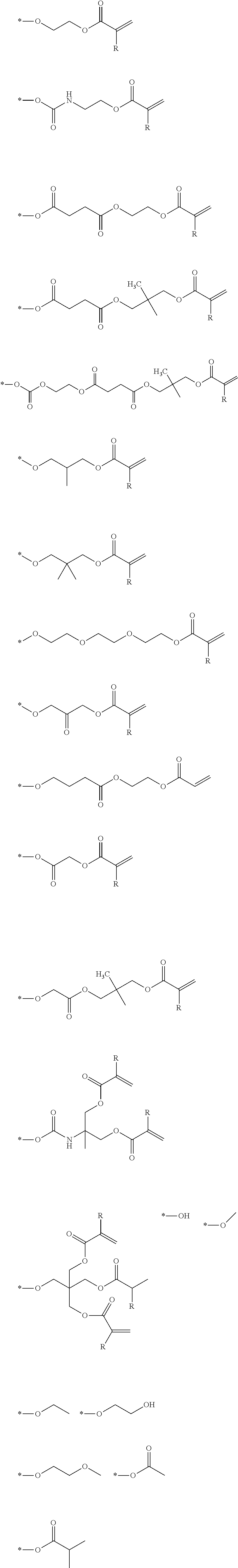

(Compound Represented by General Formula (A1) or (A2))

Preferred examples of the compound having the nitrogen-containing fused aromatic ring include a compound represented by General Formula (A1) or (A2).

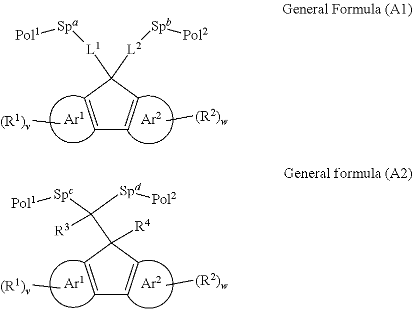

In the formulae, R³ and R⁴ represent a hydrogen atom or a monovalent substituent, L¹ and L² represent an alkylene group having 1 to 6 carbon atoms, an arylene group having 6 to 10 carbon atoms, or a heteroarylene group having 5 to 10 ring-constituting atoms, and Sp^{a} to Sp^{d} represent a single bond or a divalent linking group.

Pol¹ and Pol² represent a hydrogen atom or a polymerizable group, where at least one of Pol¹ or Pol² represents a polymerizable group.

A ring Ar¹ represents an aromatic ring represented by Formula (AR1) or a fused ring having the aromatic ring as a ring constituting the fused ring, a ring Ar² represents an aromatic ring represented by Formula (AR2) or a fused ring having the aromatic ring as a ring constituting the fused ring, where, at least one of the ring Ar¹ or the ring Ar² represents the nitrogen-containing fused aromatic ring described above.

R¹ represents a substituent contained in a ring-constituting atom of the ring Ar¹, R² represents a substituent contained in a ring-constituting atom of the ring Ar².

v represents an integer of 0 or greater, and a maximum number of v is a maximum number of substituents that may be contained in the ring-constituting atom of the ring Ar¹.

w represents an integer of 0 or greater, and a maximum number of w is a maximum number of substituents that may be contained in by the ring-constituting atom of the ring Ar².

Hereinafter, the substituents, the linking groups, and the symbols in General Formula (A1) or (A2) will be described in detail.

(1) L¹ and L²

L¹ and L² represent an alkylene group having 1 to 6 carbon atoms, an arylene group having 6 to 10 carbon atoms, or a heteroarylene group having 5 to 10 ring-constituting atoms.

As the alkylene group having 1 to 6 carbon atoms which is employed as L¹ and L², an alkylene group having 1 to 4 carbon atoms is preferable, and an alkylene group having 2 or 3 carbon atoms is more preferable. The alkylene group may be linear or branched.

In a case where an alkylene group having 1 to 6 carbon atoms is employed as L¹ and L², the number of linking atoms constituting the shortest molecular chain that links Sp^{a} or Sp^{a} and a 5-membered ring in which the ring Ar¹ and the ring Ar² are fused is preferably in a range of 1 to 6, more preferably in a range of 1 to 4, and still more preferably 2 or 3.

As the arylene group having 6 to 10 carbon atoms which can be employed as L¹ and L², a phenylene group having 6 to 10 carbon atoms is preferable, and a phenylene group having 6 or 7 carbon atoms is more preferable.

As the heteroarylene group having 5 to 10 ring-constituting atoms which can be employed as L¹ and L², a heteroarylene group having 5 to 10 ring-constituting atoms consisting of a monocycle is preferable.

In a case where an arylene group having 6 to 10 carbon atoms or a heteroarylene group having 5 to 10 ring-constituting atoms is employed as L¹ or L², the number of linking atoms constituting Sp^{a} or the shortest molecular chain among molecular chains linking Sp^{a} and a 5-membered ring in which the ring Ar¹ and the ring Ar² are fused is preferably in a range of 2 to 6 and more preferably in a range of 2 to 4.

Further, in a case where L¹ and L² represent an alkylene group having 1 to 6 carbon atoms, L¹ and L² are determined such that the number of carbon atoms of the alkylene group constituting L¹ or L² is maximized. That is, in General Formulae (A1) and (A2), the moiety bonded to L¹ or L² is not an alkylene group, among the divalent linking groups that can be employed as Sp^{a} and Sp^{b}.

Examples of the substituent that the alkylene group having 1 to 6 carbon atoms, the arylene group having 6 to 10 carbon atoms, or the heteroarylene group having 5 to 10 ring-constituting atoms, which can be employed as L¹ and L², may have include an alkyl group, a cycloalkyl group, an alkenyl group, an aryl group, a heteroaryl group, an alkoxy group, an acyl group, an acyloxy group, an alkoxycarbonyl group, a carbamoyl group, an acylamino group, an amino group, a halogen atom, a hydroxy group, a nitro group, a cyano group, and a group represented by -Sp^{δ}-Pol^{δ}.

Sp⁶ represents a single bond or a divalent linking group, and the description of Sp^{a} in General Formulae (A1) and (A2) can be applied. Pol⁶ represents a polymerizable group, and the description of the polymerizable group in Pol¹ in General Formulae (A1) and (A2) can be applied.

As the substituent that the alkylene group having 1 to 6 carbon atoms which can be employed as L¹ and L² may have, an alkoxy group, an alkoxycarbonyl group, or the group represented by -Sp-Pol is preferable, —COO-alkylene-Pol is more preferable, and —COO-alkylene-OCOCH═CH₂ or —COO-alkylene-OCOC(CH₃)═CH₂ is still more preferable.

In a case where the alkylene group having 1 to 6 carbon atoms which can be employed as L¹ and L² has substituents, the number of the substituents is not particularly limited, and for example, the alkylene group may have 1 to 4 substituents, is preferably 1 or 2 substituents, and more preferably one substituent.

It is preferable that the alkylene group having 1 to 6 carbon atoms which can be employed as L¹ and L² does not have a substituent.

As the substituent that the arylene group having 6 to 10 carbon atoms or the heteroarylene group having 5 to 10 ring-constituting atoms, which can be employed as L1 and L2, may have, a halogen atom, an alkyl group, an alkoxy group, an aryl group, or a cyano group is preferable, a halogen atom, an alkyl group having 1 to 5 carbon atoms, an alkoxy group having 1 to 5 carbon atoms, a phenyl group, or a cyano group is more preferable, a halogen atom, a methyl group, a methoxy group, a phenyl group, or a cyano group is still more preferable, and a methyl group or a methoxy group is particularly preferable.

The number of substituents of the arylene group having 6 to 10 carbon atoms or the heteroarylene group having 5 to 10 ring-constituting atoms, which can be employed as L¹ and L² is preferably 0 or 1 and more preferably 0.

It is preferable that L¹ and L² represent an alkylene group having 1 to 6 carbon atoms or an arylene group having 6 to 10 carbon atoms.

(2) Sp^{a} and Sp^{b}

Sp^{a} and Sp^{b} represent a single bond or a divalent linking group.

Examples of the divalent linking group which can be employed as Sp^{a} or Sp^{b} include a divalent linking group formed by bonding one or two or more groups selected from a linear alkylene group, a cycloalkylene group, an arylene group, a heteroarylene group, —O—, —S—, >C(═O), and >NR^{γ1}.

R^{γ1} represents a hydrogen atom or an alkyl group having 1 to 3 carbon atoms.

Here, the moiety bonded to L¹ or L² is not a linear alkylene group or a cycloalkylene group, among the divalent linking groups that can be employed as Sp^{a} and Sp^{b}.

The number of carbon atoms of the linear alkylene group that may be contained in can be employed as Sp^{a} or Sp^{b} is preferably in a range of 1 to 8, more preferably in a range of 1 to 6, still more preferably in a range of 1 to 4, and particularly preferably 1 or 2.

The number of carbon atoms of the cycloalkylene group that can be employed as Sp^{a} or Sp^{b} is preferably in a range of 3 to 6.

The number of carbon atoms of the arylene group that can be employed as Sp^{a} or Sp^{b} is preferably in a range of 6 to 10 and more preferably 6.

The number of ring-constituting atoms of the heteroarylene group that can be employed as Sp^{a} or Sp^{b} is preferably in a range of 5 to 10 and more preferably in a range of 5 to 7.

The number of carbon atoms in the “linear alkylene group” denotes the number of carbon atoms in a state where the linear alkylene group does not have a substituent. In a case where the “linear alkylene group” has a substituent, an alkyl group can also be employed as the substituent. In this case, the number of linking atoms of the moiety corresponding to the shortest molecular chain linking L¹ and Pol¹ or L² and Pol² in Sp^{a} and Sp^{b} corresponds to that in the “linear alkylene group” even though the number of linking atoms thereof corresponds to that in the branched alkylene group as a whole.

The number of carbon atoms in the “cycloalkylene group” and “arylene group” denotes the number of carbon atoms in a state where substituents are excluded.

Examples of the substituent that the linear alkylene group, the cycloalkylene group, the arylene group, or the heteroarylene group in Sp^{a} and Sp^{b} may have include an alkyl group, a cycloalkyl group, an alkoxy group, an acyl group, an acyloxy group, an alkoxycarbonyl group, a carbamoyl group, an acylamino group, an amino group, a halogen atom, a nitro group, and a cyano group. Among these, an alkyl group is preferable, an alkyl group having 1 to 3 carbon atoms is more preferable, and a methyl group is still more preferable.

The number of substituents is not particularly limited, and for example, one to four substituents may be included in Sp.

The number of kinds of the linear alkylene group, the cycloalkylene group, the arylene group, the heteroarylene group, —O—, —S—, >C(═O), and >NR^{γ1} constituting Sp^{a} and Sp^{b} which represent a divalent linking group is not particularly limited, but is preferably in a range of 1 to 5 and more preferably in a range of 1 to 3. Further, even in a case where a plurality of groups classified as the linear alkylene group are present, the number of kinds of the groups constituting Sp^{a} and Sp^{b} is calculated as one kind of linear alkylene group. The same applies to the cycloalkylene group, the arylene group, the heteroarylene group, and >NR^{γ1}.

In Sp^{a} and Sp^{b} which represent a divalent linking group, examples of the group formed by linking two or more of —O—, —S—, >C(═O), and >NR^{γ1} include —C(═O)O—, —NR^{γ1}C(═O)—, —SC(═O)—, —OC(═O)O—, and —NR^{γ1}C(═O)O—. Among these, —C(═O)O—, —NR^{γ1}C(═O)—, or —SC(═O)— is preferable, and —C(═O)O— is more preferable.

The group formed by linking two or more of —O—, —S—, >C(═O), and >NR^{γ1} may form Sp^{a} and Sp^{b} which represent a divalent linking group alone or together with at least any one of the linear alkylene group, the cycloalkylene group, the arylene group, or the heteroarylene group, preferably form Sp^{a} and Sp^{b} which represent a divalent linking group together with at least any one of the linear alkylene group, the cycloalkylene group, the arylene group, or the heteroarylene group, and more preferably form Sp^{a} and Sp^{b} which represent a divalent linking group together with at least any one of the linear alkylene group and the cycloalkylene group.

Further, —C(═O)O—, —NR^{γ1}C(═O)—, —NR^{γ1}C(═O)O—, or —SC(═O)— may be disposed such that either the left bonding site or the right bonding site is positioned on the L¹ side or the L² side.

From the viewpoint of further increasing the ratio of the cyclopentadiene skeleton in the compound and the fused structure portion consisting of Ar¹ and Ar², the number of linking atoms constituting the shortest molecular chain linking L¹ and Pol¹ or L² and Pol² in Sp^{a} and Sp^{b} is preferably in a range of 1 to 14, more preferably in a range of 1 to 10, and still more preferably in a range of 1 to 8.

Sp^{a} and Sp^{b} represent preferably a single bond or a divalent linking group formed by bonding one or two or more groups selected from a linear alkylene group, —O—, and >C(═O) and more preferably a divalent linking group formed by bonding one or two or more groups selected from a linear alkylene group, —O—, and >C(═O).

Sp^{a} and Sp^{b} may be the same as or different from each other, but it is preferable that Sp^{a} and Sp^{b} are the same as each other.

(3) Sp^{a} and Sp^{d}

Sp^{c} and Sp^{d} represent a single bond or a divalent linking group.

Examples of the divalent linking group which can be employed as Sp^{c} and Sp^{d} include a divalent linking group formed by bonding one or two or more groups selected from a linear alkylene group, a cycloalkylene group, an arylene group, a heteroarylene group, —O—, —S—, >C(═O), and >NR^{γ2}.

R^{γ2} represents a hydrogen atom or an alkyl group having 1 to 3 carbon atoms.

The number of carbon atoms of the linear alkylene group that can be employed as Sp^{c} or Sp^{d} is preferably in a range of 1 to 8, more preferably in a range of 1 to 6, still more preferably in a range of 1 to 4, and particularly preferably 1 or 2.

The number of carbon atoms of the cycloalkylene group that can be employed as Sp^{c} or Sp^{d} is preferably in a range of 3 to 6.

The number of carbon atoms of the arylene group that can be employed as Sp^{c} or Sp^{d} is preferably in a range of 6 to 10 and more preferably 6.

The number of ring-constituting atoms of the heteroarylene group that can be employed as Sp^{c} or Sp^{d} is preferably in a range of 5 to 10 and more preferably in a range of 5 to 7.

The number of carbon atoms in the “linear alkylene group” denotes the number of carbon atoms in a state where the linear alkylene group does not have a substituent. In a case where the “linear alkylene group” has a substituent, an alkyl group can also be employed as the substituent. In this case, the number of linking atoms of the moiety corresponding to the shortest molecular chain linking CR³ and Pol¹ or CR³ and Pol² in Sp^{c} and Sp^{d} corresponds to that in the “linear alkylene group” even though the number of linking atoms thereof corresponds to that in the branched alkylene group as a whole.

The number of carbon atoms in the “cycloalkylene group” and “arylene group” denotes the number of carbon atoms in a state where substituents are excluded.

Examples of the substituent that the linear alkylene group, the cycloalkylene group, the arylene group, or the heteroarylene group in Sp^{c} and Sp^{d} may have include an alkyl group, a cycloalkyl group, an alkoxy group, an acyl group, an acyloxy group, an alkoxycarbonyl group, a carbamoyl group, an acylamino group, an amino group, a halogen atom, a nitro group, and a cyano group. Among these, an alkyl group is preferable, an alkyl group having 1 to 3 carbon atoms is more preferable, and a methyl group is still more preferable.

The number of substituents is not particularly limited, and for example, one to four substituents may be included in Sp.

The number of kinds of the linear alkylene group, the cycloalkylene group, the arylene group, the heteroarylene group, —O—, —S—, >C(═O), and >NR^{γ2} constituting Sp^{c} and Sp^{d} which represent a divalent linking group is not particularly limited, but is preferably in a range of 1 to 5 and more preferably in a range of 1 to 3. Further, even in a case where a plurality of groups classified as the linear alkylene group are present, the number of kinds of the groups constituting Sp^{c} and Sp^{d} is calculated as one kind of linear alkylene group. The same applies to the cycloalkylene group, the arylene group, the heteroarylene group, and >NR^{γ2}.

In Sp^{c} and Sp^{d} which represent a divalent linking group, examples of the group formed by linking two or more of —O—, —S—, >C(═O), and —NR^{γ2} include —C(═O)O—, —NR^{γ2}C(═O)—, —SC(═O)—, —OC(═O)O—, and —NR^{γ2}C(═O)O—. Among these, —C(═O)O—, —NR^{γ2}C(═O)—, or —SC(═O)— is preferable, and —C(═O)O— is more preferable.

The group formed by linking two or more of —O—, —S—, >C(═O), and >NR^{γ2} may form Sp^{c} and Sp^{d} which represent a divalent linking group alone or together with at least any one of the linear alkylene group, the cycloalkylene group, the arylene group, or the heteroarylene group, preferably form Sp^{c} and Sp^{d} which represent a divalent linking group together with at least any one of the linear alkylene group, the cycloalkylene group, the arylene group, or the heteroarylene group, and more preferably form Sp^{c} and Sp^{d} which represent a divalent linking group together with at least any one of the linear alkylene group and the cycloalkylene group.

Further, —C(═O)O—, —NR^{γ2}C(═O)—, —NR^{γ2}C(═O)O—, or —SC(═O)— may be disposed such that either the left bonding site or the right bonding site is positioned on the CR³ side.

From the viewpoint of further increasing the ratio of the cyclopentadiene skeleton in the compound and the fused structure portion consisting of Ar¹ and Ar², the number of linking atoms constituting the shortest molecular chain linking CR³ and Pol¹ or CR³ and Pol² in Sp^{c} and Sp^{d} is preferably in a range of 1 to 14, more preferably in a range of 1 to 10, still more preferably in a range of 1 to 8, and particularly preferably in a range of 1 to 6.

It is preferable that Sp^{a} and Sp^{b} represent a single bond or a divalent linking group formed by bonding one or two or more groups selected from a linear alkylene group, —O—, and >C(═O).

Sp^{c} and Sp^{d} may be the same as or different from each other, but it is preferable that Sp^{c} and Sp^{d} are the same as each other.

In Sp^{c} and Sp^{d}, it is preferable that one of Sp^{c} or Sp^{d} represents -alkylene-C (═O)O-alkylene- and the other represents —C(═O)O-alkylene-.

(4) R³ and R⁴

R³ and R⁴ represent a hydrogen atom or a monovalent substituent.

Examples of the monovalent substituent that can be employed as R³ and R⁴ include an alkyl group, a cycloalkyl group, an alkoxy group, an acyl group, an acyloxy group, an alkoxycarbonyl group, a carbamoyl group, an acylamino group, an amino group, a halogen atom, a nitro group, and a cyano group. Among these, an alkyl group is preferable.

The number of carbon atoms of the alkyl group that can be employed as R³ and R⁴ is preferably in a range of 1 to 6, more preferably in a range of 1 to 4, and still more preferably 1 or 2.

It is preferable that R³ and R⁴ represent a hydrogen atom.

(5) Pol¹ and Pol²

Pol¹ and Pol² represent a hydrogen atom or a polymerizable group, where at least one of Pol¹ or Pol² represents a polymerizable group.

As the polymerizable group that can be employed as Pol¹ and Pol², the description of the polymerizable group that can be employed as Pol and Pol³ in General Formula (A0) can be applied.

It is preferable that any one of Pol¹ or Pol² represents a (meth)acryloyloxy group and more preferable that both Pol¹ and Pol² represent a (meth)acryloyloxy group.

Pol¹ and Pol² may be the same as or different from each other, but it is preferable that Pol¹ and Pol² are the same as each other.

(6) Ring Ar¹ and Ring Ar²

A ring Ar¹ represents an aromatic ring represented by Formula (AR1) or a fused ring having the aromatic ring as a ring constituting the fused ring, a ring Ar² represents an aromatic ring represented by Formula (AR2) or a fused ring having the aromatic ring as a ring constituting the fused ring, where, at least one of the ring Ar¹ or the ring Ar² represents the nitrogen-containing fused aromatic ring described above.

In a case where the ring Ar¹ and the ring Ar² represent a fused ring, the number of ring members of each ring constituting the fused ring is preferably in a range of 5 to 7, more preferably 5 or 6, and still more preferably 6. Here, in a case where the ring Ar¹ or the ring Ar² represents the above-described nitrogen-containing fused aromatic ring, the number of ring members of each ring constituting the fused ring is 6.

Further, in a case where the ring Ar¹ and the ring Ar² represent a fused ring, the number of rings constituting the fused ring is preferably 2 or 3 and more preferably 2. It is preferable that one of the ring Ar¹ and the ring Ar² represents a monocycle represented by Formula (AR1) or (AR2) and the other represents a fused ring. The number of rings constituting the fused ring is preferably 2.

As the ring-constituting atom other than the ring represented by Formula (AR1) or (AR2) among the ring-constituting atoms constituting the fused ring, a carbon atom, an oxygen atom, a sulfur atom, or a nitrogen atom is preferable, a carbon atom or a nitrogen atom is more preferable, and a carbon atom is still more preferable.

As the ring other than the ring represented by Formula (AR1) or (AR2) constituting the fused ring, for example, a benzene ring or a pyridine ring is preferable.

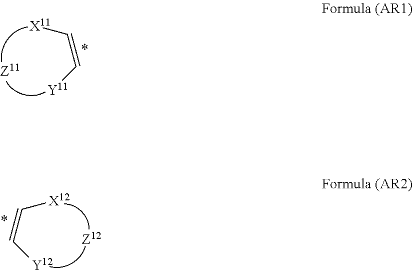

In Formulae (AR1) and (AR2), X¹¹, Y¹¹, X¹², and Y¹² represent an oxygen atom, a sulfur atom, a nitrogen atom, or a carbon atom.

Z¹¹ represents an atomic group which forms a 5- to 7-membered aromatic ring with —X¹¹—C═C—Y¹¹— and is composed of atoms selected from an oxygen atom, a sulfur atom, a nitrogen atom, and a carbon atom.

Z¹² represents an atomic group which forms a 5- to 7-membered aromatic ring with —X¹²—C═C—Y¹²— and is composed of atoms selected from an oxygen atom, a sulfur atom, a nitrogen atom, and a carbon atom.

* corresponds to a double bond of a cyclopentadiene ring in General Formulae (A1) to (A4). That is, the cyclopentadiene ring is fused with the ring Ar¹ and the ring Ar² by respectively sharing the side indicated by *.

(X¹¹, Y¹¹, X¹², and Y¹²)

X¹¹, Y¹¹, X¹², and Y¹² represent an oxygen atom, a sulfur atom, a nitrogen atom, or a carbon atom and preferably a nitrogen atom or a carbon atom.

In particular, it is preferable that both X¹¹ and Y¹¹ represent a carbon atom in a case where the ring Ar¹ described below represents a monocycle, and it is preferable that at least one of X¹¹ or Y¹¹ represents a nitrogen atom and more preferable that both X¹¹ and Y¹¹ represent a nitrogen atom in a case where the ring Ar¹ described below represents a fused ring.

Similarly, it is preferable that both X¹² and Y¹² represent a carbon atom in a case where the ring Ar² described below represents a monocycle, and it is preferable that at least one of X¹² or Y¹² represents a nitrogen atom and more preferable that both X¹² and Y¹² represent a nitrogen atom in a case where the ring Ar² described below represents a fused ring.

(Z¹¹ and Z¹²)

Z¹¹ represents an atomic group which forms a 5- to 7-membered aromatic ring together with —X¹¹—C═C—Y¹¹—, preferably an atomic group which forms a 5- or 6-membered aromatic ring, and more preferably an atomic group which forms a 6-membered aromatic ring.

Z¹² represents an atomic group which forms a 5- to 7-membered aromatic ring together with —X¹²—C═C—Y¹²—, preferably an atomic group which forms a 5- or 6-membered aromatic ring, and more preferably an atomic group which forms a 6-membered aromatic ring.

Z¹¹ and Z¹² represent an atomic group consisting of atoms selected from an oxygen atom, a sulfur atom, a nitrogen atom, and a carbon atom. As Z¹¹ and Z¹², an atomic group consisting of atoms selected from an oxygen atom, a sulfur atom, a nitrogen atom, and a carbon atom, and having at least a carbon atom is preferable, an atomic group consisting of atoms selected from a nitrogen atom and a carbon atom and having at least a carbon atom is more preferable, and an atomic group consisting of a carbon atom is still more preferable.

(7) R¹ and R²

R¹ represents a substituent contained in a ring-constituting atom of the ring Ar¹, R² represents a substituent contained in a ring-constituting atom of the ring Ar². R¹ and R² each represent a substituent that a nitrogen atom or a carbon atom represented by NH or CH may have in a case of unsubstitution, among the ring-constituting atoms in the ring Ar¹ or the ring Ar².

The substituent which can be employed as R¹ and R² is not particularly limited, and examples thereof include a halogen atom, an alkyl group, an acyl group, a hydroxy group, an alkoxy group, an aromatic hydrocarbon ring group, and a cyano group.

The substitution position of R¹ in the ring Ar¹ and the substitution position of R² in the ring Ar² are not particularly limited.

The number of carbon atoms of the alkyl group which can be employed as R¹ and R² is preferably in a range of 1 to 5, more preferably in a range of 1 to 3, and still more preferably 1.

The number of carbon atoms of the alkoxy group which can be employed as R¹ and R² is preferably in a range of 1 to 5, more preferably in a range of 1 to 3, and still more preferably 1.

The number of carbon atoms of the aromatic hydrocarbon ring group which can be employed as R¹ and R² is preferably in a range of 6 to 14 and more preferably in a range of 6 to 10.

As the halogen atom which can be employed as R¹ and R², a fluorine atom, a chlorine atom, or a bromine atom is preferable, and a chlorine atom is more preferable.

R¹ and R² represent preferably a halogen atom, an alkyl group, an alkoxy group, an aromatic hydrocarbon group, or a cyano group, more preferably a halogen atom, an alkyl group having 1 to 5 carbon atoms, or an alkoxy group having 1 to 5 carbon atoms, and still more preferably a halogen atom, a methyl group, or a methoxy group.

(8) v and w

v represents an integer of 0 or greater, and a maximum number of v is a maximum number of substituents that may be contained in the ring-constituting atom of the ring Ar¹.

w represents an integer of 0 or greater, and a maximum number of w is a maximum number of substituents that may be contained in by the ring-constituting atom of the ring Ar².

v and w represent preferably an integer of 0 to 4 and more preferably an integer of 0 to 2.

The sum of v and w is preferably an integer of 0 to 4 and more preferably an integer of 0 to 2.

As the compound having the nitrogen-containing fused aromatic ring, a compound represented by General Formula (A1) is preferable, and a compound represented by General Formula (A11) is more preferable.

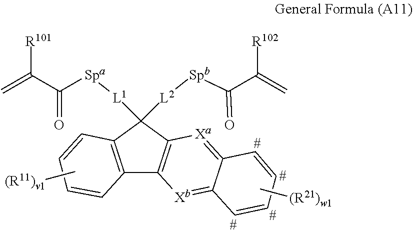

In the formula, X^{a} and X^{b} represent a nitrogen atom or CH, and CH at a position # may be substituted with a nitrogen atom, where at least one of X^{a}, X^{b}, or CH at the position # is a nitrogen atom.

R¹¹ and R²¹ represent a substituent, and v1 and w1 represent an integer of 0 to 4. R¹⁰¹ and R¹⁰² represent a hydrogen atom or a methyl group.

L¹, L², Sp^{a}, and Sp^{b} respectively have the same definition as that for L¹, L², Sp^{a}, and Sp^{b} in General Formula (A1).

It is preferable that v1 and w1 represent an integer of 0 to 2.

As the substituents that can be employed as R¹¹ and R²¹, the description of the substituents that can be employed as R¹ and R² can be applied.

Further, R²¹ represents a substituent that may be included in the carbon atom in CH which can be employed by X^{a} and X^{b} and that the carbon atom in CH at the position #.

The substitution position of R¹¹ or R²¹ in a case where R¹¹ or R²¹ is present is not particularly limited, but it is preferable that R¹¹ or R²¹ is present at the position represented by the following structure.

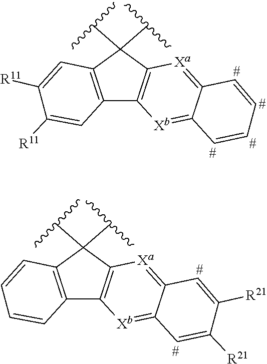

It is preferable that at least one of X^{a} or X^{b} represents a nitrogen atom and more preferable that both X^{a} and X^{b} represent a nitrogen atom.

Further, it is preferable that none of CH's at the position # is substituted with a nitrogen atom or one CH is substituted with a nitrogen atom and more preferable that none of CH's is substituted with a nitrogen atom.

Here, as the compound represented by General Formula (A11), at least one of X^{a}, X^{b}, or CH at the position # represents a nitrogen atom and it is preferable that at least one of X^{a} or X^{b} represents a nitrogen atom.

That is, as the compound represented by General Formula (A11), a compound represented by General Formula (A11a) or (A11b) is more preferable, and a compound represented by General Formula (A11b) is still more preferable.

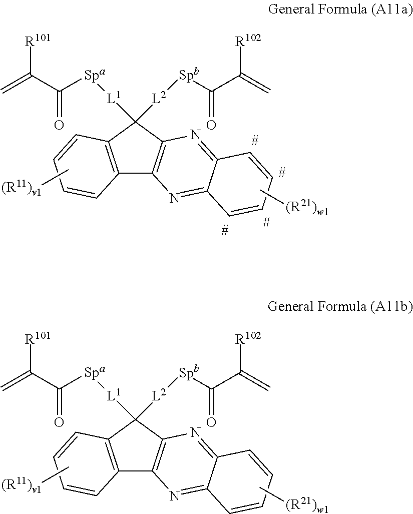

In the formulae, R¹¹, R²¹, R¹⁰¹, R¹⁰², L¹, L², Sp^{a}, Sp^{b}, v1, and w1 respectively have the same definition as that for R¹¹, R²¹, R¹⁰¹, R¹⁰², L¹, L², Sp^{a}, Sp^{b}, v1, and w1 in General Formula (A11).

One of CH's at the position # is substituted with a nitrogen atom.

As the compound having the nitrogen-containing fused aromatic ring, as described above, a compound represented by General Formula (A1) or (A2) is more preferable from the viewpoint of further improving the light resistance, and the compound represented by General Formula (A1) is still more preferable.

A method of obtaining the compound having the nitrogen-containing fused aromatic ring as the component A is not particularly limited, and a commercially available product or a compound obtained by synthesis may be used. In a case where the compound is obtained by synthesis, a method of producing the compound having the nitrogen-containing fused aromatic ring is not particularly limited, and the compound can be produced using a method of the related art with reference to the methods in examples described below.

[Polymer Having Structural Unit Having Nitrogen-Containing Fused Aromatic Ring]

(Polymer Having Structural Unit Represented by General Formula (A3) or (A4))

Preferred examples of the polymer having a structural unit having the nitrogen-containing fused aromatic ring include a polymer having a structural unit represented by General Formula (A3) or (A4).

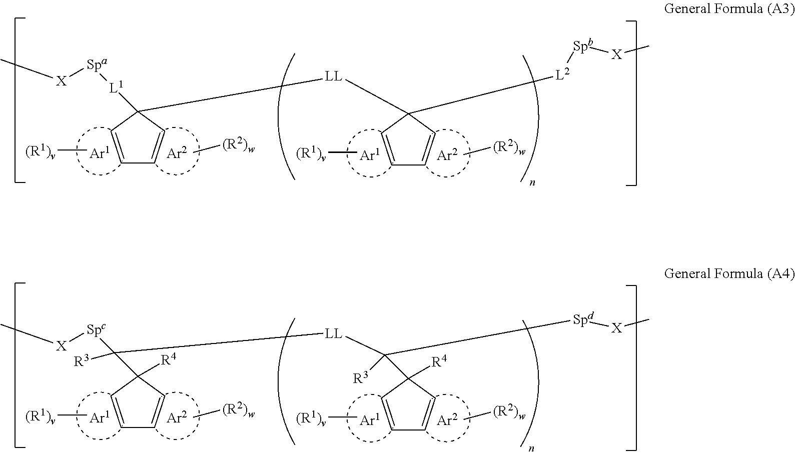

In the formulae, R¹ to R⁴, L¹, L², Sp^{a} to Sp^{d}, the ring Ar¹, the ring Ar², v, and w respectively have the same definition as that for R¹ to R⁴, L¹, L², Sp^{a} to Sp^{d}, the ring Ar¹, the ring Ar², v, and w in General Formulae (A1) and (A2).

LL represents a single bond or a divalent linking group, X represents an oxygen atom (—O—), a carbonyl group (>C═O), an amino group (>NR^{γ4}, R^{γ4} represents a hydrogen atom or a substituent), or a group formed by combining two of these groups.

n represents an integer of 0 to 5.

Examples of the divalent linking group that can be employed as LL include a divalent linking group formed by bonding one or two or more groups selected from an alkylene group, a cycloalkylene group, an arylene group, a heteroarylene group, —O—, —S—, >C(═O), and >NR^{γ3}.

R^{γ3} represents a hydrogen atom or an alkyl group having 1 to 3 carbon atoms.

The number of carbon atoms of the alkylene group that may be employed as LL is preferably in a range of 1 to 8, more preferably in a range of 1 to 6, still more preferably in a range of 1 to 4, and particularly preferably 1 or 2.

The number of carbon atoms of the cycloalkylene group that may be employed as LL is preferably in a range of 3 to 6.

The number of carbon atoms of the arylene group that may be employed as LL is preferably in a range of 6 to 10 and more preferably 6.

The number of ring-constituting atoms of the heteroarylene group that may be employed as LL is preferably in a range of 5 to 10 and more preferably in a range of 5 to 7.

Examples of the substituent that the alkylene group, the cycloalkylene group, the arylene group, or the heteroarylene group in LL may have include a substituent that a group which can be employed as L¹ and L² may have and a substituent that a group which can be employed as Sp^{a} and Sp may have. Among these, an alkyl group is preferable, an alkyl group having 1 to 3 carbon atoms is more preferable, and a methyl group is still more preferable.

In the amino group (>NR^{γ4}) that can be employed as X, R^{γ4} represents a hydrogen atom or a substituent and preferably a hydrogen atom or an alkyl group.

It is preferable that X represents —O—, >C═O, or —C(═O)O—.

n represents preferably an integer of 0 to 2 and more preferably an integer of 0 or 1.

The structural unit represented by General Formula (A3) or (A4) is a structural unit represented by General Formula (A3a) or (A4a) in a case where n represents 0.

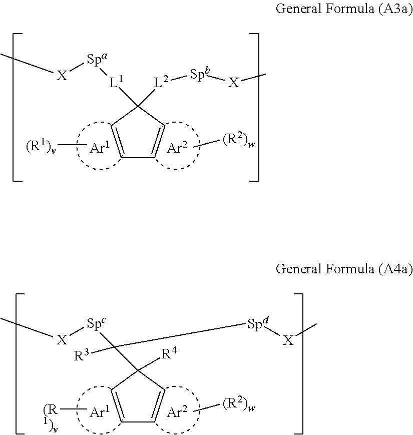

In the formulae, R¹ to R⁴, L¹, L², Sp^{a} to Sp^{d}, the ring Ar¹, the ring Ar², v, and w respectively have the same definition as that for R¹ to R⁴, L¹, L², Sp^{a} to Sp^{d}, the ring Ar¹, the ring Ar², v, and w in General Formulae (A1) and (A2), and X has the same definition as that for X in General Formulae (A3) and (A4).

Hereinafter, specific examples of the structural unit represented by General Formula (A3a) or (A4a) will be described, but the present invention is not limited to the following structural units.

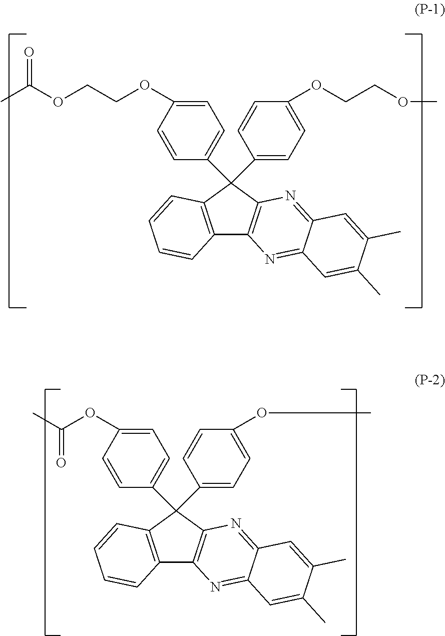

A method of obtaining the structural unit represented by General Formula (A3a) or (A4a) is not particularly limited, and a compound serving as a precursor may be obtained commercially or produced by synthesis. As the compound serving as a precursor, the compound having the nitrogen-containing fused aromatic ring described above can be used.

Preferred examples of the structural unit represented by General Formula (A3) or (A4) in a case where n represents an integer of 1 to 5 include a structural unit represented by General Formula (A3b) or (A4b).

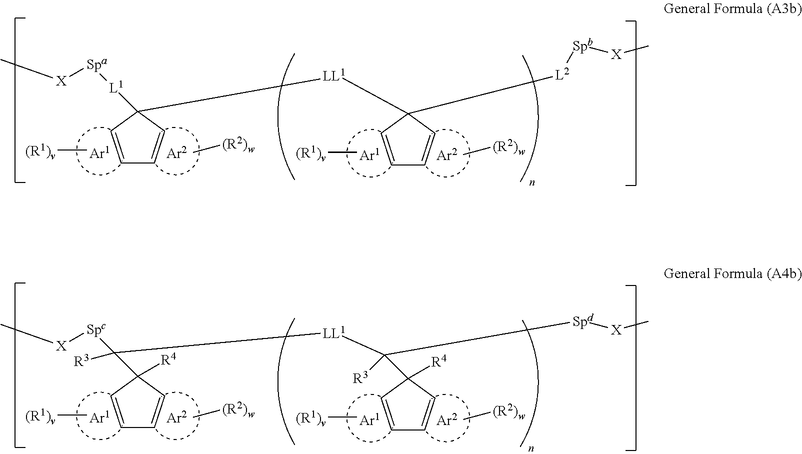

In the formulae, R¹ to R⁴, L¹, L² Sp^{a} to Sp^{d}, the ring Ar¹, the ring Ar², n, v, and w respectively have the same definition as that for R¹ to R⁴, L¹, L² Sp^{a} to Sp^{d}, the ring Ar¹, the ring Ar², n, v, and w in General Formulae (A1) and (A2), and X has the same definition as that for X in General Formulae (A3) and (A4).

LL¹ represents a single bond or an alkylene group.

As the alkylene group that can be employed as LL¹, the description of the alkylene group that can be employed as LL can be applied.

A method of obtaining the structural unit represented by General Formula (A3b) or (A4b) is not particularly limited, and a compound serving as a precursor may be obtained commercially or produced by synthesis. For example, the compound can be produced using a method of the related art with reference to the methods of the examples described below based on the synthesis method described in JP2021-1328A.

It is preferable that the polymer that has a structural unit having the nitrogen-containing fused aromatic ring has structural units other than the structural unit represented by General Formula (A3) or (A4) (hereinafter, also referred to as “other structural units”).

Preferred examples of the other structural units include a structural unit represented by General Formula (11).

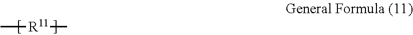

In General Formula (11), R¹¹ represents a group containing at least one selected from an alkylene group having 2 to 8 carbon atoms, a cycloalkylene group having 5 to 20 carbon atoms, an arylene group having 6 to 40 carbon atoms, or a heteroarylene group having 6 to 40 carbon atoms. It is preferable that the alkylene group, the cycloalkylene group, the arylene group, and the heteroarylene group have a substituent, and the carbon atoms of the alkylene group and the cycloalkylene group may be substituted with oxygen atoms or sulfur atoms.

R¹¹ may represent a linking group containing the above-described groups, a linking group consisting of the above-described groups, or a linking group having a structure obtained by combining two or more of the above-described groups. Further, R¹¹ may represent a linking group having at least one selected from an ether bond or a thioether bond between the above-described groups. In this case, at least one selected from an ether bond or a thioether bond may be present between identical groups or between different groups.

Here, R¹¹ represents a group that does not contain —O—C(═O)—O—.

Among the examples, R¹¹ represents preferably a cycloalkylene group having 5 to 20 carbon atoms and more preferably a cycloalkylene group having 5 to 15 carbon atoms.

Hereinafter, specific examples of the structural unit represented by General Formula (11) are shown below, but the present invention is not limited thereto. In the following specific examples, * represents a linking site with respect to other structural units.

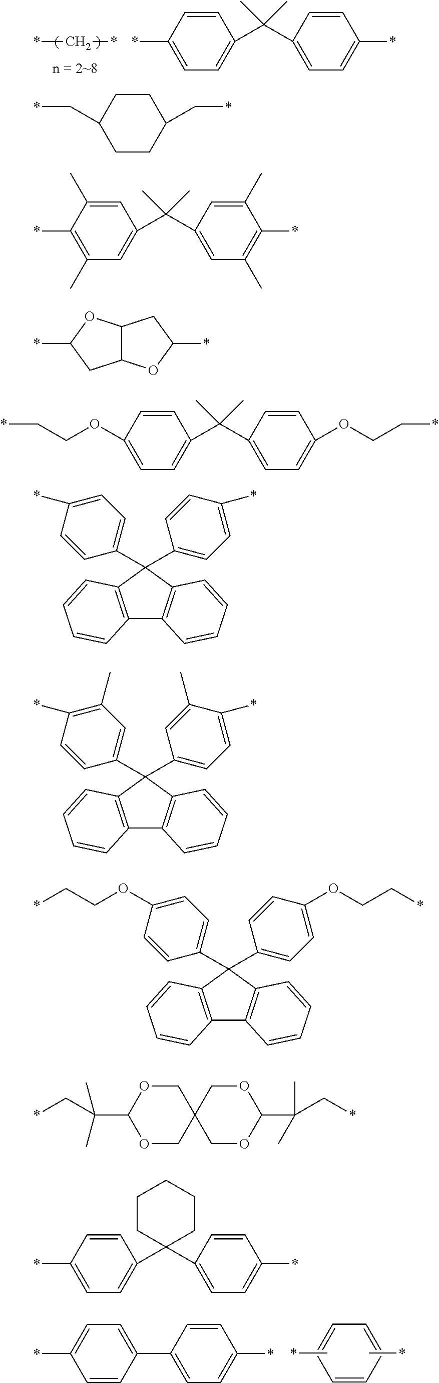

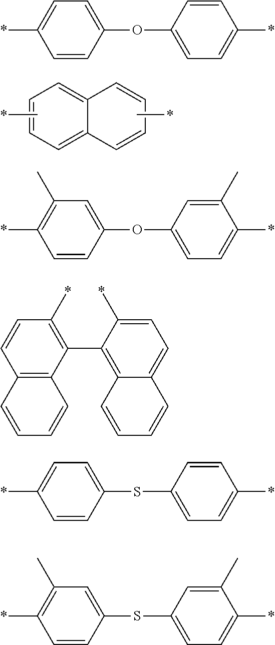

It is also preferable that the polymer that has a structural unit having the nitrogen-containing fused aromatic ring has, as other structural units, a structural unit represented by Formula (s) in addition to the structural unit represented by General Formula (11).

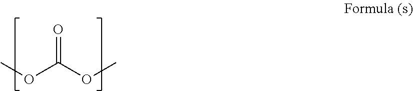

The introduction (synthesis) of other structural units into the polymer that has the structural unit having the nitrogen-containing fused aromatic ring can be performed by a method of the related art without particular limitation, and for example, the method described in JP2021-1328A can be referred to.

In the polymer that has the structural unit having the nitrogen-containing fused aromatic ring, the structural unit of the polymer may be a structural unit represented by General Formula (A3) or (A4), and the polymer may further have other structural units.

In a case where the polymer that has the structural unit having the nitrogen-containing fused aromatic ring has other structural units, the proportion of the structural unit represented by General Formula (A3) or (A4) in the polymer that has the structural unit having the nitrogen-containing fused aromatic ring is preferably in a range of 10% to 95% by mass, more preferably in a range of 10% to 90% by mass, and still more preferably in a range of 15% to 85% by mass.

In a case where the polymer has a structural unit represented by General Formula (11), the proportion of the structural unit represented by General Formula (11) in the polymer that has the structural unit having the nitrogen-containing fused aromatic ring is preferably in a range of 5% to 90% by mass, more preferably in a range of 10% to 80% by mass, and still more preferably in a range of 15% to 75% by mass.

In a case where the polymer has a structural unit represented by Formula (s), the proportion of the structural unit represented by Formula (s) in the polymer that has the structural unit having the nitrogen-containing fused aromatic ring is preferably in a range of 1% to 20% by mass, more preferably in a range of 2% to 15% by mass, and still more preferably in a range of 3% to 10% by mass.

The mass average molecular weight (Mw) of the polymer that has the structural unit A having nitrogen-containing fused aromatic ring is preferably 5,000 or greater, more preferably 10,000 or greater, and still more preferably 13,000 or greater. Further, the upper limit of the mass average molecular weight is preferably 200,000 or less, more preferably 150,000 or less, and still more preferably 100,000 or less.

In the present invention, the mass average molecular weight is a value measured by GPC in terms of standard polystyrene as described in the section of polymer B in an adhesive for a lens described below.

From the viewpoint of further improving the light resistance, a compound represented by General Formula (A1) or (A2) or polymer having a structural unit represented by General Formula (A3) or (A4) is preferable, and a compound represented by General Formula (A1) is more preferable, as the component A.

It is preferable that the component A is a non-liquid crystalline compound. That is, from the viewpoint of using the composition as the lens material, it is preferable that all of L¹, L², LL, Sp^{α}, and Sp^{a} to Sp^{d} in the polymerizable compound represented by any of General Formulae (A0) to (A2) and the polymer having a structural unit represented by General Formula (A3) or (A4) represent a linking group that does not have a ring structure.

Hereinafter, specific examples of the component A preferably used in the composition according to the embodiment of the present invention will be shown, but the present invention is not limited to the following polymerizable compounds and polymers. In the following structural formulae, Me represents a methyl group, Et represents an ethyl group, iPr represents an i-propyl group, nPr represents an n-propyl group, nBu represents an n-butyl group, and tBu represents a t-butyl group.

Further, structural units that can be employed as “X” and structural units that can be employed as “Y” are respectively shown in polymers (P-3) and (P-4), and the structural unit represented by —[X—Y]— denotes that a plurality of structural units represented by —[X—Y]— may be present in the polymer as long as any of the structural units represented by X and Y is employed. The same applies to the polymer having a structural unit represented by —[X—Y]— as well as the polymer (P-3) and the polymer (P-4).

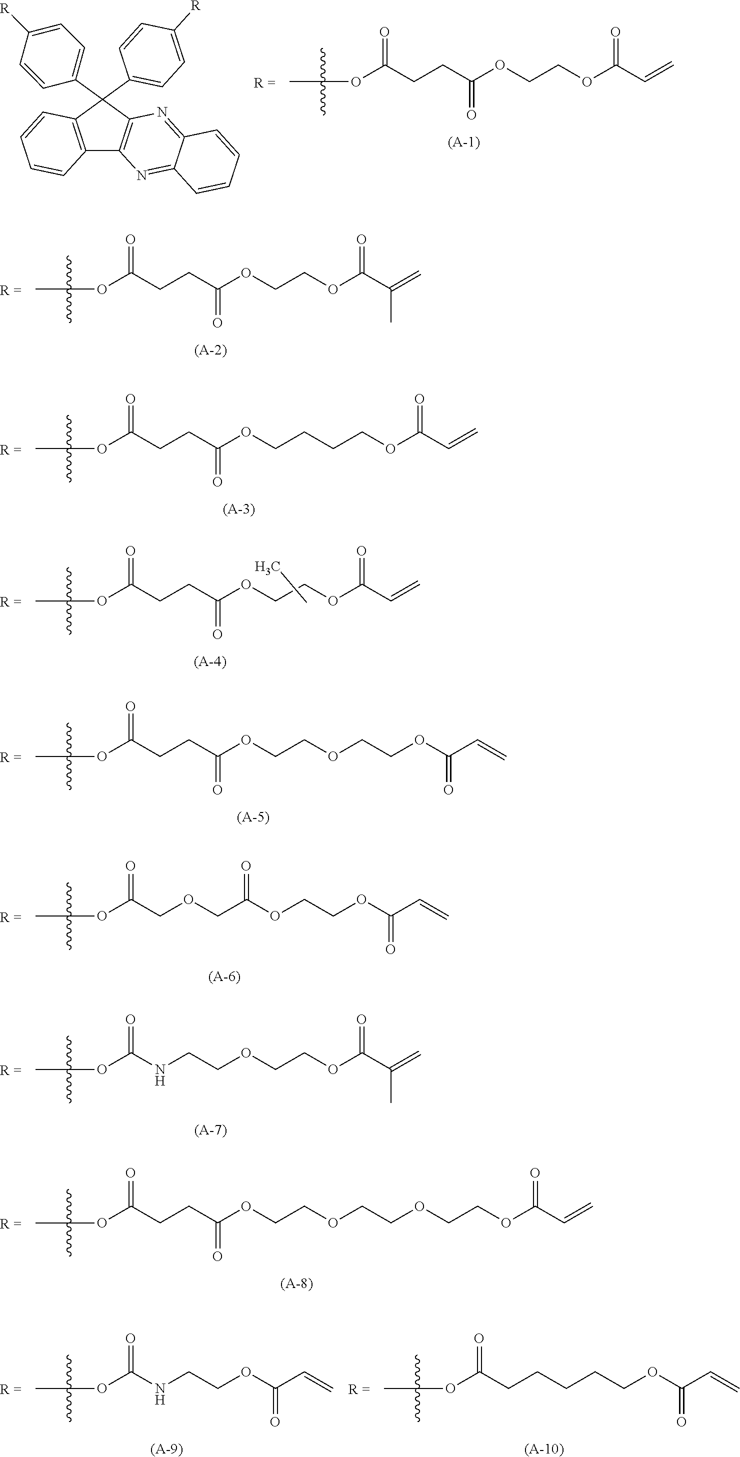

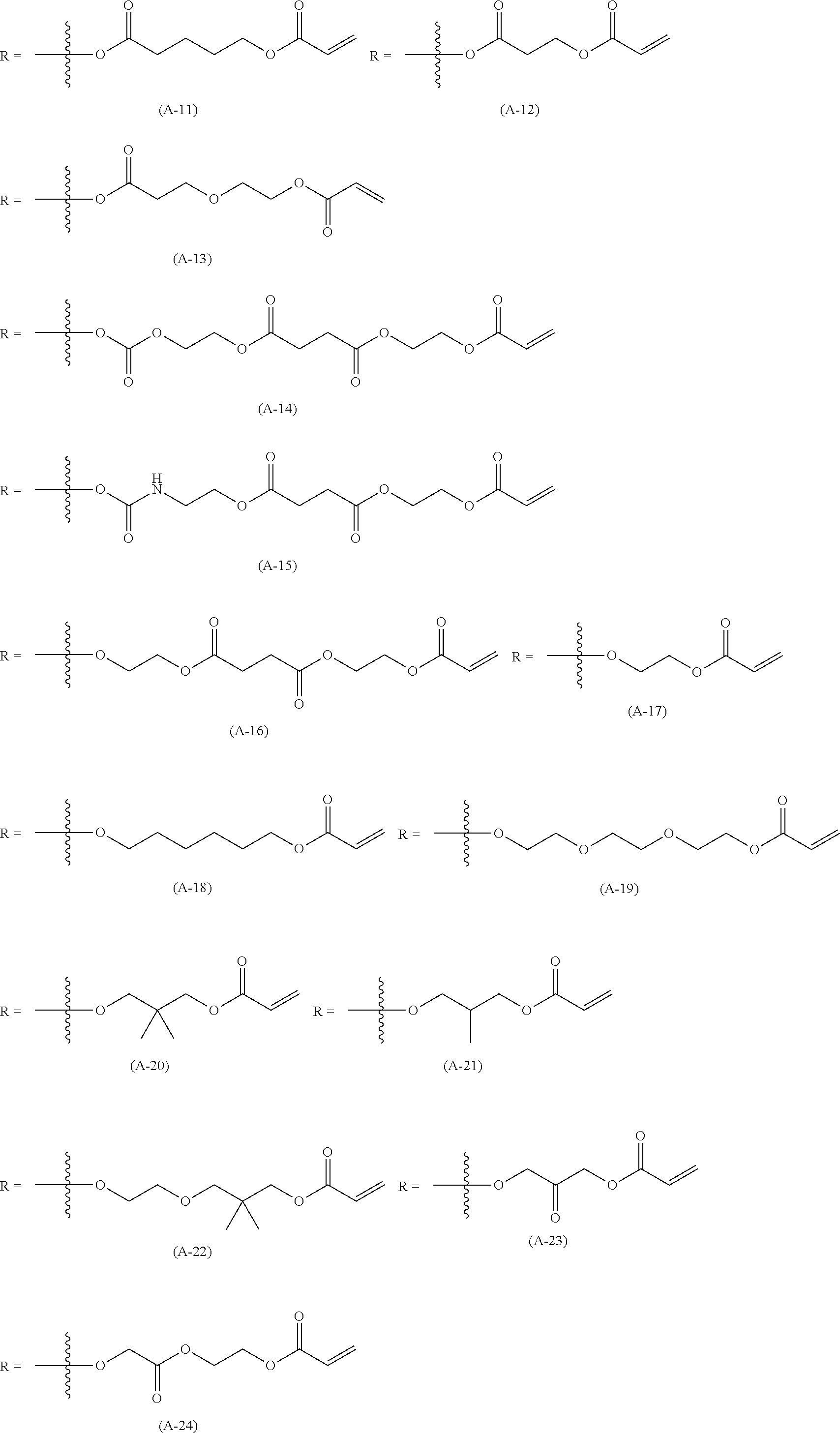

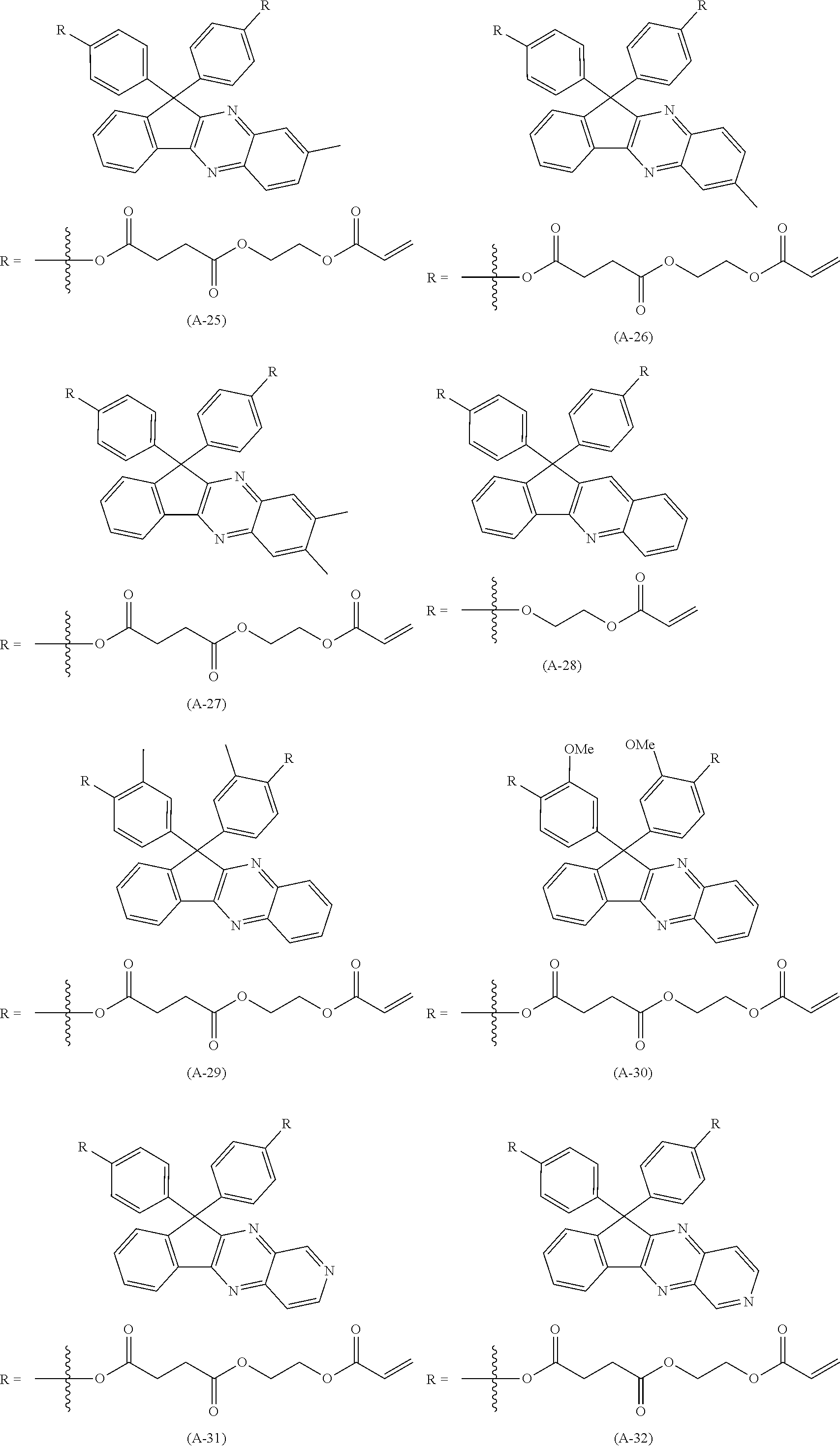

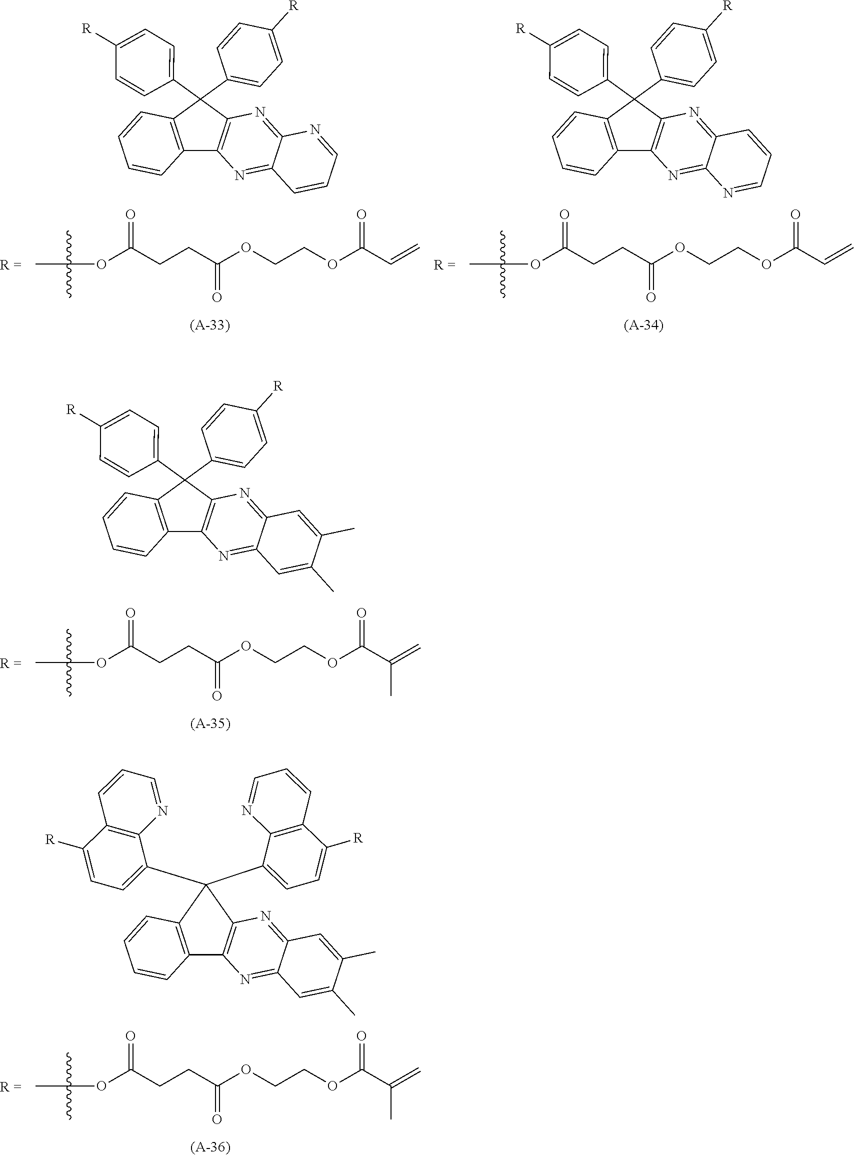

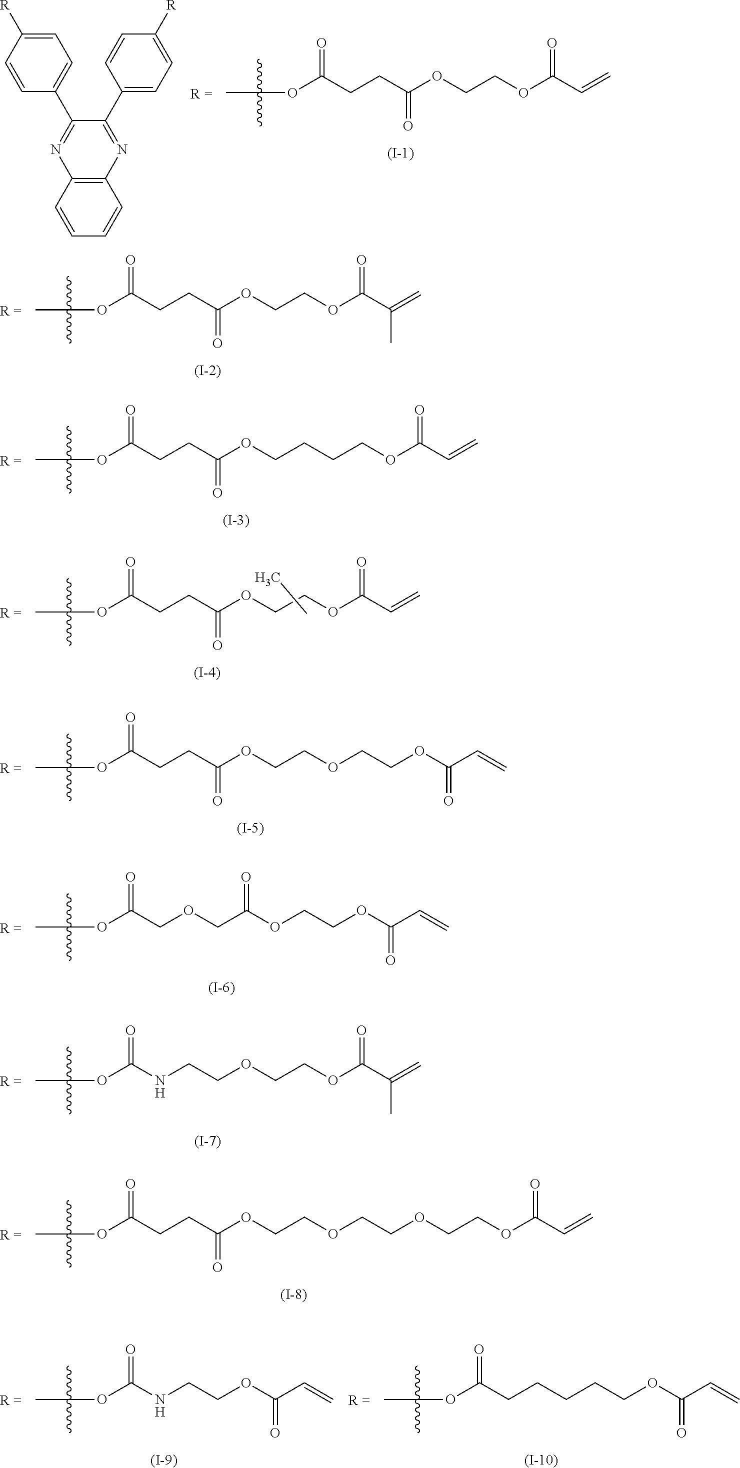

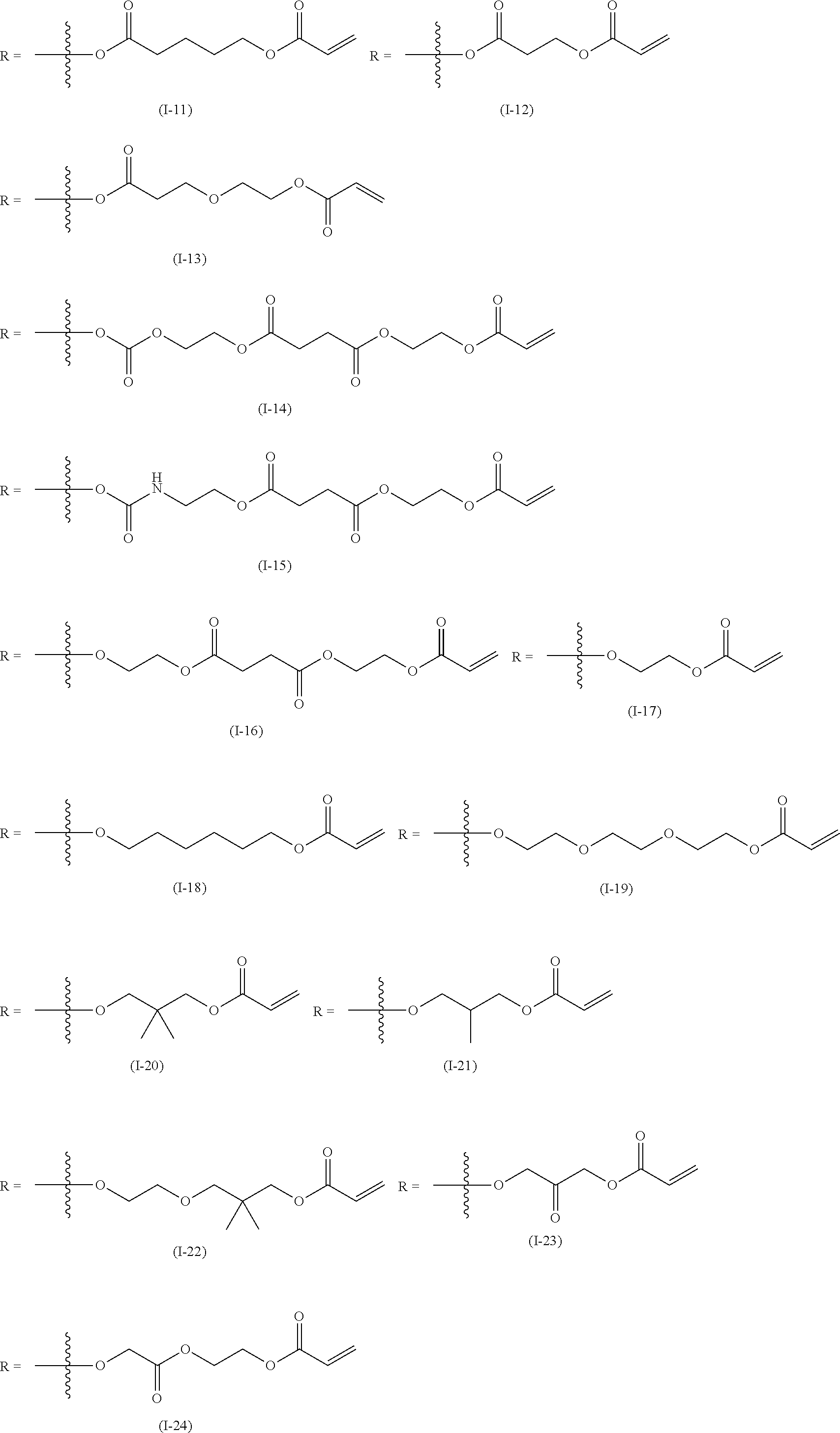

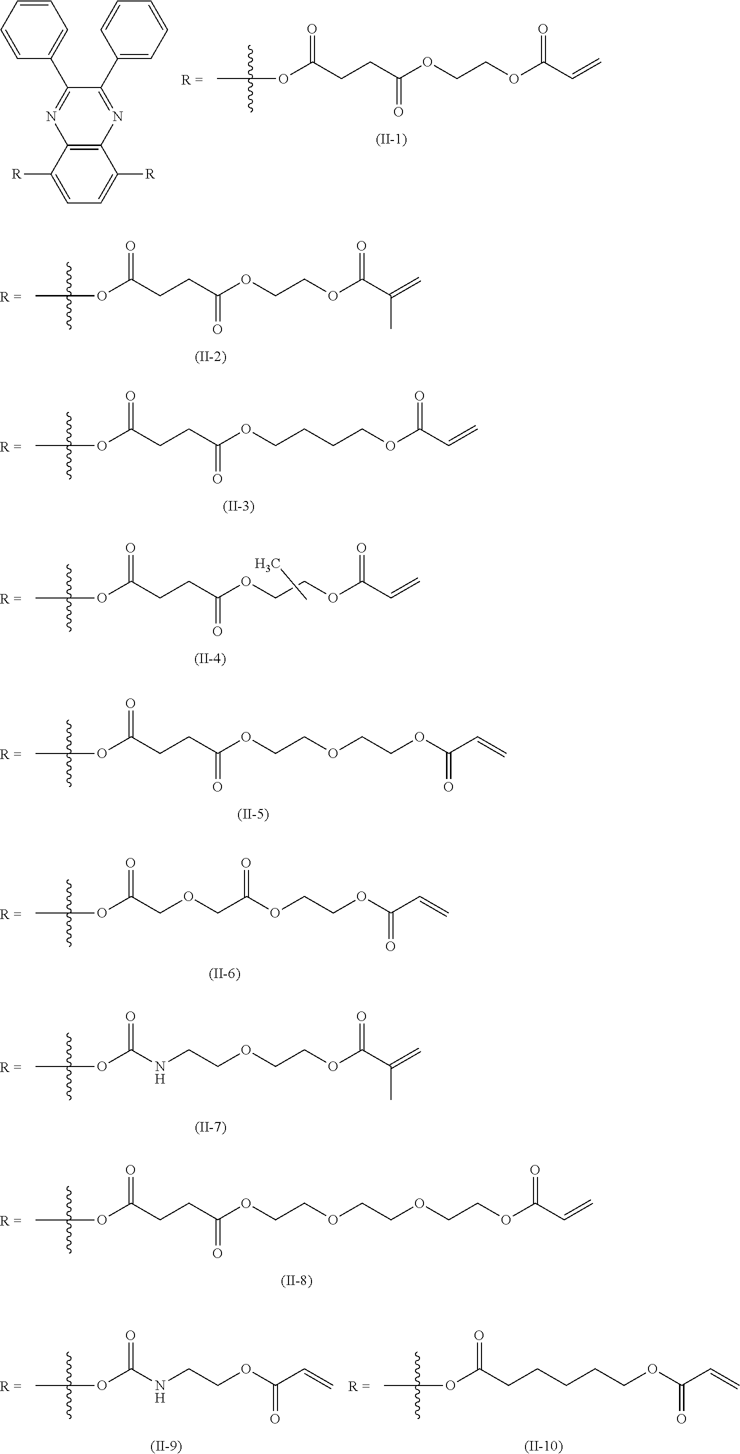

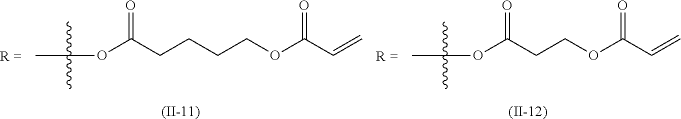

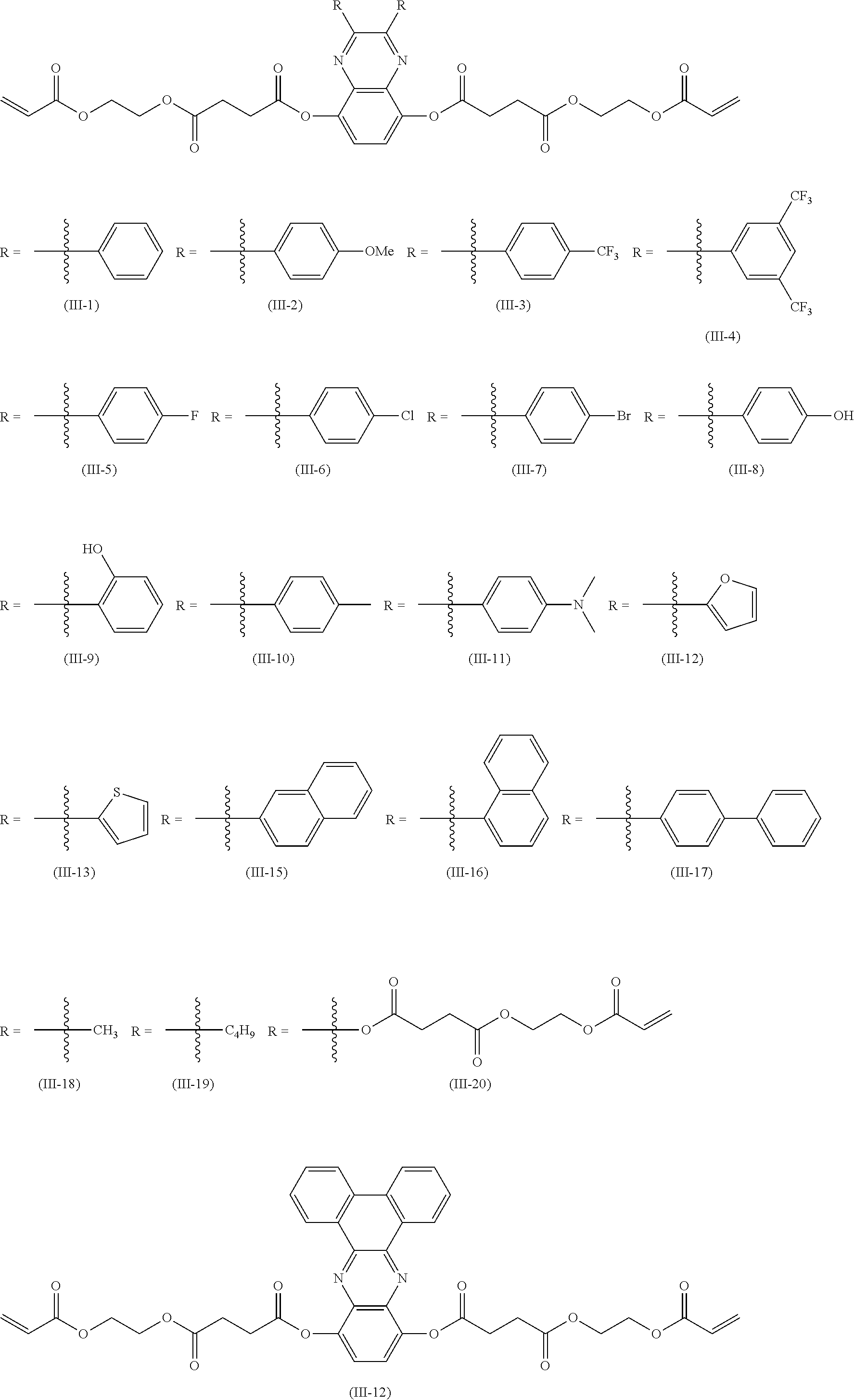

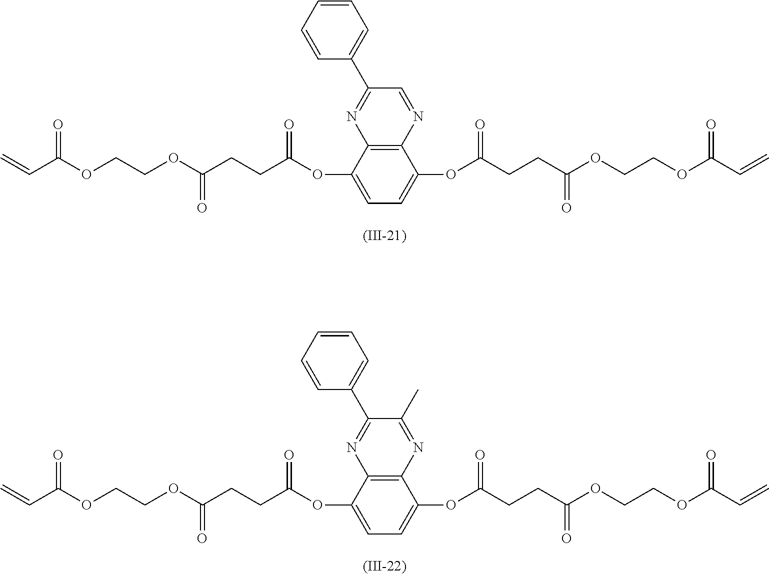

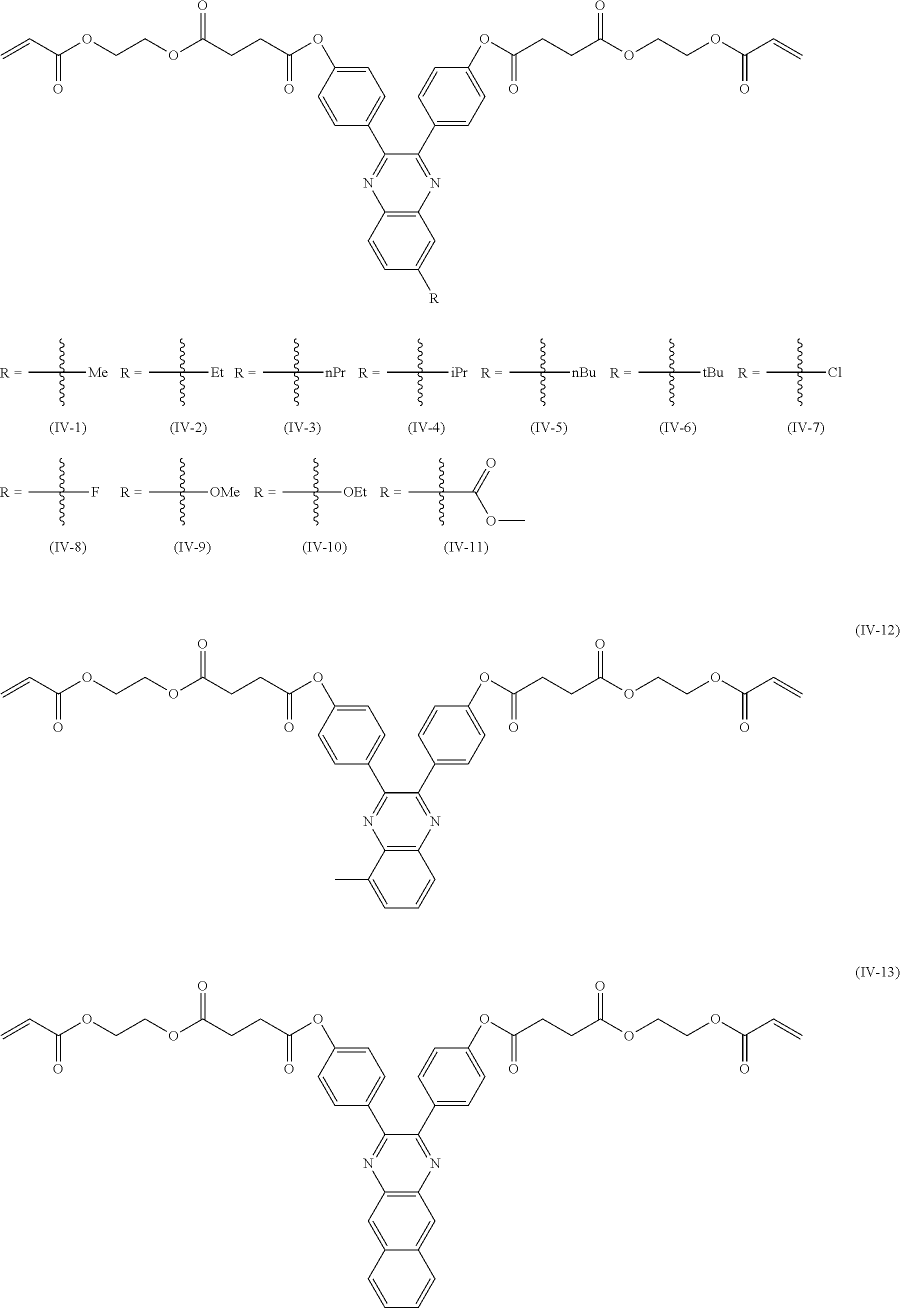

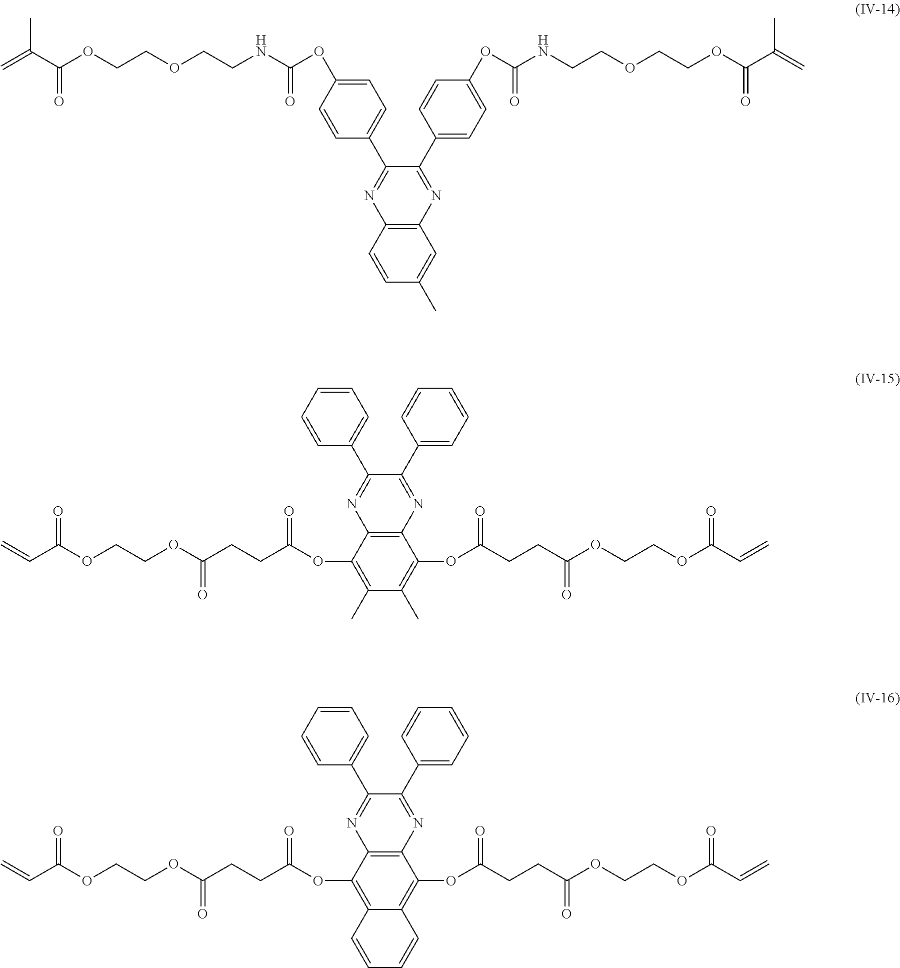

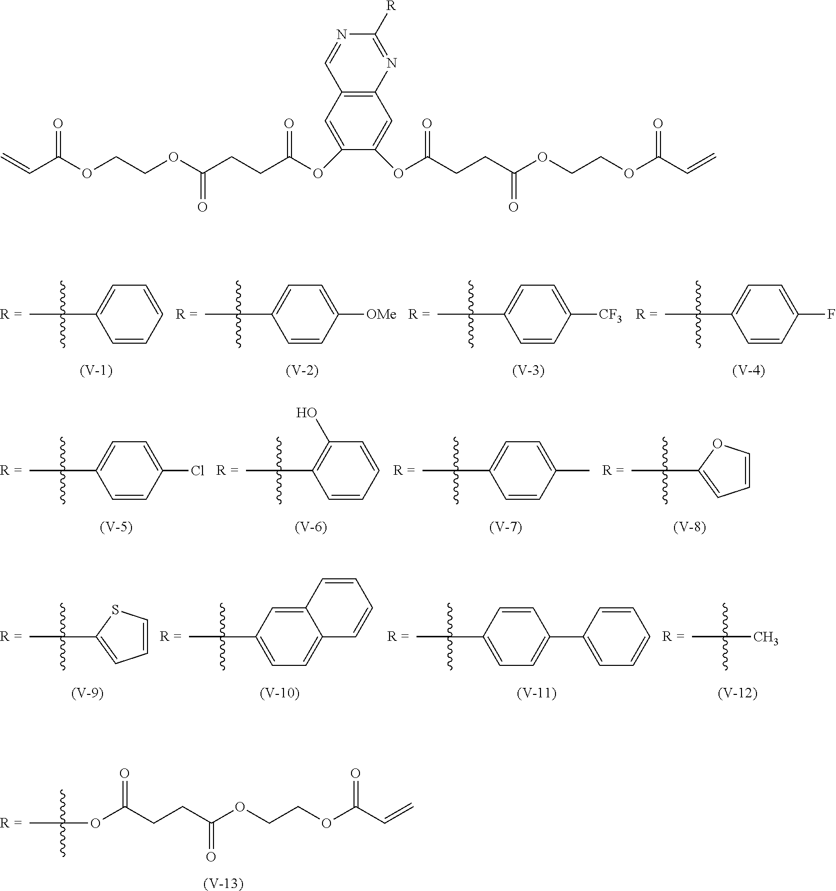

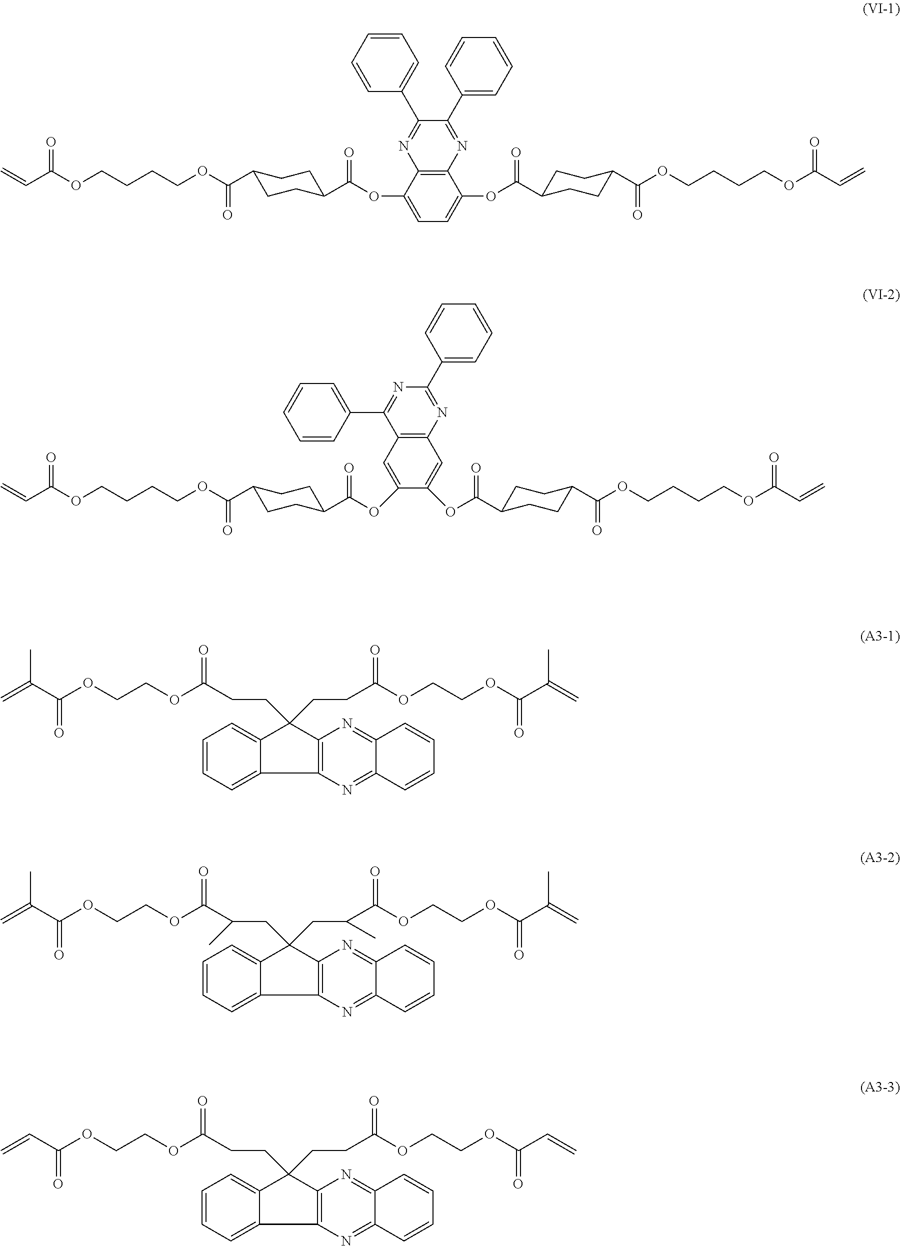

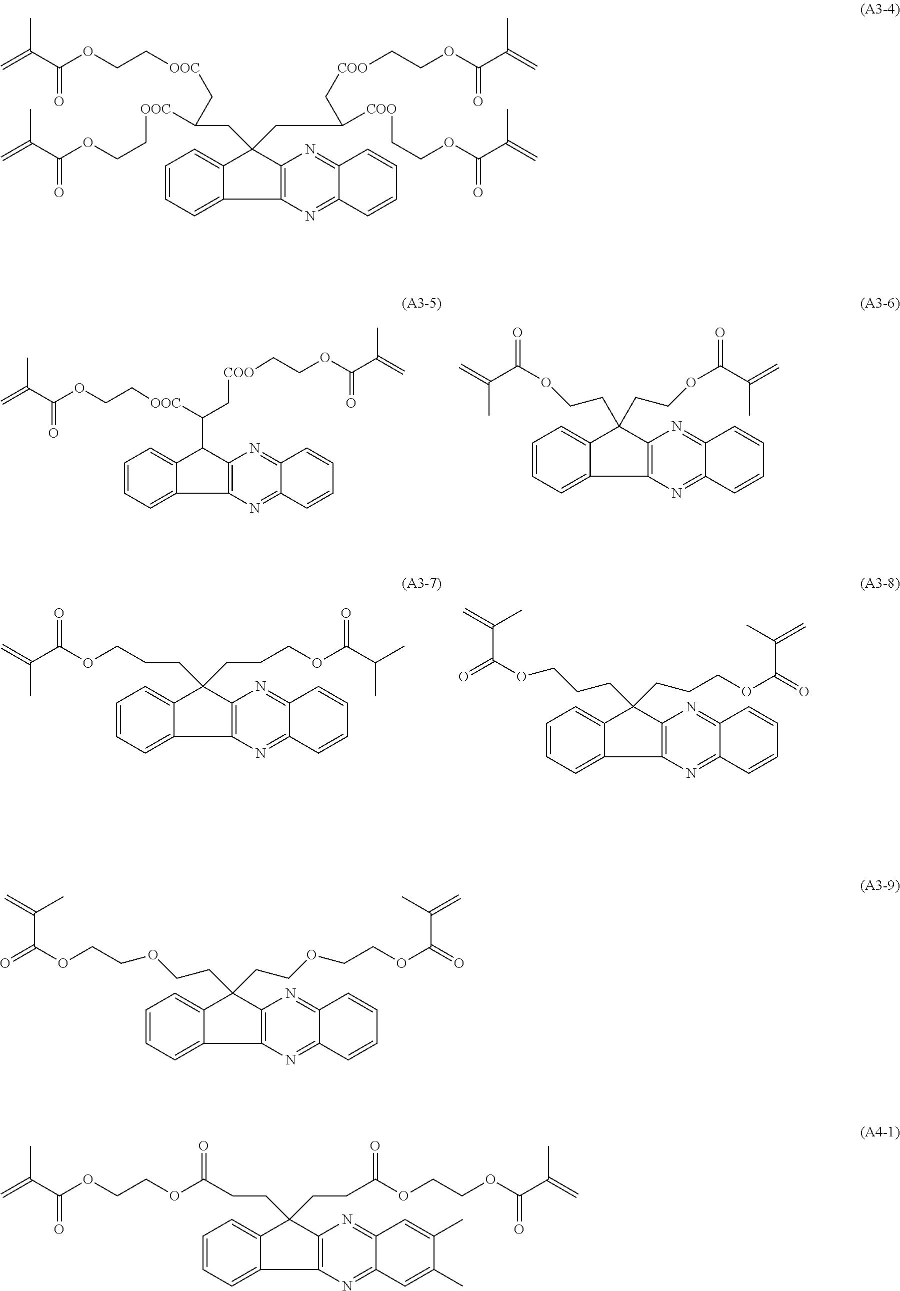

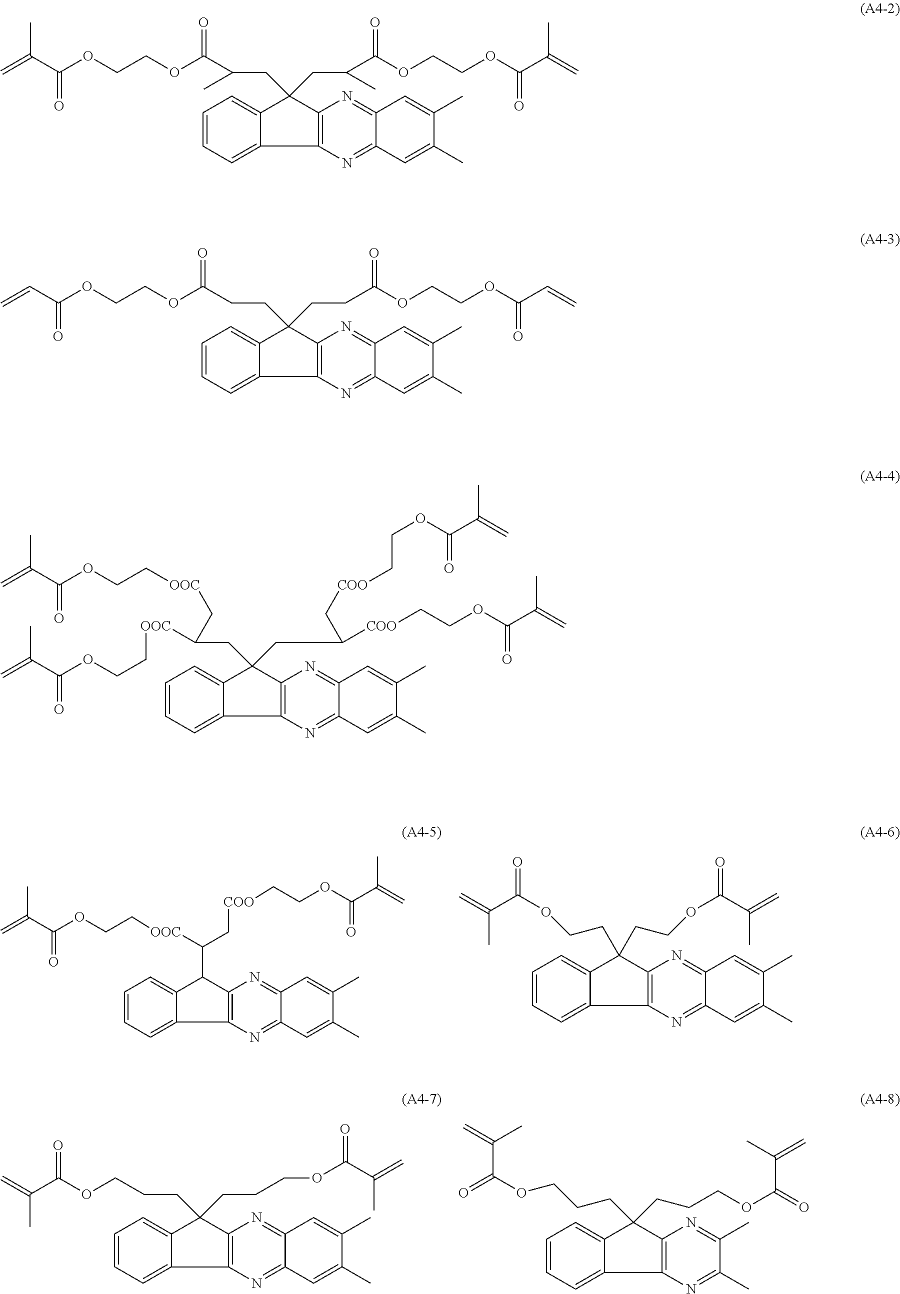

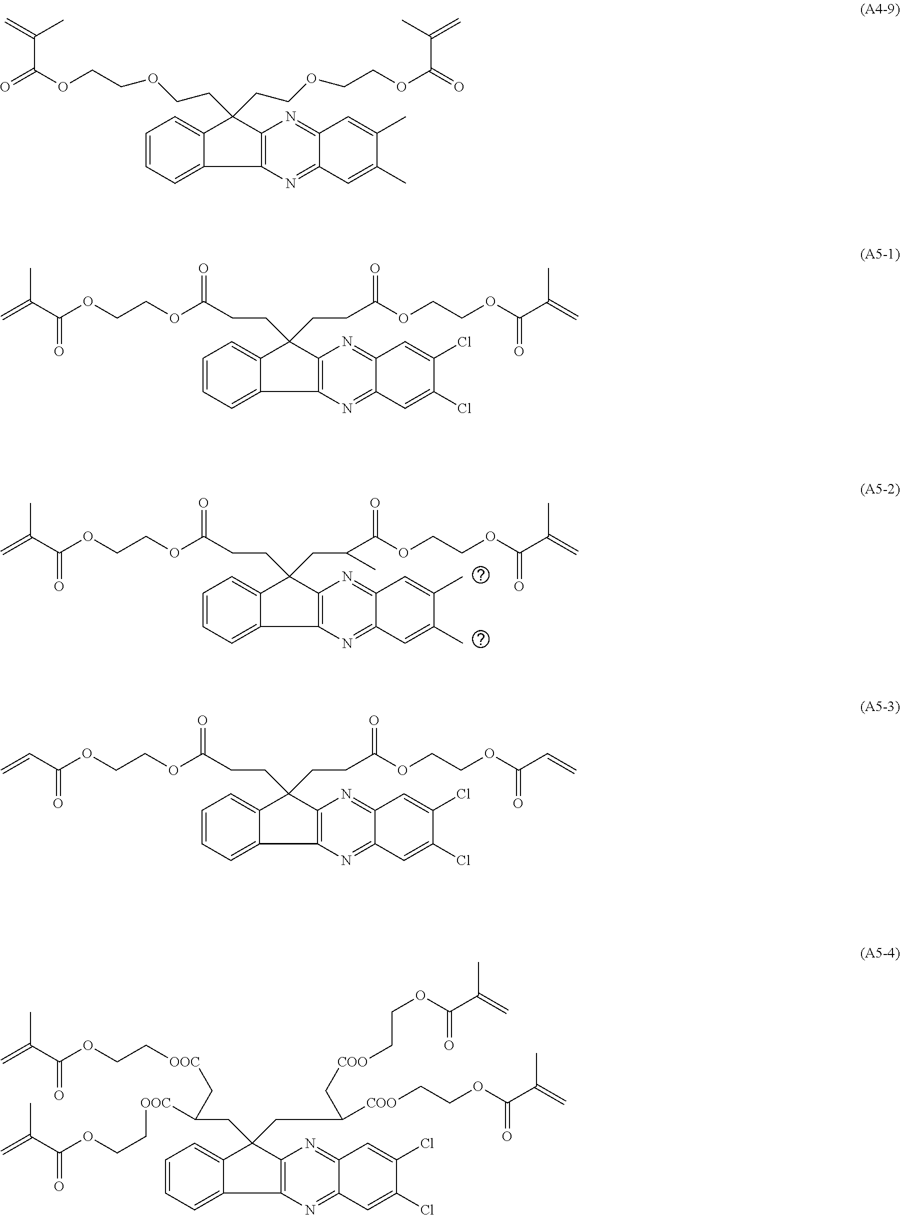

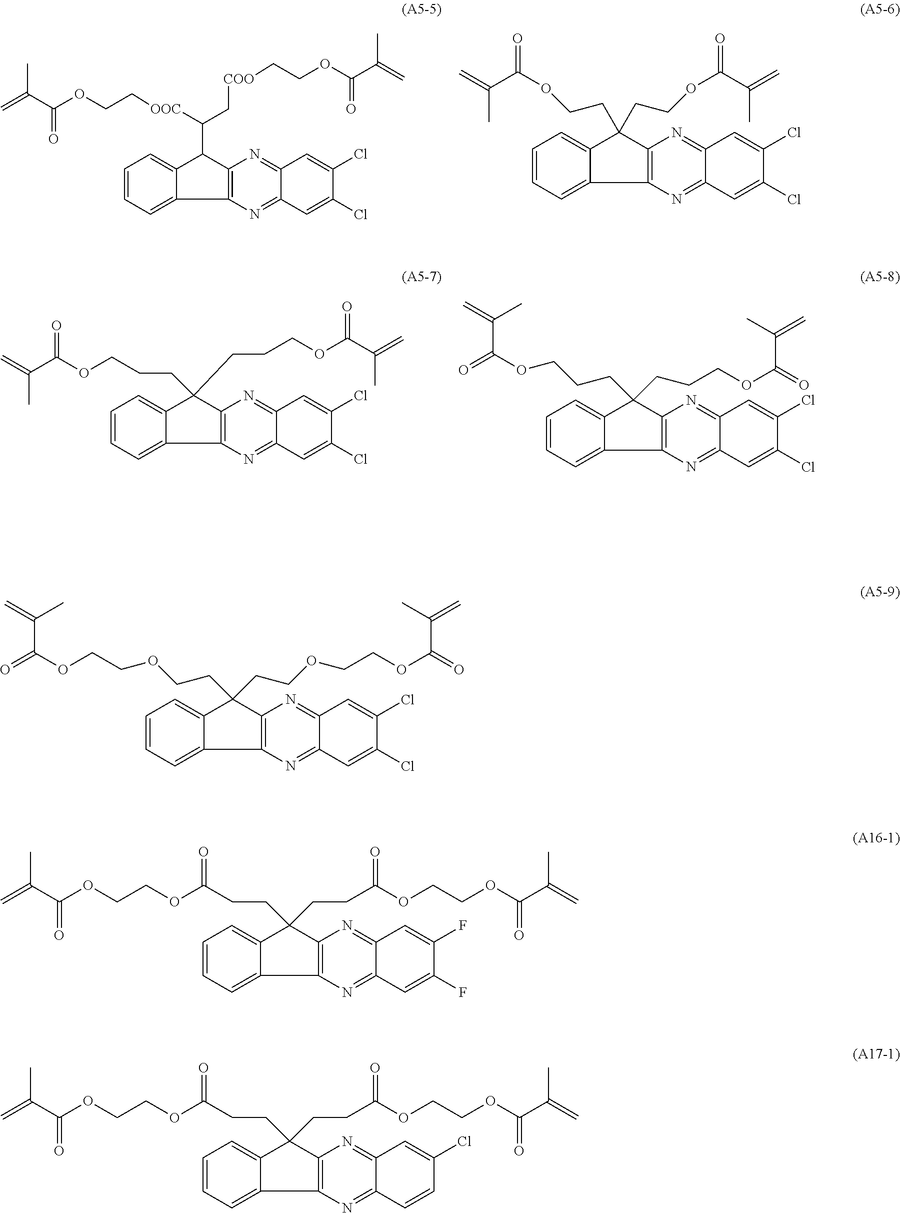

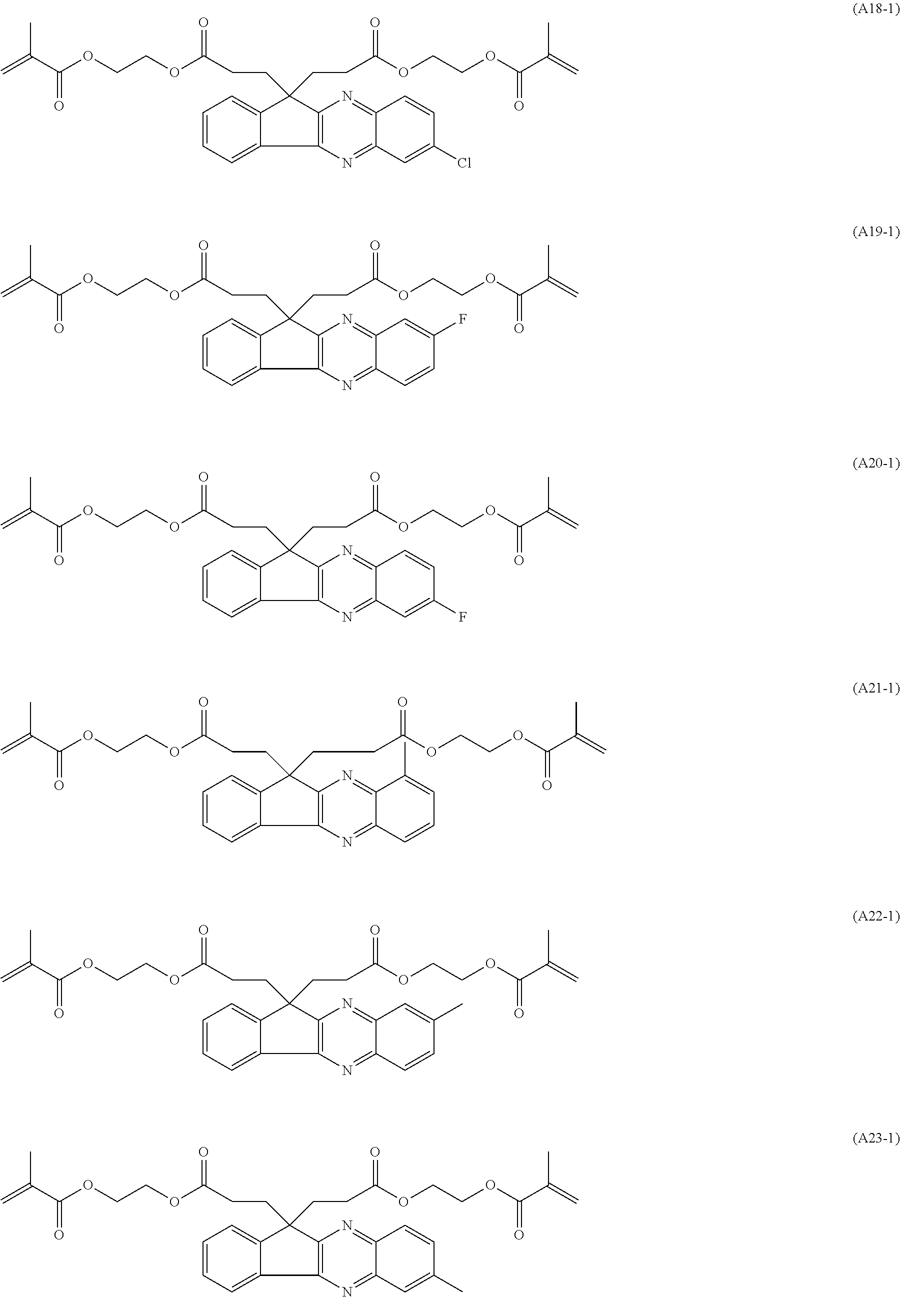

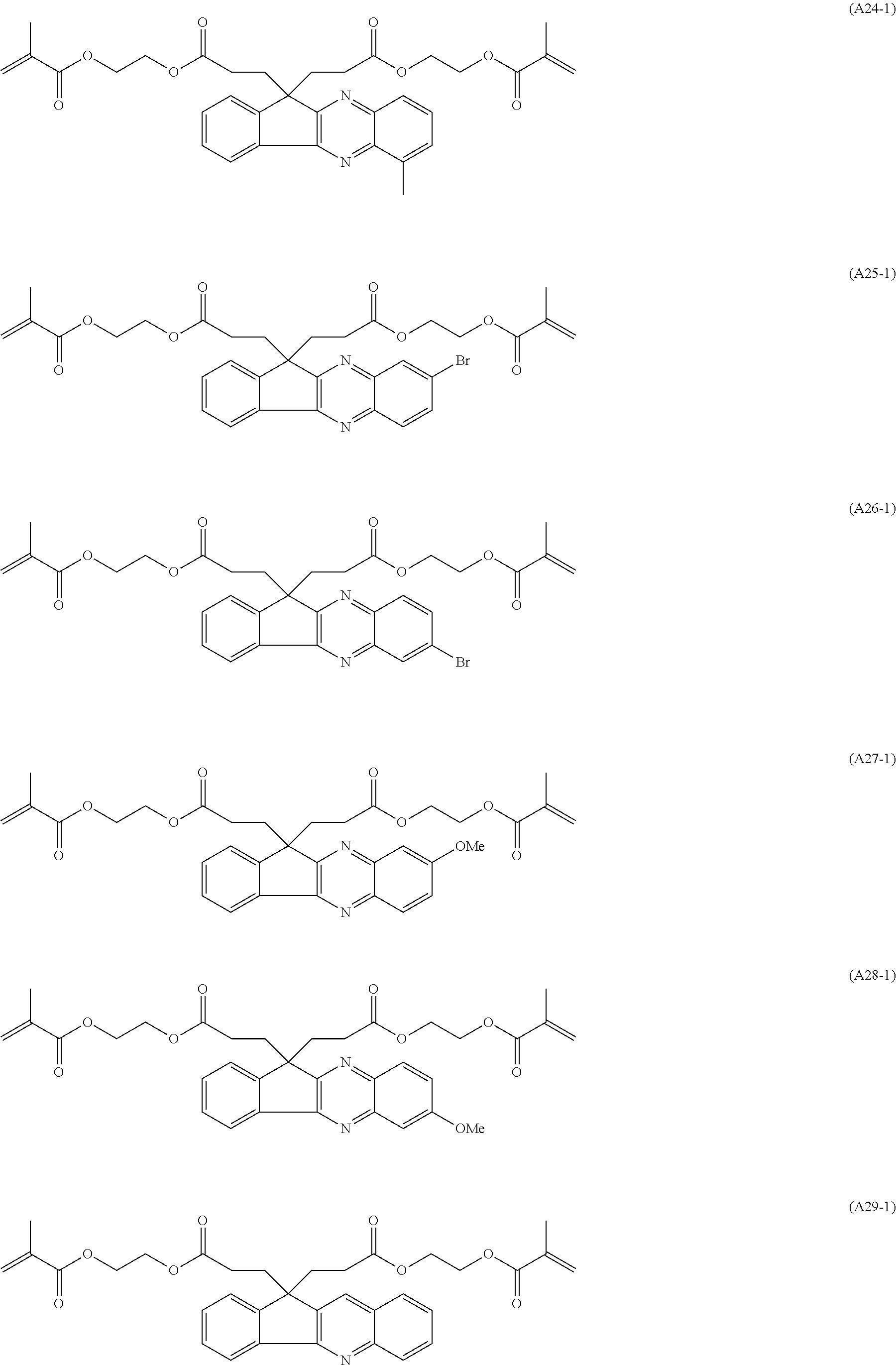

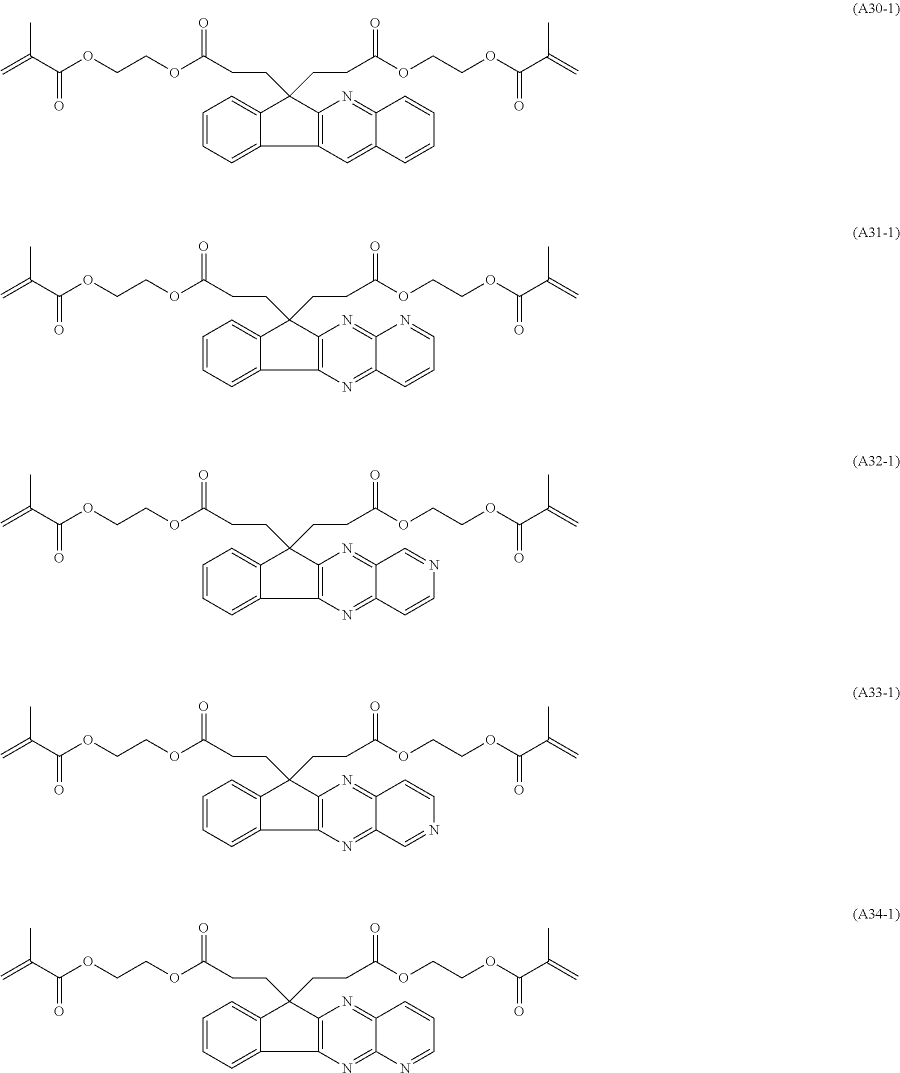

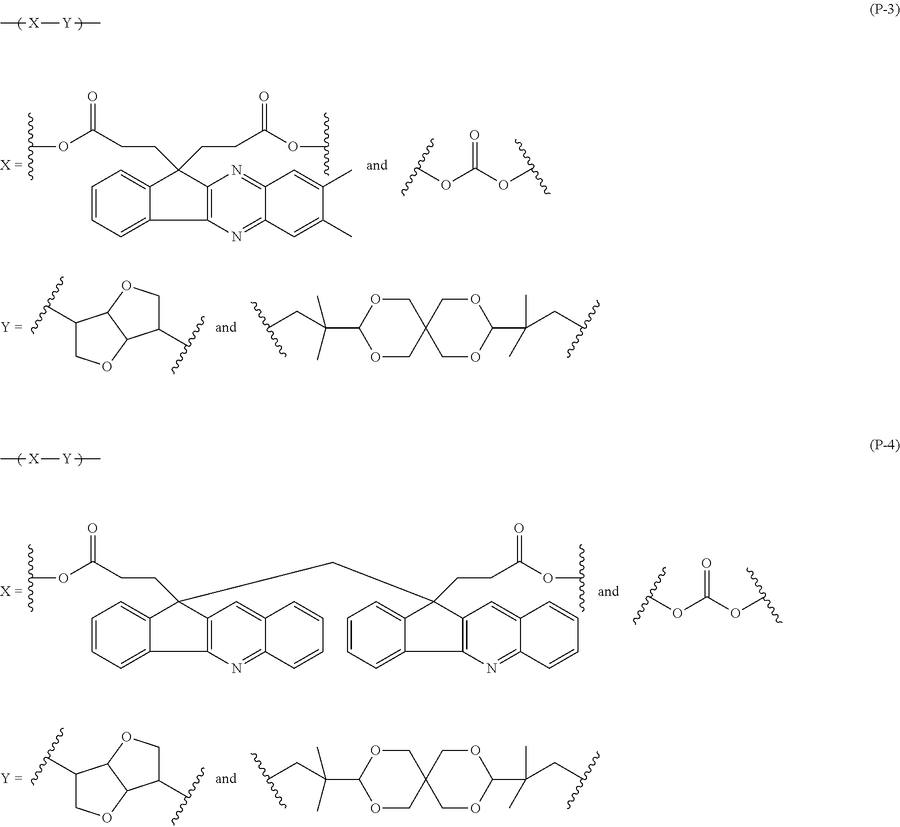

The content of the component A in the composition according to the embodiment of the present invention is preferably in a range of 30% to 99% by mass, more preferably in a range of 35% to 99% by mass, and still more preferably in a range of 40% to 99% by mass with respect to the total solid content of the composition. In a case where the content of the component A is in the above-described range, partial dispersion ratios (θg and F-Number) higher than partial dispersion ratios (θg and F-Number) to be expected are likely to be achieved in the cured substance having a predetermined Abbe number.

In a case where the composition according to the embodiment of the present invention contains two or more kinds of components A, it is preferable that the total content thereof is in the above-described range.

[Component B: Compound Represented by any of General Formulae (B1) to (B5)]

The composition according to the embodiment of the present invention contains the compound of the component B which is a compound represented by any of General Formulae (B1) to (B5) in addition to the compound of the component A which is a compound having a nitrogen-containing fused aromatic ring as a partial structure, and thus excellent light resistance can be exhibited because the component B acts as a quencher and is a compound in which the [2+2] photocyclization addition reaction is unlikely to occur as described above.

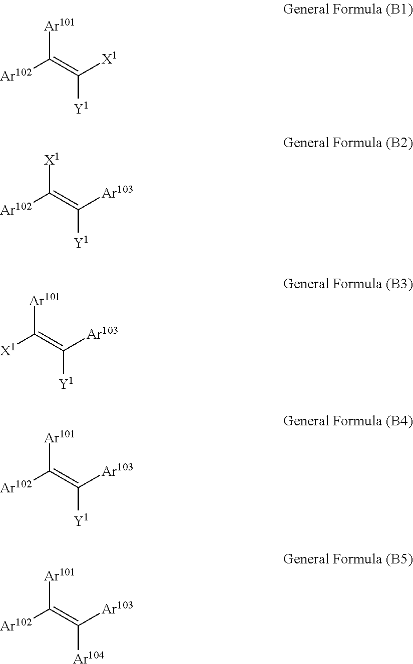

In General formulae (B1) to (B5), Ar¹⁰¹ to Ar¹⁰⁴ represent an aryl group or a heteroaryl group, X¹ represents a monovalent substituent, Y¹ represents a hydrogen atom or a monovalent substituent. Adjacent two of Ar¹⁰¹ to Ar¹⁰⁴, X¹, and Y¹ may be bonded to each other to form a ring. Here, none of the monovalent substituents employed as X¹ or Y¹ is an aryl group or a heteroaryl group.

The description of the monovalent aromatic hydrocarbon group at the beginning can be preferably applied to the aryl group which can be employed as Ar¹⁰¹ to Ar¹⁰⁴, unless otherwise specified.

Among those, the number of carbon atoms is more preferably in a range of 6 to 10, and the ring constituting the aryl group is preferably a monocycle.

As the aryl group which can be employed as Ar¹⁰¹ to Ar¹⁰⁴, a phenyl group, a 1-naphthyl group, or a 2-naphthyl group is more preferable, and a phenyl group is still more preferable.

The description of the monovalent aromatic heterocyclic group at the beginning can be preferably applied to the heteroaryl group which can be employed as Ar¹⁰¹ to Ar¹⁰⁴, unless otherwise specified.

Among these, as a ring-constituting atom, it is preferably that an aromatic heterocyclic group having a carbon atom and a nitrogen atom or a sulfur atom as a ring-constituting atom, and more preferably a carbon atom and a nitrogen atom. The number of ring-constituting atoms is preferably 5 to 10, and more preferably 5 or 6 (that is, the ring constituting the heteroaryl group is preferably a monocycle).

As the heteroaryl group that can be employed as Ar¹⁰¹ to Ar¹⁰⁴, a pyridyl group, a pyrazinyl group, a pyrimidyl group, a pyridazinyl group, or a thienyl group is more preferable, a pyridyl group, a pyrazinyl group, a pyrimidyl group, or a pyridazinyl group is still more preferable, and a pyridyl group is particularly preferable.

The aryl group and the heteroaryl group which can be employed as Ar¹⁰¹ to Ar¹⁰⁴ may be unsubstituted groups or may have a substituent.

Examples of the substituent that the aryl group or the heteroaryl group which can be employed as Ar¹⁰¹ to Ar¹⁰⁴ may have include an alkyl group having 1 to 6 carbon atoms, an alkenyl group having 2 to 6 carbon atoms, an alkoxy group having 1 to 6 carbon atoms, an alkenyloxy group having 2 to 6 carbon atoms, an alkoxycarbonyl group having 2 to 6 carbon atoms, an acyloxy group having 2 to 6 carbon atoms, an acyl group having 2 to 6 carbon atoms, an alkylcarbonyloxy group having 2 to 6 carbon atoms, a halogen atom (such as a fluorine atom, a chlorine atom, or a bromine atom), a hydroxy group, a cyano group, a nitro group, a nitroso group, and a carboxy group. Among these, an alkyl group having 1 to 6 carbon atoms, an alkoxy group having 1 to 6 carbon atoms, a halogen atom, or a hydroxy group is preferable, and an alkoxy group having 1 to 6 carbon atoms, a halogen atom or a hydroxy group is more preferable.

The description of the corresponding group at the beginning can be preferably applied to the substituent that the aryl group or the heteroaryl group which can be employed as Ar¹⁰¹ to Ar¹⁰⁴ may have, unless otherwise specified.

In addition, as the substituent that the aryl group or the heteroaryl group, which can be employed as Ar¹⁰¹ to Ar¹⁰⁴, may have, it is preferable that the substituent has a partial structure represented by any of Formulae (Pol-1) to (Pol-6) described later. Specific examples thereof preferably include an alkoxy group having a partial structure represented by any of Formulae (Pol-1) to (Pol-6) described later, and an alkoxycarbonyl group having a partial structure represented by any of Formulae (Pol-1) to (Pol-6) described later.

It is more preferable that Ar¹⁰¹ to Ar¹⁰⁴ represent an aryl group or a heteroaryl group in which the ring constituting the aryl group or the heteroaryl group is a monocycle.

Examples of the monovalent substituent that can be employed as X¹ include an alkyl group, an alkenyl group, a cycloalkyl group, a cycloalkenyl group, an alkoxy group, an alkenyloxy group, an alkoxycarbonyl group, a cyano group, and a formyl group.

The description of the alkyl group, the alkenyl group, the cycloalkyl group, the cycloalkenyl group, the alkoxy group, the alkenyloxy group, and the alkoxycarbonyl group can be preferably applied to the alkyl group, the alkenyl group, the cycloalkyl group, the cycloalkenyl group, the alkoxy group, the alkenyloxy group, and the alkoxycarbonyl group which can be employed as X¹, unless otherwise specified.

The number of carbon atoms in the alkyl group which can be employed as X¹ is preferably in a range of 1 to 10 and more preferably in a range of 1 to 8. It is noted that in a case where the substituent does not have a partial structure represented by any of Formulae (Pol-1) to (Pol-6) described later, the number of carbon atoms in the alkyl group which can be employed as X¹ is still more preferably in a range of 1 to 6, particularly preferably in a range of 1 to 4, and most preferably 1 or 2.

The number of carbon atoms in the alkenyl group which can be employed as X¹ is preferably in a range of 2 to 6, more preferably in a range of 2 to 4, and still more preferably 2.

The number of carbon atoms in the cycloalkyl group which can be employed as X¹ is preferably in a range of 3 to 15, more preferably in a range of 5 to 12, and still more preferably in a range of 6 to 10.

The number of carbon atoms in the cycloalkenyl group which can be employed as X¹ is preferably in a range of 4 to 15, more preferably in a range of 5 to 12, and still more preferably in a range of 6 to 10.

The number of carbon atoms of the alkyl group moiety in the alkoxy group and the alkoxycarbonyl group that can be employed as X¹ is the same as the number of carbon atoms of the alkyl group that can be employed as X¹.

The number of carbon atoms of the alkenyl group moiety in the alkenyloxy group that can be employed as X¹ is the same as the number of carbon atoms of the alkenyl group that can be employed as X¹.

In the above-described examples of the substituent that can be employed as X¹, examples of the substituent that the aryl group or the heteroaryl group which can be employed as Ar¹⁰¹ to Ar¹⁰⁴ may have can be applied to the examples of the substituent that each substituent may have. It is preferable that the substituent that can be employed as X¹ has a partial structure represented by any of Formulae (Pol-1) to (Pol-6) described later. Specific examples thereof preferably include an alkoxycarbonyl group having a partial structure represented by any of Formulae (Pol-1) to (Pol-6) described later.

X¹ represents preferably an alkyl group, an alkoxycarbonyl group, a cyano group, a formyl group, an alkoxy group, or an alkylcarbonyloxy group, more preferably an alkyl group, an alkoxycarbonyl group, a cyano group, or a formyl group, and still more preferably an alkoxycarbonyl group, a cyano group, or a formyl group.

As the monovalent substituent that can be employed as Y¹, the description of the monovalent substituent that can be employed as X¹ can be applied.

Y¹ represents a hydrogen atom or a monovalent substituent, preferably a hydrogen atom, an alkyl group, an alkoxycarbonyl group, a cyano group, a formyl group, an alkoxy group, or an alkylcarbonyloxy group, more preferably a hydrogen atom, an alkyl group, an alkoxycarbonyl group, a cyano group, or a formyl group, and still more preferably a hydrogen atom, an alkoxycarbonyl group, a cyano group, or a formyl group.

Adjacent two of Ar¹⁰¹ to Ar¹⁰⁴, X¹, and Y¹ may be bonded to each other to form a ring, and examples of the form include a form in which adjacent two of Ar¹⁰¹ to Ar¹⁰⁴ are bonded to each other to form a fluorene ring together with adjacent two of Ar¹⁰′ to Ar¹⁰⁴. Among the examples, a form in which Ar¹⁰¹ and Ar¹⁰² are bonded to each other to form a fluorene ring together with Ar¹⁰¹ and Ar¹⁰² is preferable.

In the present invention, it is preferable that adjacent two of Ar¹⁰¹ to Ar¹⁰⁴, X¹, and Y¹ are not bonded to each other.

Further, in the present invention, it is preferable that the component B does not have a siloxane structure.

From the viewpoint of further improving the light resistance, it is preferable that the component B is a compound represented by any of General Formulae (B11), (B41), or (B51).

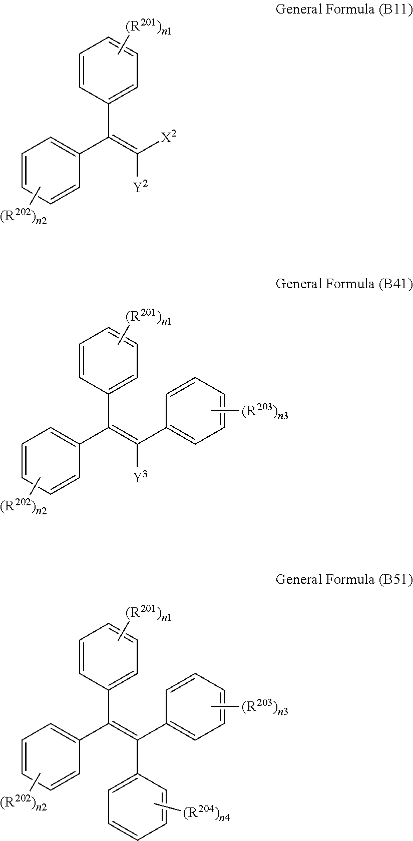

In the formulae, R²⁰¹ to R²⁰⁴ represent a substituent, n1 to n4 represent an integer of 0 to 5, X² represents a monovalent substituent, and Y² and Y³ represent a hydrogen atom or a monovalent substituent. Here, none of the monovalent substituents may be employed as X², Y², or Y³ is an aryl group or a heteroaryl group.

The description of the substituent that the aryl group or the heteroaryl group which can be employed as Ar¹⁰¹ to Ar¹⁰⁴ may have is applied to the substituent that can be employed as R²⁰¹ to R²⁰⁴.

The description of the monovalent substituent that can be employed as X¹ can be applied to the monovalent substituent that can be employed as X².

The description of the monovalent substituent that can be employed as Y¹ can be applied to the monovalent substituent that can be employed as Y² and Y³.

Y² represents preferably a monovalent substituent, more preferably an alkyl group, an alkoxycarbonyl group, a cyano group, a formyl group, an alkoxy group, or an alkylcarbonyloxy group, still more preferably an alkyl group, an alkoxycarbonyl group, a cyano group, or a formyl group, and particularly preferably an alkoxycarbonyl group, a cyano group, or a formyl group.

The description of Y¹ can be preferably applied to Y³.

n1 to n4 represent preferably an integer of 0 to 2, more preferably an integer of 0 or 1, and still more preferably 0.

In the present invention, it is preferable that adjacent two of R²⁰¹ to R²⁰⁴ are not bonded to each other.

From the viewpoint of further improving the light resistance, it is more preferable that the component B is a compound in which Y² represents a monovalent substituent or a compound represented by General Formula (B41) among the compounds represented by General Formula (B11).

In addition, it is possible to obtain a cured substance or molded body exhibiting excellent light resistance, and furthermore, from the viewpoint of obtaining excellent durability (excellent durability against thermal stress such as heat shock resistance) of the optical member including this cured substance or molded body, the component B is a compound represented by any of General Formulae (B11), (B41), or (B51), and it is preferable that at least one of R²⁰¹, R²⁰², X², or Y² in General Formula (B11), at least one of R²⁰¹, R²⁰², R²⁰³ or Y³ in General Formula (B41), and at least one of R²⁰¹, . . . , or R²⁰⁴ in General Formula (B51) are a compound having a partial structure represented by any of General Formulae (Pol-1) to (Pol-6).

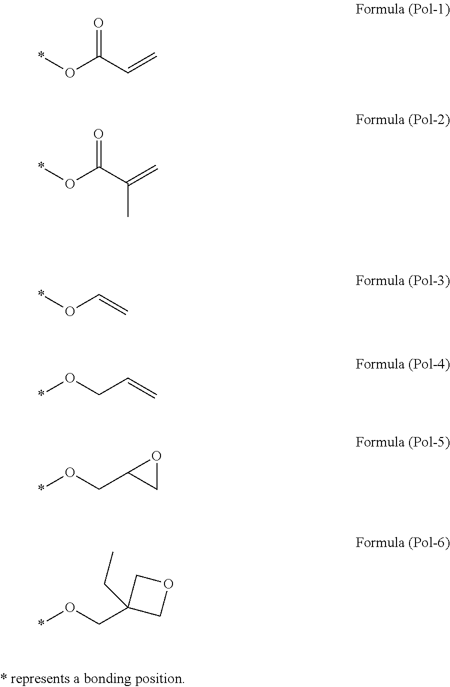

It is preferable that the compound represented by any of General Formulae (B11), (B41), or (B51) has the partial structure represented by any of General Formulae (Pol-1) to (Pol-6) as a substituent represented by -L^{a}-Sp^{g}-Pol⁷ in General Formula (B12).

The number of partial structures represented by any of General Formulae (Pol-1) to (Pol-6) in the compound represented by any of General Formulae (B11), (B41), or (B51) is not particularly limited as long as the above-described excellent light resistance and excellent durability can be obtained. However, it is preferably 1 or 2 and more preferably 1.

In General Formula (B11), it is more preferable that at least one of X² or Y² has the partial structure represented by any of General Formula (Pol-1) to (Pol-6), in General Formula (B41), it is more preferable that at least one of R²⁰¹, R²⁰², or R²⁰³ has the partial structure represented by any of General Formula (Pol-1) to (Pol-6), and in General Formula (B51), it is more preferable that at least one of R²⁰¹, . . . , or R²⁰⁴ has the partial structure represented by any of General Formula (Pol-1) to (Pol-6).

Among these, the component B is the compound represented by General Formula (B11), it is more preferable that at least one of X² or Y² is a compound having the partial structure represented by any of General Formulae (Pol-1) to (Pol-6), and still more preferable that at least one of X² or Y² is a compound represented by General Formula (B12).

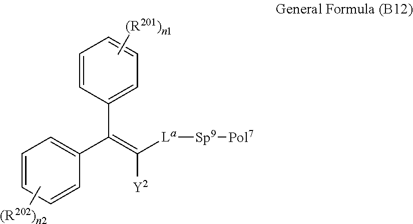

In the formula, L^{a} represents a single bond, —O—, —C(═O)—, —C(═O)O—, an alkylene group, —CR^{β1}═C^{β2}—, a cycloalkylene group, or a cycloalkenylene group. Where, a right side of —C(═O)O— is bonded to Sp^{g}. And a right side in —C(═O)O— means the ether bond side.

R^{β1} and R^{β2} represent a hydrogen atom or a monovalent substituent.

Sp^{g} represents a single bond or a divalent linking group, and Pol⁷ is the group represented by any of General Formulae (Pol-1) to (Pol-6).

Here, in a case where L^{a} is a single bond, Sp^{g} is a single bond.

R²⁰¹, R²⁰², n1, n2, and Y² respectively have the same definitions as R²⁰¹, R²⁰², n1, n2, and Y² in General Formula (B11).

As the number of carbon atoms of the cycloalkylene group and the cycloalkenylene group, which can be employed as L^{a}, the description of the number of carbon atoms of the cycloalkyl group and the cycloalkenyl group, which can be employed as X¹, can be applied.

It is preferable that L^{a} represents —C(═O)— or —C(═O)O—.

The description of the substituent that the aryl group or the heteroaryl group which can be employed as Ar¹⁰¹ to Ar¹⁰⁴ may have is applied to the monovalent substituent which can be employed as R^{β1} to R^{β2}.

As R^{β1} and R^{β2}, a hydrogen atom or an alkyl group is preferable.

The divalent linking group that can be employed as Sp^{g} is not particularly limited, but an alkylene group is exemplified, and an alkylene group having 1 to 6 carbon atoms is preferable and an alkylene group having 1 to 4 carbon atoms is more preferable.

As Sp^{g}, a single bond or an alkylene group is preferable, a single bond or an alkylene group having 1 to 6 carbon atoms is more preferable, and a single bond or an alkylene group having 1 to 4 carbon atoms is still more preferable.

-La-Sp^{g}- is preferably —C(═O)— or —C(═O)O-alkylene group-, more preferably —C(═O)—or —C(═O)O-alkylene group- having 1 to 6 carbon atoms, and still more preferably —C(═O)— or —C(═O)O-alkylene group- having 1 to 4 carbon atoms.

Pol⁷ is preferably a (meth)acryloyloxy group represented by Formula (Pol-1) or Formula (Pol-2).

Hereinafter, specific examples of the compound represented by any of General Formulae (B1) to (B5), which is preferably used in the composition according to the embodiment of the present invention, will be shown, but the present invention is not limited to the following compounds.

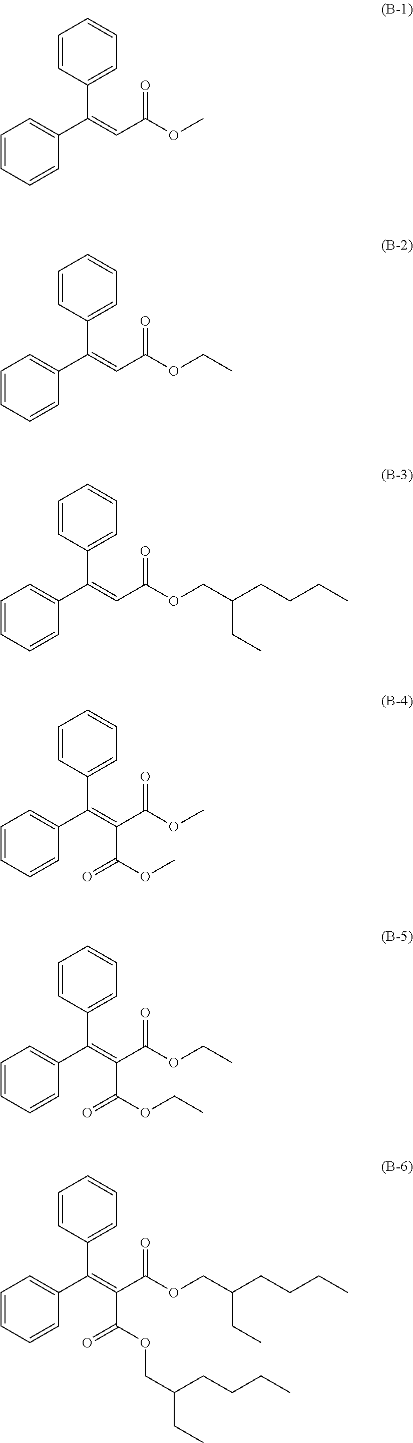

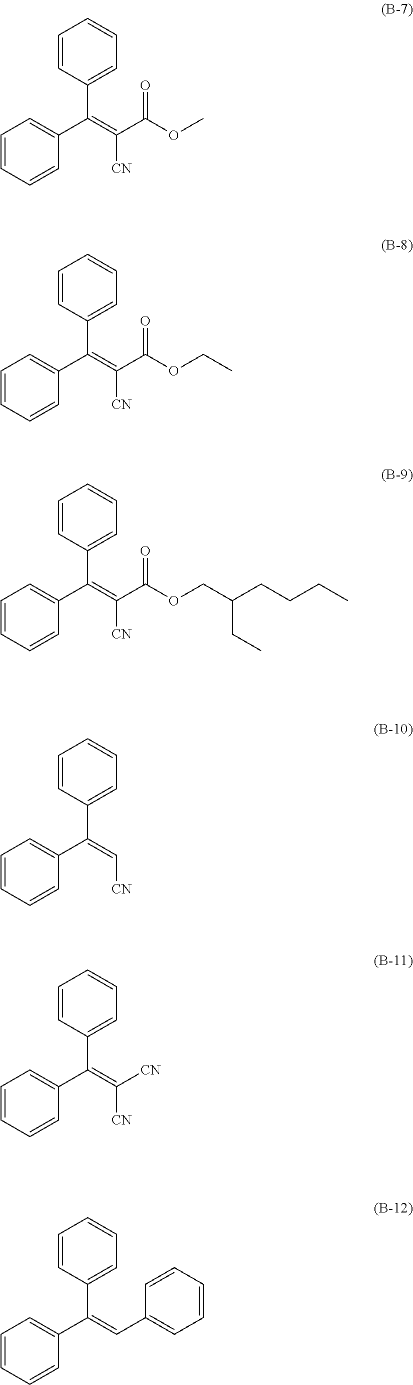

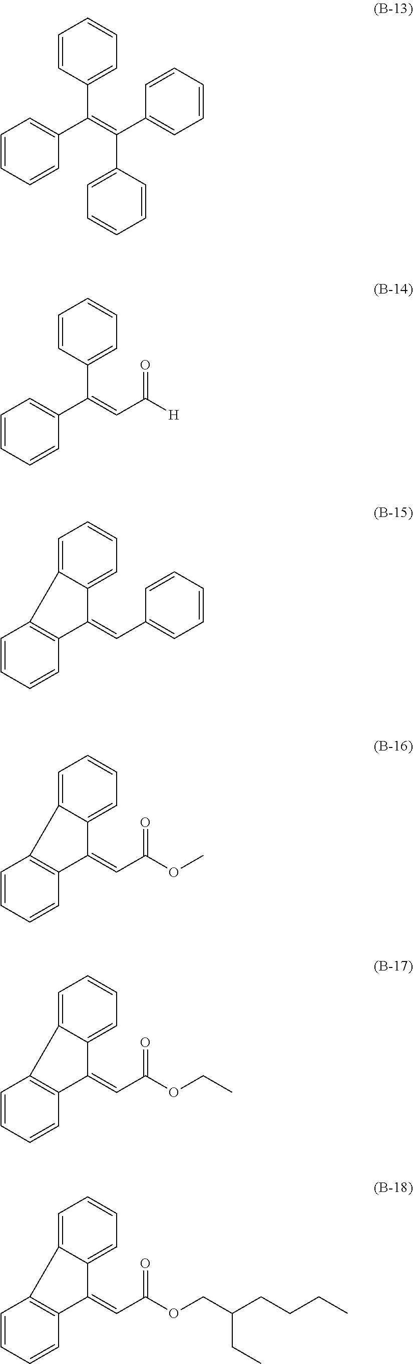

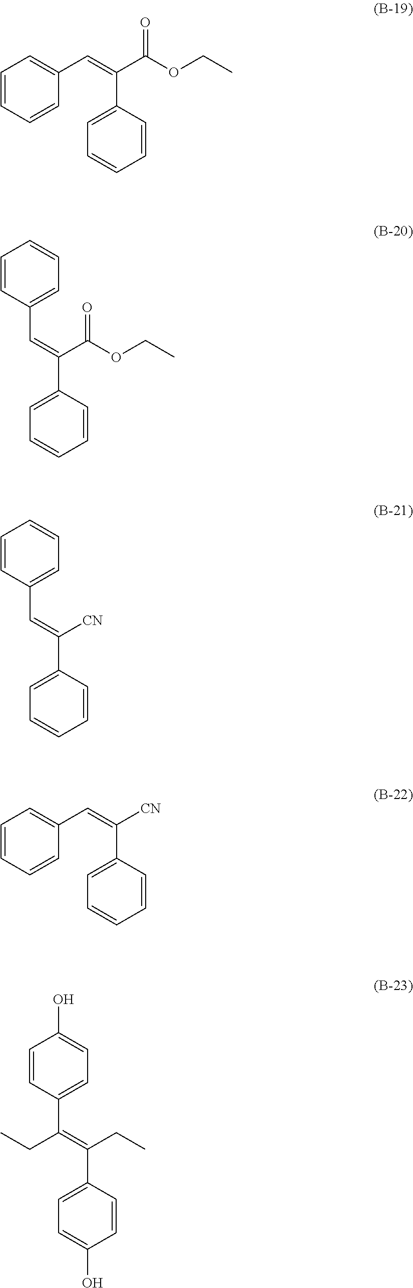

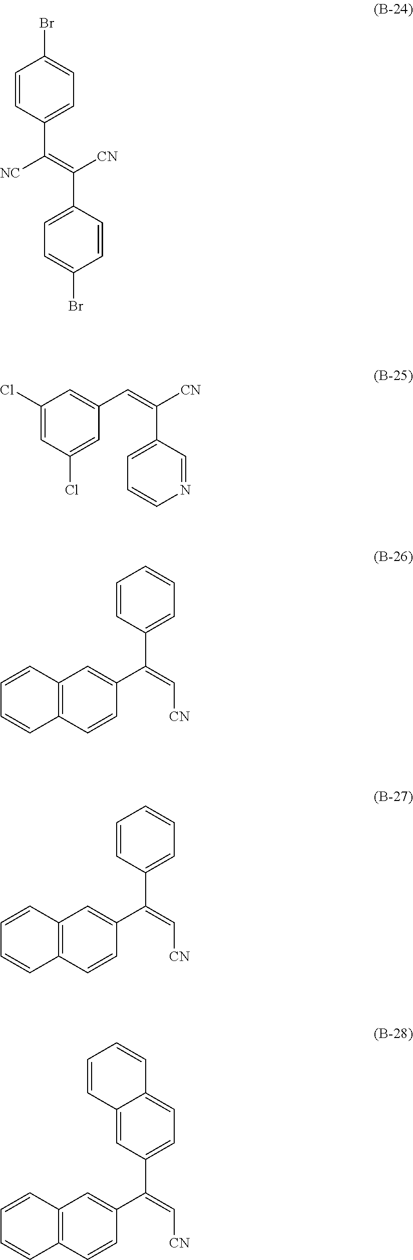

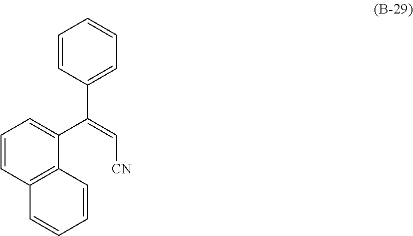

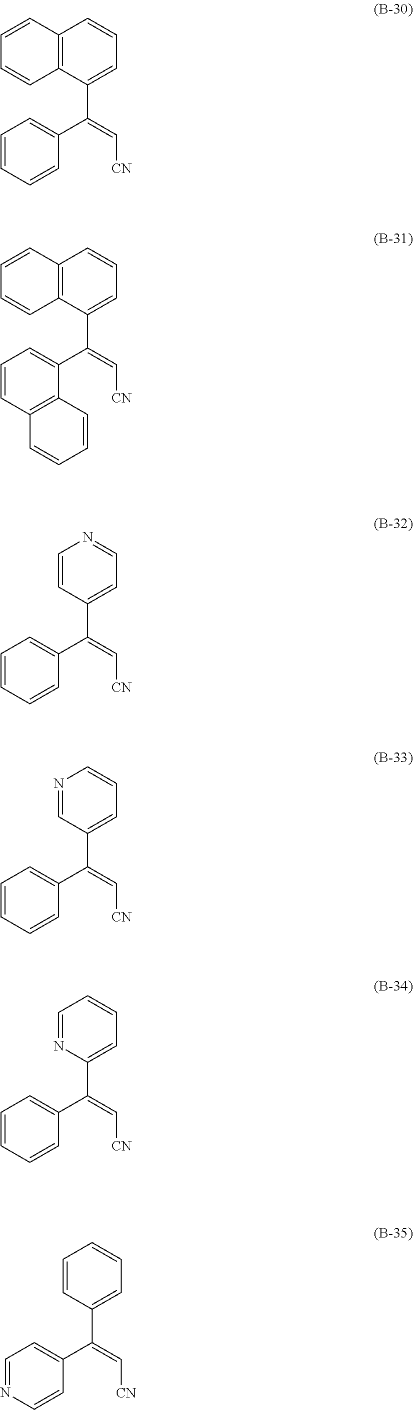

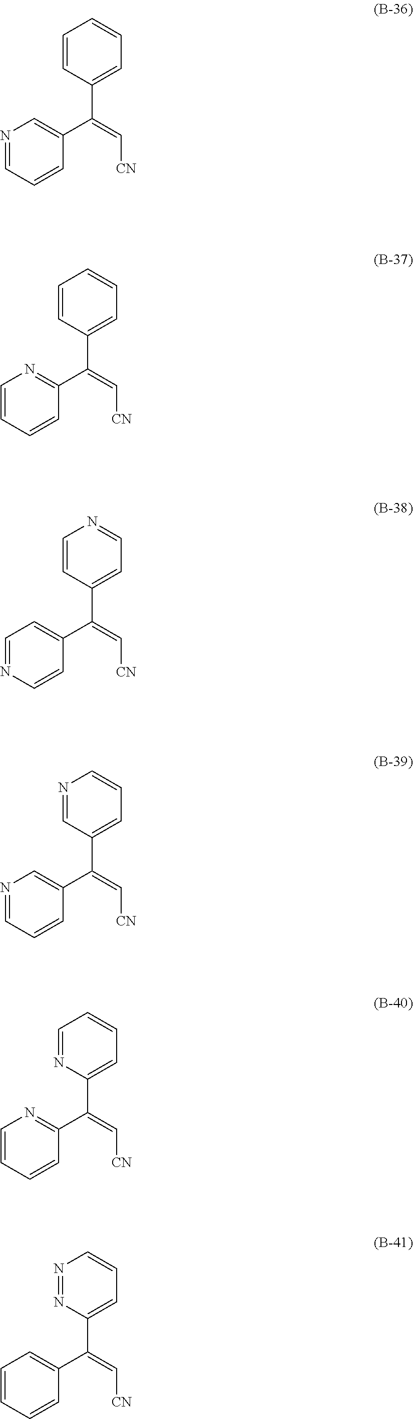

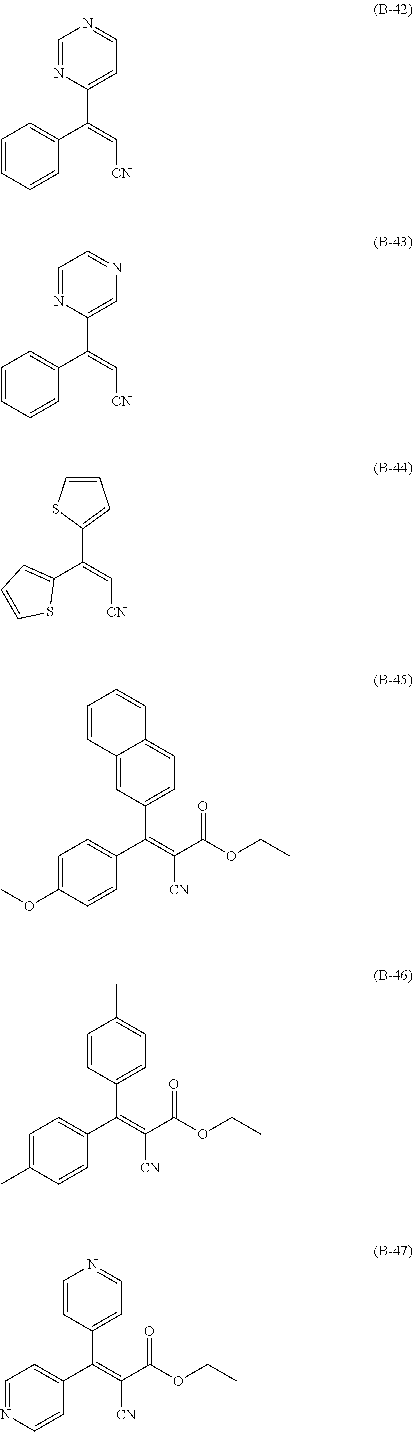

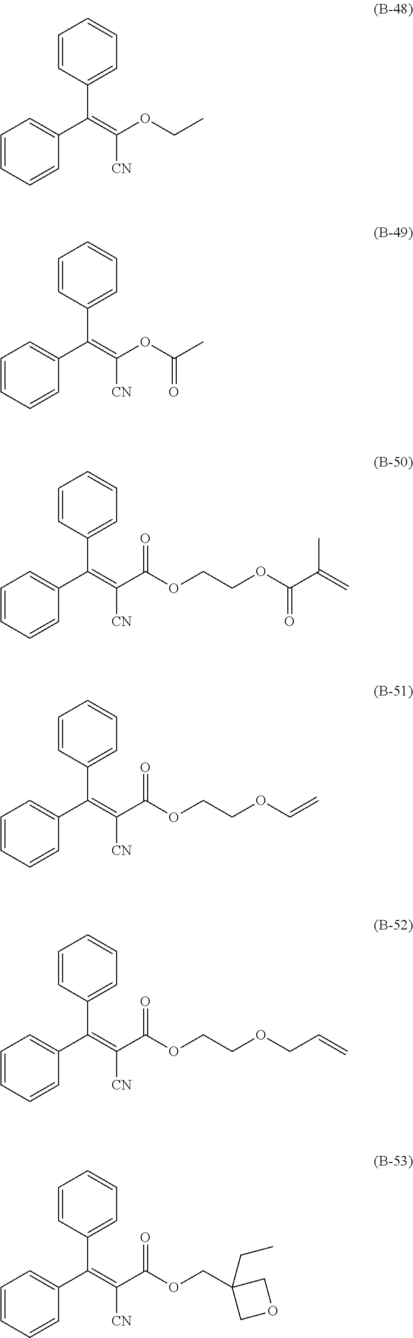

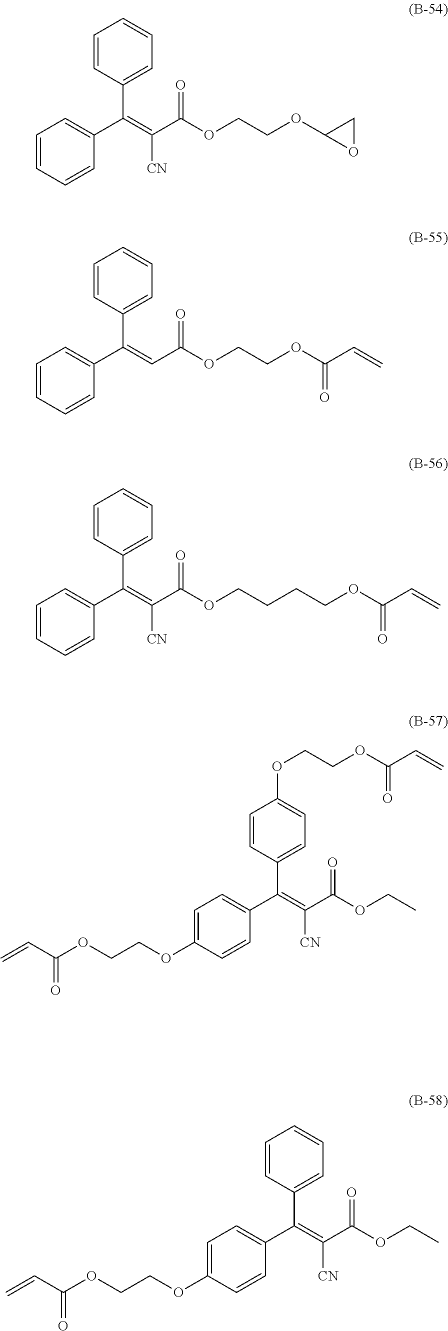

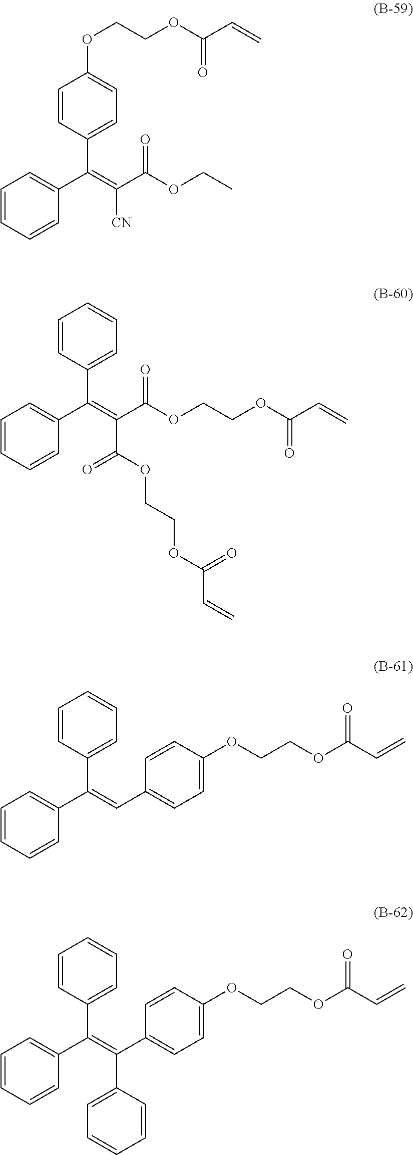

From the viewpoint of further improving the light resistance, the content of the component B in the composition according to the embodiment of the present invention is preferably 1% by mass or more. more preferably 3% by mass or more. and still more preferably 5% by mass or more with respect to the total solid content of the composition. In addition, from the viewpoint of further improving the durability against thermal stress such as heat shock resistance, it is preferably 50% by mass or less, more preferably 45% by mass or less, and still more preferably 40% by mass or less. In a case where the content of the component B is set to be in the above-described preferable range, the cured substance or the molded body obtained from the composition according to the embodiment of the present invention can achieve both excellent light resistance and excellent optical characteristics (a low Abbe number and high partial dispersion ratios). And the optical member using the cured substance and the molded body can exhibit the durability against thermal stress such as heat shock resistance. For example, the content of the component B in the composition according to the embodiment of the present invention is preferably in range of 1% to 30% by mass with respect to the total solid content of the composition.

Further, the content of the component B in the composition according to the embodiment of the present invention is preferably in a range of 2 to 80 parts by mass, more preferably in a range of 5 to 70 parts by mass, and still more preferably in a range of 10 to 60 parts by mass with respect to 100 parts by mass of the component A.

<Other Components>

The composition according to the embodiment of the present invention may further contain other components in addition to the component A and the component B. Examples of the other components may include a (meth)acrylate monomer, a polymer containing a radically polymerizable group in a side chain, and a polymerization initiator. Further, other examples thereof include a polymer or monomer other than the above-described components, a dispersant, a plasticizer, a heat stabilizer, a release agent, and a solvent. As the heat stabilizer, for example, the hindered phenol-based heat stabilizer or the phosphorus-based heat stabilizer described in paragraphs “0261” and “0262” of JP2021-1328A can be used. Since the resin composition according to the embodiment of the present invention does not require a further polymerization (curing) reaction, it is preferable that the resin composition does not contain a polymer or a monomer containing a polymerizable group.

((Meth)Acrylate Monomer)

In a case where the composition according to the embodiment of the present invention is a curable composition, the curable composition according to the embodiment of the present invention may contain a (meth)acrylate monomer. The (meth)acrylate monomer may be a polyfunctional (meth)acrylate monomer containing two or more (meth)acryloyl groups in a molecule or may be a monofunctional (meth)acrylate monomer containing one (meth)acryloyl group in a molecule.

Specific examples of the (meth)acrylate monomer include the following monomers 1 to 5 and monomers M-1 to M-10. In the following monomer 5, n denotes the number of repetitions. Further, other examples thereof include the (meth)acrylate monomer described in paragraphs “0037” to “0046” of JP2012-107191A.

The molecular weight of the (meth)acrylate monomer is preferably in a range of 100 to 500.

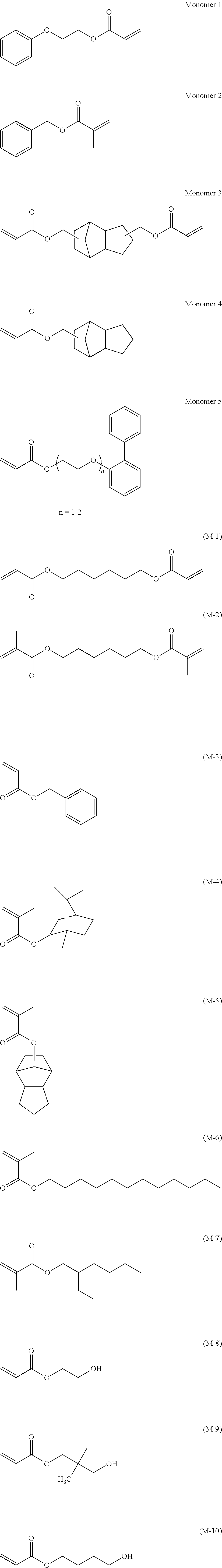

A method of obtaining the (meth)acrylate monomer is not particularly limited, and the (meth)acrylate monomer may be obtained commercially or may be produced by synthesis using a method of the related art.

In a case of being obtained commercially, for example, Viscoat #192 PEA (monomer 1 described above) (manufactured by OSAKA ORGANIC CHEMICAL INDUSTRY LTD.), Viscoat #160 BZA (monomer 2 described above) (manufactured by OSAKA ORGANIC CHEMICAL INDUSTRY LTD.), Lightester Bz (monomer 2 described above) (manufactured by KYOEISHA CHEMICAL Co., LTD.), A-DCP (monomer 3 described above) (manufactured by Shin-Nakamura Chemical Co., Ltd.), FA-513AS (monomer 4 described above) (manufactured by Hitachi Chemical Co., Ltd.), A-HD-N(M-1 described above) (manufactured by Shin-Nakamura Chemical Co., Ltd.), HD-N(M-2 described above) (manufactured by Shin-Nakamura Chemical Co., Ltd.), FA-BZA (M-3 described above) (manufactured by Hitachi Chemical Co., Ltd.), Lightester IB-X (M-4 described above) (manufactured by KYOEISHA CHEMICAL Co., LTD.), FA-513M (M-5 described above) (manufactured by Hitachi Chemical Co., Ltd.), Lightester L (M-6 described above) (manufactured by KYOEISHA CHEMICAL Co., LTD.), 2EHA (M-7 described above) (manufactured by TOAGOSEI CO., LTD.), HEA (M-8 described above) (manufactured by OSAKA ORGANIC CHEMICAL INDUSTRY LTD.), Lightester HOP-A(N) (M-9 described above) (manufactured by KYOEISHA CHEMICAL Co., LTD.), or 4-HBA (M-10 described above) (manufactured by OSAKA ORGANIC CHEMICAL INDUSTRY LTD.) can be preferably used.

In a case where the curable composition according to the embodiment of the present invention contains a (meth)acrylate monomer, the content of the (meth)acrylate monomer in the curable composition is preferably in a range of 1% to 60% by mass, more preferably in a range of 2% to 45% by mass, still more preferably in a range of 3% to 35% by mass, particularly preferably in a range of 5% to 30% by mass. Further, it is also preferably 7% to 25% by mass. The function of relieving the stress in a case where the cured substance is thermally changed can be adjusted by adjusting the amount of the (meth)acrylate monomer in the curable composition according to the embodiment of the present invention.

(Polymer Containing Radically Polymerizable Group in Side Chain)

The curable composition according to the embodiment of the present invention may further contain a polymer containing a radically polymerizable group in a side chain, in addition to the above-described compound. The polymer containing a radically polymerizable group in a side chain functions to increase the viscosity of the curable composition, and thus the polymer can also be referred to as a thickener or a thickening polymer. The polymer containing a radically polymerizable group in a side chain can be added for adjusting the viscosity of the curable composition.

The polymer containing a radically polymerizable group in a side chain may be a homopolymer or a copolymer. Among these, it is preferable that the polymer containing a radically polymerizable group in a side chain is a copolymer. In a case where the polymer containing a radically polymerizable group in a side chain is a copolymer, at least one copolymer component may have a radically polymerizable group. In addition, in the case where the polymer containing a radically polymerizable group in a side chain is a copolymer, it is more preferable that the polymer is a copolymer having a monomer unit containing a radically polymerizable group in a side chain and a monomer unit containing an aromatic hydrocarbon group in a side chain.

The above-described copolymer may be a copolymer in any of a random form, a block form, or the like.

Examples of the radically polymerizable group include a (meth)acrylate group, a vinyl group, a styryl group, and an allyl group. In the polymer containing a radically polymerizable group in a side chain, the content of a structural unit containing a radically polymerizable group is preferably in a range of 5% to 100% by mass, more preferably in a range of 10% to 90% by mass, and still more preferably in a range of 20% to 80% by mass.

Specific examples of the polymer containing a radically polymerizable group in a side chain which is preferably used in the present invention are shown below, but the polymer containing a radically polymerizable group in a side chain is not limited to the following structures. All of the specific examples shown below are copolymers, and each copolymer has two or three structural units described in close proximity. For example, the specific example described on the top left end is an allyl methacrylate-benzyl methacrylate copolymer.

In the following structural formulae, Ra and Rb each independently represent a hydrogen atom or a methyl group. Further, a plurality of Ra's in one polymer may be the same as or different from each other. In addition, n represents an integer of 0 to 10, preferably 0 to 2, and more preferably 0 or 1. The amount ratio of each structural unit in the copolymer is not particularly limited, and the description above can be preferably applied to the content of the structural unit containing a radically polymerizable group in the copolymer.

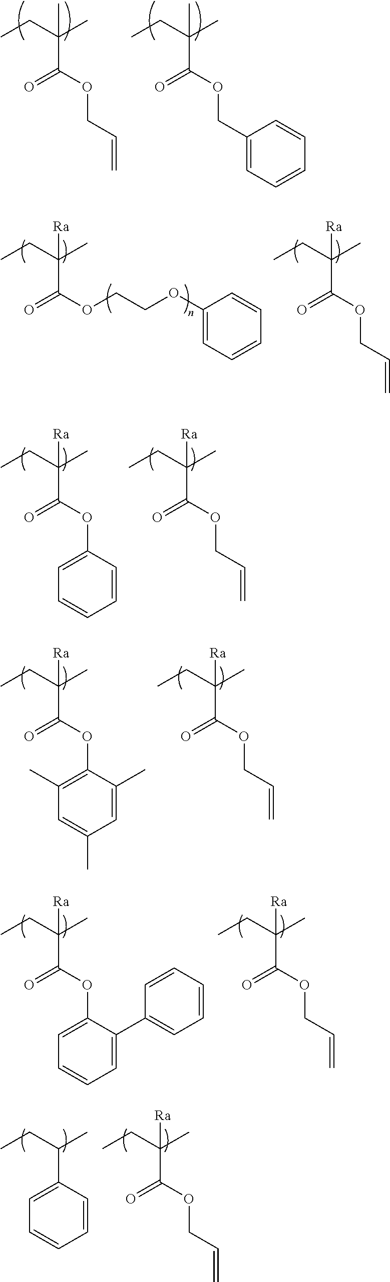

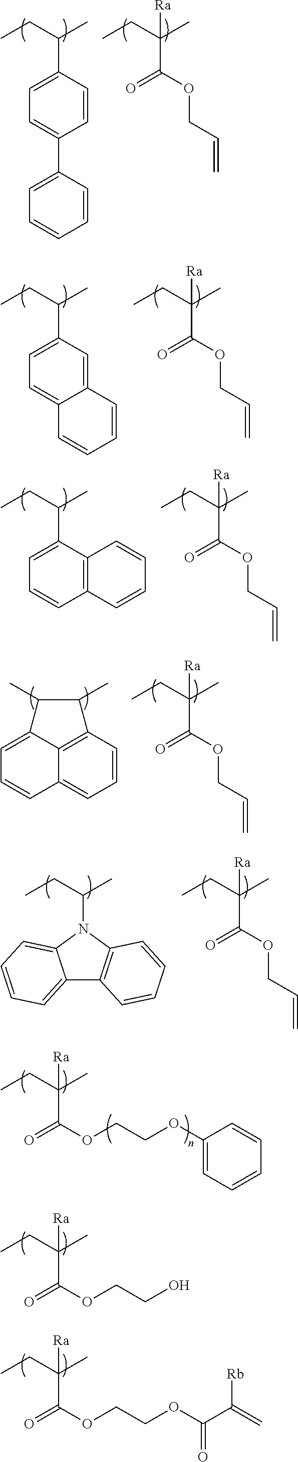

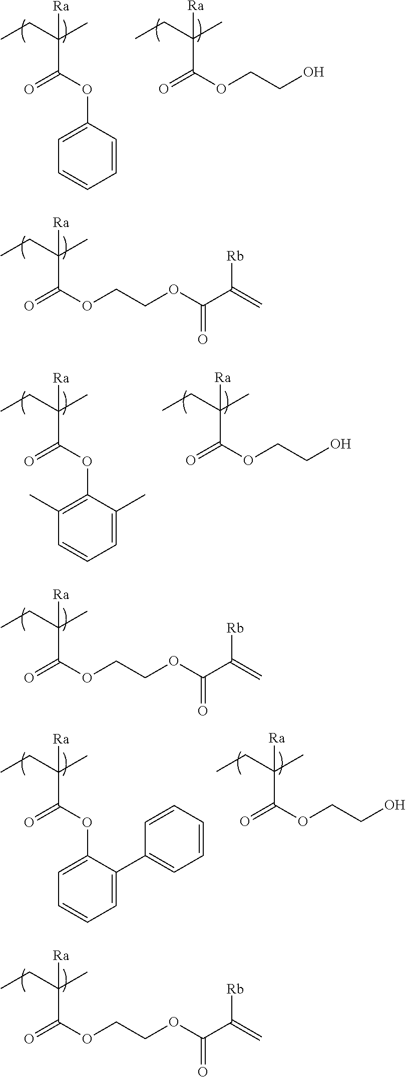

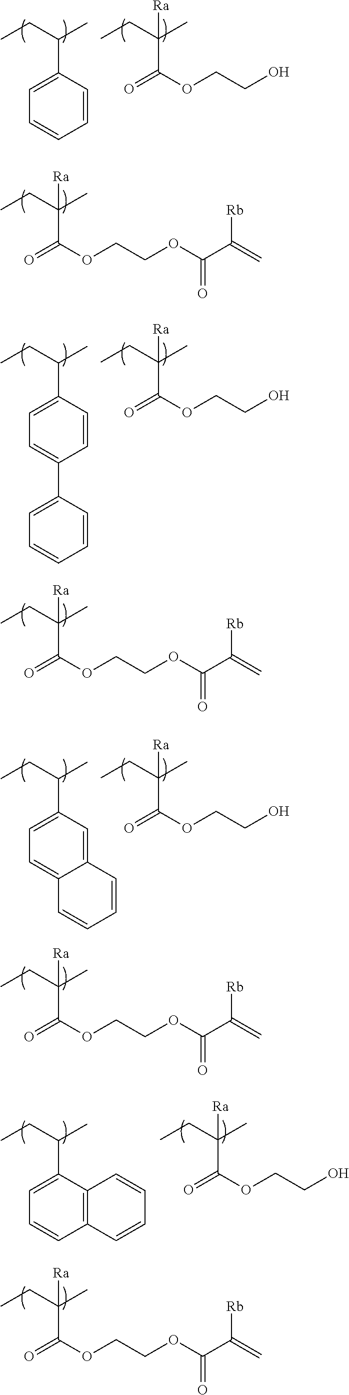

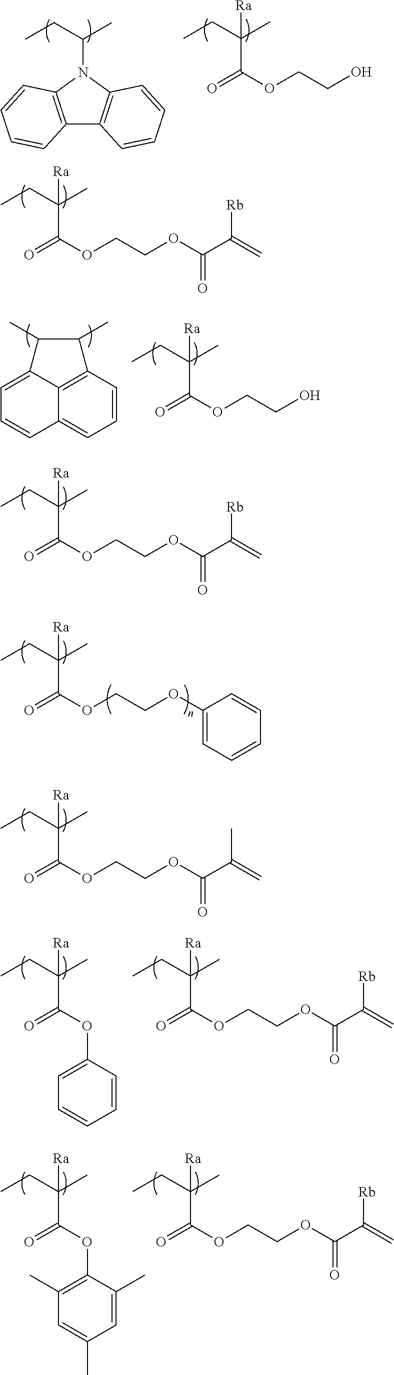

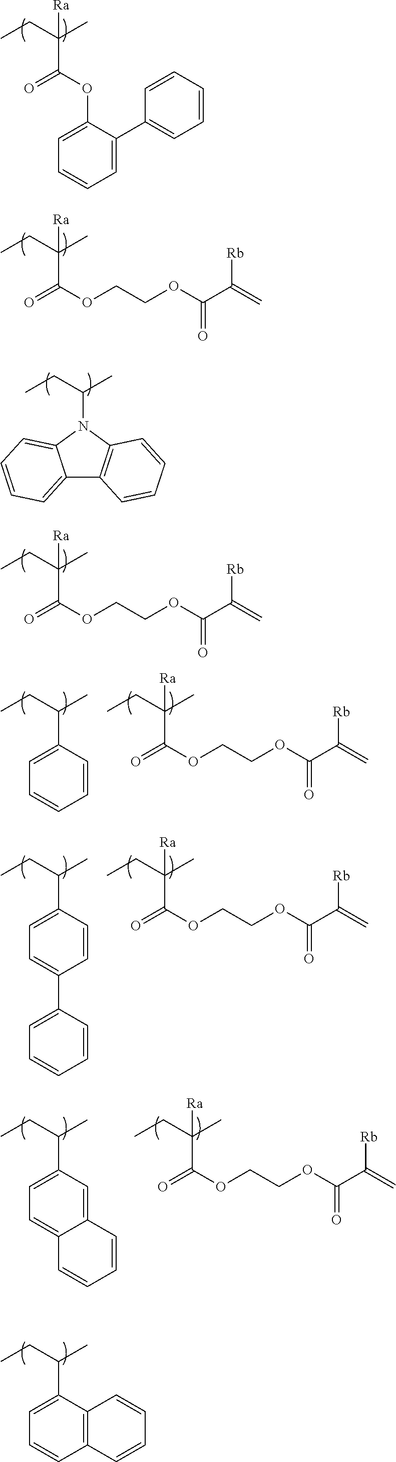

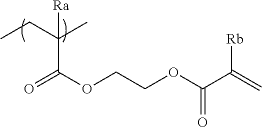

The molecular weight (weight-average molecular weight) of the polymer containing a radically polymerizable group in a side chain is preferably in a range of 1,000 to 10,000,000, more preferably in a range of 5,000 to 300,000, and still more preferably in a range of 10,000 to 200,000. The dispersity (Mw/Mn) of the polymer containing a radically polymerizable group in a side chain is preferably in a range of 1.1 to 10.0, more preferably in a range of 1.3 to 8.0, and still more preferably in a range of 1.5 to 6.0. The dispersity is calculated by dividing the weight-average molecular weight (Mw) by the number average molecular weight (Mn).

The weight-average molecular weight and the dispersity of the polymer containing a radically polymerizable group in a side chain are values measured by GPC in terms of standard polystyrene as described in the section of polymer B in the adhesive for a lens described below.

Further, the glass transition temperature of the polymer containing a radically polymerizable group in a side chain is preferably in a range of 50° C. to 400° C., more preferably in a range of 70° C. to 350° C., and still more preferably in a range of 100° C. to 300° C.

The content of the polymer containing a radically polymerizable group in a side chain is preferably 40% by mass or less, more preferably 30% by mass or less, still more preferably 25% by mass or less, and particularly preferably 15% by mass or less with respect to the amount of the curable composition according to the embodiment of the present invention. Further, the content of the polymer containing a radically polymerizable group in a side chain may be 0% by mass, and an aspect in which the polymer containing a radically polymerizable group in a side chain is not added is also preferable.

(Polymerization Initiator)

It is preferable that the curable composition according to the embodiment of the present invention contains at least one of a thermal radical polymerization initiator or a photoradical polymerization initiator as a polymerization initiator.

(Thermal Radical Polymerization Initiator)

It is preferable that the curable composition according to the embodiment of the present invention contains a thermal radical polymerization initiator (hereinafter, also referred to as “thermal polymerization initiator”). In a case where the curable composition according to the embodiment of the present invention is thermally polymerized due to the action of the thermal polymerization initiator, a cured substance in which a low Abbe number and high partial dispersion ratios are exhibited and the light resistance is excellent can be obtained.

As the thermal radical polymerization initiator, a compound typically used as a thermal radical polymerization initiator can be appropriately used under the conditions of the thermal polymerization (thermosetting) step described below. Examples thereof include an organic peroxide, and specifically, the following compounds can be used.

Examples of the thermal radical polymerization initiator include 1,1-di(t-hexylperoxy)cyclohexane, 1,1-di(t-butylperoxy)cyclohexane, 2,2-di(4,4-di-(t-butylperoxy)cyclohexyl)propane, t-hexylperoxyisopropyl monocarbonate, t-butylperoxy-3,5,5-trimethylhexanoate, t-butylperoxy laurate, dicumyl peroxide, di-t-butyl peroxide, t-butylperoxy-2-ethylhexanoate, di-t-hexyl peroxide, t-hexylperoxy-2-ethylhexanoate, cumene hydroperoxide, t-butyl hydroperoxide, t-butylperoxy-2-ethylhexyl, and 2,3-dimethyl-2,3-diphenylbutane. In addition, “t-butyl” denotes “tert-butyl”.

In a case where the curable composition contains a thermal radical polymerization initiator, the content of the thermal radical polymerization initiator in the curable composition according to the embodiment of the present invention is preferably in a range of 0.01% to 5.0% by mass, more preferably in a range of 0.02% to 3.0% by mass, still more preferably in a range of 0.03% to 2.0% by mass, and particularly preferably in a range of 0.05% to 1.0% by mass.

(Photoradical Polymerization Initiator)

It is preferable that the curable composition according to the embodiment of the present invention contains a photoradical polymerization initiator (hereinafter, also referred to as a “photopolymerization initiator”). As the photoradical polymerization initiator, a compound typically used as a photoradical polymerization initiator can be appropriately used under the conditions of the photopolymerization (photocuring) step described below, and specifically, the following compounds can be used.

Examples of photoradical polymerization initiators include bis(2,6-dimethoxybenzoyl)-2,4,4-trimethylpentylphosphine oxide, bis(2,6-dimethylbenzoyl)-2,4,4-trimethylpentylphosphine oxide, bis(2,4,6-trimethylbenzoyl)-2,4,4-trimethylpentylphosphine oxide, bis(2,6-dichlorobenzoyl)-2,4,4-trimethylpentylphosphine oxide, 1-phenyl-2-hydroxy-2-methylpropan-1-one, 1-hydroxycyclohexyl phenyl ketone, 1-(4-isopropylphenyl)-2-hydroxy-2-methylpropan-1-one, 1,2-diphenylethanedione, methylphenyl glyoxylate, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2,2-dimethoxy-1,2-diphenylethan-1-one, 2-methyl-1-(4-methylthiophenyl)-2-morpholinopropan-1-one, 2-benzyl-2-dimethylamino-1-(4-morpholinophenyl)-butanone-1, 2,4,6-trimethylbenzoyl-diphenyl-phosphine oxide, and bis(2,4,6-trimethylbenzoyl)-phenylphosphine oxide.

Among the photoradical polymerization initiators described above, the acylphosphine oxide photopolymerization initiator is preferable from the viewpoint that a cured substance having excellent light resistance can be obtained.

Among these, in the present invention, preferred examples of the photoradical polymerization initiator include 1-hydroxycyclohexylphenylketone (available as IRGACURE 184 (trade name), manufactured by BASF SE), bis(2,4,6-trimethylbenzoyl)-phenylphosphine oxide (available as IRGACURE 819 (trade name), manufactured by BASF SE), 2,4,6-trimethylbenzoyl-diphenyl-phosphine oxide (available as IRGACURE TPO (trade name), manufactured by BASF SE), 2,2-dimethoxy-1,2-diphenylethan-1-one (available as IRGACURE 651 (trade name), manufactured by BASF SE), 1-[4-(2-hydroxyethoxy)-phenyl]-2-hydroxy-2-methyl-1-propan-1-one, and 2-methyl-1-(4-methylthiophenyl)-2-morpholinopropan-1-one.

In a case where the curable composition contains a photoradical polymerization initiator, the content of the photoradical polymerization initiator in the curable composition is preferably in a range of 0.01% to 5.0% by mass, more preferably in a range of 0.05% to 1.0% by mass, and still more preferably in a range of 0.05% to 0.5% by mass.

It is preferable that the curable composition contains both the photoradical polymerization initiator and the thermal radical polymerization initiator, and in this case, the total content of the photoradical polymerization initiator and the thermal radical polymerization initiator is preferably in a range of 0.01% to 5.0% by mass, more preferably in a range of 0.05% to 1.0% by mass, and still more preferably in a range of 0.05% to 0.5% by mass with respect to the total mass of the curable composition.

From the viewpoint of enhancing the handleability in a case of molding the cured substance and forming a high-quality cured substance, the viscosity of the curable composition according to the embodiment of the present invention is preferably in a range of 1000 to 30000 mPa·s, more preferably in a range of 3000 to 20000 mPa·s, and still more preferably in a range of 5000 to 15000 mPa·s.

<Cured Substance or Molded Body>

The cured substance according to the embodiment of the present invention is a cured substance of the curable composition according to the embodiment of the present invention, containing a polymerizable compound having a nitrogen-containing fused aromatic ring as the component A and the component B.

The cured substance according to the embodiment of the present invention is obtained by promoting the polymerization reaction of a monomer containing a polymerizable compound having a nitrogen-containing fused aromatic ring as the component A and curing the composition. The cured substance according to the embodiment of the present invention may contain an unreacted monomer (for example, the component A).

The molded body according to the embodiment of the present invention is a molded body of the resin composition according to the embodiment of the present invention, containing a polymer having a nitrogen-containing fused aromatic ring as the component A and the component B.

The molded body according to the embodiment of the present invention is obtained by molding the resin composition containing a polymer that has a nitrogen-containing fused aromatic ring as the component A.

In the present invention, the cured substance obtained from the curable composition according to the embodiment of the present invention and the molded body obtained from the resin composition according to the embodiment of the present invention are also referred to as “the cured substance and the molded body according to the embodiment of the present invention”.

As described above, the cured substance and the molded body according to the embodiment of the present invention have a low Abbe number (νD) and high partial dispersion ratios and can also exhibit excellent light resistance.

The Abbe number (νD) and the partial dispersion ratios (θg and F-Number) of the cured substance and the molded body are values measured using an Abbe refractometer (trade name: DR-M4, manufactured by Atago Co., Ltd.). Specifically, the measurement is performed based on the description in the section of <Measurement of optical characteristics> in the example below.

The Abbe number (νD) and the partial dispersion ratios (θg and F-Number) of the cured substance and the molded body are calculated by the following equations. In a case of molding the cured substance, the cured substance may be molded by the preparation of a photocured sample described in Example 1 described later, and a heating step may be employed in place of the ultraviolet irradiation step or both the heating step and the ultraviolet irradiation step may be employed. Further, JIS B 7090: 1999 Optics and optical Instruments-Reference wavelengths (ISO 7944: 1998) can be appropriately referred to.

νD=(nD−1)/(nF−nC)

θg and F-Number=(ng−nF)/(nF−nC)

Here, nD represents a refractive index at a wavelength of 589 nm, nF represents a refractive index at a wavelength of 486 nm, nC represents a refractive index at a wavelength of 656 nm, and ng represents a refractive index at a wavelength of 436 nm.

In a case where the d line (587.56 nm) is used as a reference instead of the D line, an Abbe number is denoted as an Abbe number (νd). However, in a case where a compound having a nitrogen-containing fused aromatic ring is used, the Abbe number (νD) and the Abbe number (νd) generally show the same values.

The Abbe number of the cured substance and the molded body according to the embodiment of the present invention is not particularly limited, but it is preferably 35 or less, more preferably 30 or less, still more preferably 29 or less, and particularly preferably 28 or less. In addition, the Abbe number of the cured substance and the molded body according to the embodiment of the present invention is not particularly limited, but it is preferably 1 or greater, more preferably 3 or greater, still more preferably 5 or greater, and particularly preferably 7 or greater.

The partial dispersion ratios (θg and F-Number) of the cured substance and the molded body according to the embodiment of the present invention is not particularly limited, but it is preferably 0.65 or greater, more preferably 0.70 or greater, still more preferably 0.72 or greater, and particularly preferably 0.75 or greater. Further, the partial dispersion ratios (θg and F-Number) of the cured substance and the molded body according to the embodiment of the present invention are not particularly limited, but are preferably 2 or less, more preferably 1.8 or less, and still more preferably 1.7 or less.

In a case where the cured substance and the molded body according to the embodiment of the present invention are used as a lens, the cured substance and the molded body according to the embodiment of the present invention are required to have no absorption in a visible light region, that is, to be transparent, as a performance.

The cured substance and the molded body according to the embodiment of the present invention have substantially no absorption in a long wavelength range of the visible light region, and the transmittance decreases toward a short wavelength side. Therefore, the transparency of the cured substance and the molded body according to the embodiment of the present invention can be evaluated by measuring the transmittance at a wavelength of 430 nm.

The transmittances of the cured substance and the molded body according to the embodiment of the present invention at a wavelength of 430 nm are values measured using an ultraviolet-visible spectrophotometer (for example, UV-2600 (trade name, manufactured by Shimadzu Corporation)). Specifically, the transmittance of the cured substance and the molded body at a wavelength of 430 nm, which has a thickness of approximately 500 m and is produced in the same manner as that for the photocured sample in the description of Example 1 described later, for example, a transparent glass mold having a diameter of 20 mm and a thickness of 500 m, is measured. Further, the transmittance of the cured substance and the molded body at a wavelength of 430 nm, which has a thickness of approximately 500 m and is produced in the same manner as that for the evaluation sample in the description of Example 2 described later, for example, a spacer having a thickness of 500 mm, is measured.

Further, a light irradiation test for evaluating the light resistance of the cured substance and the molded body is performed based on a xenon-light irradiation test described in the examples below.

Hereinafter, preferable values of the transmittances of the cured substance and the molded body at a wavelength of 430 nm, measured by the following method, will be described.

The transmittances of the cured substance and the molded body according to the embodiment of the present invention immediately after preparation, that is, the transmittances before the light irradiation test are not particularly limited, but are preferably 80% or greater, more preferably 82% or greater, still more preferably 83% or greater, and particularly preferably 85% or greater.

Further, the transmittances of the cured substance and the molded body according to the embodiment of the present invention after the light irradiation test are not particularly limited. However, in Evaluation 2 (transmittance after the xenon-light irradiation test for 48 hours), the transmittances are preferably 72% or greater, more preferably 75% or greater, still more preferably 79% or greater, and particularly preferably 81% or greater.

A decrease range in the transmittance of the cured substance and the molded body according to the embodiment of the present invention before and after the light irradiation test is not particularly limited. However, in Evaluation 3 (decrease range in the transmittance before and after the xenon-light irradiation test for 48 hours), the transmittances are preferably 15% or less, more preferably 12% or less, still more preferably 8% or less, and particularly preferably 5% or less.

The decrease range in the transmittance before and after the light irradiation test is calculated by subtracting the value of the transmittance after the light irradiation test from the value of the transmittance before the light irradiation test.

In addition, preferable values of the transmittance at a wavelength of 430 nm of a compound lens that includes a lens base material produced by using the cured substance or the molded body according to the embodiment of the present invention, will be described later.

The transmittances of the compound lens according to the embodiment of the present invention immediately after preparation, that is, the transmittances before the light irradiation test are not particularly limited, but are preferably 80% or greater, more preferably 82% or greater, still more preferably 83% or greater, and particularly preferably 85% or greater.

Further, the transmittances of the compound lens according to the embodiment of the present invention after the light irradiation test are not particularly limited. However, in Evaluation 5 (transmittance after the xenon-light irradiation test for 240 hours), the transmittances are preferably 74% or greater, more preferably 75% or greater, still more preferably 78% or greater, and particularly preferably 79% or greater.

A decrease range in the transmittance of the compound lens according to the embodiment of the present invention before and after the light irradiation test is not particularly limited. However, in Evaluation 6 (decrease range in the transmittance before and after the xenon-light irradiation test for 240 hours), the decrease range is preferably 15% or less, more preferably 12% or less, still more preferably 8% or less, and particularly preferably 5% or less.

The decrease range in the transmittance before and after the light irradiation test is calculated by subtracting the value of the transmittance after the light irradiation test from the value of the transmittance before the light irradiation test.

The transmittances of the compound lens according to the embodiment of the present invention at a wavelength of 430 nm are values measured using an ultraviolet-visible spectrophotometer (for example, UV-2600 (trade name, manufactured by Shimadzu Corporation)). Specifically, the transmittance of the compound lens at a wavelength of 430 nm is measured, the compound lens is prepared in the same manner as in the preparation of the compound lens described in Reference Example 1.

[Method of Producing Cured Substance]

The cured substance according to the embodiment of the present invention can be produced by a method including at least one of a step of photocuring or a step of thermosetting the curable composition according to the embodiment of the present invention. Among these, it is preferable that the method of producing a cured substance includes a step of forming a semi-cured substance by irradiating the curable composition with light or heating the curable composition, and a step of forming a cured substance by irradiating the obtained semi-cured substance with light or heating the obtained semi-cured substance.

As each of the “step of forming a semi-cured substance”, the “step of forming a cured substance”, and the “semi-cured substance”, unless otherwise specified, the description of the “step of forming a semi-cured substance”, the “step of forming a cured substance”, and the “semi-cured substance” in “0106” to “0117”, “0118” to “0124”, and “0125” of WO2019/044863A can be applied as they are, except for replacing “curable composition” with the “curable composition according to the embodiment of the present invention”.

In the present invention, a pressure for a deformation under pressure in the “step of forming the cured substance” is preferably in a range of 0.098 MPa to 9.8 MPa, more preferably in a range of 0.154 MPa to 4.9 MPa, and still more preferably in a range of 0.154 MPa to 2.94 MPa.

[Method of Producing Molded Body]

The molded body of the present invention can be produced by molding the resin composition according to the embodiment of the present invention. Examples of the molding method of the molded body include heat pressure molding, and for example, compression molding, injection molding, extrusion molding, blow molding, or emboss molding can be employed.

The resin composition according to the embodiment of the present invention may be pelletized before heat pressure molding. The handleability of the resin during the heat pressure molding can be enhanced by pelletizing the resin composition according to the embodiment of the present invention. In a case of pelletizing the resin composition according to the embodiment of the present invention, for example, a vent type single-screw extruder or the like can be used.

In a case of performing compression molding, the upper and lower portions of the resin composition (preferably pellets of the resin composition according to the embodiment of the present invention) according to the embodiment of the present invention are sandwiched between resin films, such as polyimide films using a spacer having a desired thickness. And then heat compression is performed thereon, the resin composition together with the spacer is removed from the resin films, and the resin composition is cooled (including natural cooling) to room temperature to mold the molded body.

As the conditions for heat compression, the heating temperature is preferably in a range of 180° C. to 450° C. and more preferably in a range of 180° C. to 390° C., the pressure is preferably in a range of 0.098 MPa to 9.8 MPa, more preferably in a range of 0.294 MPa to 9.8 MPa, and still more preferably in a range of 1.0 MPa to 9.8 MPa, and the pressurization time is preferably in a range of 30 to 1000 seconds, more preferably in a range of 30 to 500 seconds, and still more preferably in a range of 60 to 500 seconds.

In a case of performing injection molding, an injection molding machine (including an injection compression molding machine) is used. The melt of the resin composition according to the embodiment of the present invention is accumulated at the tip of a cylinder, and the melt of the resin composition according to the embodiment of the present invention is injected into a mold for molding, using an injection molding machine. An injection molding machine that has been typically used can be used as the injection molding machine. A cylinder made of a material that has low adhesiveness to the resin composition according to the embodiment of the present invention and exhibits corrosion resistance and abrasion resistance is preferable as the cylinder. As the injection molding machine, for example, Micro-1 (manufactured by MEIHO CO., LTD.) can be exemplified.

The temperature of the cylinder in a case of performing injection molding is preferably in a range of 200° C. to 450° C. and more preferably in a range of 250° C. to 390° C. Further, the temperature of the mold is preferably in a range of 50° C. to 300° C. and more preferably 100° C. to 250° C.

[Applications of Cured Substance and Molded Body]

Since the cured substance and the molded body according to the embodiment of the present invention are cured substances exhibiting a low Abbe number (νD) or high partial dispersion ratios and also exhibit excellent light resistance, the cured substance and the molded body can be used for various applications and preferably used for optical members among the applications.

<Optical Member>

The type of optical member is not particularly limited, but any optical member that transmits light (so-called passive optical member) can be suitably used. Examples of optically-functional devices including such optical members include various types of display devices (a liquid crystal display, a plasma display, or the like), various types of projector devices (an overhead projector (OHP), a liquid crystal projector, and the like), optical fiber communication devices (an optical waveguide, a optical amplifier, and the like), image-capturing devices such as a camera and a video.

Examples of the passive optical members include lenses, prisms, prism sheets, panels (plate-like molded bodies), films, optical waveguides (such as film-like or fiber-like optical waveguides), optical discs, and sealants of light emitting diodes (LEDs). The passive optical member may be provided with an optional coating layer or an optional additional functional layer, as necessary. For example, the passive optical member may be provided with a protective layer for preventing mechanical damage to a coating surface caused by friction or abrasion, a light-absorbing layer for absorbing light having an undesirable wavelength which is a factor of deterioration of inorganic particles, base materials, and the like, a permeation blocking layer for suppressing or preventing permeation of reactive low molecules such as moisture or oxygen gas, an antiglare layer, an antireflection layer, a low-refractive index layer, or the like. Specific examples of the coating layer include a transparent conductive film or gas barrier film consisting of an inorganic oxide coating layer or inorganic nitride coating layer, and a gas barrier film or hard coating film consisting of an organic material coating layer. As a coating method for forming the coating layer, a known coating method such as a vacuum deposition method, a chemical vapor deposition (CVD) method, a sputtering method, a dip coating method, or a spin coating method can be used.

[Lens Base Material]

The optical member may be a lens base material. That is, the cured substance or the molded body according to the embodiment of the present invention may be used as a lens base material. In the present specification, “lens base material” denotes a single member capable of exhibiting a lens function. The lens base material produced by using the cured substance or the molded body according to the embodiment of the present invention has a small Abbe number and high partial dispersion ratios and exhibits excellent light resistance. It is preferable that the refractive index of the lens base material is optionally adjusted by appropriately adjusting the kind of monomer constituting the curable composition according to the embodiment of the present invention and monomer components constituting the polymer serving as the component A contained in the resin composition according to the embodiment of the present invention, and thus a lightweight lens base material having high refractivity and high partial dispersion ratios can be obtained.

A film or a member can be provided on a surface or in the periphery of the lens base material depending on the use environment and the applications of the lens. For example, a protective film, an antireflection film, a hard coating film, or the like can be formed on the surface of the lens base material. In addition, the lens base material produced by using the cured substance or the molded body according to the embodiment of the present invention can be formed into a compound lens laminated with one or more of other lens base materials (hereinafter, also referred to as “other lens base materials”) selected from a glass lens base material and a plastic lens base material.

Such a compound lens can be produced by, for example, photocuring the curable composition according to the embodiment of the present invention to form a semi-cured substance on the other lens base materials and heating the obtained semi-cured substance to form a cured substance. The description above can be preferably applied to the semi-curing step and the step of forming the cured substance. Since the curable composition according to the embodiment of the present invention has excellent photocuring sensitivity, a high-quality compound lens can be obtained. In the present invention, excellent photocuring sensitivity denotes that a gel-like or rubber-like semi-cured substance can be obtained from a liquid curable composition by a photocuring reaction.

Further, in a case where the resin composition according to the embodiment of the present invention is used, for example, a compound lens can be obtained by injecting a pelletized melt of the resin composition according to the embodiment of the present invention into a molding mold using an injection molding machine, covering the surface of the resin with a transparent glass lens such that the entire surface of the resin on a side where the resin is not in contact with the molding mold is covered, pressing and stretching the lens, cooling the lens, and separating the mold.

The periphery of the lens base material may be fitted to be fixed to a base material holding frame or the like. Here, such films, frames, or the like are members to be added to the lens base material, and therefore these members are distinguished from the lens base material itself in the present specification.

In a case where the lens base material is used for lenses, the lens base material may be used alone as a lens or the above-described films or frames and other lens base materials may be added thereto and used as a lens. The kind and the shape of the lens formed of the lens base material are not particularly limited, but the maximum thickness thereof is preferably in a range of 0.1 to 10 mm. The maximum thickness thereof is more preferably in a range of 0.1 to 5 mm and still more preferably in a range of 0.15 to 3 mm. Further, it is preferable that the lens base material has a circular shape with a maximum diameter in a range of 1 to 1000 mm. The maximum diameter thereof is more preferably in a range of 2 to 200 mm and still more preferably in a range of 2.5 to 100 mm.

It is preferable that the lens base material is used for lenses for imaging lenses such as mobile phones or digital cameras, shooting lenses such as TVs or video cameras, in-vehicle lenses, and endoscope lenses.

<Cemented Lens>

A cemented lens can be produced by adhering the lens base material or the lens produced by using the composition according to the embodiment of the present invention to another lens with an adhesive for a lens.

[Other Lenses]

The kind of other lenses is not particularly limited, and examples thereof include a disk-shaped convex lens, a concave lens, a meniscus lens, an aspheric lens, a cylindrical lens having a cylindrical lens surface, a ball lens, and a rod lens. In addition, the material of other lenses is not particularly limited, and a glass lens, a resin lens, or a compound lens may be used.

(Glass lens)

As a glass lens, known glass lenses can be used without limitation. Examples of commercially available glass lenses include BK7 (trade name, manufactured by OHARA INC.).

Similar glass lenses can also be used even in a case where a compound lens includes a glass lens.

(Resin Lens and Compound Lens)

A resin lens denotes a lens consisting of a resin cured substance.

In the present specification, the compound lens denotes a lens having a layer consisting of glass and a resin layer. The resin layer is a layer consisting of a resin cured substance. Each layer of the compound lens may be a lens (single lens), and in this case, it is preferable that optical axes of each single lens (a line connecting curvature centers of both spherical surfaces) coincide with each other. The compound lens may have a resin layer on a surface thereof or therein.

[Adhesive for Lens]

As an adhesive for a lens, known lenses which have been used can be used without limitation.

As the adhesive for a lens, it is particularly preferable to use an adhesive for a lens which contains a compound represented by General Formula (1). The adhesive for a lens which contains a compound represented by General Formula (1) absorbs ultraviolet rays, but is still excellent in fastness with respect to ultraviolet irradiation, and thus a cured substance with high light stability can be obtained as a cemented lens by using the adhesive for a lens. Further, an adhesive layer formed of the adhesive for a lens which contains a compound represented by General Formula 1 has high heat shock resistance.

(Compound represented by General Formula (1))

In General formula (1), Ar²¹ represents an aromatic ring group represented by any of General Formulae (21-1) to (21-4).

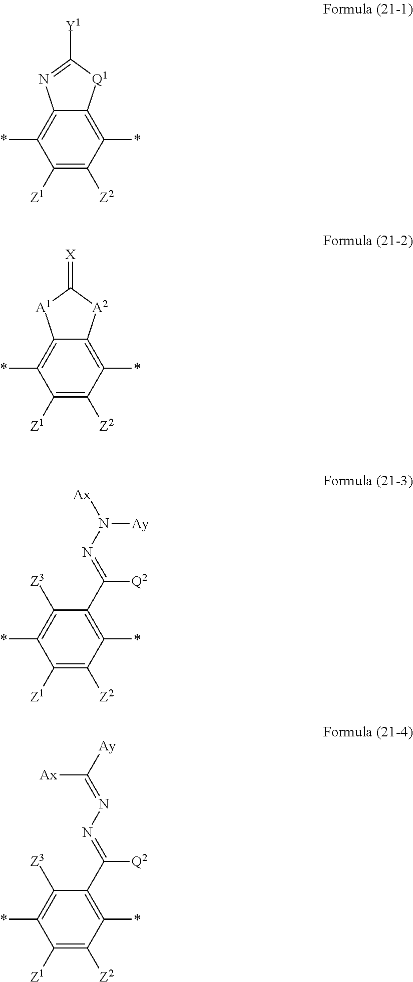

In the above formulae, Q¹ represents —S—, —O—, or NR¹¹—, and R¹¹ represents a hydrogen atom or an alkyl group having 1 to 6 carbon atoms.

Y¹ represents an alkyl group having 1 to 6 carbon atoms, an aromatic hydrocarbon group having 6 to 12 carbon atoms, or an aromatic heterocyclic group having 3 to 12 carbon atoms.

Z¹, Z², and Z³ represent a hydrogen atom, an aliphatic hydrocarbon group having 1 to 20 carbon atoms, an alkoxy group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, —NR¹²R¹³, or —SR¹², Z¹ and Z² may be bonded to each other to form an aromatic hydrocarbon ring or an aromatic heterocyclic ring, and R¹² to R¹³ each independently represent a hydrogen atom or an alkyl group having 1 to 6 carbon atoms.

A¹ and A² each independently represent a group selected from the group consisting of —O—, —NR²¹— (R²¹ represents a hydrogen atom or a substituent), —S—, and —C(═O)—, X represents an oxygen atom (O), a sulfur atom (S), a carbon atom (C) to which a hydrogen atom or a substituent is bonded, or a nitrogen atom (N) to which a hydrogen atom or a substituent is bonded.

Ax represents an organic group having 1 to 30 carbon atoms which has at least one aromatic ring selected from the group consisting of an aromatic hydrocarbon ring and an aromatic heterocyclic ring, Ay represents a hydrogen atom, an alkyl group having 1 to 6 carbon atoms, or an organic group having 1 to 30 carbon atoms which has at least one aromatic ring selected from the group consisting of an aromatic hydrocarbon ring and an aromatic heterocyclic ring, the aromatic ring of Ax and Ay may have a substituent, and Ax and Ay may be bonded to each other to form a ring.

Q² represents a hydrogen atom or an alkyl group having 1 to 6 carbon atoms.

Further, * represents a bonding position with respect to L¹ or L².

With regard to the definition and the preferred range of each substituent in General Formulae (21-1) to (21-4), the description of Y¹, Q¹, and Q² for the compound (A) described in JP2012-21068A can be applied to Y¹, Z¹, and Z², the description of A₁, A₂, and X for the compound represented by General Formula (I) described in JP2008-107767A can be applied to A¹, A², and X, the description of A^{a}, A^{b}, and Q¹ for the compound represented by General Formula (I) described in WO2013/018526A can be applied to Ax, Ay, and Q² in General Formula (21-3), and the description of A^{a}, A^{b}, and Q¹ for the compound represented by General Formula (II) described in WO2013/018526A can be applied to Ax, Ay, and Q² in General Formula (21-4). The description regarding Q¹ in the compound (A) described in JP2012-21068A can be adopted as they are to Z².

It is preferable that X in General Formula (21-2) represents a carbon atom to which two substituents are bonded and that both A¹ and A² represent —S—. In General Formula (21-3), as the ring formed by Ax and Ay being bonded to each other, an alicyclic hydrocarbon ring, an aromatic hydrocarbon ring, or an aromatic heterocyclic ring is preferable, and an aromatic heterocyclic ring is more preferable. In General Formula (21-4), as the ring formed by Ax and Ay being bonded to each other, an unsaturated hydrocarbon ring is preferable.

It is preferable that Ar²¹ in General Formula (1) represents an aromatic ring group represented by General Formula (21-2).

As the aromatic ring group represented by General Formula (21-2), an aromatic ring group represented by General Formula (21-2-1) is preferable.

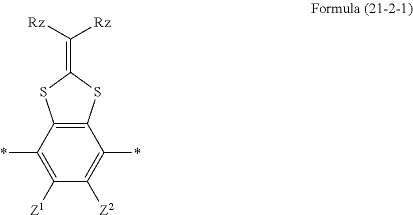

In the formula, Rz represents a substituent, and Z¹ and Z² respectively have the same definition as that for Z¹ and Z² in General Formula (21-2).

Examples of the substituent represented by Rz include substituents that the linear alkylene group as Sp^{e} and Sp^{f} described below may have, and preferred examples thereof include an alkyl group, an alkoxy group, an alkoxycarbonyl group, a halogen atom, and a cyano group. Two Rz's may be the same as or different from each other.

In addition, the two Rz's may be bonded to each other to form a ring. As the ring formed here, a 5-membered ring or a 6-membered ring is preferable, and a 5-membered ring or a 6-membered ring having a nitrogen atom or an oxygen atom as an atom constituting the ring is more preferable. It is still more preferable that the ring formed by two Rz's being bonded to each other is a ring represented by any of the following structures.

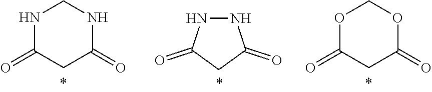

In the formulae, each * represents a position of the carbon atom to which the two Rz's are bonded in General Formula (21-2-1). In addition, the ring represented by any of the formulae may have a substituent in a nitrogen atom or a carbon atom. As the substituent in this case, an alkyl group having 1 to 6 carbon atoms is preferable, and a linear alkyl group having 1 to 4 carbon atoms is more preferable.

As the aromatic ring group represented by General Formula (21-2-1), an aromatic ring group in which at least one of Rz's represents a cyano group or an aromatic ring group in which two Rz's are bonded to each other to form a ring is preferable, and an aromatic ring group in which both Rz's represent a cyano group is more preferable.

This is because, in the adhesive for a lens which contains a compound represented by General Formula (1), having such an aromatic ring group, a more significant effect of increasing absorption in an ultraviolet region while maintaining a high transmittance in a visible light region can be obtained.

In General Formula (1), L¹ and L² each have the same definition as that for L in General Formula (A0), and the preferable ranges are the same as described above.

In General Formula (1), Sp^{e} and Sp^{f} each have the same definition as that for Sp in General Formula (A0), and the preferable ranges are the same as described above.

In General Formula (1), Pol¹ and Pol² each have the same definition as that for Pol in General Formula (A0), and the preferable ranges are the same as described above.

Examples of specific structures of Pol¹-Sp^{e}-L¹- or Pol²-Sp^{f}-L²- include those exemplified as the structure of Pol-Sp-L- in General Formula (A0).

Hereinafter, specific examples of the compound represented by General Formula (1) which is preferably used in the adhesive for a lens are shown below, but examples are not limited to the following compounds. In the following structural formulae, Me represents a methyl group, Et represents an ethyl group, nPr represents an n-propyl group, iPr represents an isopropyl group, nBu represents an n-butyl group, and tBu represents a t-butyl group. Further, the compounds used in the examples described below are also preferably used.

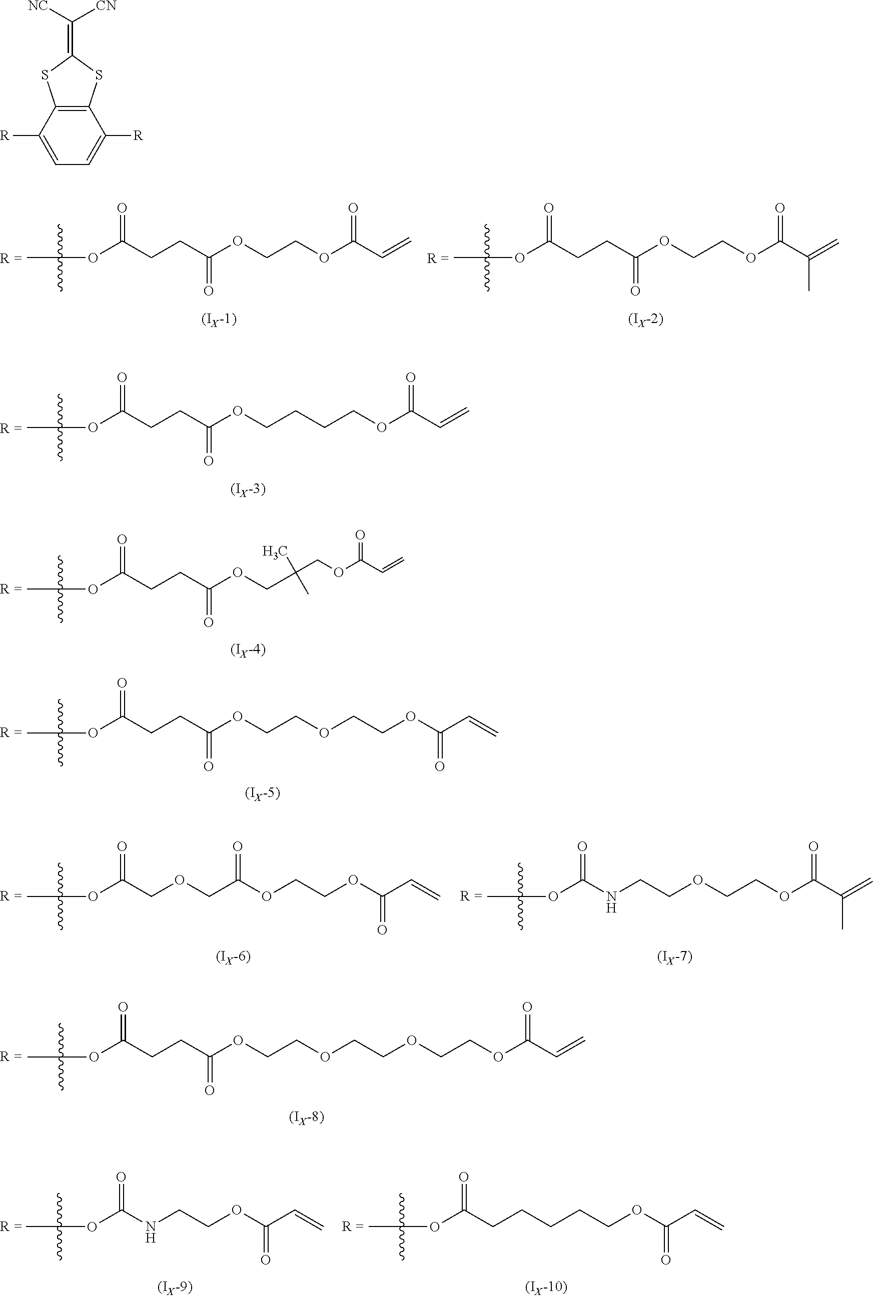

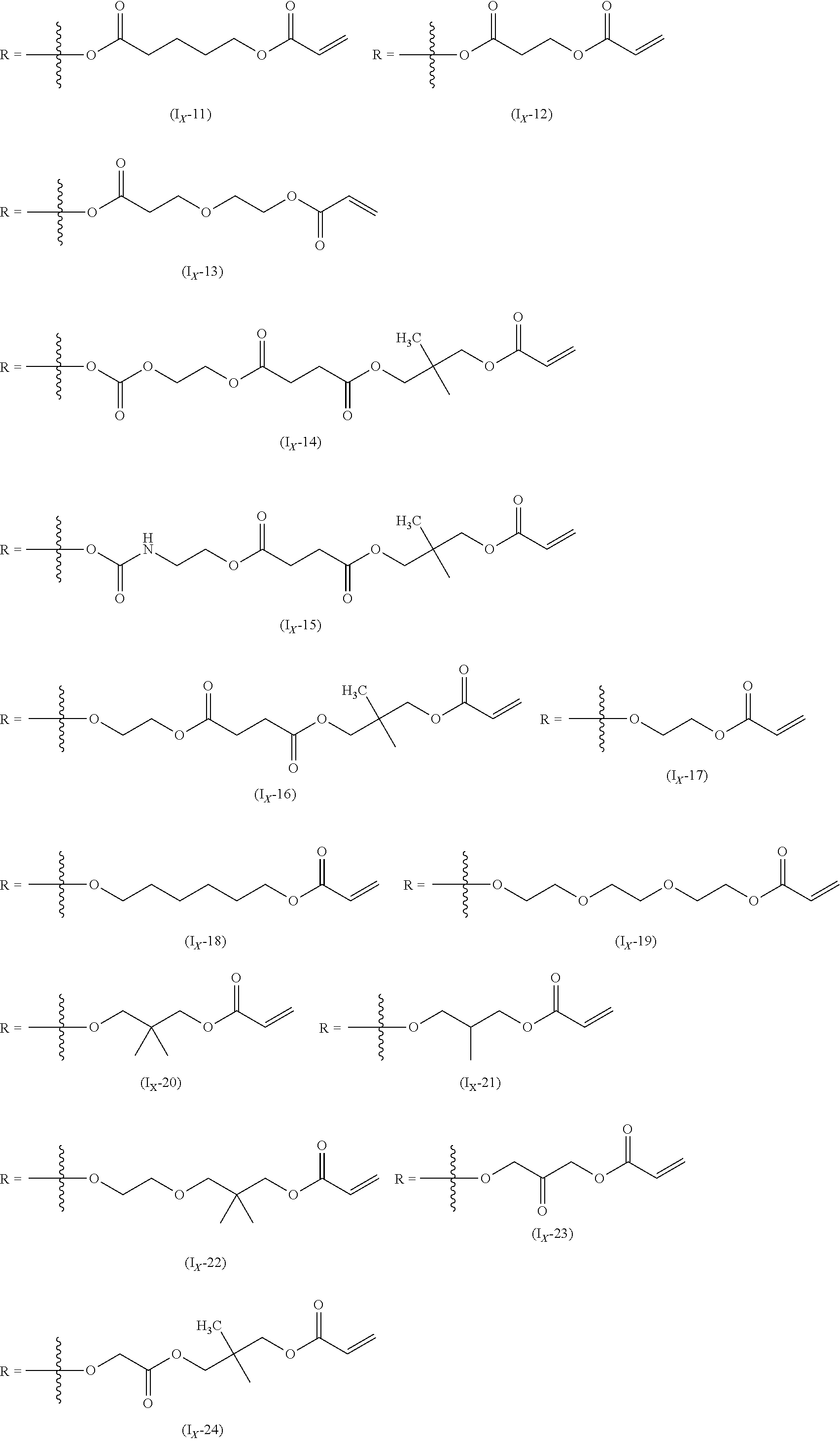

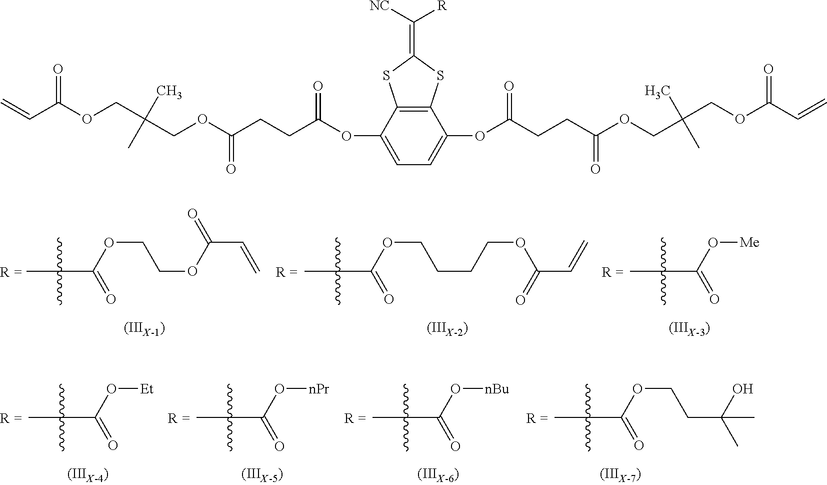

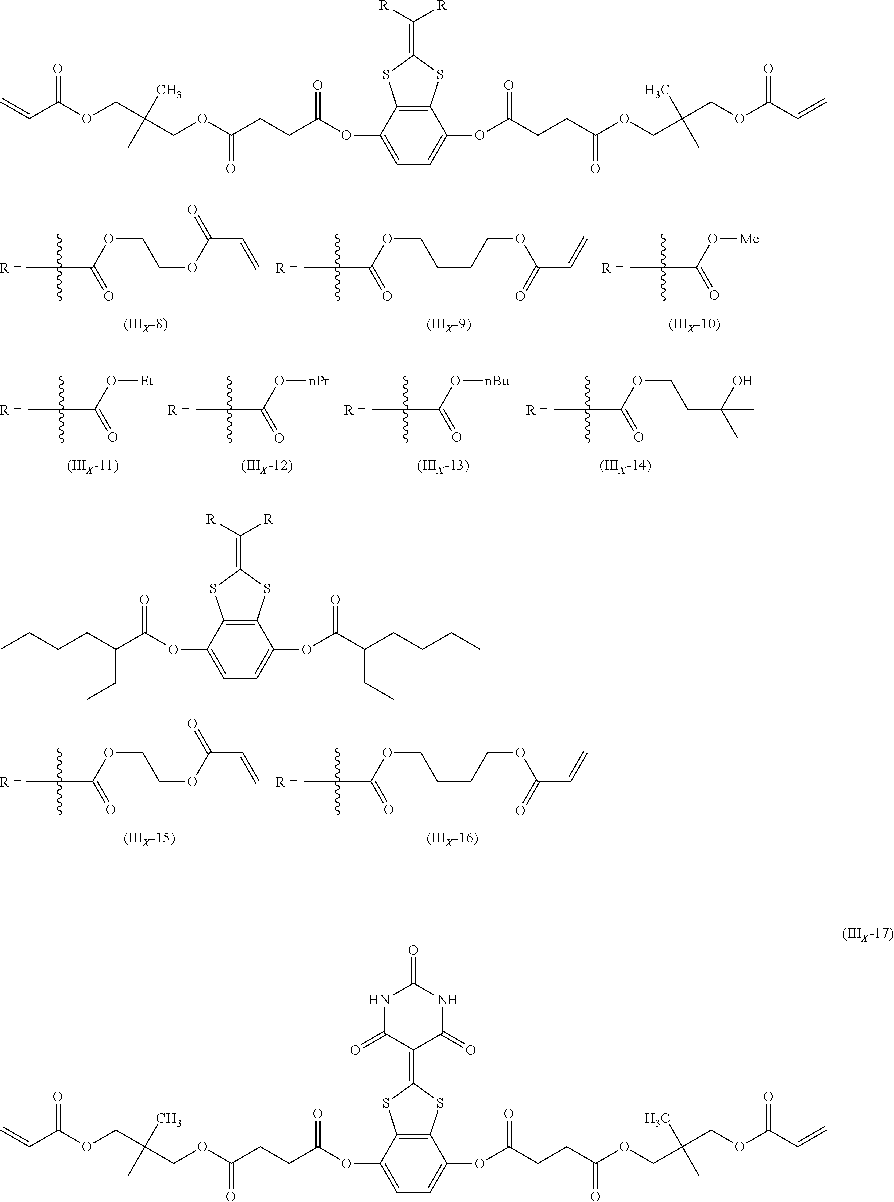

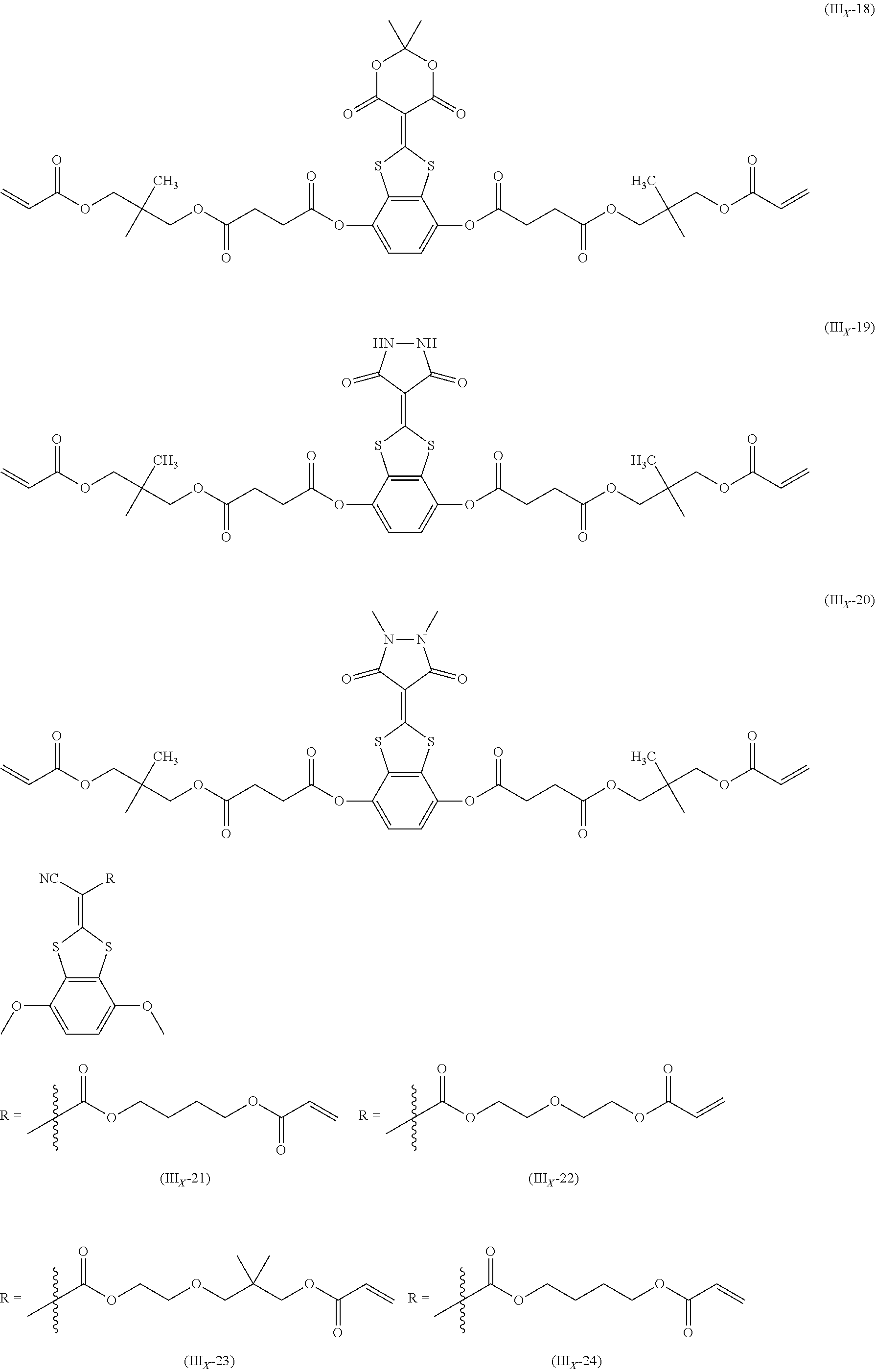

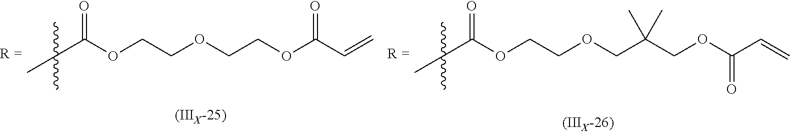 [SMILES: *C(=O)OCCOCCOC(=O)C=C ; *C(=O)OCCOCC(C)(C)COC(=O)C=C]

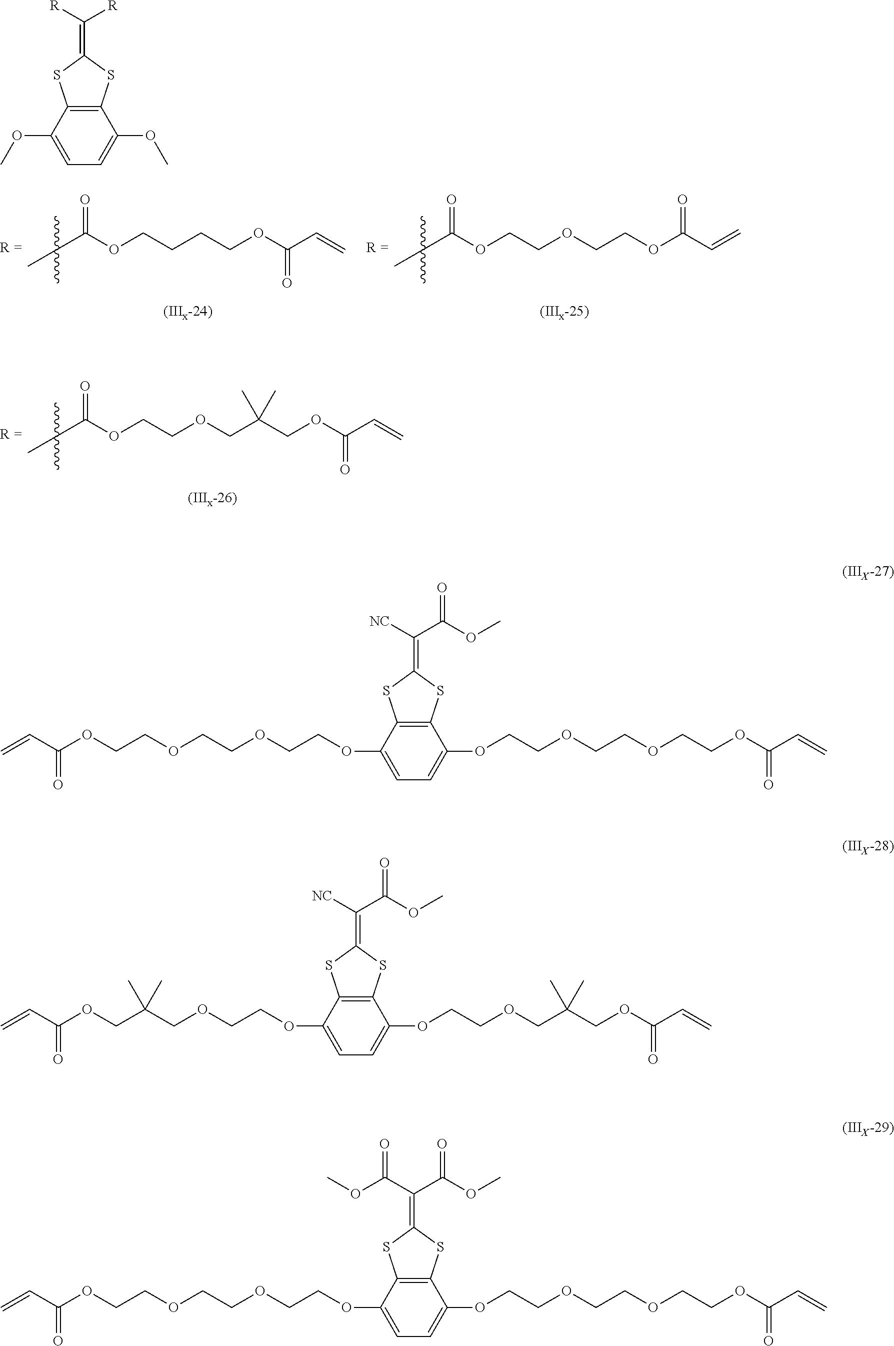

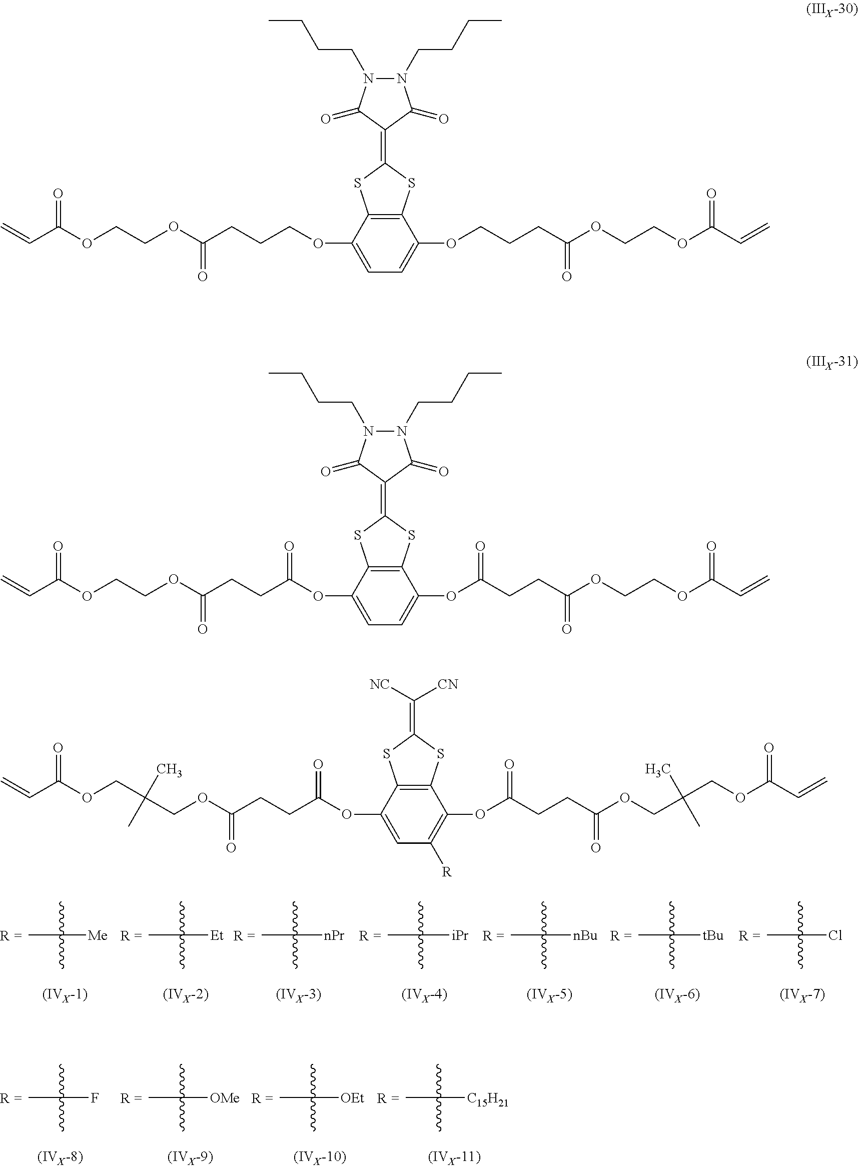

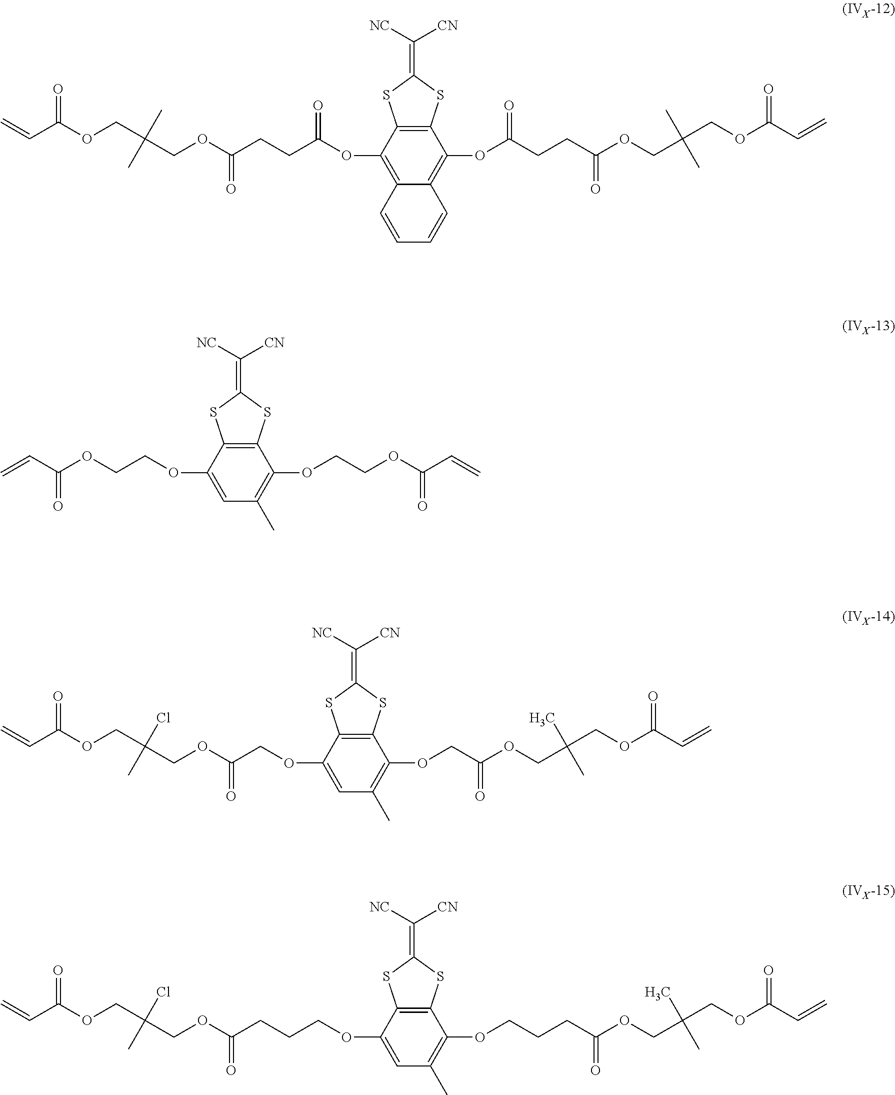

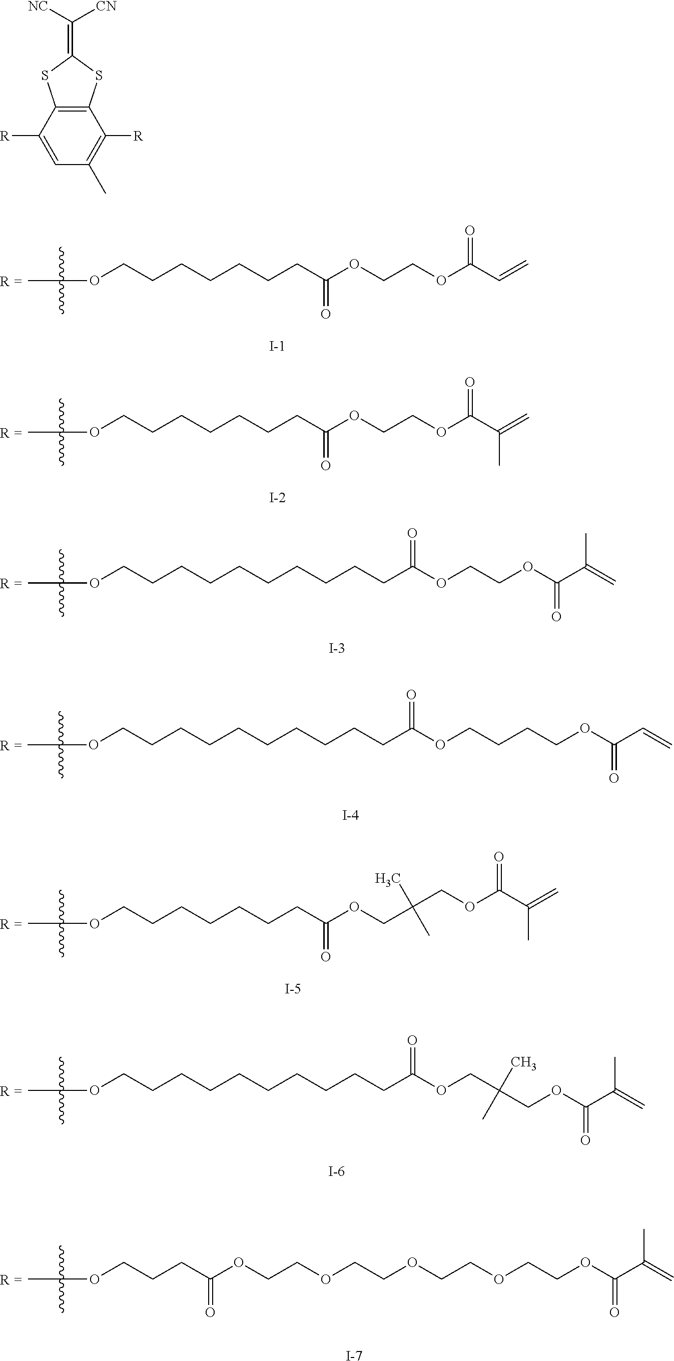

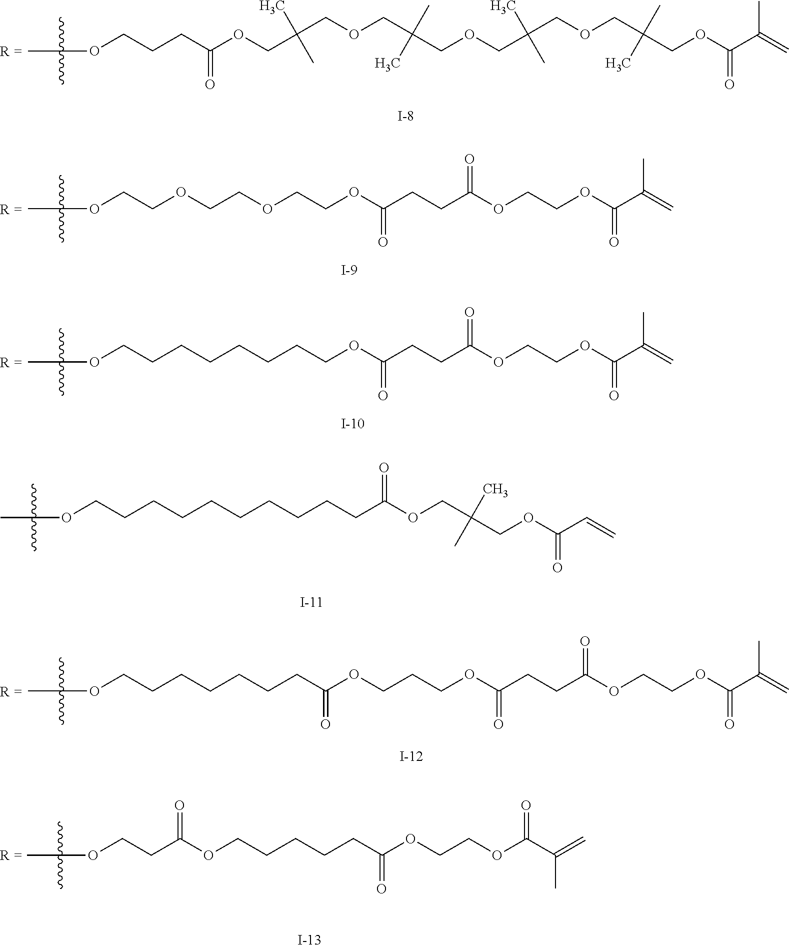

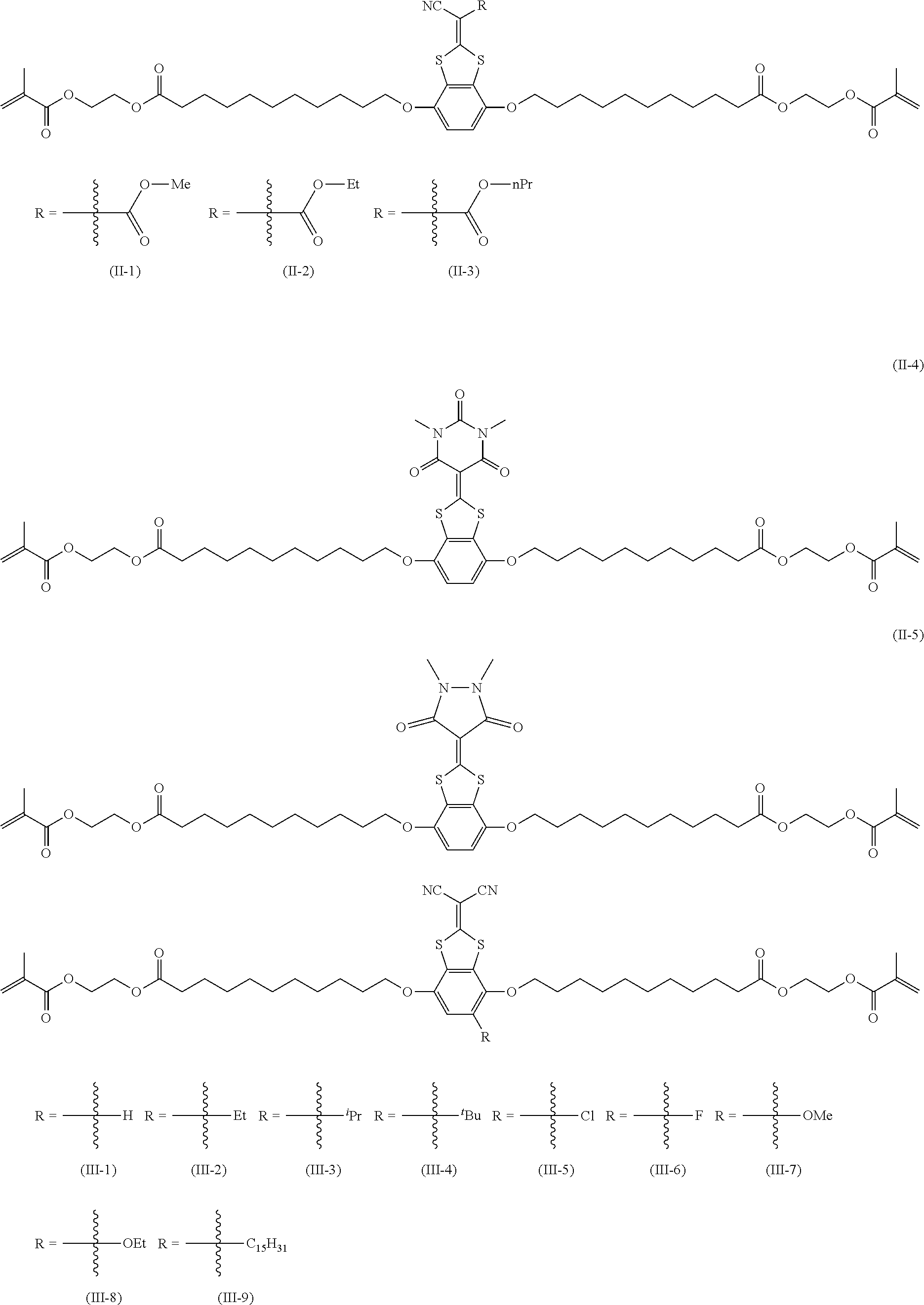

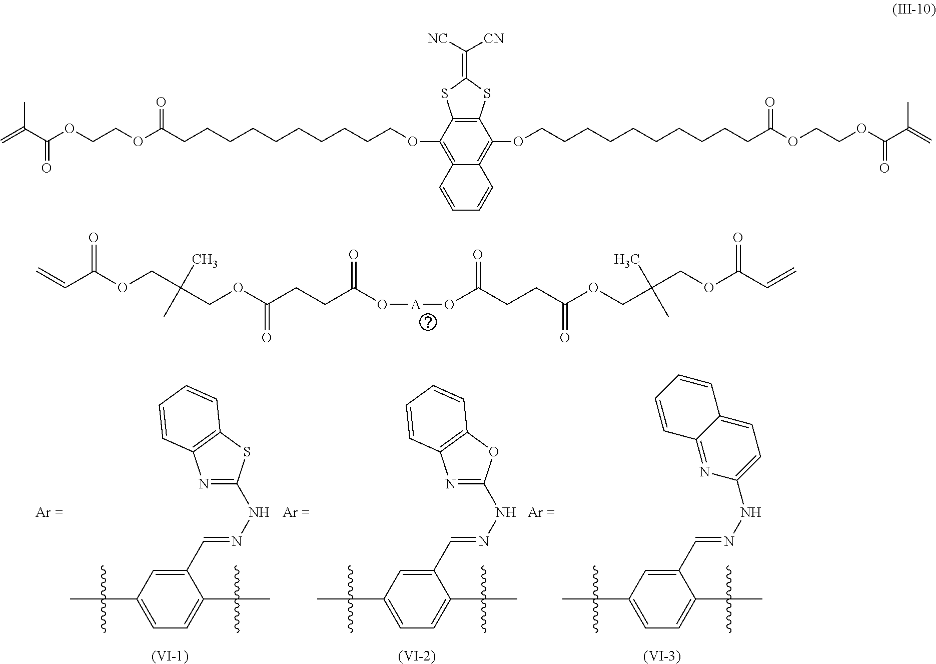

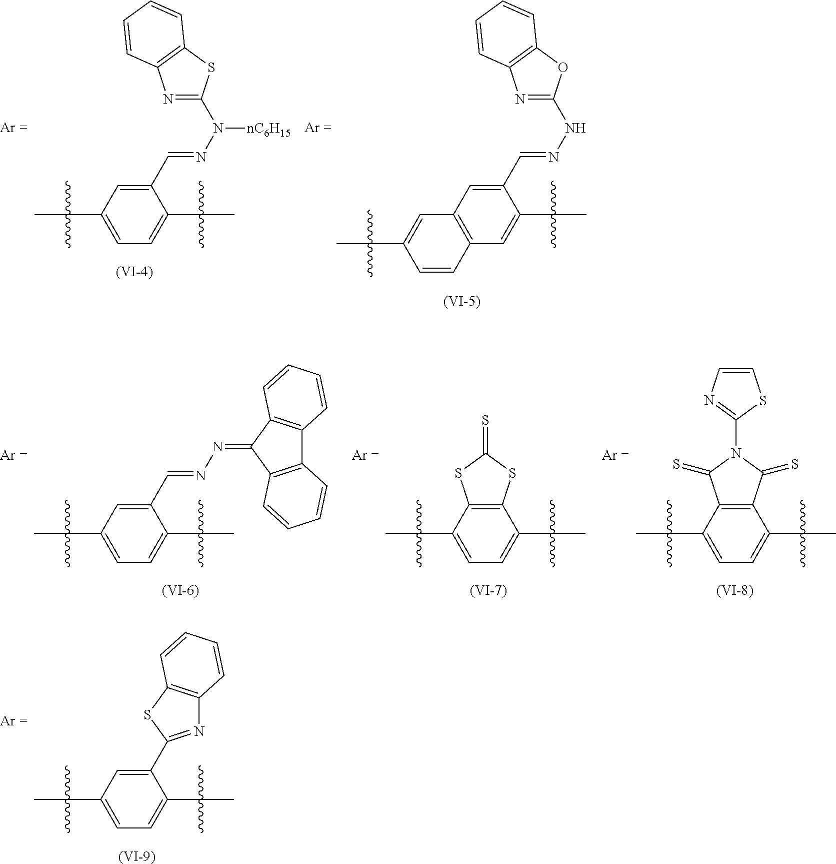

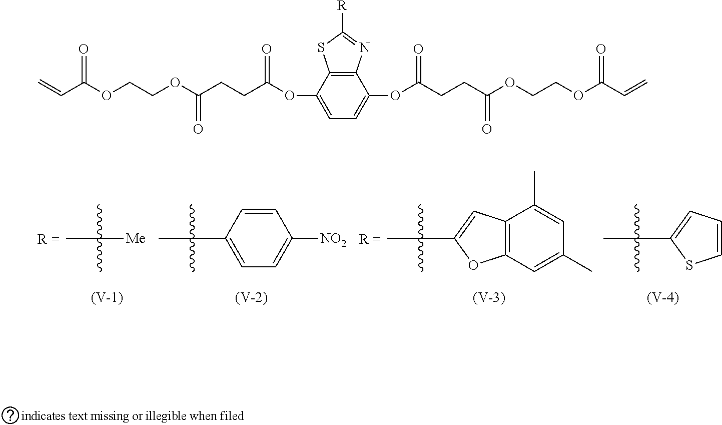

The content of the compound represented by General Formula (1) in the adhesive for a lens is preferably in a range of 10% to 90% by mass, more preferably in a range of 15% to 85% by mass, and still more preferably in a range of 20% to 80% by mass with respect to a total mass of the adhesive for a lens. The viscosity thereof can be set to be in the preferable range by setting the content thereof to 90% by mass or less.

The adhesive for a lens may contain two or more compounds represented by General Formula (1). In a case where the adhesive for a lens contains two or more compounds represented by General Formula (1), it is preferable that the total content thereof is in the above-described range.

(Polymer)

The adhesive for a lens may contain a polymer or an oligomer (hereinafter, also referred to as “polymer”) for the purpose of adjusting the viscosity or the Young's modulus of the cured substance. The polymer is not particularly limited, but a polymer containing an ethylenically unsaturated group is preferable. The ethylenically unsaturated group may be contained in any of the inside of a main chain, a terminal of the main chain, or a side chain of the polymer. The ethylenically unsaturated group is not particularly limited, but an ethylenically unsaturated bond derived from butadiene or isoprene, or a (meth)acryloyl group is preferable.

As the polymer contained in the adhesive for a lens, a conjugated diene-based polymer and a polymer selected from the group consisting of a polyurethane resin containing an ethylenically unsaturated group are preferable, and a polymer having a polybutadiene structure, a polymer having a polyisoprene structure, and a polymer selected from the group consisting of urethane (meth)acrylate are more preferable.

Examples of commercially available products of the polymer having a polybutadiene structure include NIPOL BR Series (manufactured by Zeon Corporation), UBEPOL BR Series (manufactured by Ube Corporation), NISSO-PB Series (manufactured by Nippon Soda Co., Ltd.), and KURARAY LIQUID RUBBER LBR Series and KURARAY LIQUID RUBBER L-SBR Series (manufactured by Kuraray Co., Ltd.).

Examples of commercially available products of the polymer having a polyisoprene structure include NIPOL IR Series (manufactured by Zeon Corporation), and KURARAY LIQUID RUBBER LIR Series and KURARAY LIQUID RUBBER UC Series (manufactured by Kuraray Co., Ltd.).

Examples of commercially available products of the urethane (meth)acrylate include UV-3200, UV-3000B, UV-3700B, UV-3210EA, UV-2000B, and UV-3630 of SHIKOH (registered trademark) Series (all manufactured by Nippon Synthetic Chemical Industry Co., Ltd.), EBECRYL 230 and EBECRYL 9227EA (manufactured by DAICEL-ALLNEX LTD.), and AU-3040, AU-3050, AU-3090, AU-3110, and AU-3120 of Hi-Cope AU (registered trademark) Series (all manufactured by TOKUSHIKI CO., Ltd.).

Preferred examples of the polymer that may be contained in the adhesive for a lens include a polymer (hereinafter, also simply referred to as “polymer B”) which has a structural unit (b1) having an aromatic ring and a structural unit (b2) containing a hydrogen-bonding group and in which the proportion of the structural unit (b1) in all structural units constituting the polymer is 10% by mass or greater and the proportion of the structural unit (b2) in all structural units constituting the polymer is 3% by mass or greater.

In the present invention, among the structural units contained in the polymer B, the structural unit containing a hydrogen-bonding group is constantly classified into the structural unit (b2). That is, the above-described structural unit (b1) does not have a hydrogen bonding group, and a structural unit having both an aromatic ring and a hydrogen bonding group is classified into the above-described structural unit (b2).

The kind of the polymer B is not particularly limited as long as the polymer contains the structural unit (b1) having an aromatic ring and the structural unit (b2) having a hydrogen-bonding group, and examples thereof include a vinyl polymer such as an acrylic polymer, formed by chain polymerization of one or two or more kinds of monomers having a carbon-carbon double bond, an addition polymer such as polyurethane, a condensation polymer such as polyester or polycarbonate, and a ring-opening metathesis polymer formed of a cyclic olefin monomer. Among these, from the viewpoint of further improving the adhesiveness and the moist heat durability, a vinyl polymer is preferable.

(b1) Structural Unit Having Aromatic Ring

The polymer B has the structural unit (b1) having an aromatic ring.

Examples of the aromatic ring of the structural unit (b1) include an aromatic hydrocarbon ring such as a benzene ring, a naphthalene ring, an anthracene ring, or a phenanthrene ring, and an aromatic heterocyclic ring such as a furan ring, a pyrrole ring, a thiophene ring, a pyridine ring, a thiazole ring, a benzothiazole ring, or a phenanthroline ring.

As the aromatic ring of the structural unit (b1), a benzene ring, a naphthalene ring, or a pyridine ring is preferable, and a benzene ring is more preferable from the viewpoint of further improving the adhesiveness.

It is preferable that the polymer B has a structural unit represented by General Formula (p1) as the structural unit (b1).

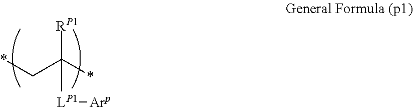

In the formula, R^{P1} represents a hydrogen atom or a methyl group, L^{P1} represents a single bond or a divalent linking group, and Ar^{P} represents an aromatic hydrocarbon group which may have a substituent or an aromatic heterocyclic group which may have a substituent.

Here, the structural unit represented by General Formula (p1) does not contain a hydrogen-bonding group. That is, L^{P1} does not contain a hydrogen-bonding group, and Ar^{P} does not contain a hydrogen-bonding group.

Further, * represents the bonding site for incorporation into the polymer.

In the group represented by -L^{P1}-Ar^{P}, the aromatic hydrocarbon ring or the aromatic heterocyclic ring positioned on the most terminal side from the carbon atom to which R^{P1} is bonded, among the longest bonding chains, is interpreted to be represented by Ar^{P} and the remaining portion is interpreted to be represented by L^{P1}.

That is, with regard to Ar^{P}, as an aromatic hydrocarbon ring in the aromatic hydrocarbon group which may have a substituent and an aromatic heterocyclic ring in the aromatic heterocyclic group which may have a substituent, the description of the aromatic hydrocarbon ring and the aromatic heterocyclic ring as the aromatic ring included in the above-described structural unit (b1) can be adopted.

Examples of the substituent that the aromatic hydrocarbon ring group and the aromatic heterocyclic group as Ar^{P} may have include an alkyl group, an alkoxy group, an alkoxysilyl group, and an acyloxy group.

L^{P1} represents a single bond or a divalent linking group.

Examples of the divalent linking group which can be employed by L^{P1} include an alkylene group, a divalent aromatic hydrocarbon group (such as a 1,4-phenylene group, hereinafter, also referred to as “arylene group”), a divalent aromatic heterocyclic group (hereinafter, referred to as “heteroarylene group”), a group selected from —O—, >C(═O), and >NR^{b}, and a linking group consisting of a combination of two or more of these groups.

R^{b} represents an alkyl group, a monovalent aliphatic heterocyclic group, a monovalent aromatic heterocyclic group, or a monovalent aromatic hydrocarbon ring group.

Examples of the linking group consisting of a combination of two or more of the groups selected from —O—, >C(═O), and >NR^{b} include —OC(═O)—, —C(═O)O—, —OC(═O)O—, —NR^{b}C(═O)—, —C(═O)NR^{b}—, —OC(═O)NR^{b}—, and —NR^{b}C(═O)O—. Among these, —OC(═O)—, —C(═O)O—, —NR^{b}C(═O)—, or —C(═O)NR^{b}— is preferable. In the description of the linking group, the left side is bonded to the carbon atom to which R^{P1} is bonded and the right side is bonded to Ar^{P}. The same applies hereinafter. For example, in a case where the linking group —OC(═O)— is described as an example, the left side means an ether bond side and the right side means a carbonyl bond side.

Further, preferred examples include a group consisting of a combination of an alkylene group, at least one of group selected from an arylene group or a heteroarylene group and at least one of a group selected from —O—, >C(═O), and >NR^{b} or a linking group consisting of a combination of two or more of these groups. Examples thereof include a —C(═O)O-alkylene group. Further, preferred examples thereof include a group formed by combining an alkylene group in a —C(═O)O-alkylene group with —O—, arylene group-O—, a —O-arylene group, heteroarylene group-O—, or a —O-heteroarylene group.

L^{P1} represents preferably a single bond, a —C(═O)O-alkylene group, an alkylene group in a —C(═O)O-alkylene group, or a group formed by combining —O—, arylene group-O—, a —O-arylene group, heteroarylene group-O—, or a —O-heteroarylene group, more preferably a —C(═O)O-alkylene group, an alkylene group in a —C(═O)O-alkylene group, or a group formed by combining —O—, arylene group-O—, or a —O-arylene group, and still more preferably a —C(═O)O-alkylene group or —C(═O)O-alkylene-O—.

Examples of the structural unit represented by General Formula (p1) include the following structural units. However, the examples are not limited to the following structural units.

In the following chemical structural formulae, Me represents a methyl group, and t-Bu represents a tert-butyl group.

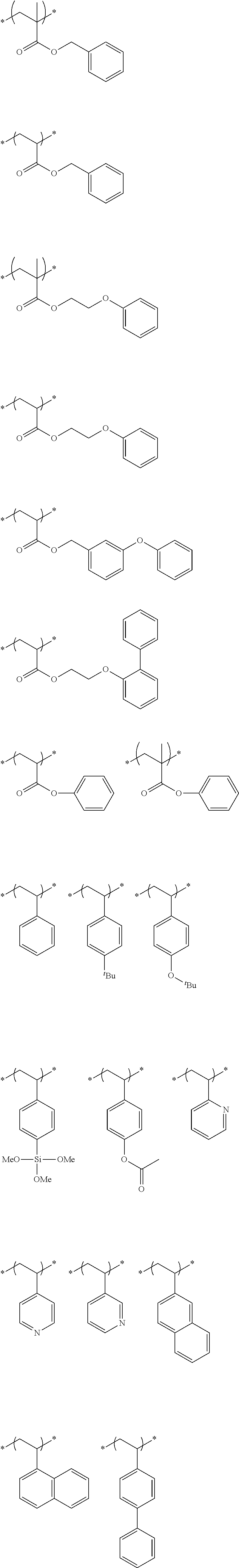

The proportion of the structural unit (b1) having an aromatic ring in all structural units constituting the polymer B is preferably in a range of 10% to 97% by mass, more preferably in a range of 20% to 96% by mass, and particularly preferably in a range of 30% to 95% by mass from the viewpoint of further improving the transmittance.

In a case where the polymer B has a structural unit other than the structural units (b1) and (b2) (other structural units), a proportion of the structural unit (b1) having an aromatic ring in all structural units constituting the polymer B is preferably 10% to 80% by mass, more preferably 20% to 80% by mass, and still more preferably 30% to 75% by mass.

The proportion of the structural unit (b1) having an aromatic ring and the proportion of the structural unit (b2) having a hydrogen-bonding group in all structural units constituting the polymer B can be determined by determining a component corresponding to the structural unit (b1) having an aromatic ring in the monomer components used to obtain the polymer and determining a component corresponding to the structural unit (b2) containing a hydrogen-bonding group in the remaining monomer components, based on the mass ratio between these components. For example, in a case of polyurethane synthesized by addition polymerization of a bifunctional isocyanato compound (A1) having an aromatic ring and a diol compound (B1), the proportion of the isocyanato compound (A1) in the monomer components corresponds to the proportion of the structural unit (b1), and the proportion of the diol compound (B1) in the monomer components corresponds to the proportion of the structural unit (b2). Further, in a case of a polymer obtained with an elimination reaction during synthesis, for example, in a case of a polyamide obtained by condensation polymerization of a bifunctional acid chloride compound (A2) having an aromatic ring and a compound (B2) containing two primary amino groups, a structural unit in which two chlorine atoms are eliminated from the acid chloride compound (A2) corresponds to the structural unit (b1) and a structural unit in which two hydrogen atoms (that is, one hydrogen atom from each of the two primary amino groups) are eliminated from the compound (B2) corresponds to the structural unit (b2). Therefore, the content ratios of the structural units (b1) and (b2) can be determined based on the mass ratios of the compounds (A2) and (B2).

(b2) Structural Unit Having Hydrogen Bonding Group

The polymer B has a structural unit (b2) having a hydrogen-bonding group.

The hydrogen-bonding group of the structural unit (b2) denotes a group having a hydrogen atom capable of forming a hydrogen bond, and examples thereof include a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group.

Among these, the hydroxy group, the carboxy group, the sulfo group (sulfonic acid group, —S(═O)₂(OH)), the phosphoric acid group (—OP(═O)(OH)₂), the phosphonic acid group (—P(═O)(OH)₂), and the sulfanyl group are monovalent groups.

Among these, the amino group, the amide group, and the sulfonamide group are monovalent groups or divalent groups having a hydrogen-bonding hydrogen atom. The monovalent groups denote an amino group (—NH₂), an amide group (—CONH₂), and a sulfonamide group (—SO₂NH₂), and the divalent groups having a hydrogen-bonding hydrogen atom denote an amino group (>NH), an amide group (—CONH—), and a sulfonamide group (—SO₂NH—).

Among these, the urethane group (—NHC(═O)O—), the urea group (—NR^{a}C(═O)NH—), the thiourethane group (—NHC(═O)S— or —NHC(═S)O—), and the thiourea group (—NR^{a}C(═S)NH—) are divalent groups having a hydrogen-bonding hydrogen atom.

R^{a} represents a hydrogen atom, an alkyl group, a monovalent aliphatic heterocyclic group, a monovalent aromatic heterocyclic group, or a monovalent aromatic hydrocarbon ring group and preferably a hydrogen atom.

As the hydrogen-bonding group of the structural unit (b2), at least one of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group is preferable, and at least one of a hydroxy group, an amide group, a urethane group, or a urea group is more preferable from the viewpoint of further improving the adhesiveness.

The number of the hydrogen-bonding groups contained in one structural unit may be one or two or more, and in a case where one structural unit contains two or more hydrogen-bonding groups, the two or more hydrogen-bonding groups may be partially or entirely the same as each other or different from each other.

It is preferable that the polymer B has a structural unit represented by General Formula (p2) as the structural unit (b2).

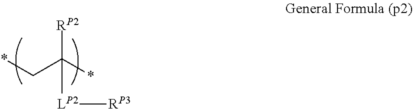

In the formula, R¹² represents a hydrogen atom or a methyl group, L^{P2} represents a single bond or a divalent linking group, and R^{P3} represents a monovalent substituent. Here, at least one of L^{P2} or R^{P3} includes at least one of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group.

Further, * represents the bonding site for incorporation into the polymer.

The description of the hydroxy group, the carboxy group, the sulfo group, the phosphoric acid group, the phosphonic acid group, the amino group, the sulfanyl group, the amide group, the urethane group, the urea group, the thiourethane group, the thiourea group, and the sulfonamide group serving as the hydrogen-bonding group of the structural unit (b2) can be applied to the hydroxy group, the carboxy group, the sulfo group, the phosphoric acid group, the phosphonic acid group, the amino group, the sulfanyl group, the amide group, the urethane group, the urea group, the thiourethane group, the thiourea group, and the sulfonamide group, included in at least one of L^{P2} or R^{P3}.

Further, the group represented by -L^{P2}-R^{P3} is interpreted based on the following rules (i) to (iii). The rule (i) is given the highest priority, the rule (ii) is subsequently applied, and the rule (iii) is finally applied.
(i) In the group represented by -L^{P2}-R^{P3}, in a case where a structure positioned at the most terminal of the longest bonding chain counted from a carbon atom to which R^{P2} is bonded (hereinafter, also referred to as “most terminal structure”) corresponds to a monovalent group in the above-described hydrogen bonding group, R^{P3} is interpreted as the monovalent group in the above-described hydrogen bonding group and the remainder is interpreted as L^{P2}.
(ii) In a case of not corresponding to (i) described above and in a case where an atom constituting the longest bonding chain, which is positioned on a side of the above-described most terminal structure, is a ring-constituting atom, R^{P3} is interpreted as a monovalent ring group consisting of a ring structure including the ring-constituting atom and the remainder is interpreted as L^{P2}.
(iii) In a case that does not correspond to the rule (i) or the rule (ii), the atom constituting the longest bonding chain from the most terminal structure side is counted to be included in the carbon atoms to which R^{P2} is bonded. L^{P2} and R^{P3} are interpreted by defining a site where the atom constituting the bonding chain is an oxygen atom, a sulfur atom, a nitrogen atom, or a carbon atom constituting >C(═O) or >C(═S) for the first time as the atom bonded to R^{P3} among the atoms constituting L^{P2}.

L^{P2} represents a single bond or a divalent linking group.

Examples of the divalent linking group which can be employed by L^{P2} include an alkylene group, an arylene group, a group selected from —O—, —S—, >C(═O), >C(═S), and >NR^{a}, and a linking group consisting of a combination of two or more of these groups.

The description of R^{a} in the section of the hydrogen-bonding group included in the structural unit (b2) can be applied to R^{a}.

The alkylene group and arylene group which can form L^{P2} may have a substituent. Examples of the substituent which may be included in the alkylene group and arylene group which can form L^{P2} include an alkyl group, a cycloalkyl group, an alkoxy group, an acyl group, an acyloxy group, an alkoxycarbonyl group, a hydroxy group, a carboxy group, a sulfo group, a phosphoric acid group, a phosphonic acid group, an amino group (—N(R^{X})₂), a sulfanyl group, an amide group (—CON(R^{X})₂ or —NR^{X}COR^{Z}), and a sulfonamide group (—SO₂N(R^{X})₂ or —NR^{X}SO₂R^{Z}), and a hydroxy group is preferable. R^{X} is a hydrogen atom, an alkyl group, a monovalent aliphatic or aromatic heterocyclic group, or a monovalent aromatic hydrocarbon ring group, and a hydrogen atom is preferable. R^{Z} is a hydroxy group, an alkyl group, a monovalent aliphatic or aromatic heterocyclic group, or a monovalent aromatic hydrocarbon ring group, and a hydroxy group is preferable.

The number of substituents is not particularly limited, and for example, one to four substituents may be included in Sp.

Examples of the linking group consisting of a combination of two or more of groups selected from —O—, —S—, >C(═O), >C(═S), and >NR^{a} include —OC(═O)—, —C(═O)O—, —OC(═O)O—, —NR^{a}C(═O)—, —C(═O)NR^{a}—, —OC(═O)NR^{a}—, —NR^{a}C(═O)O—, —SC(═O)—, —C(═O)S—, —OC(═S)O—, —SC(═O)O—, —OC(═O)S—, —NR^{a}C(═S)—, —C(═S)NR^{a}—, —SC(═O)NR^{a}—, —OC(═S)NR^{a}—, —NR^{a}C(═S)O—, and —NR^{a}C(═O)S—. Among these, —OC(═O)—, —C(═O)O—, —OC(═O)O—, —NR^{a}C(═O)—, —C(═O)NR^{a}—, —OC(═O)NR^{a}—, or —NR^{a}C(═O)O— is preferable. In the description of the linking group, the left side is bonded to the carbon atom to which R¹² is bonded and the right side is bonded to R^{P3}. For example, in a case where the linking group —OC(═O)— is described as an example, the left side means an ether bond side and the right side means a carbonyl bond side. The same applies hereinafter.

Further, preferred examples include a group consisting of a combination of an alkylene group or an arylene group, and at least one of a group selected from —O—, —S—, >C(═O), >C(═S), and >NR^{a} or a linking group consisting of a combination of two or more of these groups. Examples of the group include a —C(═O)NH-alkylene group, a —C(═O)O-alkylene group, a —C(═O)NH-arylene group, and a —C(═O)O-arylene group. Further, preferred examples thereof include a group formed by combining an alkylene group in a —C(═O)NH-alkylene group or a —C(═O)O-alkylene group or an arylene group in a —C(═O)NH-arylene group or a —C(═O)O-arylene group with —OC(═O)—, —C(═O)O—, —NR^{a}C(═O)—, —C(═O)NR^{a}—, —OC(═O)NR^{a}—, —NR^{a}C(═O)O—, —SC(═O)—, —C(═O)S—, —NR^{a}C(═S)—, —C(═S)NR^{a}—, —SC(═O)NR^{a}—, —OC(═S)NR^{a}—, —NR^{a}C(═S)O—, or —NR^{a}C(═O)S—.

L¹² represents preferably a single bond, a —C(═O)NH-alkylene group, a —C(═O)O-alkylene group, a —C(═O)NH-arylene group, a —C(═O)O-arylene group, or a group formed by combining an alkylene group in a —C(═O)NH-alkylene group or —C(═O)O-alkylene group or an arylene group in a —C(═O)NH-arylene group or a —C(═O)O-arylene group with —OC(═O)—, —C(═O)O—, —NR^{a}C(═O)—, —C(═O)NR^{a}—, —OC(═O)NR^{a}—, —NR^{a}C(═O)O—, —SC(═O)—, —C(═O)S—, —NR^{a}C(═S)—, —C(═S)NR^{a}—, —SC(═O)NR^{a}—, —OC(═S)NR^{a}—, —NR^{a}C(═S)O—, or —NR^{a}C(═O)S— and more preferably a single bond, a —C(═O)NH-alkylene group, a —C(═O)O-alkylene group, a —C(═O)NH-arylene group, a —C(═O)O-arylene group, or a group formed by combining an alkylene group in a —C(═O)NH-alkylene group or a —C(═O)O-alkylene group or an arylene group in a —C(═O)NH-arylene group or a —C(═O)O-arylene group with —OC(═O)—, —C(═O)O—, —NR^{a}C(═O)—, —C(═O)NR^{a}—, —OC(═O)NR^{a}—, or —NR^{a}C(═O)O—.

In each of the combined groups described above, —OC(═O)—, —C(═O)O—, —NR^{a}C(═O)—, —C(═O)NR^{a}—, —OC(═O)NR^{a}—, —NR^{a}C(═O)O—, —SC(═O)—, —C(═O)S—, —NR^{a}C(═S)—, —C(═S)NR^{a}—, —SC(═O)NR^{a}—, —OC(═S)NR^{a}—, —NR^{a}C(═S)O—, or —NR^{a}C(═O)S— positioned at the terminal may be further combined with an alkylene group or an arylene group.

R^{P3} represents a monovalent substituent.

Preferred examples of the monovalent substituent as R^{P3} includes an alkyl group, an alkenyl group, a monovalent aliphatic heterocyclic group, a monovalent aromatic heterocyclic group, an aryl group, a hydroxy group, a carboxy group, a sulfo group, a phosphoric acid group, a phosphonic acid group, a sulfanyl group, —NH₂, —CONH₂, and —SO₂NH₂.

R^{P3} represents preferably an alkyl group, an alkenyl group, an aryl group, a hydroxy group, a carboxy group, a sulfo group, a phosphoric acid group, a phosphonic acid group, a sulfanyl group, —NH₂, —CONH₂, or —SO₂NH₂ and more preferably an alkyl group, an alkenyl group, an aryl group, a hydroxy group, or —CONH₂.

Examples of the structural unit represented by General Formula (p2) include the following structural units. However, the examples are not limited to the following structural units.

Further, in the following chemical structural formula, R represents a hydrogen atom or a methyl group.

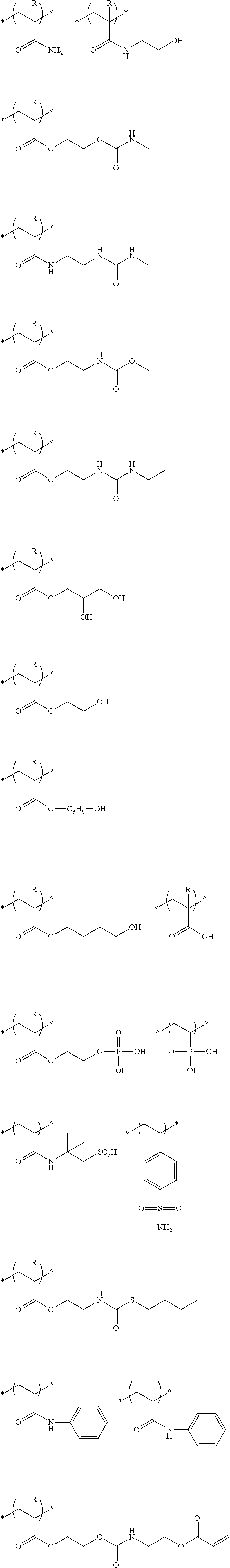

The proportion of the structural unit (b2) containing a hydrogen-bonding group in all structural units constituting the polymer B is preferably in a range of 3% to 90% by mass, more preferably in a range of 4% to 80% by mass from the viewpoint of further improving the adhesiveness, and still more preferably in a range of 5% to 70% by mass from the viewpoint of further improving the transmittance.

In a case where the polymer B has a structural unit other than the structural units (b1) and (b2) (other structural units), a proportion of the structural unit (b2) having a hydrogen bonding group in all structural units constituting the polymer B is preferably 3% to 30% by mass, more preferably 4% to 25% by mass, and still more preferably 5% to 20% by mass.

From the viewpoint of further improving the adhesiveness and moist heat durability, a vinyl polymer is preferable, and a vinyl polymer having a structural unit represented by General Formula (p1) as the structural unit (b1) and a structural unit represented by General Formula (p2) as the structural unit (b2) is more preferable as the polymer B.

(b3) Other Structural Units

The polymer B may have structural units other than the above-described structural units (b1) and (b2) (hereinafter, also referred to as “other structural units”).

The above-described other structural units are not particularly limited as long as the structural unit is a structural unit having neither the aromatic ring nor the hydrogen bonding group described above, and examples thereof include structural units derived from common monomers such as a (meth)acrylic acid ester compound, a vinyl ester compound, a (meth)acrylonitrile compound, and a maleic acid anhydride compound. By containing these structural units, it is possible to make adjustments so as to further improve the transmittance and the moisture heat durability.

Among these, preferred examples of the monomer for deriving the other structural units include a monomer selected from a (meth)acrylic acid ester compound, a (meth)acrylonitrile compound, or the like, and a (meth)acrylic acid ester compound is more preferable.

Specific examples thereof include an acrylic acid ester compound (specific examples thereof include methyl acrylate, ethyl acrylate, propyl acrylate, butyl acrylate, amyl acrylate, ethyl hexyl acrylate, octyl acrylate, t-octyl acrylate, chloroethyl acrylate, glycidyl acrylate, methoxybenzyl acrylate, or tetrahydrofurfuryl acrylate) such as alkyl acrylate (the number of carbon atoms of the alkyl group is preferably in a range of 1 to 20), a methacrylic acid ester compound (such as methyl methacrylate, ethyl methacrylate, propyl methacrylate, isopropyl methacrylate, amyl methacrylate, hexyl methacrylate, cyclohexyl methacrylate, chlorobenzyl methacrylate, octyl methacrylate, glycidyl methacrylate, or tetrahydrofurfuryl methacrylate) such as alkyl methacrylate (the number of carbon atoms of the alkyl group is preferably in a range of 1 to 20), acrylonitrile, and methacrylonitrile.

Among the above-described monomers, from the viewpoint of further improving the transmittance, an alkyl (meth)acrylate compound having an alkyl group having 4 to 20 carbon atoms is particularly preferable. The compatibility between the polymer B and the compound represented by General Formula (1) in the adhesive for a lens can be improved by using the polymer B having a structural unit derived from the above-described monomers as other structural units, and the compatibility between the compound represented by General Formula (1), the polymer B, and other components can be improved in a case where the polymer B contains other components, and thus a cured substance with high transparency can be obtained.

Further, from the viewpoint of improving the adhesiveness to glass, it is also preferable that the polymer B has a structural unit derived from a monomer (compound) containing an alkoxysilyl group as other structural units.

The monomer having an alkoxysilyl group is not particularly limited as long as it is a compound having at least one alkoxy group directly bonded to a silicon atom and having a polymerizable group (preferably, a radically polymerizable group), and it is preferable that the monomer having an alkoxysilyl group is a monomer having a dialkoxysilyl group and/or a trialkoxysilyl group and a polymerizable group, and it is more preferable to be a monomer having a trialkoxysilyl group and a polymerizable group.

Specific examples thereof include γ-methacryloxypropyltrialkoxysilane, γ-methacryloxypropyldialkoxysilane, or vinyltrialkoxysilane. Among these, γ-methacryloxypropyltrialkoxysilane or γ-acryloxypropyltrialkoxysilane is more preferable.

These monomers may be used alone or in combination of two or more kinds thereof.

In a case where the polymer B has other structural units, the proportion of the other structural units in all structural units constituting the polymer is preferably in a range of 2% to 65% by mass, more preferably in a range of 3% to 45% by mass, and still more preferably in a range of 5% to 40% by mass.

(Molecular Weight of Polymer B)

The mass average molecular weight (Mw) of the polymer B is preferably 1000 or greater, more preferably 3000 or greater, and still more preferably 5000 or greater. The upper limit of the mass average molecular weight thereof is preferably 500000 or less, more preferably 300000 or less, and still more preferably 200000 or less.

In the present invention, the mass average molecular weight is a weight-average molecular weight in terms of polystyrene measured by gel permeation chromatography (GPC) and is a value measured under the following measurement conditions. However, an appropriate eluant can be appropriately selected and used depending on a sample to be measured.

(Measurement Condition)
Measuring instrument: HLC-8320GPC (trade name, manufactured by Tosoh Corporation)
Column: connection of TOSOH TSKgel HZM-H (trade name, manufactured by Tosoh Corporation), TOSOH TSKgel HZ4000 (trade name, manufactured by Tosoh Corporation), and TOSOH TSKgel HZ2000 (trade name, manufactured by Tosoh Corporation)
Carrier: THF
Measurement temperature: 40° C.
Carrier flow rate: 0.35 ml/min
Sample concentration: 0.1% by mass
Detector: refractive index (RI) detector

Specific examples of the polymer B are shown below, but the polymer B in the present invention is not limited thereto. (in the following structural formulae means that it is a structural unit, and a numerical value described on the right side of each structural unit means a mass content ratio of each structural unit.

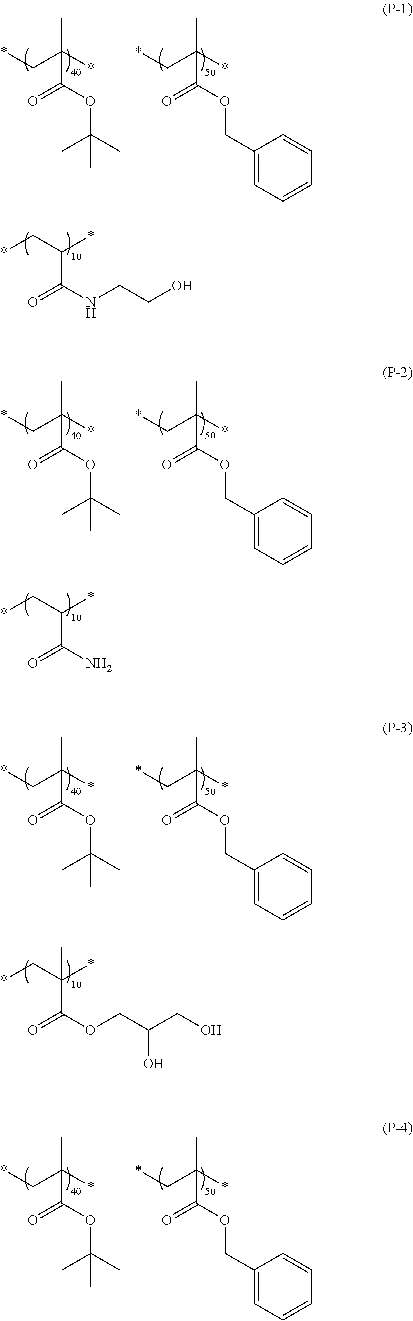

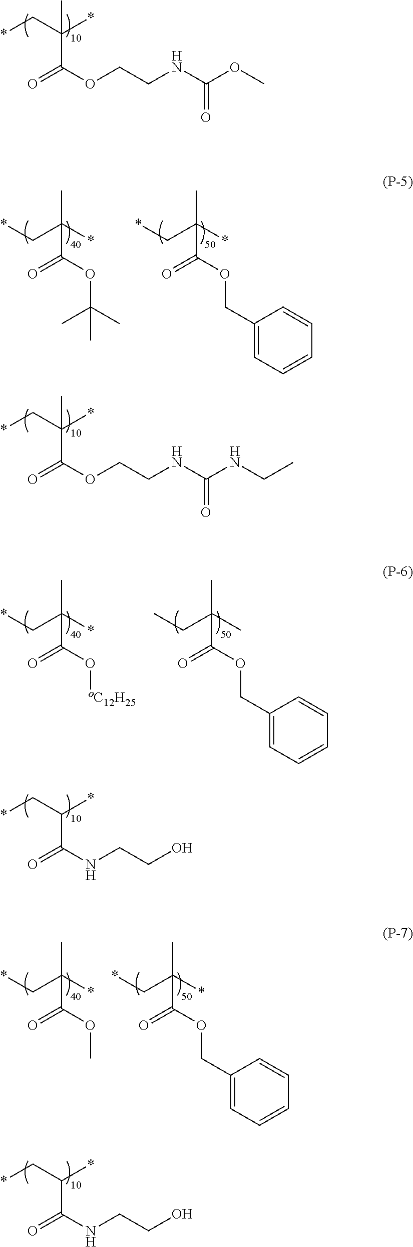

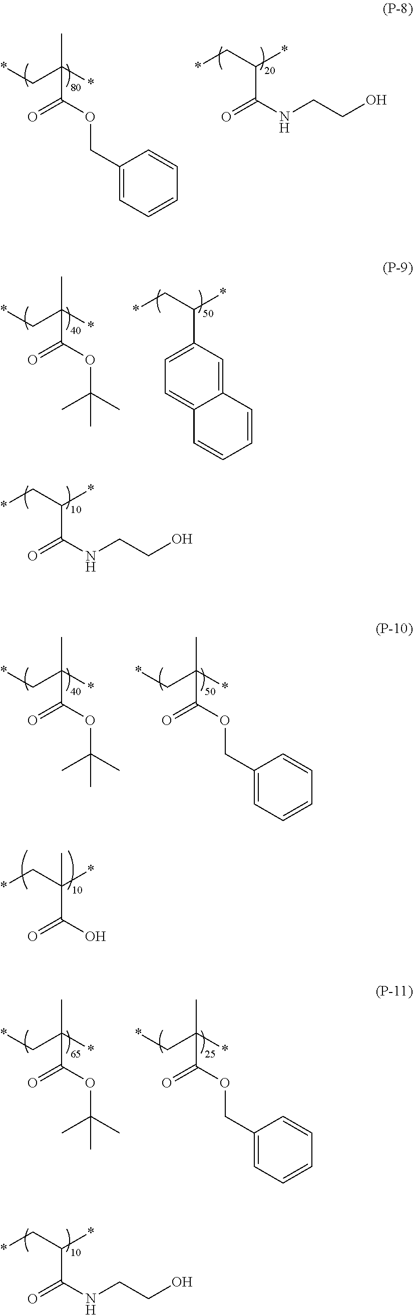

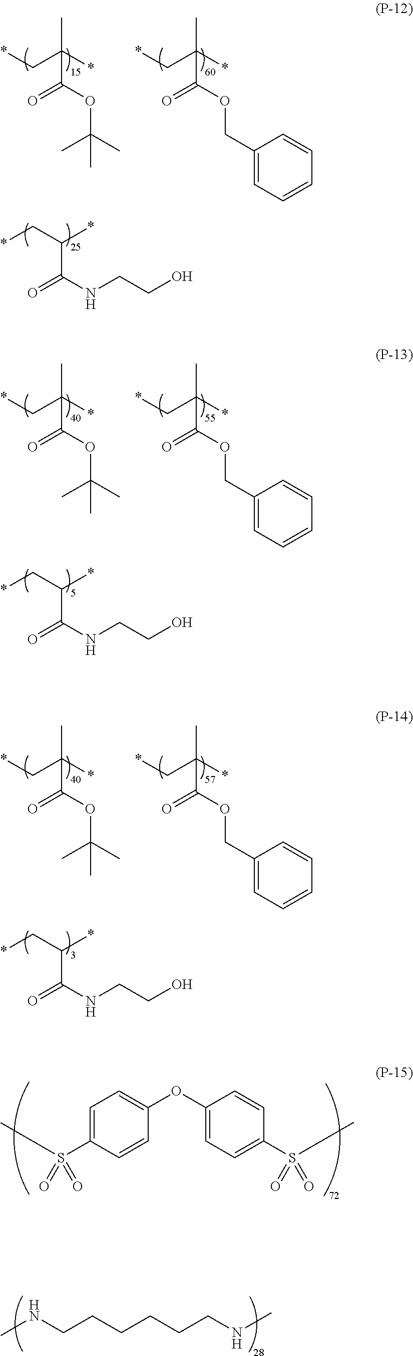

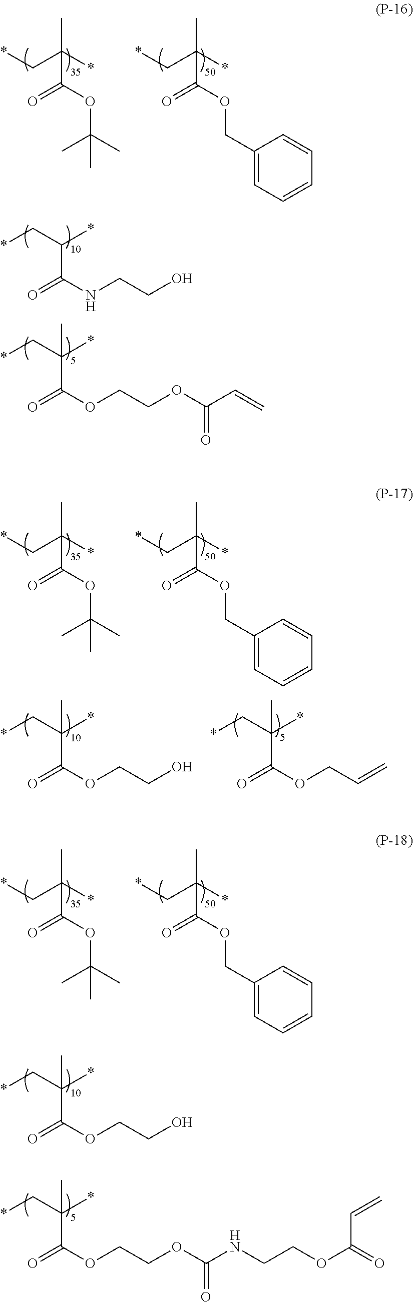

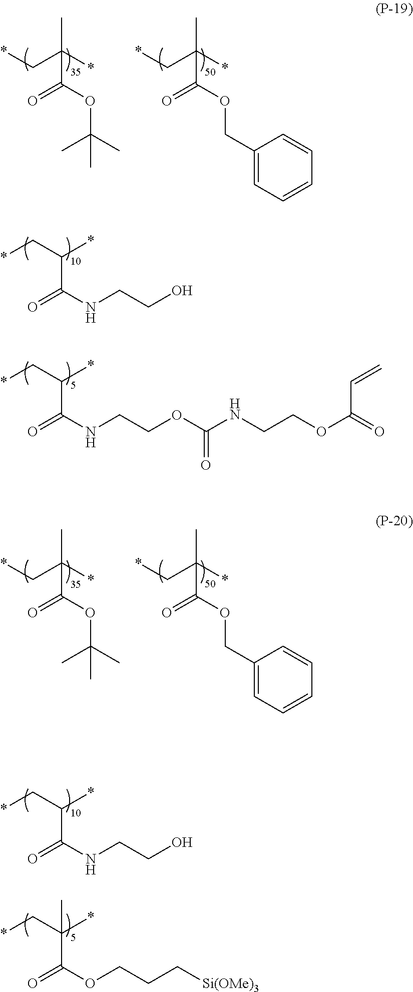

The content of the polymer B in the adhesive for a lens is preferably 60% by mass or less, more preferably 50% by mass or less, and still more preferably 40% by mass or less. The lower limit thereof is preferably 3% by mass or greater, more preferably 5% by mass or greater, and still more preferably 10% by mass or greater.

((Meth)Acrylate Monomer)

The adhesive for a lens may contain a (meth)acrylate monomer. As the (meth)acrylate monomer, those exemplified in the section of the curable composition according to the embodiment of the present invention can be used.

Preferred examples of (meth)acrylate monomers contained in the adhesive for a lens include a monofunctional (meth)acrylate monomer having an aromatic ring, such as phenoxyethyl acrylate (the above-described monomer 1) or benzyl acrylate, a (meth)acrylate monomer having an aliphatic group, such as a monomer a (2-ethylhexyl acrylate), a monomer b (1,6-hexanediol diacrylate), or a monomer c (1,6-hexanediol dimethacrylate), and a (meth)acrylate monomer containing a hydroxy group such as a monomer d (2-hydroxyethyl acrylate), a monomer e (hydroxypropyl acrylate), or a monomer f (4-hydroxybutyl acrylate).

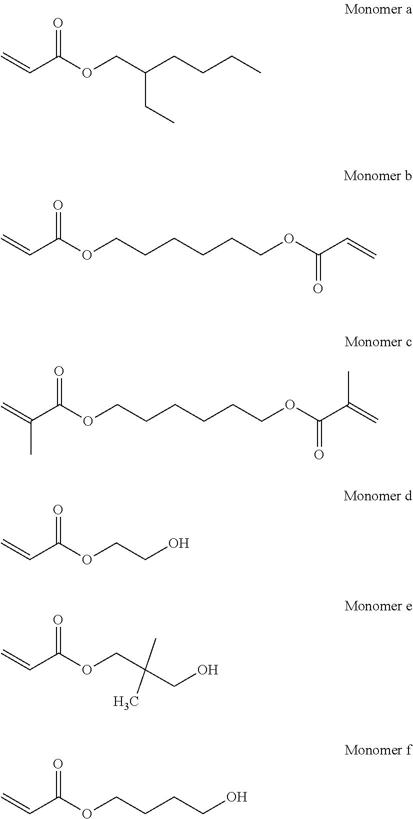

The method of obtaining the (meth)acrylate monomer is not particularly limited, and the (meth)acrylate monomer may be obtained commercially or produced synthetically. In a case where the compound is commercially available, preferred examples of the commercially available products thereof include VISCOAT #192 PEA (phenoxyethyl acrylate) (manufactured by Osaka Organic Chemical Industry Ltd.), VISCOAT #160 BZA (benzyl acrylate) (manufactured by Osaka Organic Chemical Industry Ltd.), 2EHA (monomer a) (manufactured by Toagosei Co., Ltd.), A-HD-N (monomer b) (manufactured by Shin-Nakamura Chemical Co., Ltd.), HD-N (monomer c) (manufactured by Shin-Nakamura Chemical Co., Ltd.), HEA (monomer d) (manufactured by Osaka Organic Chemical Industry Ltd.), LIGHT ESTER HOP-A (N) (monomer e) (manufactured by Kyoeisha Chemical Co., Ltd.), and 4-HBA (monomer f) (manufactured by Osaka Organic Chemical Industry Ltd.).

In a case where the adhesive for a lens contains a (meth)acrylate monomer, the content of the (meth)acrylate monomer is preferably in a range of 5% to 90% by mass, more preferably in a range of 10% to 85% by mass, and still more preferably in a range of 20% to 80% by mass with respect to the total mass of the adhesive for a lens. The function of relieving the stress in a case where the cured substance is thermally changed can be adjusted by adjusting the amount of the (meth)acrylate monomer in the adhesive for a lens.

(Polymerization Initiator)

It is preferable that the adhesive for a lens contains a photoradical polymerization initiator. The description of the photoradical polymerization initiator in the section of the composition according to the embodiment of the present invention can be applied to the photoradical polymerization initiator.

Further, the adhesive for a lens may contain a thermal radical polymerization initiator in addition to the photoradical polymerization initiator. The curing of a region where light does not reach can be promoted by allowing the adhesive for a lens to contain a thermal radical polymerization initiator. The description of the thermal radical polymerization initiator in the section of the composition according to the embodiment of the present invention can be applied to the thermal radical polymerization initiator.

[Production of Cemented Lens]

The cemented lens can be obtained by superimposing two lenses using the adhesive for a lens and curing the adhesive to form the adhesive layer. It is preferable that the curing is performed after removing air bubbles mixed into the adhesive after the superimposition.

The adhesive can be cured by performing irradiation with light or performing heating. It is preferable that the curing is performed by carrying out at least irradiation with light. In addition, a step of further heating the adhesive may be performed after the irradiation with light. The curing of the adhesive by light irradiation and heating is not particularly limited as long as an adhesive layer is formed, and the adhesive can be cured by a method of the related art.

The thickness of the adhesive layer is preferably in a range of 10 to 50 m and more preferably in a range of 20 to 30 m. In a case where the thickness thereof is set to 10 m or greater, an effect of absorbing ultraviolet rays can be sufficiently obtained. Further, in a case where the thickness thereof is set to 50 m or less, the transmittance in a short wavelength range (400 to 430 nm) of visible light can be increased while high adhesiveness is exhibited.

The refractive index of the adhesive layer at a wavelength of 587 nm is preferably 1.51 or greater, more preferably 1.53 or greater, and still more preferably 1.55 or greater. The reason for this is because a difference in the refractive index between the adhesive layer and a lens to be cemented decreases.

Further, a cutoff wavelength of the adhesive layer having a film thickness of 30 m is preferably 380 nm or less, more preferably 385 nm or less, and still more preferably 390 nm or less. A wavelength at which a transmittance of the adhesive layer is 0.5% or less is defined as the cutoff wavelength. The transmittance of the adhesive layer can be measured using a spectrophotometer (for example, UV-2550 (trade name) manufactured by Shimadzu Corporation).

The refractive index and the cutoff wavelength of the adhesive layer can be adjusted to be in the above-described ranges by the amount of the compound represented by General Formula (1) in the adhesive for a lens.

### EXAMPLES

Hereinafter, the present invention will be described in more detail based on the following examples. The materials, the amounts of materials used, the proportions, the treatment details, the treatment procedure, and the like shown in the examples below can be appropriately changed within a range not departing from the gist of the present invention. Therefore, the scope of the present invention should not be limitedly interpreted by the following specific examples.

Further, a step of preparing a curable composition and a preservation step of the prepared curable composition until using the prepared curable composition to prepare a cured substance were carried out in an environment where a yellow lamp was used as illumination.

### Synthesis Example

A component A was synthesized in the following manner.

Further, the abbreviations used in the synthesis of each compound described below denote the following compounds. Further, w/v % denotes a mass-to-volume percentage, and room temperature denotes 25° C.
EDAC: 1-ethyl-3-(3-dimethylaminopropyl) carbodiimide hydrochloride
MEK: methyl ethyl ketone
THF: tetrahydrofuran
Et: ethyl group

The HPLC measurement and the transmittance measurement were performed by the measurement methods described below.

(HPLC Measurement)

The purity of each compound was measured under the following conditions using high performance liquid chromatography (trade name: SPD-10AV VP) (manufactured by Shimadzu Corporation). Further, in a case where the compound was solvated, the HPLC purity was calculated after the peak derived from the solvent was subtracted.
Column: TSKgel ODS-100Z, 5 m (4.6 mmφ×150 mm) (manufactured by Tosoh Corporation)
Column temperature: 40° C.
Eluant: Acetonitrile:Pure water:Phosphoric acid (volume ratio)=700:300:1
Flow Rate: 1.0 ml/min
Detection wavelength: 254 nm
Injection volume: 10 μL
Sample: The compound was dissolved in the eluant such that the concentration thereof reached 5 mg/50 ml.

(Transmittance Measurement)

The transmittance of the compound at a wavelength of 420 nm was measured under the following conditions using a spectrophotometer (trade name: UV-2550, manufactured by Shimadzu Corporation). It was found that the coloring was less as the transmittance at a wavelength of 420 nm increased.
Cell: Square quartz cell (length of optical path: 1 cm)
Sample: The compound was dissolved in THF such that the concentration thereof reached 50 mg/5 mL.
Blank: THF (solvent)

[1. Synthesis of Raw Material Compounds (A4) and (A5)]

Raw material compounds (A4) and (A5) were synthesized in the following manner after compounds (SA-4) and (SA-5) were synthesized.

<Synthesis of Compound (SA-4)>

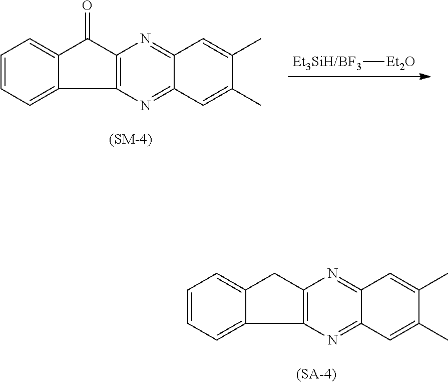

9.9 g of the compound (SM-4) and 40 mL of methylene chloride were added to a 500 mL three-neck flask, and 40 mL of trifluoroacetic acid and 15.2 g of triethylsilane were added while the mixture was cooled in an ice bath. Subsequently, 12.4 g of a boron trifluoride-diethyl ether complex was added dropwise to the mixture for 30 minutes, and the mixture was allowed to react at 40° C. for 3 hours. After the mixture was cooled to room temperature, 180 mL of cyclopentyl methyl ether was added thereto, and the mixture was further stirred for 2 hours. The precipitated solid was recovered by filtration and vacuum-dried in a pressure-reduced oven, thereby obtaining 6.2 g of a compound (SA-4) (yield of 66.0%).

<Synthesis of Compound (SA-5)>

8.2 g of a compound (SA-5) (yield of 86.5%) was obtained in the same manner as in the synthesis of the above-described compound (SA-4) except that the compound (SM-4) was changed to the compound (SM-5).

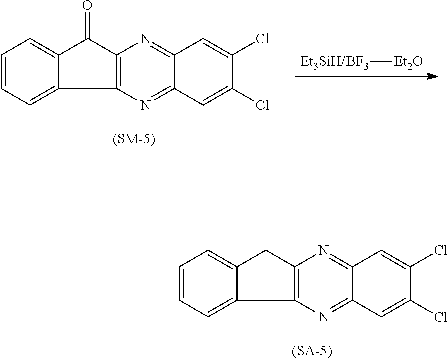

### Synthesis Example 1-1: Synthesis of Compound (A4)

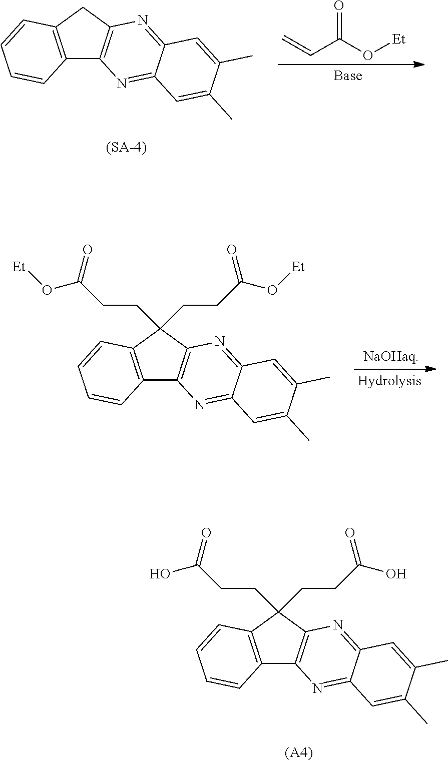

5.0 g of the compound (SA-4), 6.9 g of ethyl acrylate, and 50 mL of N,N-dimethylacetamide were added to a 200 mL three-neck flask, and the mixture was stirred at room temperature for 10 minutes. 2.9 g of a 40% by mass methanol solution of benzyltrimethylammonium hydroxide was added thereto, and the mixture was allowed to react at 80° C. for 1 hour. After the disappearance of the raw material compound (SA-4) was confirmed by TLC, 7.5 mL of water and 7.5 mL of a 50 w/v % sodium hydroxide aqueous solution were added thereto, and the mixture was stirred at 80° C. for 1 hour to hydrolyze ethyl ester. The mixture was cooled to room temperature and neutralized with 6 N hydrochloric acid, ethyl acetate was added thereto, and a liquid separation operation was performed. The organic layer was further washed with 1 N hydrochloric acid and saturated saline and dried over magnesium sulfate. The magnesium sulfate was removed by filtration, the solvent was concentrated, and the precipitated solid was dispersed and washed with a mixed solvent of ethyl acetate and hexane, thereby obtaining 6.2 g of a compound (A4) (yield of 78%). The area (%) of the compound (A4) acquired by HPLC measurement was 97.6%, and the area of the raw material compound (SA-4) was 0.1% or less. Further, the transmittance of the compound (A4) at 420 nm was 98.9%.

¹H-NMR data of compound (A4) (400 MHz, DMSO-d₆): δ 1.50 to 1.75 ppm (m, 4H), 2.35 to 2.55 ppm (m, 10H), 7.55 ppm (t, 1H), 7.62 ppm (t, 1H), 7.76 ppm (d, 1H), 7.90 to 7.95 ppm (m, 2H), 8.10 ppm (d, 1H), 12.0 ppm (s, 2H)

### Synthesis Example 1-2: Synthesis of Compound (A5)

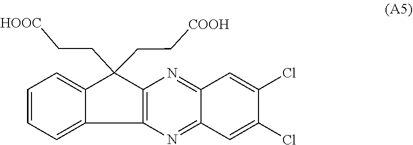 [SMILES: O=C(O)CCC1(CCC(=O)O)c2ccccc2-c2nc3cc(Cl)c(Cl)cc3nc21]

6.7 g of a compound (A5) was obtained (yield of 89%) in the same manner as in Synthesis Example 1-1 except that the compound (SA-4) was changed to the compound (SA-5). The area % of the compound (A5) acquired by HPLC measurement was 95.9%, and the area of the raw material compound (SA-5) was 0.1% or less. Further, the transmittance of the compound (A5) at 420 nm was 98.7%.

¹H-NMR data of compound (A5) (400 MHz, DMSO-d₆): δ 1.55 to 1.80 ppm (m, 4H), 2.35 to 2.55 ppm (m, 4H), 7.60 ppm (t, 1H), 7.75 ppm (t, 1H), 7.80 ppm (d, 1H), 8.12 ppm (d, 1H), 8.40 to 8.50 ppm (m, 2H), 12.0 ppm (s, 2H)

### Synthesis Example 2-1: Synthesis of Compound (A4-1)

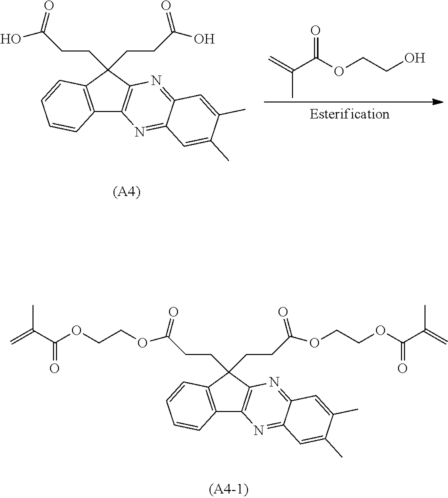

4.0 g of the compound (A4), 20 mL of dichloromethane, 3.3 g of 2-hydroxyethyl methacrylate, 0.1 g of N,N-dimethylaminopyridine, and 4.9 g of 1-ethyl-3-(3-dimethylaminopropyl) carbodiimide hydrochloride were mixed. The mixture was stirred at 40° C. for 2 hours, 1 N hydrochloric acid was added thereto, the mixture was washed and subjected to liquid separation, a 5% sodium hydrogen carbonate aqueous solution was added thereto, and the mixture was washed and subjected to liquid separation. The mixture was dehydrated, filtered, and concentrated with magnesium sulfate and purified by column chromatography (eluant: mixed solution of chloroform and methanol), thereby obtaining 4.4 g of a compound (A4-1) (yield of 70%).

¹H-NMR of compound (A4-1) (400 MHz, CDCl₃): δ=1.65 to 1.85 ppm (m, 4H), 1.89 ppm (s, 6H), 2.35 to 2.45 ppm (m, 2H), 2.50 ppm (s, 3H), 2.52 ppm (s, 3H), 2.65 to 2.75 ppm (m, 2H), 4.15 to 4.25 ppm (m, 8H), 5.55 ppm (s, 2H), 6.05 ppm (s, 2H), 7.55 to 7.65 ppm (m, 3H), 7.88 ppm (s, 1H), 7.92 ppm (s, 1H), 8.20 ppm (d, 2H)

The absorption spectrum (absorbance) of the compound (A4-1) was measured by the following procedure.

50 mg of the compound was precisely weighed, diluted with tetrahydrofuran (THF) using a 5 mL volumetric flask, and further diluted with THF such that the solution concentration was 1/500 times to prepare a measurement solution. The measurement was performed using UV-2550 (trade name, manufactured by Shimadzu Corporation).

First, a square quartz cell (cell length: 10 mm) in which a control sample (THF) was added to both a sample optical path and a control optical path was placed, and the absorbance in a wavelength range of 250 to 800 nm was adjusted to zero. Next, the sample in the cell on the sample optical path side was replaced with a measurement solution of the prepared compound, and the absorption spectrum at 250 to 800 nm was measured.

The wavelength λmax of the maximum peak on the longest wavelength side in a range of 300 to 400 nm obtained from the measurement results was 369 nm.

### Synthesis Example 2-2: Synthesis of Compound (A5-1)

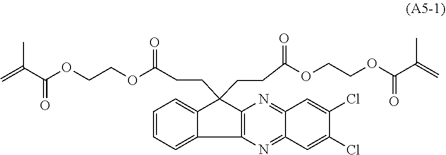 [SMILES: C=C(C)C(=O)OCCOC(=O)CCC1(CCC(=O)OCCOC(=O)C(=C)C)c2ccccc2-c2nc3cc(Cl)c(Cl)cc3nc21]

5.1 g of a compound (A5-1) (yield of 84%) was obtained in the same manner as in Synthesis Example 2-1 except that the compound (A4) was changed to the compound (A5).

¹H-NMR of compound (A5-1) (400 MHz, CDCl₃): δ=1.65 to 1.85 ppm (m, 4H), 1.89 ppm (s, 6H), 2.35 to 2.45 ppm (m, 2H), 2.65 to 2.75 ppm (m, 2H), 4.15 to 4.25 ppm (m, 8H), 5.55 ppm (s, 2H), 6.05 ppm (s, 2H), 7.55 to 7.65 ppm (m, 3H), 8.16 ppm (d, 1H), 8.24 ppm (s, 1H), 8.28 ppm (s, 1H)

The wavelength λmax of the maximum peak on the longest wavelength side in a range of 300 to 400 nm of the compound (A5-1) measured in the same manner as that for the compound (A4-1) was 372 nm.

### Synthesis Example 3: Synthesis of Polymer (P-4)

Pellets of the following polymer (P-4) were synthesized and used as a resin composition No. c14 in the same manner as in Example 1 of paragraph “0331” of JP2021-1328A. Further, the mass average molecular weight of the polymer (P-4) was 29,000.

Further, a two-stage reaction was carried out in the same manner as in Example 1 of paragraph “0331” of JP2021-1328A, the reaction was stopped by restoring the pressure to the normal pressure with nitrogen to synthesize the following polymer (P-4), and a compound (B-9) (octocrylene, manufactured by Tokyo Chemical Industry Co., Ltd.) or methyl cinnamate was added and kneaded to obtain the blending ratio listed in the table below. The obtained kneaded product was extruded into water, and the strands were cut to prepare resin pellet samples (resin compositions Nos. 105, c15, and c16).

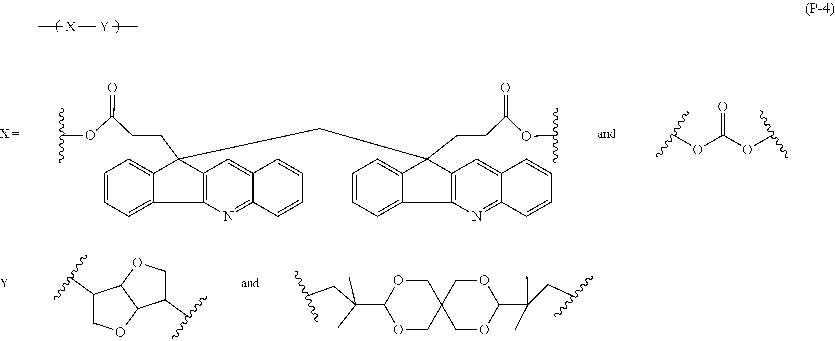

### Example 1: Curable Composition and Cured Substance Thereof

(1) Preparation of Curable Compositions (Compositions Nos. 101 to 104, 106 to 116, and c11 to c13)

The respective components were mixed to obtain the composition listed in the table described below, and the mixture was uniformly stirred, thereby preparing a curable composition.

(2) Preparation of Photocuring Sample

The prepared composition was injected into a circular transparent glass mold (made of borosilicate glass whose surface was subjected to a hydrophobic treatment with dichlorodimethylsilane) having a diameter of 20 mm such that the thickness of the cured substance reached 500 m. A short wavelength cut filter LU0422 (trade name, manufactured by Asahi Spectra Co., Ltd.) was disposed between a light source and the transparent glass mold using Execure 3000 (trade name, manufactured by HOYA Corporation) as the light source, and the transparent glass mold was irradiated with ultraviolet rays at an irradiation dose of 1000 mJ/cm² from above in an atmosphere where nitrogen substitution was carried out such that the oxygen concentration was set to 1% or less, thereby preparing a photocuring sample. Thereafter, the prepared sample was heated at 200° C. for 30 minutes and cooled to room temperature to obtain an evaluation sample, in an atmosphere where nitrogen substitution was carried out such that the oxygen concentration was set to 1% or less.

The curing reaction was completed by performing the ultraviolet irradiation step, and all cured substances were obtained as completely cured substances.

### Example 2: Resin Composition (Compositions Nos. 105 and c14 to c16) and Molded Body Thereof

A polyimide film was laid on the top and the bottom of the resin pellet sample prepared in the above-described manner using a spacer with a thickness of 500 m, the sample was preheated at a temperature of 200° C. to 230° C. for 3 minutes and pressurized at a pressure of 7 MPa for 5 minutes, the entire spacer was taken out, and the sample was cooled to room temperature, thereby obtaining an evaluation sample.

In addition, the compositions Nos. 101 to 116 are the compositions of the present invention, and the compositions Nos. c11 to c16 are comparative compositions.

[Evaluation 1: Transmittance Before Irradiation Test]

With regard to the obtained evaluation sample, an ultraviolet-visible transmittance measurement was performed on a central portion (5 mm in diameter) using an ultraviolet-visible spectrophotometer UV-2600 (trade name, manufactured by Shimadzu Corporation), and a transmittance (before the irradiation test) at a wavelength of 430 nm is acquired.

[Evaluation 2: Transmittance after Xenon-Light Irradiation Test for 48 Hours]

The evaluation samples prepared using compositions Nos. 101 to 116 and c11 to c16 were subjected to the xenon-light irradiation test under the following conditions. The irradiation test corresponds to a light resistance acceleration test in a sunlight environment.

The transmittance (after the irradiation test) of the evaluation sample after the xenon-light irradiation test at a wavelength of 430 nm was acquired by the method described in the section of “Evaluation 1: transmittance before irradiation test”.

(Xenon-Light Irradiation Conditions)
Device: Xenon accelerated weathering tester Q-SUN Xe-1 (trade name, manufactured by Q-Lab Corporation)
Light source: Xenon arc lamp
Optical filter: Extended UV Q/B (trade name, manufactured by Q-Lab Corporation)
Illuminance: 0.43 W/m² (340 nm illuminance meter)
Black panel temperature: 63° C.
Test time: 48 hours

[Evaluation 3: Decrease Range in the Transmittance Before and After Xenon-Light Irradiation Test for 48 Hours]

A difference between the transmittance at a wavelength of 430 nm obtained in the above-described Evaluation 1 (before the irradiation test) and the transmittance at a wavelength of 430 nm obtained in the above-described Evaluation 2 (after the irradiation test) was defined as the decrease range in the transmittance before and after the irradiation test.

<Optical Characteristics Measurement>

The “refractive index (nD)”, “Abbe number (νD)”, and “partial dispersion ratios (θg and F-Number)” of the cured substance of the curable composition obtained in Example 1 and the molded body of the resin composition obtained in Example 2 were measured using an Abbe refractometer (trade name: DR-M4, manufactured by Atago Co., Ltd.). The measurement was performed three times for each sample at 25° C., and the measurement result was obtained by calculating the average value thereof.

The “refractive index (nD)” is a refractive index at a wavelength of 587.56 nm. In addition, the “Abbe number (νD)” and the “partial dispersion ratios (θg and F-Number)” are values calculated from the refractive index measurement values at different wavelengths according to the following equations.

νD=(nD−1)/(nF−nC)

θg and F-Number=(ng−nF)/(nF−nC)

Here, nD represents a refractive index at a wavelength of 589 nm, nF represents a refractive index at a wavelength of 486 nm, nC represents a refractive index at a wavelength of 656 nm, and ng represents a refractive index at a wavelength of 436 nm.

All cured substances obtained from the curable compositions Nos. 101 to 104 and 106 to 116 and the molded bodies obtained from the resin composition Nos. 105 had an Abbe number of 26 to 20, which was low, and a partial dispersion ratio of 0.72 to 0.86, which was high, and thus the abnormal dispersibility of the refractive index acquired for a chromatic aberration correction lens was satisfied.

TABLE 1

| | Composition No. | | 101 | 102 | 103 | 104 | 105 | 106 | 107 | 108 | 109 | 110 | 111 |
|---|---|---|---|---|---|---|---|---|---|---|---|---|---|
| Composition | Component A | A-35 | 70 | — | — | — | — | — | 70 | 70 | 70 | 70 | 70 |
| | | A4-1 | — | 80 | — | — | — | — | — | — | — | — | — |
| | | A5-1 | — | — | 80 | — | — | — | — | — | — | — | — |
| | | VI-2 | — | — | — | 80 | — | — | — | — | — | — | — |
| | | P-4 | — | — | — | — | 90 | — | — | — | — | — | — |
| | | A-28 | — | — | — | — | — | 80 | — | — | — | — | — |
| | Other monomers | 2PEA | 10 | 5 | 5 | 5 | — | 5 | 10 | 10 | 10 | 10 | 5 |
| | | HDDMA | 10 | 5 | 5 | 5 | — | 5 | 10 | 10 | 10 | 10 | 15 |
| | Component B | B-9 | 10 | 10 | 10 | 10 | 10 | 10 | — | — | — | — | — |
| | | B-12 | — | — | — | — | — | — | 10 | — | — | — | — |
| | | B-13 | — | — | — | — | — | — | — | 10 | — | — | — |
| | | B-14 | — | — | — | — | — | — | — | — | 10 | — | — |
| | | B-21 | — | — | — | — | — | — | — | — | — | 10 | — |
| | | B-25 | — | — | — | — | — | — | — | — | — | — | 10 |
| | | B-50 | — | — | — | — | — | — | — | — | — | — | — |
| | | B-56 | — | — | — | — | — | — | — | — | — | — | — |
| | Comparative | Methyl cinnamate | — | — | — | — | — | — | — | — | — | — | — |
| | compositions | | | | | | | | | | | | |
| | Polymerization | Irg819 | 0.1 | 0.1 | 0.1 | 0.1 | — | 0.1 | 0.1 | 0.1 | 0.1 | 0.1 | 0.1 |
| | initiator | | | | | | | | | | | | |
| | Thermal | Perhexyl D | 0.1 | 0.1 | 0.1 | 0.1 | — | 0.1 | 0.1 | 0.1 | 0.1 | 0.1 | 0.1 |
| | polymerization | | | | | | | | | | | | |
| | initiator | | | | | | | | | | | | |
| | Total | | 100.2 | 100.2 | 100.2 | 100.2 | 100 | 100.2 | 100.2 | 100.2 | 100.2 | 100.2 | 100.2 |
| Evaluation | Transmittance at | Before irradiation test | 87% | 87% | 86% | 86% | 87% | 86% | 87% | 87% | 86% | 87% | 85% |
| | wavelength of | After irradiation test for | 83% | 82% | 81% | 72% | 76% | 79% | 82% | 80% | 79% | 76% | 75% |
| | 430 nm | 48 hours | | | | | | | | | | | |
| | | Decrease range before and | 4% | 5% | 5% | 14% | 11% | 7% | 5% | 7% | 7% | 11% | 10% |
| | | after irradiation test | | | | | | | | | | | |
| | Composition No. | | 112 | 113 | 114 | 115 | 116 | c11 | c12 | c13 | c 14 | c15 | c16 |
| Composition | Component A | A-35 | 70 | 70 | 70 | 70 | 70 | 70 | 70 | 70 | — | — | — |
| | | A4-1 | — | — | — | — | — | — | — | — | — | — | — |
| | | A5-1 | — | — | — | — | — | — | — | — | — | — | — |
| | | VI-2 | — | — | — | — | — | — | — | — | — | — | — |
| | | P-4 | — | — | — | — | — | — | — | — | 100 | 90 | 80 |
| | | A-28 | — | — | — | — | — | — | — | — | — | — | — |
| | Other | 2PEA | 12 | 13 | 14 | 10 | 10 | 15 | 10 | 5 | — | — | — |
| | monomers | HDDMA | 12 | 13 | 14 | 10 | 10 | 15 | 10 | 5 | — | — | — |
| | Component B | B-9 | — | — | — | — | — | — | — | — | — | — | — |
| | | B-12 | 6 | 4 | 2 | — | — | — | — | — | — | — | — |
| | | B-13 | — | — | — | — | — | — | — | — | — | — | — |
| | | B-14 | — | — | — | — | — | — | — | — | — | — | — |
| | | B-21 | — | — | — | — | — | — | — | — | — | — | — |
| | | B-25 | — | — | — | — | — | — | — | — | — | — | — |
| | | B-50 | — | — | — | 10 | — | — | — | — | — | — | — |
| | | B-56 | — | — | — | — | 10 | — | — | — | — | — | — |
| | Comparative | Methyl cinnamate | — | — | — | — | — | — | 10 | 20 | — | 10 | 20 |
| | compositions | | | | | | | | | | | | |
| | Polymerization | Irg819 | 0.1 | 0.1 | 0.1 | 0.1 | 0.1 | 0.1 | 0.1 | 0.1 | — | — | — |
| | initiator | | | | | | | | | | | | |
| | Thermal | Perhexyl D | 0.1 | 0.1 | 0.1 | 0.1 | 0.1 | 0.1 | 0.1 | 0.1 | — | — | — |
| | polymerization | | | | | | | | | | | | |
| | initiator | | | | | | | | | | | | |
| | Total | | 100.2 | 100.2 | 100.2 | 100.2 | 100.2 | 100.2 | 100.2 | 100.2 | 100 | 100 | 100 |
| Evaluation | Transmittance | Before irradiation test | 87% | 87% | 87% | 87% | 87% | 87% | 87% | 87% | 87% | 87% | 87% |
| | at wavelength | After irradiation test for | 82% | 80% | 77% | 83% | 83% | 42% | 70% | 70% | 38% | 64% | 64% |
| | of 430 nm | 48 hours | | | | | | | | | | | |
| | | Decrease range before | 5% | 7% | 10% | 4% | 4% | 45% | 17% | 17% | 49% | 23% | 23% |
| | | and after irradiation test | | | | | | | | | | | |

<Notes in tables>
Each component in the tables is as follows. Further, the blending amount ratio between components is on a mass basis, and ″—″ denotes that the corresponding component is not contained.

(Component A)

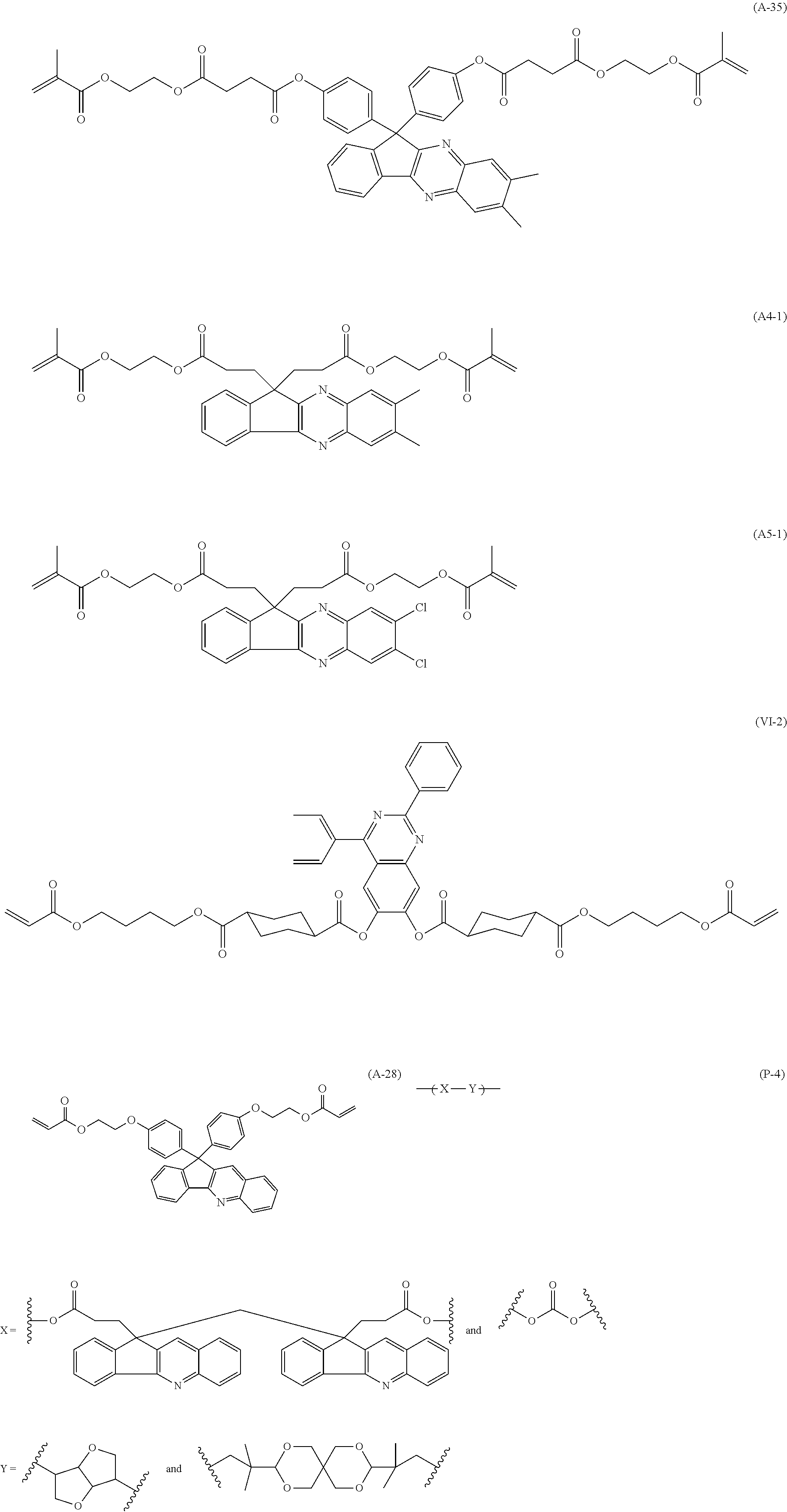

The compound (A-35) was synthesized according to Synthesis Example 9 [Synthesis of A-35] described in paragraph “0256” of WO2020/009053A.

The compound (VI-2) was synthesized according to [Synthesis of compound (VI-2)] described in paragraph “0233” of WO2020/009053A.

The compound (A-28) was synthesized according to the method for synthesizing the compound (27) described in paragraph “0139” of WO2017/115649A.

(Other monomers)

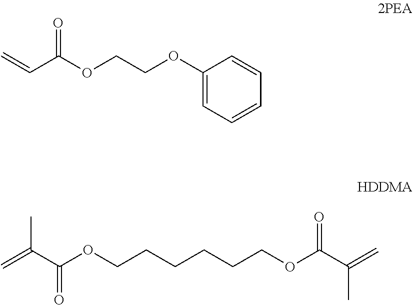 [SMILES: C=CC(=O)OCCOc1ccccc1 ; C=C(C)C(=O)OCCCCCCOC(=O)C(=C)C]

(Component B)

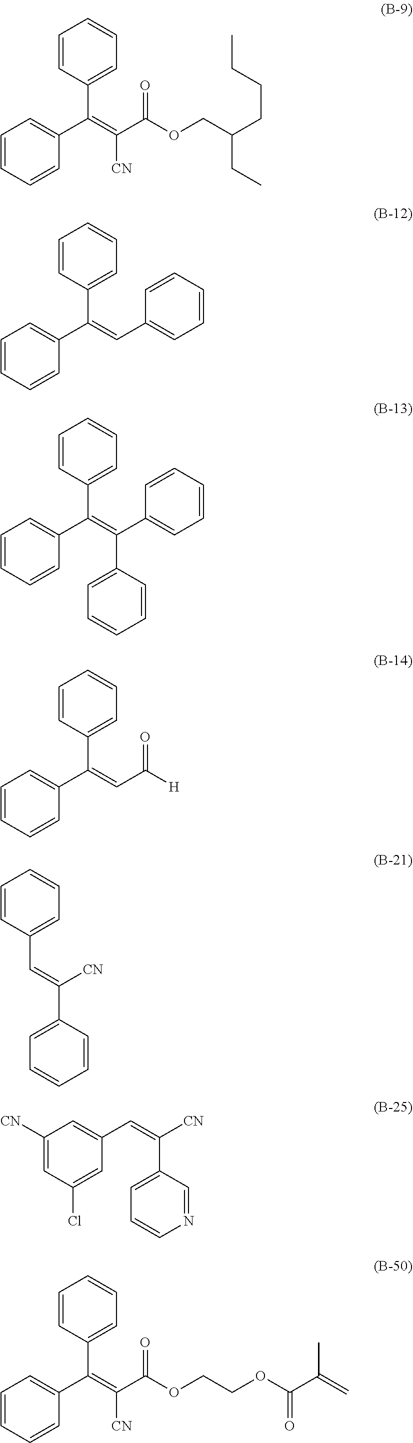

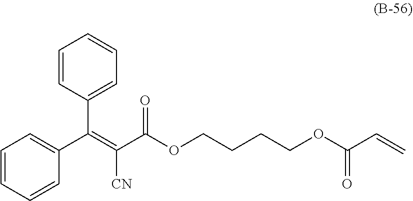 [SMILES: C=CC(=O)OCCCCOC(=O)C(C#N)=C(c1ccccc1)c1ccccc1]

A compound (B-50) was synthesized with reference to Example 3 of U.S. Pat. No. 4,218,392A.

A compound (B-56) was synthesized with reference to Example 5 of U.S. Pat. No. 4,218,392A.

(Comparative Compound)

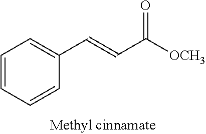 [SMILES: COC(=O)/C=C/c1ccccc1]

(Photopolymerization Initiator)

Irg819: Irgacure 819 (trade name, manufactured by BASF SE)

(Thermal Polymerization Initiator)

Perhexyl D: trade name, manufactured by NOF Corporation, di-tert-hexyl peroxide

The following results were found based on the results listed in Table 1.

The comparative composition No. c11 is not the composition defined in the present invention in terms that the comparative composition does not contain the component B defined in the present invention. It was found that in the cured substance obtained from the comparative composition No. c11, the transmittance before and after the light irradiation test was significantly decreased by 45% and the light resistance was not excellent. Further, the comparative compositions Nos. c12 and c13 are not the compositions defined in the present invention in terms that methyl cinnamate is used in place of the component B defined in the present invention. All cured substances obtained from the comparative compositions Nos. c12 and c13 have poor light resistance, with the decrease in the transmittance of 17% before and after the light irradiation test. In particular, although the amount of methyl cinnamate used in the comparative composition No. c13 was twice the amount of methyl cinnamate used in the comparative composition No. c12, there was no difference in the transmittance before and after the light irradiation test, and thus it was considered that the effect of suppressing the decrease in the transmittance was not obtained any more in a case of using methyl cinnamate.

On the contrary, in all the cured substances obtained from the curable compositions Nos. 101 to 104 and 106 to 116 of the present invention, the transmittance of each cured substance before the light irradiation test was excellent, and even the transmittance thereof after the light irradiation test was also excellent, and thus it was found that the decrease in the transmittance was able to be suppressed.

Further, the comparative composition No. c14 is not the composition defined in the present invention in terms that the comparative composition does not contain the component B defined in the present invention. It was found that in the molded body obtained from the comparative composition No. c14, the transmittance before and after the light irradiation test was significantly decreased by 49% and the light resistance was not excellent. Further, the comparative compositions Nos. c15 and c16 are not the compositions defined in the present invention in terms that methyl cinnamate is used in place of the component B defined in the present invention. All molded bodies obtained from the comparative compositions Nos. c15 and c16 have poor light resistance, with the decrease in the transmittance of 23% before and after the light irradiation test. In particular, although the amount of methyl cinnamate used in the comparative composition No. c16 was twice the amount of methyl cinnamate used in the comparative composition No. c15, there was no difference in the transmittance before and after the light irradiation test, and thus it was considered that the effect of suppressing the decrease in the transmittance was not obtained any more in a case of using methyl cinnamate.

On the contrary, in the molded body obtained from the resin composition No. 105 of the present invention, the transmittance of the molded body before the light irradiation test was excellent, and even the transmittance thereof after the light irradiation test was also excellent, and thus it was found that the decrease in the transmittance was able to be suppressed.

As described above, since the cured substance obtained from the curable composition of the present invention and the molded body obtained from the resin composition of the present invention have excellent light resistance, even in a case where the optical member and the lens which contain the cured substance or the molded body as the constituent member are used long-term in a light irradiation environment such as outdoors, coloration can be suppressed.

### Reference Example 1 (Preparation of Compound Lens Formed of Composition of Embodiment of Present Invention)

(1) Preparation of Curable Compositions (Compositions Nos. 117 to 125)

The each components were mixed to obtain the composition listed in the table described below, and the mixture was uniformly stirred, thereby preparing a curable composition (compositions Nos. 117 to 125).

(2) Preparation of Compound Lens

A compound lens was prepared in an atmosphere where nitrogen substitution was carried out such that the oxygen concentration was set to 1% or less. Specifically, 50 mg of the curable composition was injected into a biconcave glass lens A (glass material: BK7, outer diameter of 10 mm, the radius of curvature of the surface in contact with the curable composition was 12 mm and the radius of curvature of the other surface was 10 mm), and the lens was covered with a molding mold whose surface was subjected to a chromium nitride treatment, and pressed and stretched such that the diameter of the curable composition was set to 10 mm. In this case, a film thickness of layer of the curable composition in the central portion was about 600 m. After the glass lens A entered this state, a short wavelength cut filter LU0422 (trade name, manufactured by Asahi Spectra Co., Ltd.) was disposed between a light source and the glass lens A using Execure 3000 (trade name, manufactured by HOYA Corporation) as the light source, and the glass lens A was irradiated with ultraviolet rays at an irradiation dose of 300 mJ/cm² from above the glass lens A.

Next, while maintaining the state sandwiched between the molding mold and the glass lens A, the temperature was raised to 200° C. while applying a pressure of 0.196 MPa (2 kgf/cm²) to the curable composition. Thereafter, a compound lens consisting of the biconcave glass lens A and the cured substance of the curable composition was prepared by separating the cured substance of the curable composition and the molding mold at a speed of 0.05 mm/sec.

[Evaluation 4: Transmittance Before Irradiation Test]

With regard to the obtained compound lens, an ultraviolet-visible transmittance measurement was performed on a central portion (5 mm in diameter) using an ultraviolet-visible spectrophotometer UV-2600 (trade name, manufactured by Shimadzu Corporation), and a transmittance (before the irradiation test) at a wavelength of 430 nm is acquired.

[Evaluation 5: Transmittance after Xenon-Light Irradiation Test for 240 Hours]

The compound lenses formed of compositions Nos. 117 to 125 were subjected to the xenon-light irradiation test under the following conditions. The irradiation test corresponds to a light resistance acceleration test in a sunlight environment.

The transmittance (after the irradiation test) of the compound lens after the xenon-light irradiation test at a wavelength of 430 nm was acquired by the method described in the section of “Evaluation 4: transmittance before irradiation test”.

(Xenon-Light Irradiation Conditions)
Device: Xenon accelerated weathering tester Q-SUN Xe-1 (trade name, manufactured by Q-Lab Corporation)
Light source: Xenon arc lamp
Optical filter: Extended UV Q/B (trade name, manufactured by Q-Lab Corporation)
Illuminance: 0.43 W/m² (340 nm illuminance meter)
Black panel temperature: 63° C.
Test time: 240 hours

[Evaluation 6: Decrease Range in the Transmittance Before and After Xenon-Light Irradiation Test for 240 Hours]

A difference between the transmittance at a wavelength of 430 nm obtained in the above-described evaluation (before the irradiation test) and the transmittance at a wavelength of 430 nm obtained in the above-described evaluation 5 (after the irradiation test) was defined as the decrease range in the transmittance before and after the irradiation test.

[Evaluation 7: Heat Shock Resistance of Compound Lens]

Each 30 compound lenses formed of compositions Nos. 117 to 125 were prepared in the same procedure as in the preparation of the compound lens. In order to confirm the heat shock resistance of the obtained compound lens, the obtained lens was heated at 100° C. for 48 hours, then allowed to cool naturally to room temperature, and further cooled to −40° C. for 48 hours. Subsequently, the obtained compound lens was placed at room temperature environment and the temperature was returned to room temperature. Each of the compound lenses were subjected to a visual evaluation and an appearance inspection for cracks or peeling using a microscope (trade name: VHX-1000, manufactured by KEYENCE CORPORATION, magnification: 200×), and lenses that did not change before and after the test were determined as non-defective products. A non-defective product ratio was defined as a ratio of non-defective products to the 30 lenses, and the heat shock resistance was evaluated based on the following standard.

Evaluation Standards
A: A non-defective rate was 90% or more.
B: A non-defective rate was 80% or more and less than 90%.
C: A non-defective rate was 70% or more and less than 80%.
D: A non-defective rate was less than 70%.

TABLE 2

| | Composition No. | | 117 | 118 | 119 | 120 | 121 | 122 | 123 | 124 | 125 |
|---|---|---|---|---|---|---|---|---|---|---|---|
| Composition | Component A | A-35 | 60 | 60 | 60 | 60 | 60 | 60 | 60 | 60 | 60 |
| | Other monomers | HDDMA | 30 | 20 | 10 | 30 | 20 | 10 | 30 | 20 | 10 |
| | Component B | B-9 | 10 | 20 | 30 | — | — | — | — | — | — |
| | | B-50 | — | — | — | 10 | 20 | 30 | — | — | — |
| | | B-56 | — | — | — | — | — | — | 10 | 20 | 30 |
| | Polymerization | Irg819 | 0.1 | 0.1 | 0.1 | 0.1 | 0.1 | 0.1 | 0.1 | 0.1 | 0.1 |
| | initiator | | | | | | | | | | |
| | Thermal | Perhexyl D | 0.1 | 0.1 | 0.1 | 0.1 | 0.1 | 0.1 | 0.1 | 0.1 | 0.1 |
| | polymerization | | | | | | | | | | |
| | initiator | | | | | | | | | | |
| | Total | | 100.2 | 100.2 | 100.2 | 100.2 | 100.2 | 100.2 | 100.2 | 100.2 | 100.2 |
| Evaluation | Transmittance at | Before irradiation test | 88% | 87% | 87% | 88% | 86% | 86% | 88% | 87% | 87% |
| | wavelength of | After irradiation test for | 74% | 78% | 82% | 74% | 79% | 81% | 75% | 81% | 83% |
| | 430 nm | 240 hours | | | | | | | | | |
| | | Decrease range before and | 14% | 9% | 5% | 14% | 7% | 5% | 13% | 6% | 4% |
| | | after irradiation test | | | | | | | | | |

| | Compound lens | 117 | 118 | 119 | 120 | 121 | 122 | 123 | 124 | 125 |
|---|---|---|---|---|---|---|---|---|---|---|
| Evaluation | Heat shock resistance | A | B | C | A | A | A | A | A | A |

<Notes in tables>
Each component in the tables is as shown in Table 1 above. Further, the blending amount ratio between components is on a mass basis, and ″—″ denotes that the corresponding component is not contained.

From the results in Table 2, the following facts can be seen.

In all the compound lenses formed of the curable compositions Nos. 117 to 125 of the embodiment of the present invention, the transmittance of each cured substance before the light irradiation test was excellent, and even the transmittance thereof after the xenon-light irradiation test for 240 hours was also excellent, and thus it was found that the decrease in the transmittance was able to be suppressed and excellent light resistance exhibited.

Furthermore, it was found that in the compound lenses formed of the curable compositions Nos. 117 to 125 of the embodiment of the present invention, the occurrence of appearance changes such as cracks or peeling is suppressed and excellent heat shock resistance is also exhibited, even after the heat shock test.

As described above, the compound lens formed of the composition of the present invention has excellent light resistance, which is comparable to the light resistance of the cured substance formed of the curable composition of the present invention or the molded body formed of the resin composition of the present invention. Furthermore, excellent heat shock resistance is also exhibited.

### Reference Example (Preparation of Composition of Present Invention and Cemented Lens Formed of UV-Cut Adhesive)

[Synthesis of Monomer I-6 for Adhesive]

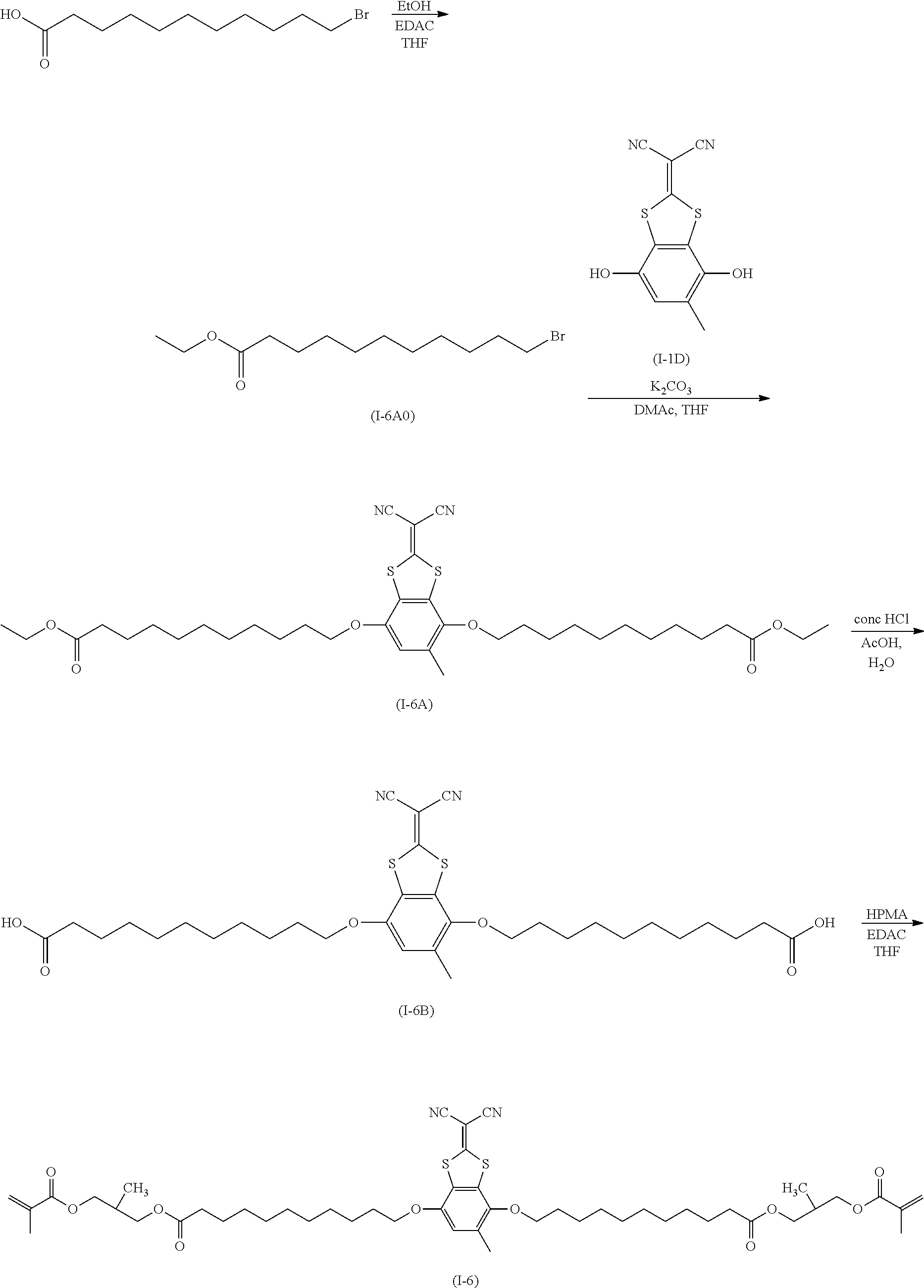

<Synthesis of Compound (I-6A0)>

The compound was synthesized by the same synthetic method as that for ethyl 11-bromoundecanoate (compound (I-6A0)) described in Bulletin of the Chemical Society of Japan, 81, 1518. The yield was 90%.

<Synthesis of Compound (I-6A)>

While mixing 36.9 g (125.8 mmol) of the compound (I-6A0), 15 g (57.2 mmol) of a compound (I-1D), 17.4 g (125.8 mmol) of potassium carbonate, 60 mL of THF, and 90 mL of N,N-dimethylacetamide, and the mixture was heated so that an internal temperature (liquid temperature) was 80° C. After stirring at 80° C. for 3 hours, 150 mL of ethyl acetate, 180 mL of water, and 30 mL of concentrated hydrochloric acid were added thereto, and the mixture was stirred, washed, and liquid-separated. Next, 150 mL of a 5% sodium hydrogen carbonate aqueous solution was added thereto, and the mixture was stirred, washed, and liquid-separated. Thereafter, 230 mL of methanol was added to the organic layer, and the precipitated crystals were filtered, thereby obtaining a compound (I-6A). The yield was 65%.

<Synthesis of Compound (I-6B)>

20 g (30.6 mmol) of the compound (I-6A), 20 mL of concentrated hydrochloric acid, 240 mL of acetic acid, and 80 mL of water were mixed and stirred at 80° C. for 1 hour. Thereafter, the temperature was returned to 25° C., 200 mL of water was added thereto, and the precipitated solid was filtered and washed with methanol and water and dried at 50° C., thereby obtaining a compound (I-6B). The yield was 90%.

<Synthesis of Compound (I-6) (Monomer I-6 for Adhesive)>

18 g (28.5 mmol) of the carboxylic acid compound (I-6B), 45 mL of ethyl acetate, 9.1 g (62.8 mmol) of hydroxypropyl methacrylate, 0.4 g (2.9 mmol) of N,N-dimethylaminopyridine, and 12 g (62.8 mmol) of 1-ethyl-3-(3-dimethylaminopropyl) carbodiimide hydrochloride (abbreviation: EDAC) were mixed. The mixture was stirred at 40° C. for 2 hours, 300 ml of 1 N hydrochloric acid was added thereto, the mixture was washed and subjected to liquid separation, a 5% sodium hydrogen carbonate aqueous solution was added thereto, and the mixture was washed and subjected to liquid separation. The mixture was dehydrated, filtered, and concentrated with magnesium sulfate to obtain an oily composition and purified by column chromatography, thereby obtaining a compound (I-6). The yield was 70%.

¹H-NMR (300 MHz, CDCl₃): δ (ppm) 1.25 to 1.50 (m, 30H), 1.50 to 1.70 (m, 8H), 1.95 (s, 6H), 2.20 to 2.40 (m, 7H), 3.85 (t, 2H), 4.0 (t, 2H), 4.10 to 4.30 (m, 4H), 5.10 to 5.30 (m, 2H), 5.60 (s, 2H), 6.10 (s, 2H), 6.70 (s, 1H)

[Synthesis of Polymer P10 for Adhesive]

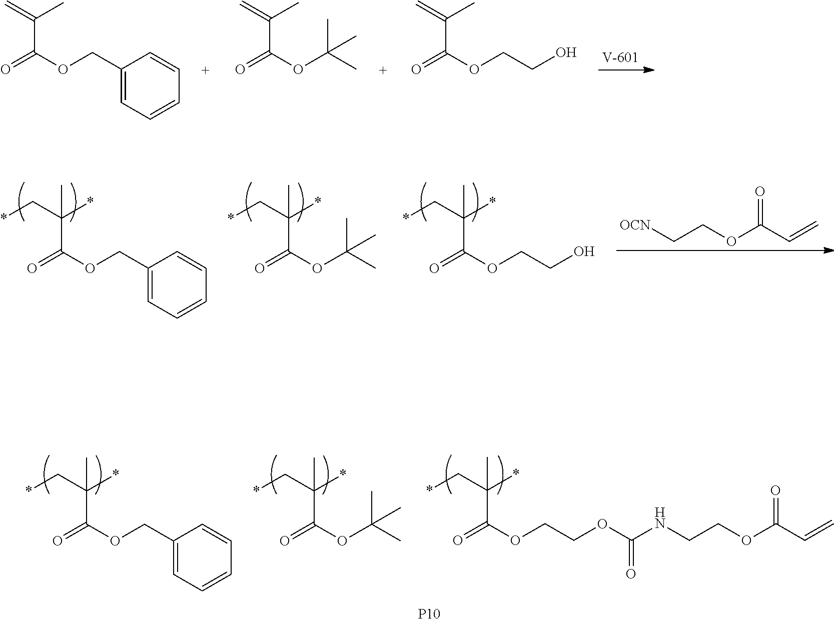

20.0 g of benzyl methacrylate (manufactured by FUJIFILM Wako Pure Chemical Corporation), 18.0 g of tert-butyl methacrylate (manufactured by FUJIFILM Wako Pure Chemical Corporation), and 2.0 g of (2-hydroxyethyl) methacrylate (manufactured by Tokyo Chemical Industry Co., Ltd.) were dissolved in 50 mL of cyclohexanone and heated to 80° C. in a nitrogen flow. A solution obtained by dissolving 1.0 g of a polymerization initiator (trade name: V-601, manufactured by FUJIFILM Wako Pure Chemical Corporation) in 20 mL of cyclohexanone was added dropwise to the solution for 30 minutes, and the resulting solution was allowed to react at 80° C. for 6 hours. The nitrogen flow was stopped, the temperature of the reaction solution was set to 70° C., 0.12 g of 2-tert-butyl-1,4-benzoquinone (manufactured by Tokyo Chemical Industry Co., Ltd.), 0.14 g of bismuth tris(2-ethylhexanoate) (trade name: NEOSTANN U-600, manufactured by Nitto Kasei Co., Ltd.), and 4.4 g of 2-isocyanatoethyl acrylate (trade name: KARENZ AOI, manufactured by Showa Denko K.K.) were added thereto, and the solution was allowed to react at 70° C. for 8 hours. The reaction solution was naturally cooled, a mixed solution of 200 mL of water and 1800 mL of methanol was added dropwise to the reaction solution, and the precipitated powder was collected by filtration and dried, thereby obtaining 30 g of a polymer P10. The mass average molecular weight (Mw) of the obtained polymer P10 was 19,000.

(1) Preparation of Adhesive Composition 1

3.0 g of the monomer I-6 for an adhesive, 3.0 g of the polymer P10, 2.0 g of dodecyl acrylate, 2.0 g of 4-hydroxybutyl acrylate, and 40 mg of Irgacure 819 (trade name, manufactured by BASF SE) serving as a photopolymerization initiator were mixed and stirred to be uniform, thereby preparing an adhesive composition 1.

(2) Preparation of Compound Lens

A compound lens was prepared in an atmosphere where nitrogen substitution was carried out such that the oxygen concentration was set to 1% or less. Specifically, 50 mg of the curable composition No. 101 was injected into a biconcave glass lens A (glass material: BK7, outer diameter of 10 mm, the radius of curvature of the surface in contact with the curable composition No. 101 was 12 mm and the radius of curvature of the other surface was 10 mm), and the lens was covered with a molding mold whose surface was subjected to a chromium nitride treatment, and pressed and stretched such that the diameter of the curable composition No. 101 was set to 10 mm. In this case, a film thickness of layer of the curable composition No. 101 in the central portion was about 600 m. After the glass lens A entered this state, a short wavelength cut filter LU0422 (trade name, manufactured by Asahi Spectra Co., Ltd.) was disposed between a light source and the glass lens A using Execure 3000 (trade name, manufactured by HOYA Corporation) as the light source, and the glass lens A was irradiated with ultraviolet rays at an irradiation dose of 300 mJ/cm² from above the glass lens A.

Next, the curable composition No. 101 was heated to 200° C. in a maintained state where the composition was sandwiched between the molding mold and the glass lens A while a pressure of 0.196 MPa (2 kgf/cm²) was applied to the composition. Thereafter, a compound lens 1 consisting of the biconcave glass lens A and the cured substance of the curable composition No. 101 was prepared by separating the cured substance of the curable composition No. 101 and the molding mold at a speed of 0.05 mm/sec.

(3) Preparation of Cemented Lens

The compound lens 1 prepared in the above-described manner was horizontally placed in a work box where nitrogen substitution was carried out, and a surface of the cured substance of the curable composition No. 101 was coated with the adhesive composition 1 prepared in the above-described manner. Next, a biconvex glass lens B (glass material: BK7, outer diameter of 10 mm, the radius of curvature of the surface that was bonded to the biconcave glass lens A was 12 mm and the radius of curvature of the other surface was 10 mm) was superimposed on the adhesive composition 1 applied onto the surface of the cured substance and pressed and stretched such that air bubbles did not enter. Here, the coating amount was adjusted such that the film thickness of the layer of the adhesive composition 1 at the central portion reached 20 m. Next, the adhesive composition 1 was cured by being irradiated with ultraviolet rays at an irradiation dose of 300 mJ/cm2 from the biconvex glass lens B side using Execure 3000 (trade name, manufactured by HOYA Corporation) as the light source in an atmosphere with an oxygen concentration of 1% or less, thereby preparing a cemented lens 1 with a configuration in which the biconcave glass lens A, the cured substance of the curable composition No. 101, the cured substance of the adhesive composition 1, and the biconvex glass lens B were laminated in order.

The transmittance of the obtained cemented lens 1 before and after the xenon-light irradiation test for 48 hours was measured in the same manner as in the evaluations 1 to 3 described above, and the decrease range in the transmittance before and after the irradiation test was calculated. In a case where xenon-light irradiation was performed, the cemented lens 1 was disposed such that light was incident on a side of the biconvex glass lens B of the cemented lens 1.

The transmittance before the xenon-light irradiation at 430 nm was 77% while the transmittance after the xenon light irradiation at 430 nm was 72%, and thus the decrease range in the transmittance was 5%, which indicated that the light resistance was excellent. This means that the cemented lens formed of the curable composition No. 101 of the present invention had excellent light resistance, which was comparable to the light resistance of the circular cured substance prepared by using the curable composition No. 101 of the present invention. Further, it was found that each cemented lens prepared by using the curable compositions Nos. 102 to 104 and 106 to 116 or the resin composition 105 of the embodiment of the present invention has excellent light resistance, which was comparable to the light resistance of the circular cured substance prepared by using the curable composition in Example 1.

As described above, the cemented lens formed of the composition of the present invention has excellent light resistance, which is comparable to the light resistance of the cured substance prepared by using the curable composition of the present invention or the molded body prepared by using the resin composition of the present invention.

The present invention has been described with the embodiments thereof, any details of the description of the present invention are not limited unless described otherwise, and it is obvious that the present invention is widely construed without departing from the gist and scope of the present invention described in the accompanying claims.

What is claimed is:

1. A composition comprising:
a component A which is a compound having a nitrogen-containing fused aromatic ring as a partial structure; and
a component B which is a compound represented by any of General Formulae (B1) to (B5), 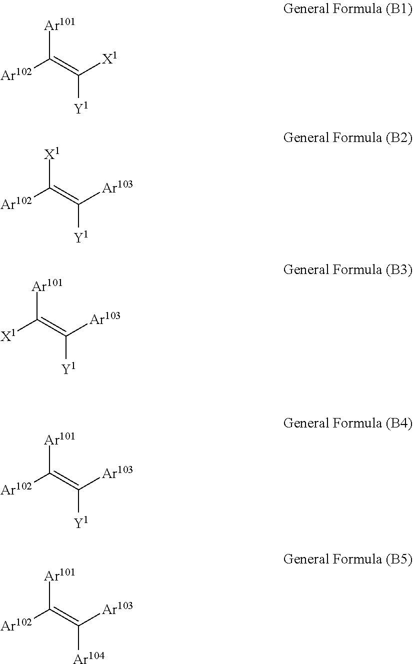
in General Formulae (B1) to (B5), Ar¹⁰¹ to Ar¹⁰⁴ represent an aryl group or a heteroaryl group, X¹ represents a monovalent substituent, Y¹ represents a hydrogen atom or a monovalent substituent, and adjacent two of Ar¹⁰¹ to Ar¹⁰⁴, X¹, and Y¹ may be bonded to each other to form a ring, where none of the monovalent substituents which may be employed as X¹ or Y¹ is an aryl group or a heteroaryl group.

2. The composition according to claim 1,
wherein the component A is a compound represented by General Formula (A1) or (A2) or a polymer having a structural unit represented by General Formula (A3) or (A4), 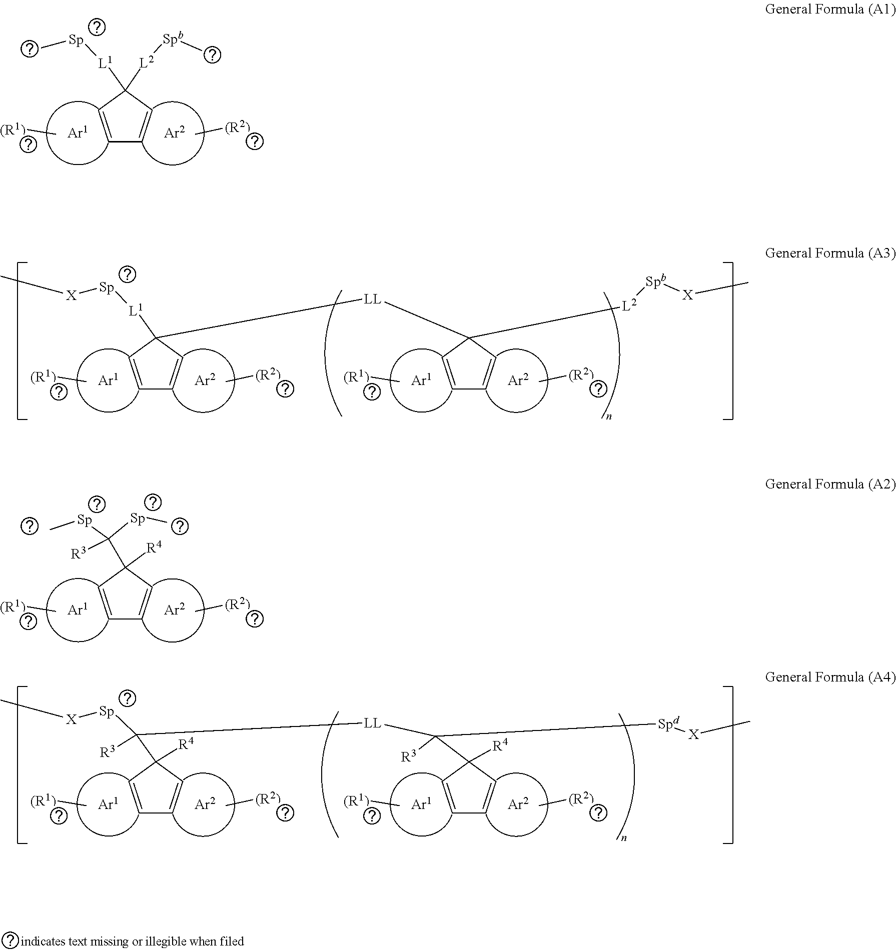
in General Formulae (A1) to (A4), R³ and R⁴ represent a hydrogen atom or a monovalent substituent,
L¹ and L² represent an alkylene group having 1 to 6 carbon atoms, an arylene group having 6 to 10 carbon atoms, or a heteroarylene group having 5 to 10 ring-constituting atoms,
LL represents a single bond or a divalent linking group, Sp^{a} to Sp^{d} represent a single bond or a divalent linking group,
Pol¹ and Pol² represent a hydrogen atom or a polymerizable group, where at least one of Pol¹ or Pol² represents a polymerizable group,
a ring Ar¹ represents an aromatic ring represented by Formula (AR1) or a fused ring having the aromatic ring as a ring constituting the fused ring,
a ring Ar² represents an aromatic ring represented by Formula (AR2) or a fused ring having the aromatic ring as a ring constituting the fused ring, where at least one of the ring Ar¹ or the ring Ar² is the nitrogen-containing fused aromatic ring,
R¹ represents a substituent contained in a ring-constituting atom of the ring Ar¹,
R² represents a substituent contained in a ring-constituting atom of the ring Ar²,
v represents an integer of 0 or greater, and a maximum number of v is a maximum number of substituents that may be contained in the ring-constituting atom of the ring Ar¹,
w represents an integer of 0 or greater, and a maximum number of w is a maximum number of substituents that may be contained in the ring-constituting atom of the ring Ar²,
n represents an integer of 0 to 5, and
X represents an oxygen atom, a carbonyl group, an amino group, or a group formed by combining two of these groups, 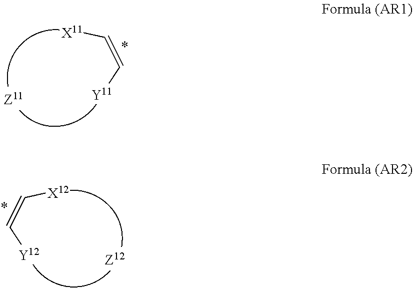
in Formulae (AR1) and (AR2), X¹¹, Y¹, X¹², and Y¹² represent an oxygen atom, a sulfur atom, a nitrogen atom, or a carbon atom,
Z¹¹ represents an atomic group which forms a 5- to 7-membered aromatic ring with —X¹¹—C═C—Y¹¹— and is composed of atoms selected from an oxygen atom, a sulfur atom, a nitrogen atom, and a carbon atom,
Z¹² represents an atomic group which forms a 5- to 7-membered aromatic ring with —X¹²—C═C—Y¹²— and is composed of atoms selected from an oxygen atom, a sulfur atom, a nitrogen atom, and a carbon atom, and
* corresponds to a double bond of a cyclopentadiene ring in General Formulae (A1) to (A4).

3. The composition according to claim 2,
wherein the component A is a compound represented by General Formula (A1).

4. The composition according to claim 3,
wherein the component A is a compound represented by General Formula (A11), 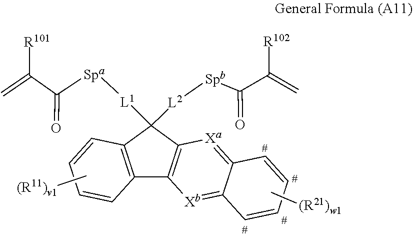
in General Formula (A11), X^{a} and X^{b} represent a nitrogen atom or CH, and CH at a position # may be substituted with a nitrogen atom, where at least one of X^{a}, X^{b}, or CH at the position # is a nitrogen atom,
R¹¹ and R²¹ represent a substituent,
v1 and w1 represent an integer of 0 to 4,
R¹⁰¹ and R¹⁰² represent a hydrogen atom or a methyl group, and
L¹, L², Sp^{a}, and Sp^{b} respectively have the same definition as that for L¹, L², Sp^{a}, and Sp^{b} in General Formula (A1).

5. The composition according to claim 1,
wherein the component B is a compound represented by any of General Formula (B11), (B41), or (B51), 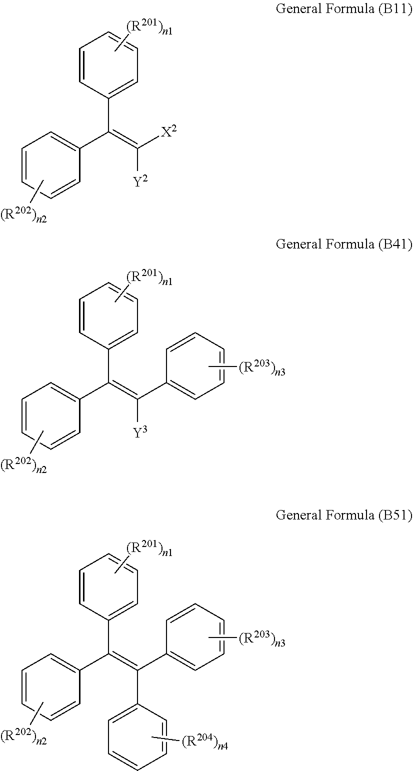
in General Formulae (B11), (B41), and (B51), R²⁰¹ to R²⁰⁴ represent a substituent, n1 to n4 represent an integer of 0 to 5,
X² represents a monovalent substituent, and
Y² and Y³ represent a hydrogen atom or a monovalent substituent, where none of the monovalent substituents may be employed as X², Y², or Y³ is an aryl group or a heteroaryl group.

6. The composition according to claim 5,
wherein at least one of R²⁰¹, R²⁰², X², or Y² in General Formula (B11), at least one of R²⁰¹, R²⁰², R²⁰³ or Y³ in General Formula (B41), and at least one of R²⁰¹, R²⁰², R²⁰³ or R²⁰⁴ in General Formula (B51) have a partial structure represented by any of Formulae (Pol-1) to (Pol-6),

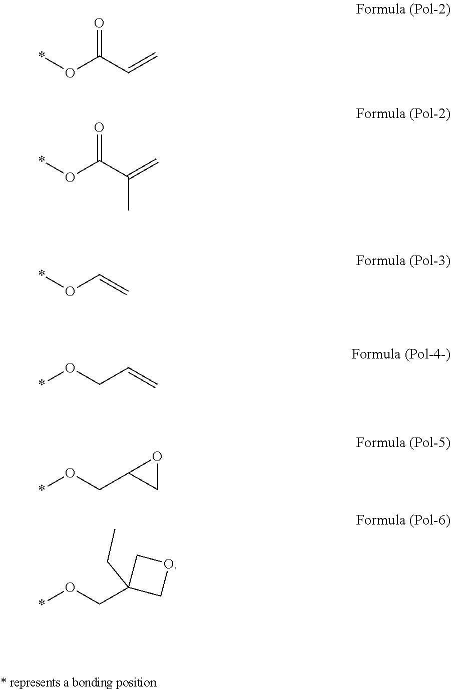

7. The composition according to claim 5,
wherein the component B is the compound represented by General Formula (B11) or (B41), where Y² represents a monovalent substituent.

8. The composition according to claim 6,
wherein the component B is a compound represented by General Formula (B12), 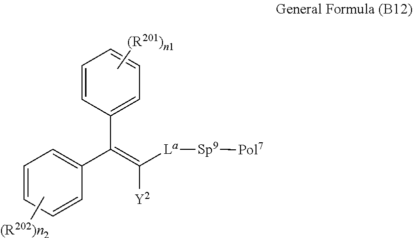
in General Formula (B12), L represents a single bond, —O—, —C(═O)—, —C(═O)O—, an alkylene group, —CR^{β1}═CR^{β2}—, a cycloalkylene group, or a cycloalkenylene group, where a right side of —C(═O)O— is bonded to Sp^{g},
R^{β1} and R^{β2} represent a hydrogen atom or a monovalent substituent,
Sp^{g} represents a single bond or a divalent linking group,
Pol⁷ is the group represented by any of Formulae (Pol-1) to (Pol-6),
where, in a case where L is a single bond, Sp^{g} is a single bond, and
R²⁰¹, R²⁰², n1, n2, and Y² respectively have the same definition as that for R²⁰¹, R²⁰², n1, n2, and Y².

9. A cured substance or a molded body of the composition according to claim 1.

10. An optical member comprising:
the cured substance or the molded body according to claim 9.

11. A lens comprising:
the cured substance or the molded body according to claim 9.
